(19) United States
(12) Patent Application Publication
(10) Pub. No.: US 2014/0335907 A1
(43) Pub. Date: Nov. 13, 2014

(54) Dynamic Point to Point Mobile Network Including Base Station Aspects System and Method

(71) Applicant: Elwha LLC, Bellevue, WA (US)

(72) Inventors: Roderick A. Hyde, Redmond, WA (US); Edward K.Y. Jung, Bellevue, WA (US); Royce A. Levien, Lexington, MA (US); Richard T. Lord, Tacoma, WA (US); Robert W. Lord, Seattle, WA (US); Mark A. Malamud, Seattle, WA (US); Clarence T. Tegreene, Mercer Island, WA (US)

(21) Appl. No.: 13/954,258

(22) Filed: Jul. 30, 2013

Related U.S. Application Data
(63) Continuation-in-part of application No. 13/891,369, filed on May 10, 2013.
Application No. 13/891,369 is a continuation-in-part of application No. 13/927,870, filed on Jun. 26, 2013.
Application No. 13/927,870 is a continuation-in-part of application No. 13/934,389, filed on Jul. 3, 2013.
Application No. 13/934,389 is a continuation-in-part of application No. 13/935,657, filed on Jul. 5, 2013.
Application No. 13/935,657 is a continuation-in-part of application No. 13/952,387, filed on Jul. 26, 2013.
Application No. 13/952,387 is a continuation-in-part of application No. 13/953,480, filed on Jul. 29, 2013.
Application No. 13/953,480 is a continuation-in-part of application No. 13/953,430, filed on Jul. 29, 2013.

(51) Int. Cl. H04B 7/26

(52) U.S. Cl. CPC H04B 7/26
USPC 455/517

(57) ABSTRACT

A computationally implemented system and method that is designed to, but is not limited to: relating first information with third information, the first information regarding second information having been received at first fixed position base station devices being part of a base station network, the second information regarding first communication related events involving one or more of the first mobile operating system based mobile communication devices and one or more of the first fixed position base station devices, the third information regarding the fourth information having been received at the one or more second fixed position base station devices being part of the base station network regarding second communication related events occurring directly between the two or more second mobile operating system based mobile communication devices. In addition to the foregoing, other method aspects are described in the claims, drawings, and text forming a part of the present disclosure.

### CROSS-REFERENCE TO RELATED APPLICATIONS

The present application is related to and/or claims the benefit of the earliest available effective filing date(s) from the following listed application(s) (the “Priority Applications”), if any, listed below (e.g., claims earliest available priority dates for other than provisional patent applications or claims benefits under 35 USC §119(e) for provisional patent applications, for any and all parent, grandparent, great-grandparent, etc. applications of the Priority Application(s)). In addition, the present application is related to the “Related Applications,” if any, listed below.

### PRIORITY APPLICATIONS

For purposes of the USPTO extra-statutory requirements, the present application constitutes a continuation-in-part of U.S. patent application Ser. No. 13/891,369, entitled DYNAMIC POINT TO POINT MOBILE NETWORK SYSTEM AND METHOD, naming Roderick A. Hyde, Edward K. Y. Jung, Royce A. Levien, Richard T. Lord, Robert W. Lord, Mark A. Malamud, Doug O. Reudink and Clarence T. Tegreene as inventors, filed 10 May 2013 with attorney docket no. 0213-003-024-000000, which is currently co-pending or is an application of which a currently co-pending application is entitled to the benefit of the filing date.

For purposes of the USPTO extra-statutory requirements, the present application constitutes a continuation-in-part of U.S. patent application Ser. No. 13/927,870, entitled DYNAMIC POINT TO POINT MOBILE NETWORK INCLUDING ORIGINATION DEVICE ASPECTS SYSTEM AND METHOD, naming Roderick A. Hyde, Edward K. Y. Jung, Royce A. Levien, Richard T. Lord, Robert W. Lord, Mark A. Malamud, Doug O. Reudink and Clarence T. Tegreene as inventors, filed 26 Jun. 2013 with attorney docket no. 0213-003-025-000000, which is currently co-pending or is an application of which a currently co-pending application is entitled to the benefit of the filing date.

For purposes of the USPTO extra-statutory requirements, the present application constitutes a continuation-in-part of U.S. patent application Ser. No. 13/934,389, entitled DYNAMIC POINT TO POINT MOBILE NETWORK INCLUDING INTERMEDIATE DEVICE ASPECTS SYSTEM AND METHOD, naming Roderick A. Hyde, Edward K. Y. Jung, Royce A. Levien, Richard T. Lord, Robert W. Lord, Mark A. Malamud, Doug O. Reudink and Clarence T. Tegreene as inventors, filed 3 Jul. 2013 with attorney docket no. 0213-003-026-000000, which is currently co-pending or is an application of which a currently co-pending application is entitled to the benefit of the filing date.

For purposes of the USPTO extra-statutory requirements, the present application constitutes a continuation-in-part of U.S. patent application Ser. No. 13/935,657, entitled DYNAMIC POINT TO POINT MOBILE NETWORK INCLUDING DESTINATION DEVICE ASPECTS SYSTEM AND METHOD, naming Roderick A. Hyde, Edward K. Y. Jung, Royce A. Levien, Richard T. Lord, Robert W. Lord, Mark A. Malamud, Doug O. Reudink and Clarence T. Tegreene as inventors, filed 5 Jul. 2013 with attorney docket no. 0213-003-027-000000, which is currently co-pending or is an application of which a currently co-pending application is entitled to the benefit of the filing date.

For purposes of the USPTO extra-statutory requirements, the present application constitutes a continuation-in-part of U.S. patent application Ser. No. 13/952,387, entitled DYNAMIC POINT TO POINT MOBILE NETWORK INCLUDING ORIGINATION DEVICE ASPECTS SYSTEM AND METHOD, naming Roderick A. Hyde, Edward K. Y. Jung, Royce A. Levien, Richard T. Lord, Robert W. Lord, Mark A. Malamud, Doug O. Reudink and Clarence T. Tegreene as inventors, filed 26 Jul. 2013 with attorney docket no. 0213-003-025-000001, which is currently co-pending or is an application of which a currently co-pending application is entitled to the benefit of the filing date.

For purposes of the USPTO extra-statutory requirements, the present application constitutes a continuation-in-part of U.S. patent application Ser. No. 13/953,480, entitled DYNAMIC POINT TO POINT MOBILE NETWORK INCLUDING INTERMEDIATE DEVICE ASPECTS SYSTEM AND METHOD, naming Roderick A. Hyde, Edward K. Y. Jung, Royce A. Levien, Richard T. Lord, Robert W. Lord, Mark A. Malamud, Doug O. Reudink and Clarence T. Tegreene as inventors, filed 29 Jul. 2013 with attorney docket no. 0213-003-026-000001, which is currently co-pending or is an application of which a currently co-pending application is entitled to the benefit of the filing date.

For purposes of the USPTO extra-statutory requirements, the present application constitutes a continuation-in-part of U.S. patent application Ser. No. 13/953,430, entitled DYNAMIC POINT TO POINT MOBILE NETWORK INCLUDING DESTINATION DEVICE ASPECTS SYSTEM AND METHOD, naming Roderick A. Hyde, Edward K. Y. Jung, Royce A. Levien, Richard T. Lord, Robert W. Lord, Mark A. Malamud, Doug O. Reudink and Clarence T. Tegreene as inventors, filed 29 Jul. 2013 with attorney docket no. 0213-003-027-000001, which is currently co-pending or is an application of which a currently co-pending application is entitled to the benefit of the filing date.

### RELATED APPLICATIONS

None.

The United States Patent Office (USPTO) has published a notice to the effect that the USPTO's computer programs require that patent applicants reference both a serial number and indicate whether an application is a continuation, continuation-in-part, or divisional of a parent application. Stephen G. Kunin, Benefit of Prior-Filed Application, USPTO Official Gazette Mar. 18, 2003. The USPTO further has provided forms for the Application Data Sheet which allow automatic loading of bibliographic data but which require identification of each application as a continuation, continuation-in-part, or divisional of a parent application. The present Applicant Entity (hereinafter “Applicant”) has provided above a specific reference to the application(s) from which priority is being claimed as recited by statute. Applicant understands that the statute is unambiguous in its specific reference language and does not require either a serial number or any characterization, such as “continuation” or “continuation-in-part,” for claiming priority to U.S. patent applications. Notwithstanding the foregoing, Applicant understands that the USPTO's computer programs have certain data entry requirements, and hence Applicant has provided designation(s) of a relationship between the present application and its parent application(s) as set forth above and in any ADS filed in this application, but expressly points out that such designation(s) are not to be construed in any way as any type of commentary and/or admission as to whether or not the present application contains any new matter in addition to the matter of its parent application(s).

If the listings of applications provided above are inconsistent with the listings provided via an ADS, it is the intent of the Applicant to claim priority to each application that appears in the Priority Applications section of the ADS and to each application that appears in the Priority Applications section of this application.

All subject matter of the Priority Applications and the Related Applications and of any and all parent, grandparent, great-grandparent, etc. applications of the Priority Applications and the Related Applications, including any priority claims, is incorporated herein by reference to the extent such subject matter is not inconsistent herewith.

If an Application Data Sheet (ADS) has been filed on the filing date of this application, it is incorporated by reference herein. Any applications claimed on the ADS for priority under 35 U.S.C. §§119, 120, 121, or 365(c), and any and all parent, grandparent, great-grandparent, etc. applications of such applications, are also incorporated by reference, including any priority claims made in those applications and any material incorporated by reference, to the extent such subject matter is not inconsistent herewith.

### SUMMARY

In one aspect, a computationally-implemented method includes, but is not limited to receiving first information regarding second information, the second information having been received at one or more first fixed position base station devices being part of a base station network including fixed position base station devices, the second information regarding one or more first communication related events involving one or more first mobile operating system based mobile communication devices and the one or more first fixed position base station devices, each of the first communication related events involving one or more of the first mobile operating system based mobile communication devices and one or more of the first fixed position base station devices; receiving third information regarding fourth information, the fourth information having been received at one or more second fixed position base station devices being part of the base station network including fixed position base station devices, the fourth information regarding one or more second communication related events occurring directly between two or more second mobile operating system based mobile communication devices; and relating the first information with the third information, the first information regarding the second information having been received at the one or more first fixed position base station devices being part of a base station network including fixed position base station devices, the second information regarding the one or more first communication related events involving the one or more first mobile operating system based mobile communication devices and the one or more first fixed position base station devices, each of the first communication related events involving one or more of the first mobile operating system based mobile communication devices and one or more of the first fixed position base station devices, the third information regarding the fourth information the fourth information having been received at the one or more second fixed position base station devices being part of the base station network including fixed position base station devices, the fourth information regarding the one or more second communication related events occurring directly between the two or more second mobile operating system based mobile communication devices. In addition to the foregoing, other method aspects are described in the claims, drawings, and text forming a part of the disclosure set forth herein.

In one or more various aspects, related machines, compositions of matter, or manufactures of systems may include, but are not limited to, circuitry and/or programming for effecting the herein-referenced method aspects; the circuitry and/or programming can be virtually any combination of hardware, software, and/or firmware configured to effect the herein-referenced method aspects depending upon the design choices of the system designer (limited to patentable subject matter under 35 USC 101).

A computationally-implemented system includes, but is not limited to: means for receiving first information regarding second information, the second information having been received at one or more first fixed position base station devices being part of a base station network including fixed position base station devices, the second information regarding one or more first communication related events involving one or more first mobile operating system based mobile communication devices and the one or more first fixed position base station devices, each of the first communication related events involving one or more of the first mobile operating system based mobile communication devices and one or more of the first fixed position base station devices; means for receiving third information regarding fourth information, the fourth information having been received at one or more second fixed position base station devices being part of the base station network including fixed position base station devices, the fourth information regarding one or more second communication related events occurring directly between two or more second mobile operating system based mobile communication devices; and means for relating the first information with the third information, the first information regarding the second information having been received at the one or more first fixed position base station devices being part of a base station network including fixed position base station devices, the second information regarding the one or more first communication related events involving the one or more first mobile operating system based mobile communication devices and the one or more first fixed position base station devices, each of the first communication related events involving one or more of the first mobile operating system based mobile communication devices and one or more of the first fixed position base station devices, the third information regarding the fourth information the fourth information having been received at the one or more second fixed position base station devices being part of the base station network including fixed position base station devices, the fourth information regarding the one or more second communication related events occurring directly between the two or more second mobile operating system based mobile communication devices. In addition to the foregoing, other system aspects are described in the claims, drawings, and text forming a part of the disclosure set forth herein.

A computationally-implemented system includes, but is not limited to electrical circuitry arrangement for receiving first information regarding second information regarding first communication related events involving first mobile operating system based mobile communication devices and first fixed position base station devices; electrical circuitry arrangement for receiving third information regarding fourth information regarding second communication related events occurring directly between second mobile operating system based mobile communication devices; and electrical circuitry arrangement for relating first information with third information. In addition to the foregoing, other system aspects are described in the claims, drawings, and text forming a part of the disclosure set forth herein.

A system includes, but is not limited to receiving first information regarding second information regarding first communication related events involving first mobile operating system based mobile communication devices and first fixed position base station devices module configured to operate in accordance with receiving first information regarding second information, the second information having been received at one or more first fixed position base station devices being part of a base station network including fixed position base station devices, the second information regarding one or more first communication related events involving one or more first mobile operating system based mobile communication devices and the one or more first fixed position base station devices, each of the first communication related events involving one or more of the first mobile operating system based mobile communication devices and one or more of the first fixed position base station devices; receiving third information regarding fourth information regarding second communication related events occurring directly between second mobile operating system based mobile communication devices module configured to operate in accordance with receiving third information regarding fourth information, the fourth information having been received at one or more second fixed position base station devices being part of the base station network including fixed position base station devices, the fourth information regarding one or more second communication related events occurring directly between two or more second mobile operating system based mobile communication devices; and relating first information with third information module configured to operate in accordance with relating the first information with the third information, the first information regarding the second information having been received at the one or more first fixed position base station devices being part of a base station network including fixed position base station devices, the second information regarding the one or more first communication related events involving the one or more first mobile operating system based mobile communication devices and the one or more first fixed position base station devices, each of the first communication related events involving one or more of the first mobile operating system based mobile communication devices and one or more of the first fixed position base station devices, the third information regarding the fourth information the fourth information having been received at the one or more second fixed position base station devices being part of the base station network including fixed position base station devices, the fourth information regarding the one or more second communication related events occurring directly between the two or more second mobile operating system based mobile communication devices. In addition to the foregoing, other system aspects are described in the claims, drawings, and text forming a part of the disclosure set forth herein.

An article of manufacture including one or more non-transitory signal-bearing storage medium bearing one or more instructions for receiving first information regarding second information, the second information having been received at one or more first fixed position base station devices being part of a base station network including fixed position base station devices, the second information regarding one or more first communication related events involving one or more first mobile operating system based mobile communication devices and the one or more first fixed position base station devices, each of the first communication related events involving one or more of the first mobile operating system based mobile communication devices and one or more of the first fixed position base station devices; one or more instructions for receiving third information regarding fourth information, the fourth information having been received at one or more second fixed position base station devices being part of the base station network including fixed position base station devices, the fourth information regarding one or more second communication related events occurring directly between two or more second mobile operating system based mobile communication devices; and one or more instructions for relating the first information with the third information, the first information regarding the second information having been received at the one or more first fixed position base station devices being part of a base station network including fixed position base station devices, the second information regarding the one or more first communication related events involving the one or more first mobile operating system based mobile communication devices and the one or more first fixed position base station devices, each of the first communication related events involving one or more of the first mobile operating system based mobile communication devices and one or more of the first fixed position base station devices, the third information regarding the fourth information the fourth information having been received at the one or more second fixed position base station devices being part of the base station network including fixed position base station devices, the fourth information regarding the one or more second communication related events occurring directly between the two or more second mobile operating system based mobile communication devices. In addition to the foregoing, other computer program product aspects are described in the claims, drawings, and text forming a part of the disclosure set forth herein.

A system including one or more computing devices; and one or more instructions when executed on the one or more computing devices cause the one or more computing devices to perform receiving first information regarding second information, the second information having been received at one or more first fixed position base station devices being part of a base station network including fixed position base station devices, the second information regarding one or more first communication related events involving one or more first mobile operating system based mobile communication devices and the one or more first fixed position base station devices, each of the first communication related events involving one or more of the first mobile operating system based mobile communication devices and one or more of the first fixed position base station devices; receiving third information regarding fourth information, the fourth information having been received at one or more second fixed position base station devices being part of the base station network including fixed position base station devices, the fourth information regarding one or more second communication related events occurring directly between two or more second mobile operating system based mobile communication devices; and relating the first information with the third information, the first information regarding the second information having been received at the one or more first fixed position base station devices being part of a base station network including fixed position base station devices, the second information regarding the one or more first communication related events involving the one or more first mobile operating system based mobile communication devices and the one or more first fixed position base station devices, each of the first communication related events involving one or more of the first mobile operating system based mobile communication devices and one or more of the first fixed position base station devices, the third information regarding the fourth information the fourth information having been received at the one or more second fixed position base station devices being part of the base station network including fixed position base station devices, the fourth information regarding the one or more second communication related events occurring directly between the two or more second mobile operating system based mobile communication devices.

In addition to the foregoing, other computer program product aspects are described in the claims, drawings, and text forming a part of the disclosure set forth herein. In addition to the foregoing, various other method and/or system and/or program product aspects are set forth and described in the teachings such as text (e.g., claims and/or detailed description) and/or drawings of the present disclosure.

The foregoing is a summary and thus may contain simplifications, generalizations, inclusions, and/or omissions of detail; consequently, those skilled in the art will appreciate that the summary is illustrative only and is NOT intended to be in any way limiting. Other aspects, features, and advantages of the devices and/or processes and/or other subject matter described herein will become apparent in the teachings set forth herein.

### BRIEF DESCRIPTION OF THE FIGURES

For a more complete understanding of embodiments, reference now is made to the following descriptions taken in connection with the accompanying drawings. The use of the same symbols in different drawings typically indicates similar or identical items, unless context dictates otherwise.

With reference now to the figures, shown are one or more examples of is an example of Dynamic Point to Point Mobile Network Including Base Station Aspects System and Method that may provide context, for instance, in introducing one or more processes and/or devices described herein.

FIG. 1 shows a partially schematic diagram of an environment(s) and/or an implementation(s) of technologies described herein. FIG. 1 is inclusive of FIG. 1-A through FIG. 1-T (Sheets 1-20).

FIG. 2 shows a partially schematic diagram of an environment(s) and/or an implementation(s) of technologies described herein including an origination electronic communication device. FIG. 2 is inclusive of FIG. 2-A through FIG. 2-C (Sheets 21-24).

FIG. 3 shows a partially schematic diagram of an environment(s) and/or an implementation(s) of technologies described herein including an intermediate electronic communication device. FIG. 3 is inclusive of FIG. 3-A through FIG. 3-H (Sheets 25-33).

FIG. 4 shows a partially schematic diagram of an environment(s) and/or an implementation(s) of technologies described herein including a destination electronic communication device. FIG. 4 is inclusive of FIG. 4-A through FIG. 4-C (Sheets 34-37).

FIG. 5 shows a partially schematic diagram of an environment(s) and/or an implementation(s) of technologies described herein including a base station. FIG. 5 is inclusive of FIG. 5-A through FIG. 5-B (Sheets 38-40).

FIG. 6 shows a schematic diagram of an implementation(s) of an environment(s) and/or an implementations(s) of technologies described herein including an implementation(s) of a base-station communication network system(s) and an implementation(s) of a standby point-to-point communication network system(s).

FIG. 7 shows a schematic diagram of an implementation(s) of a processing module.

FIG. 8 shows a partially schematic diagram of an implementation(s) of receiving first information regarding second information regarding first communication related events involving first mobile operating system based mobile communication devices and first fixed position base station devices module(s). FIG. 5 is inclusive of FIG. 8-A through FIG. 8-B (Sheets 43-44).

FIG. 9 shows a partially schematic diagram of an implementation(s) of receiving third information regarding fourth information regarding second communication related events occurring directly between second mobile operating system based mobile communication devices module(s). FIG. 9 is inclusive of FIG. 9-A through FIG. 9-E (Sheets 45-49).

FIG. 10 shows a partially schematic diagram of an implementation(s) of relating first information with third information module(s). FIG. 10 is inclusive of FIG. 10-A through FIG. 10-C (Sheets 50-52).

FIG. 11 shows a high-level flowchart illustrating an operational flow o10 representing exemplary operations related to operation o11, operation o12, and operation o13.

FIG. 12 shows a high-level flowchart including exemplary implementations of operation o11 of FIG. 7. FIG. 12 is inclusive of FIG. 12-A through FIG. 12-F (Sheets 54-59).

FIG. 13 shows a high-level flowchart including exemplary implementations of operation o12 of FIG. 13. FIG. 13 is inclusive of FIG. 13-A through FIG. 13-L (Sheets 60-70).

FIG. 14 shows a high-level flowchart including exemplary implementations of operation o13 of FIG. 14. FIG. 14 is inclusive of FIG. 14-A through FIG. 14-G (Sheets 71-77).

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

The present application may use formal outline headings for clarity of presentation. However, it is to be understood that the outline headings are for presentation purposes, and that different types of subject matter may be discussed throughout the application (e.g., device(s)/structure(s) may be described under process(es)/operations heading(s) and/or process(es)/operations may be discussed under structure(s)/process(es) headings; and/or descriptions of single topics may span two or more topic headings). Hence, the use of the formal outline headings is not intended to be in any way limiting.

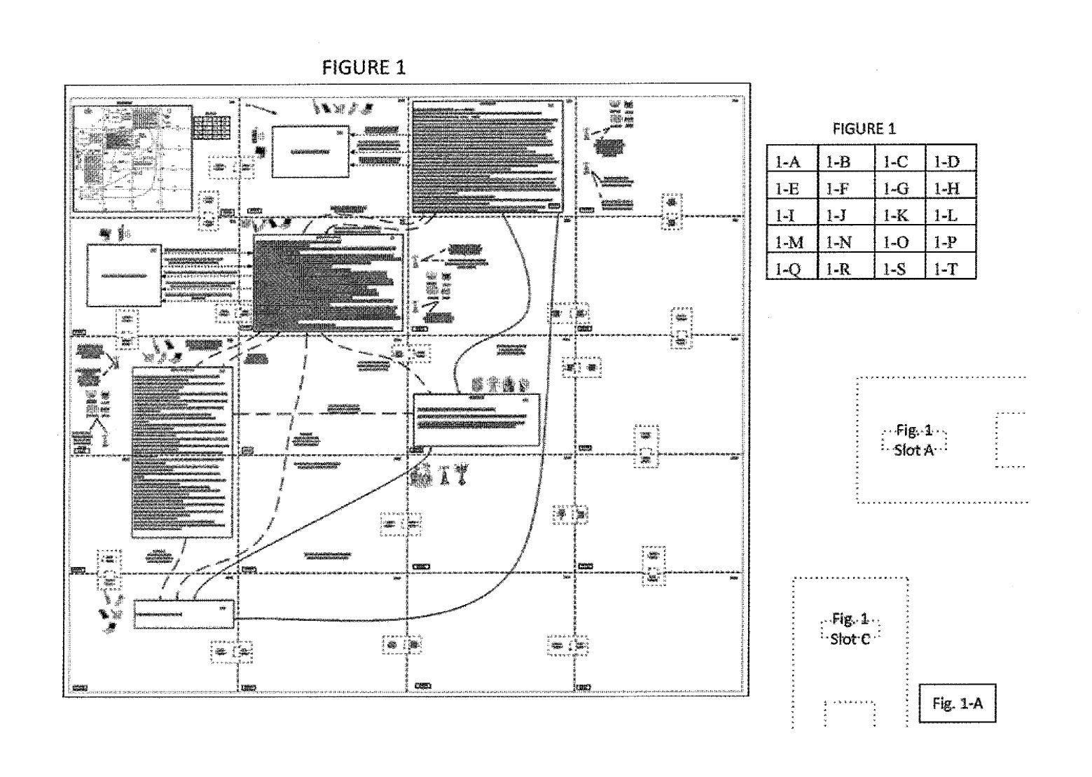

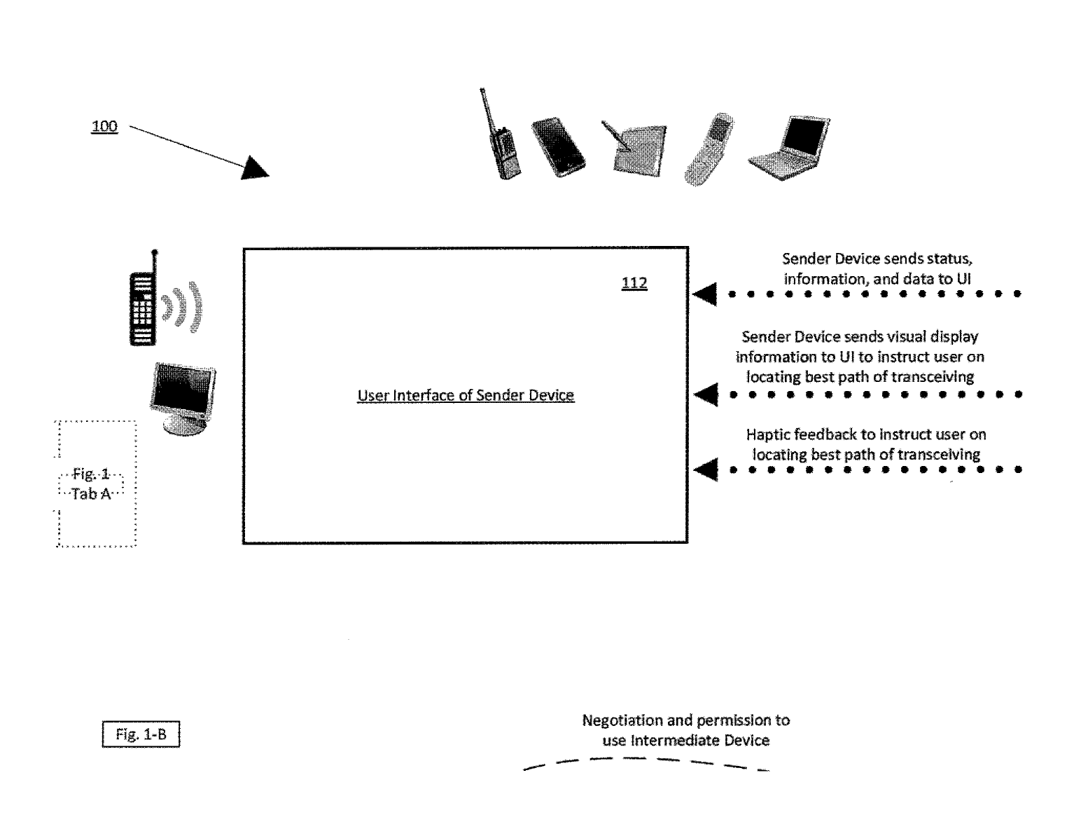

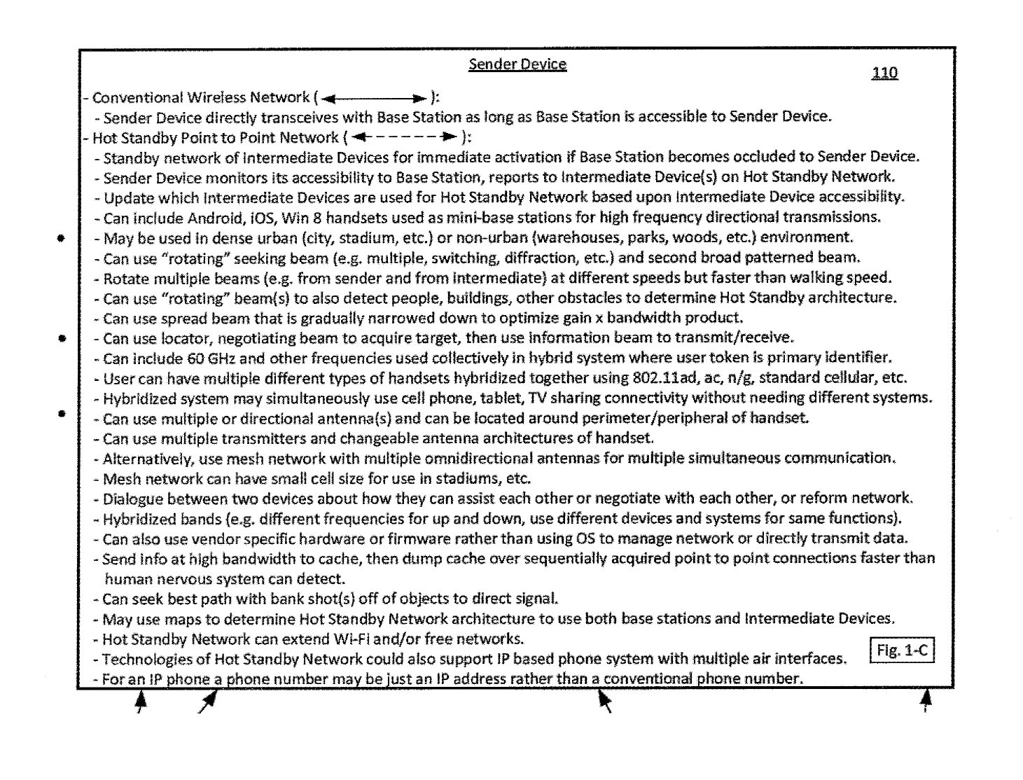

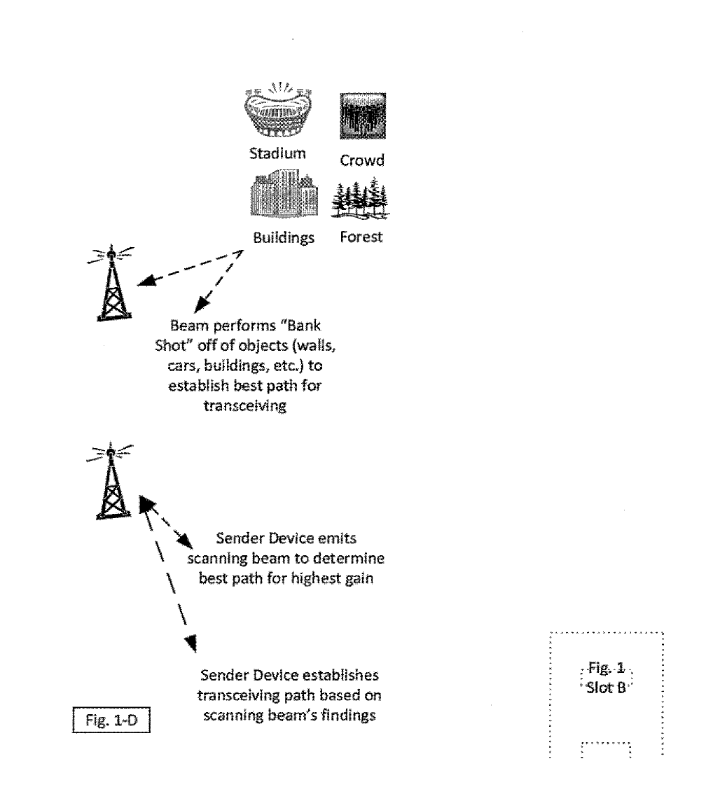

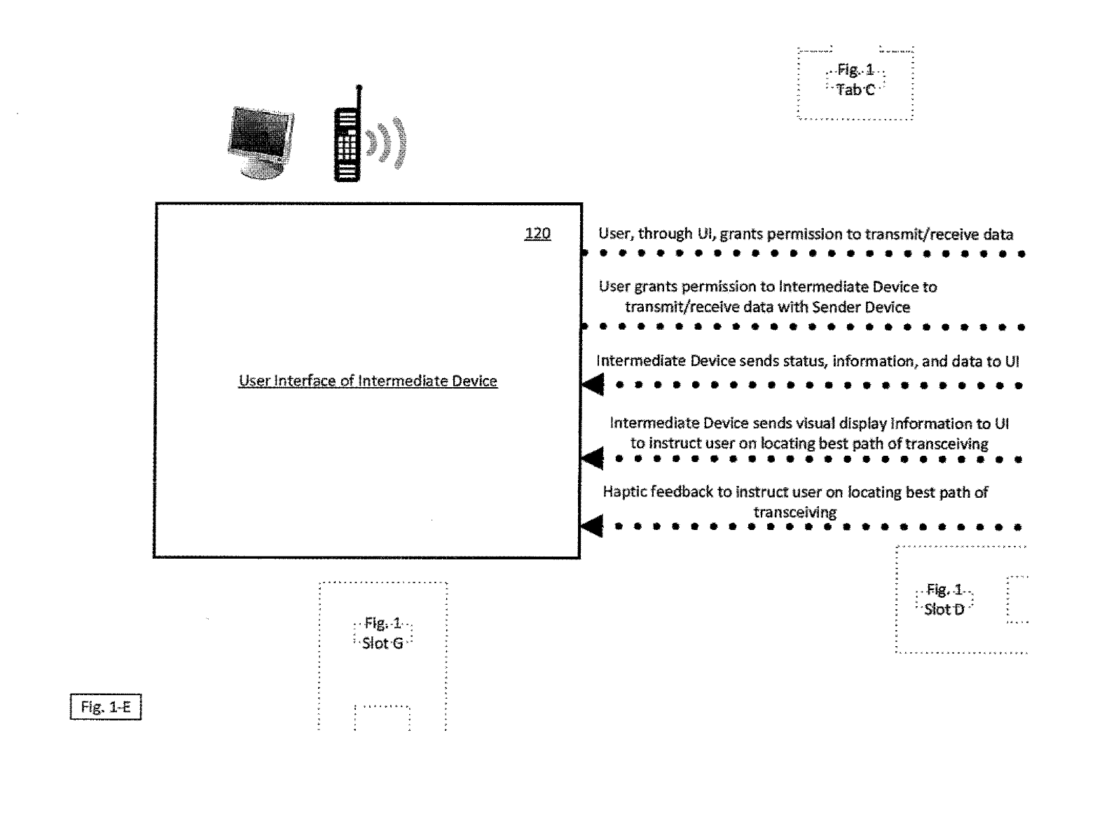

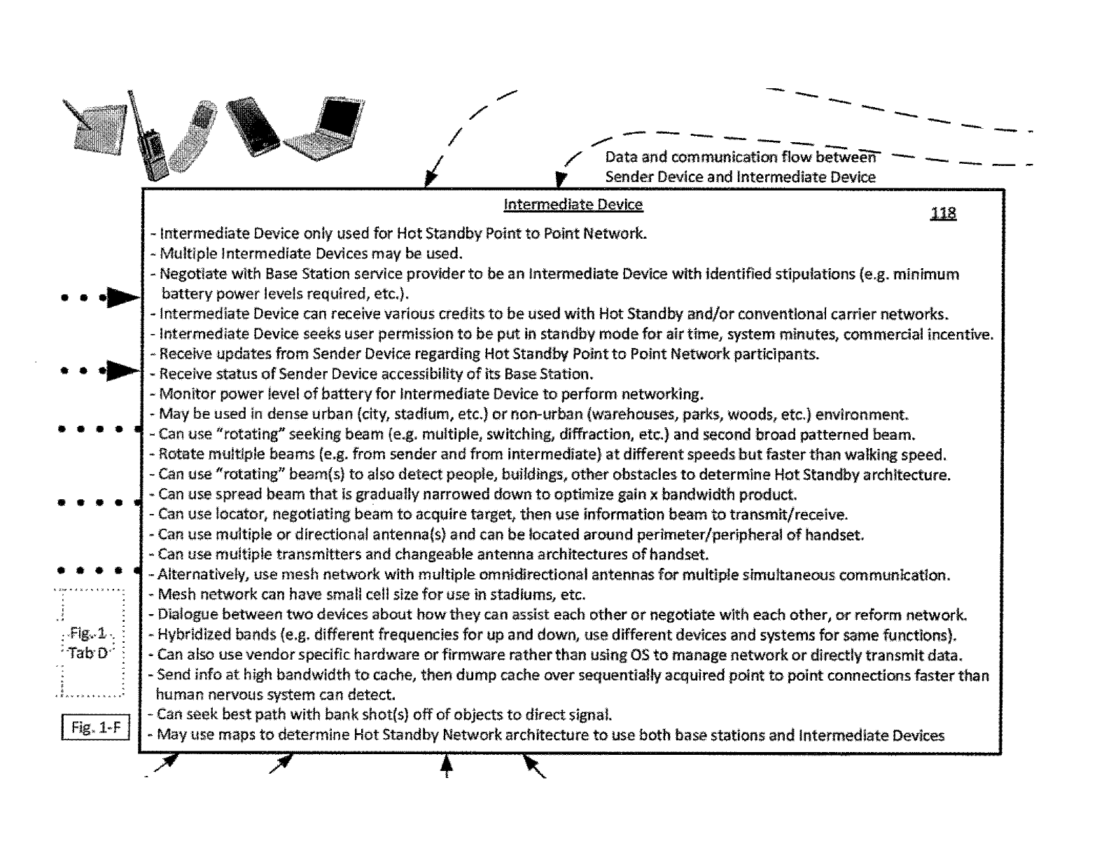

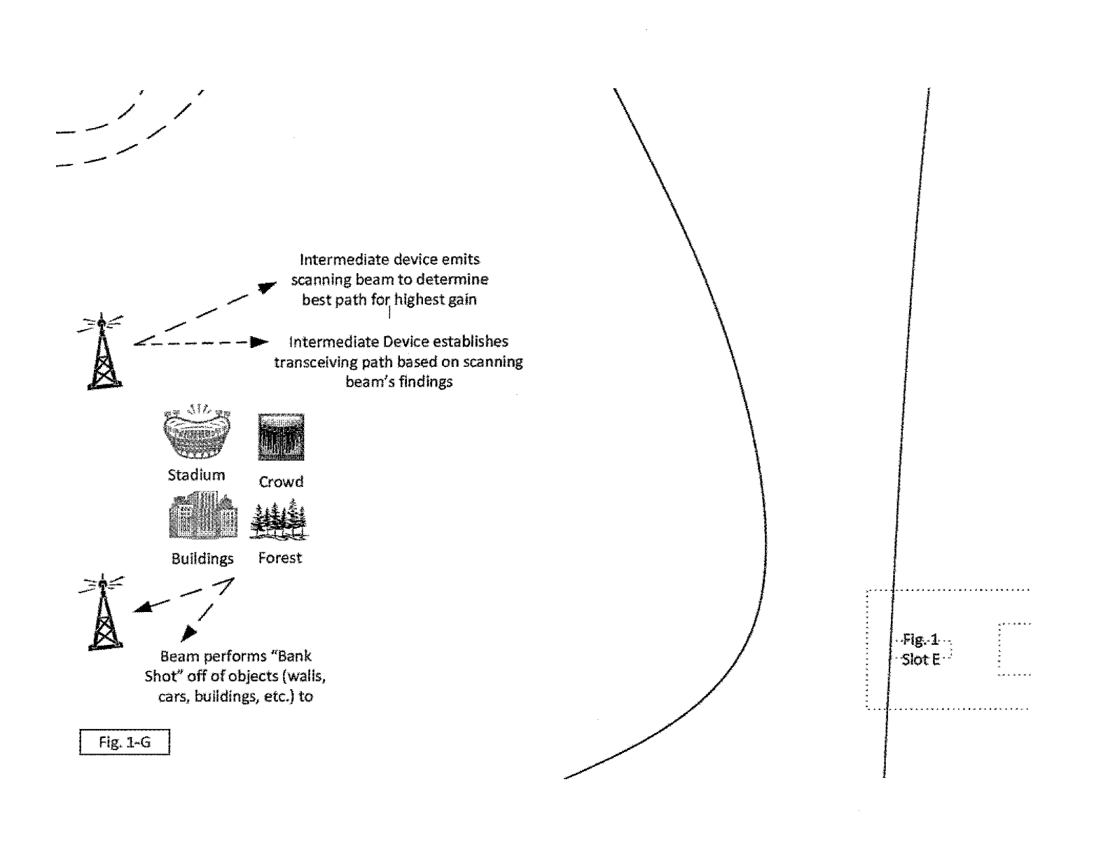

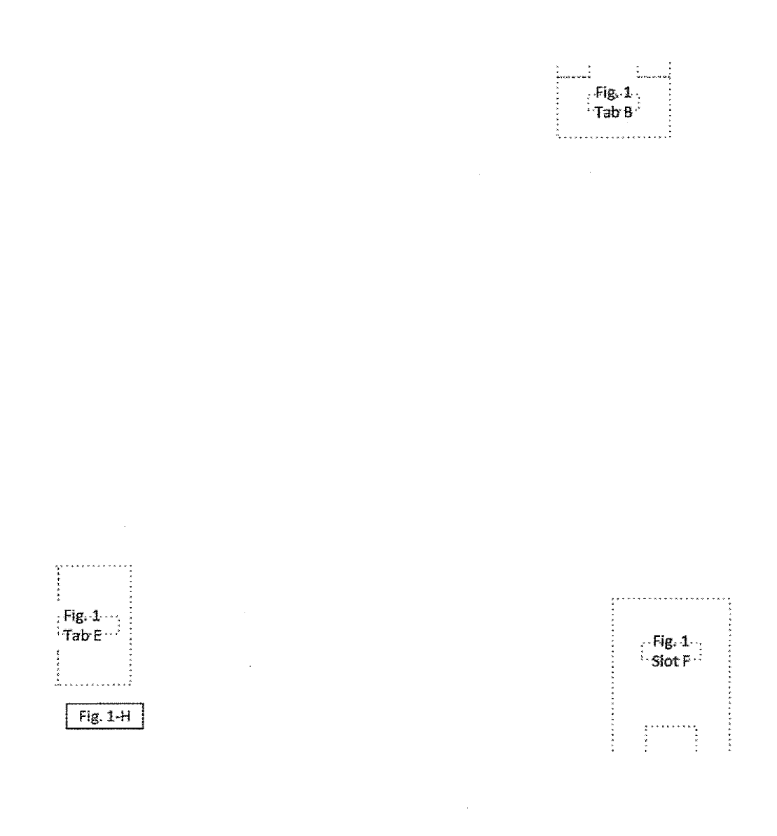

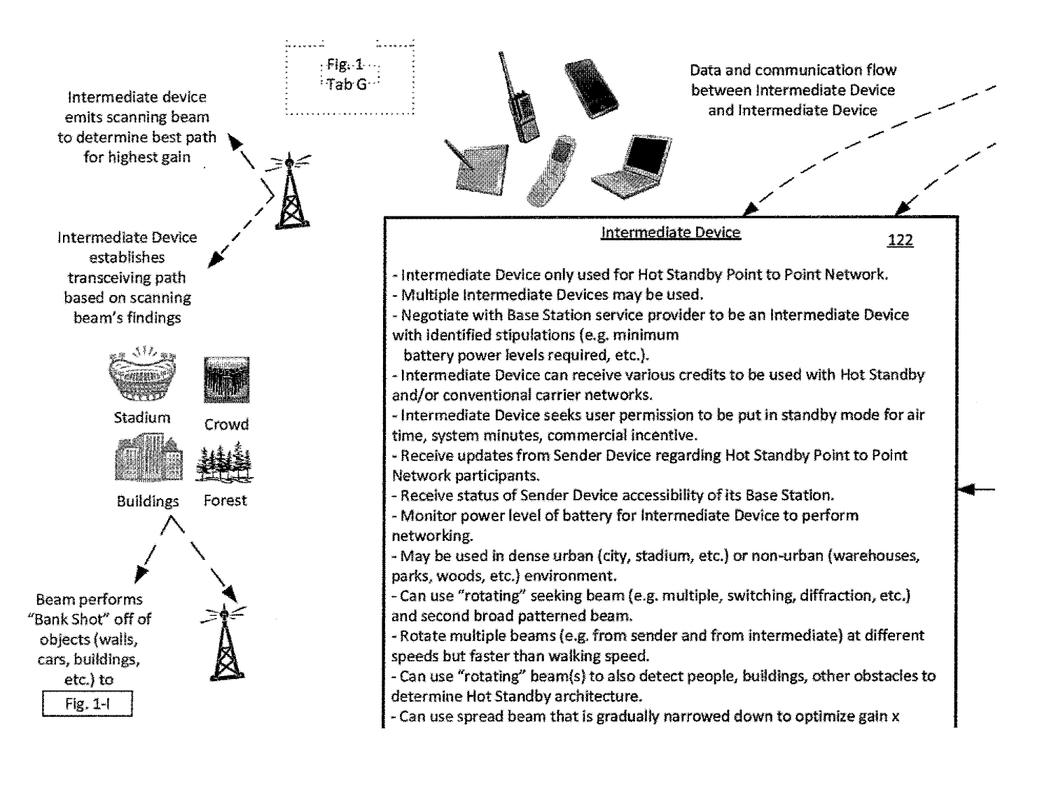

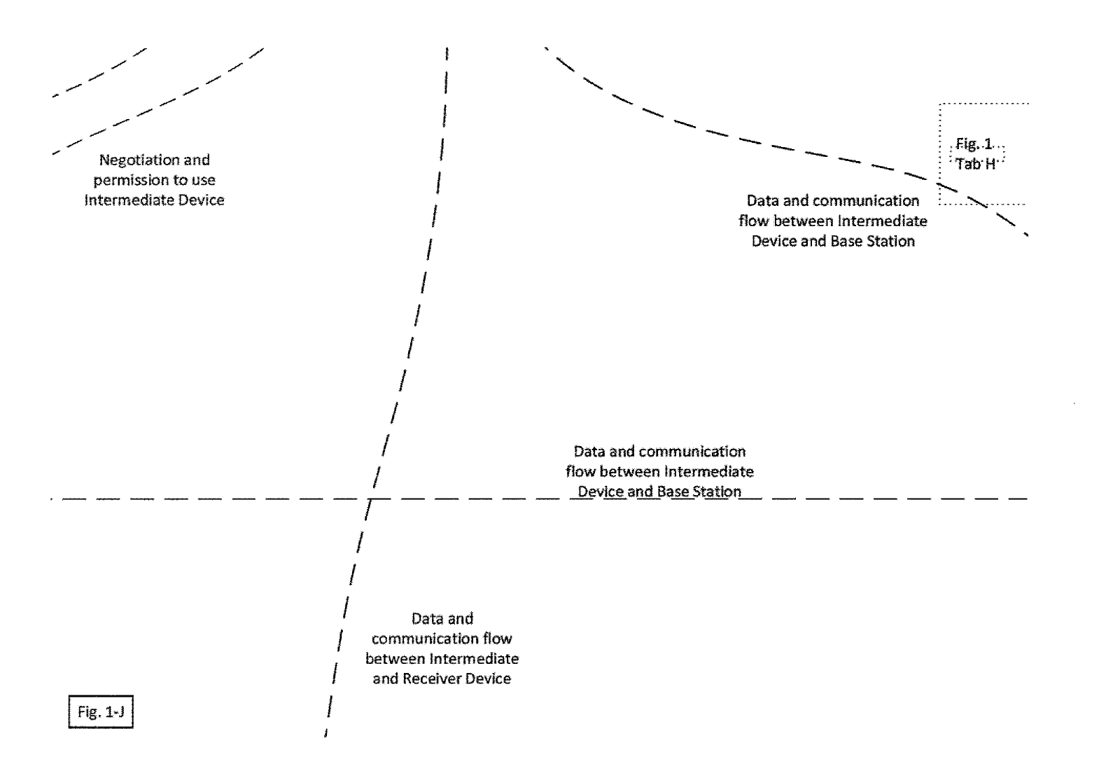

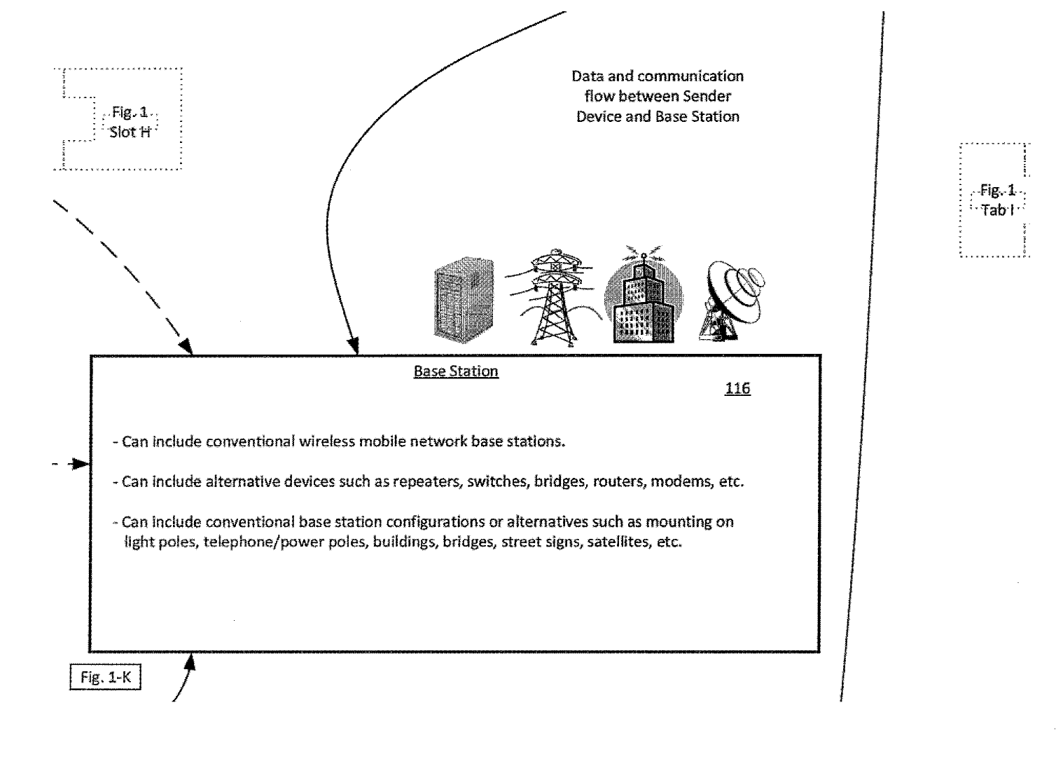

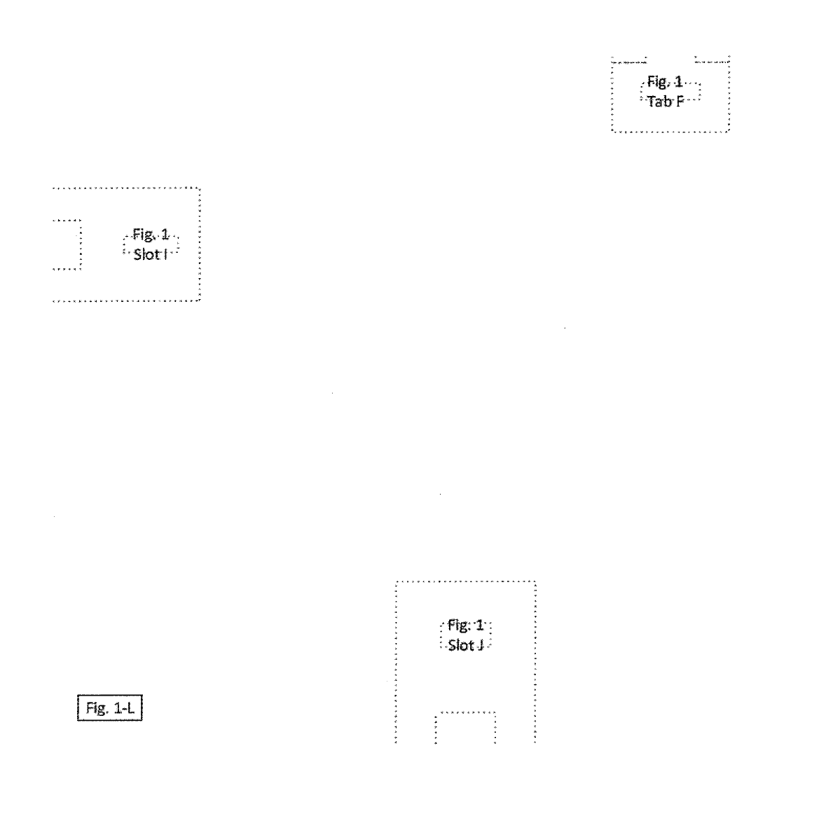

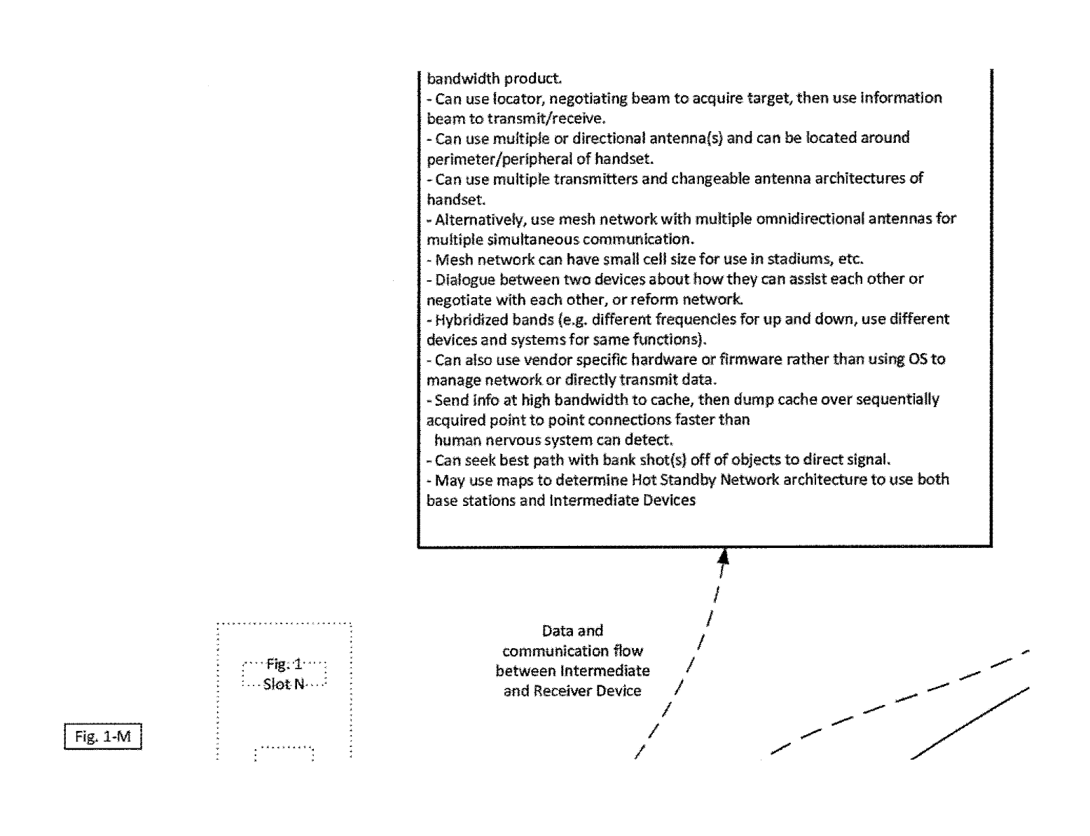

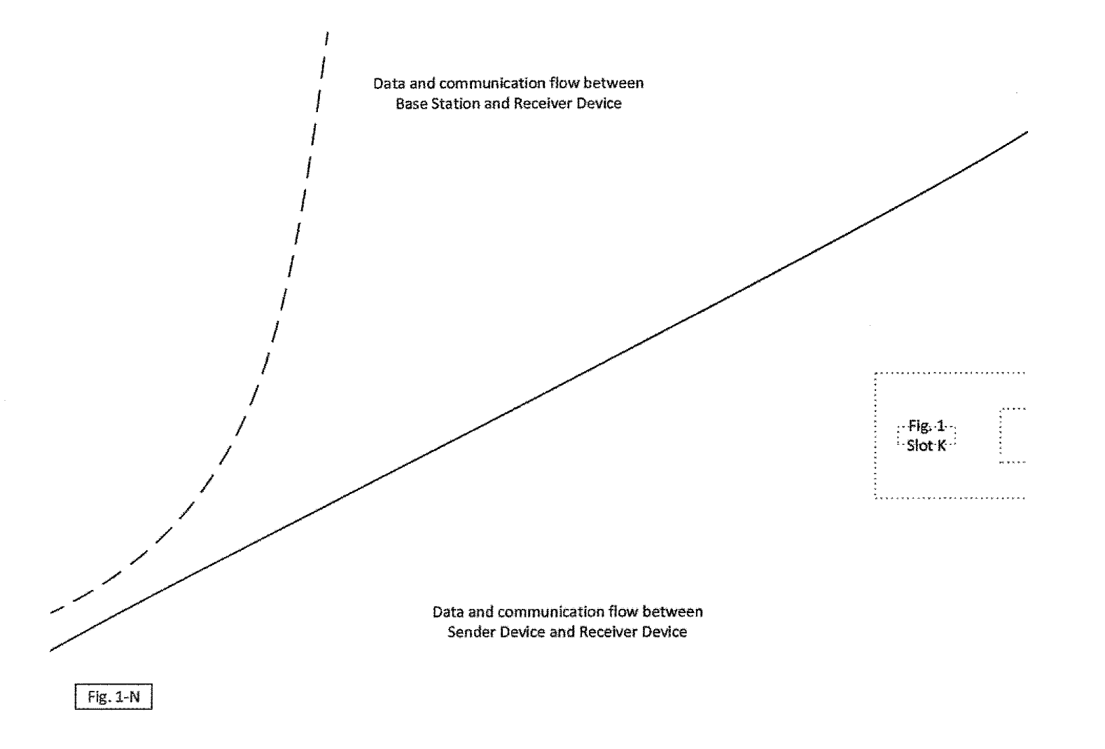

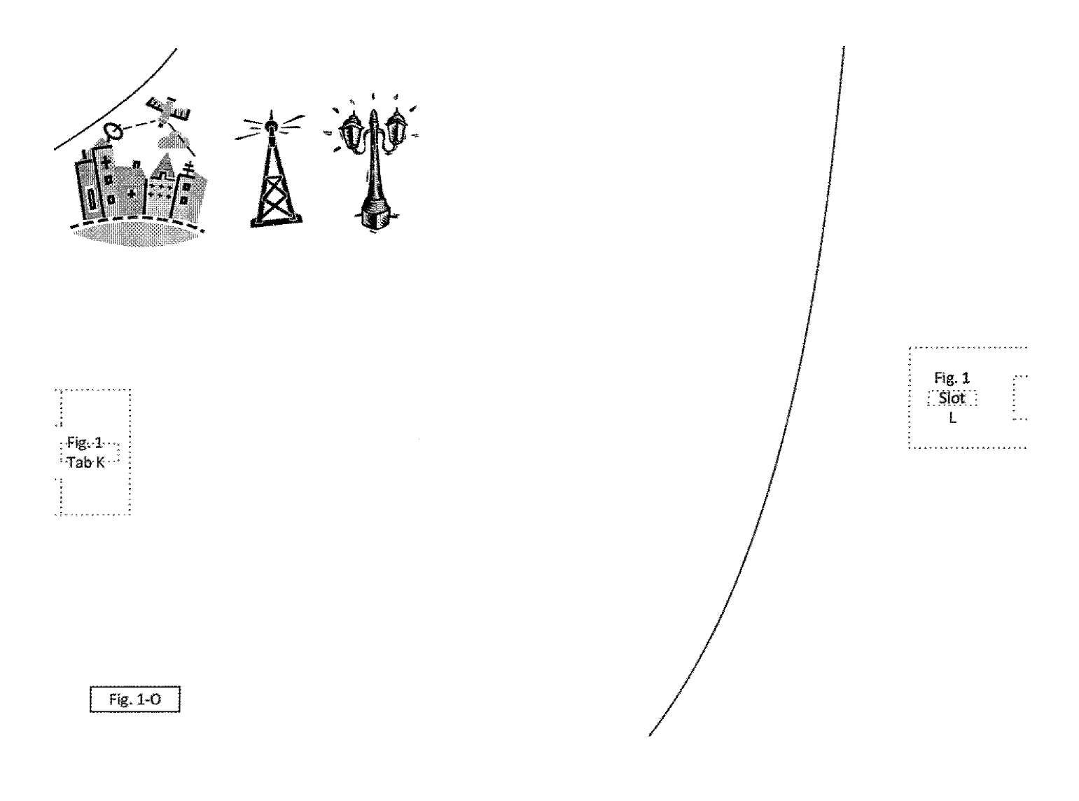

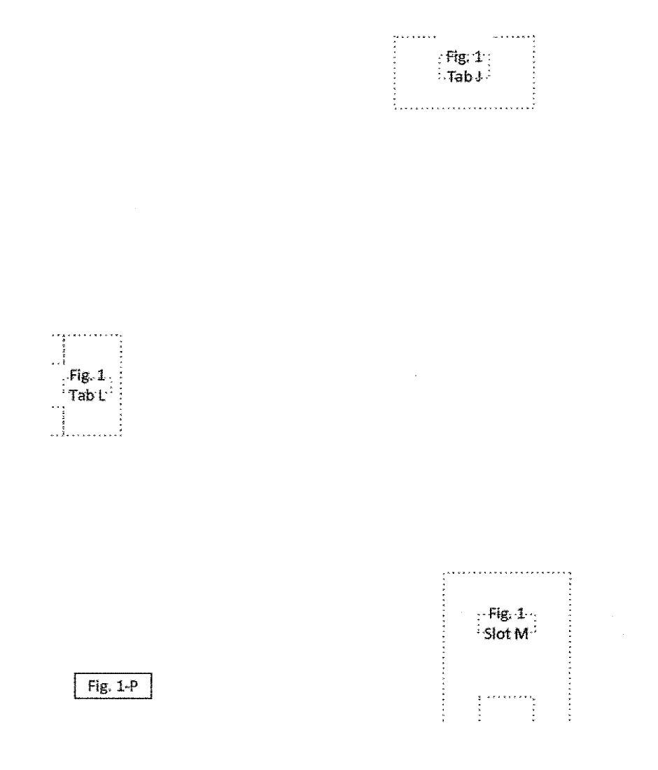

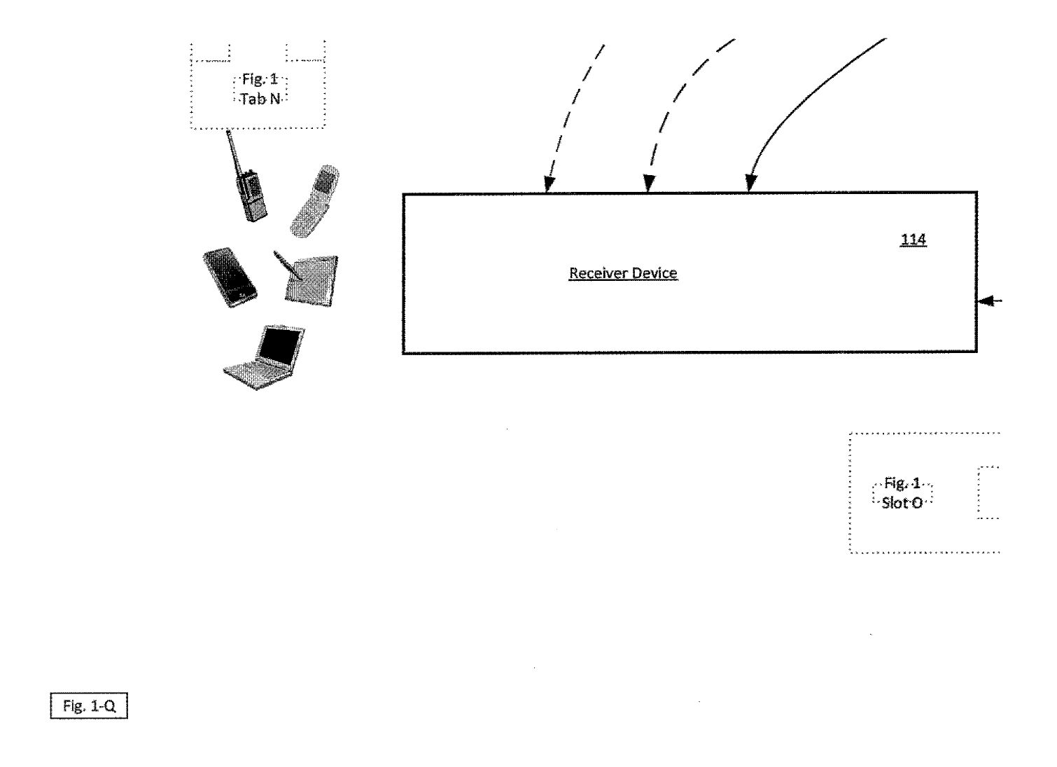

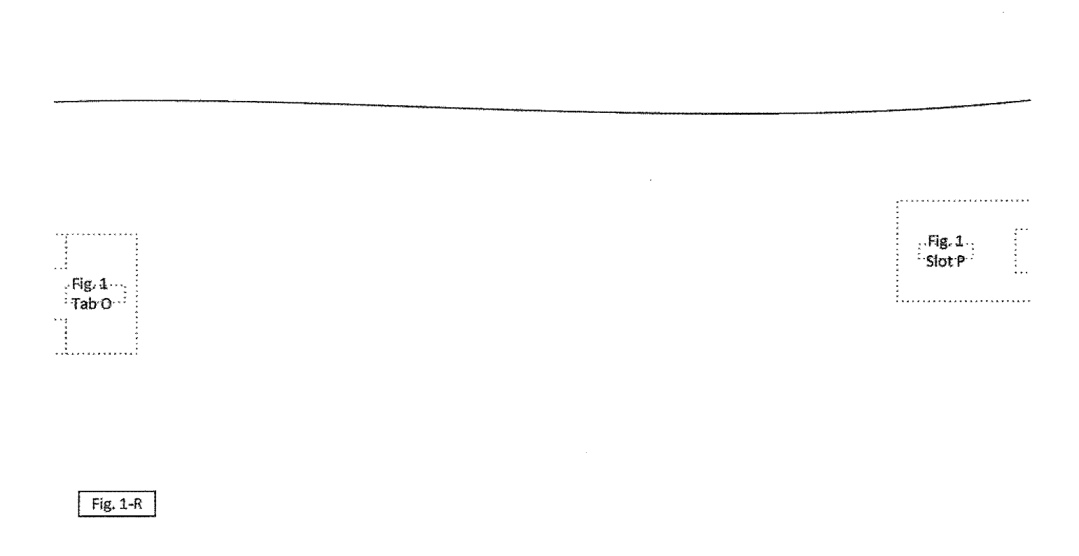

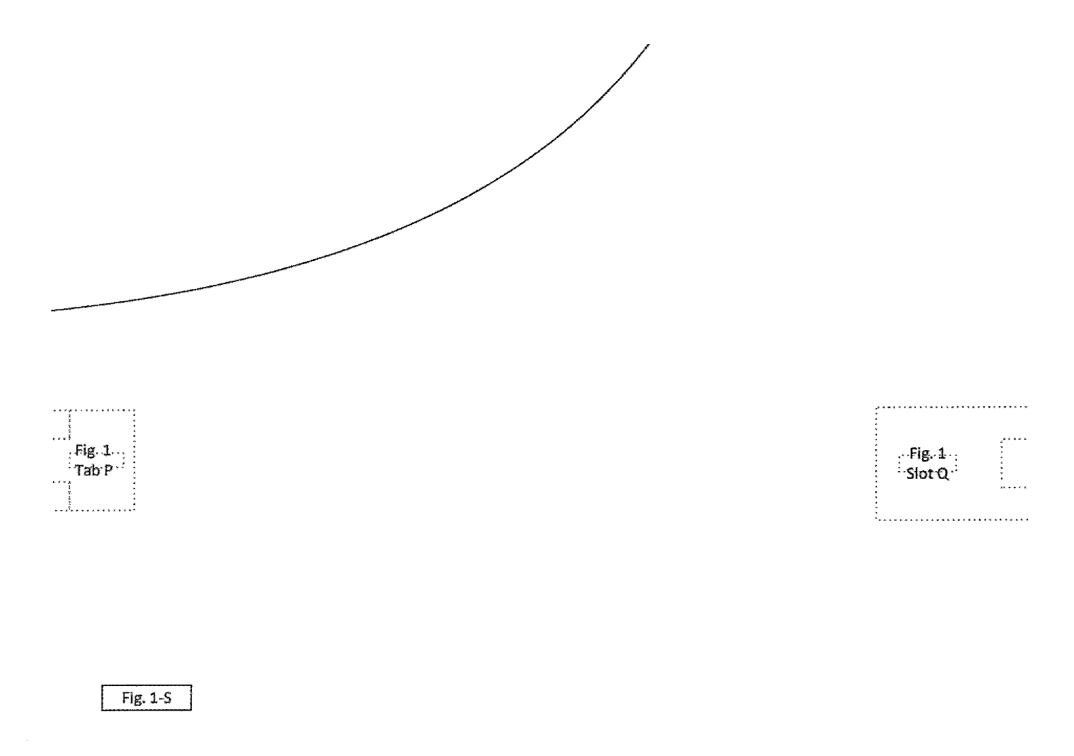

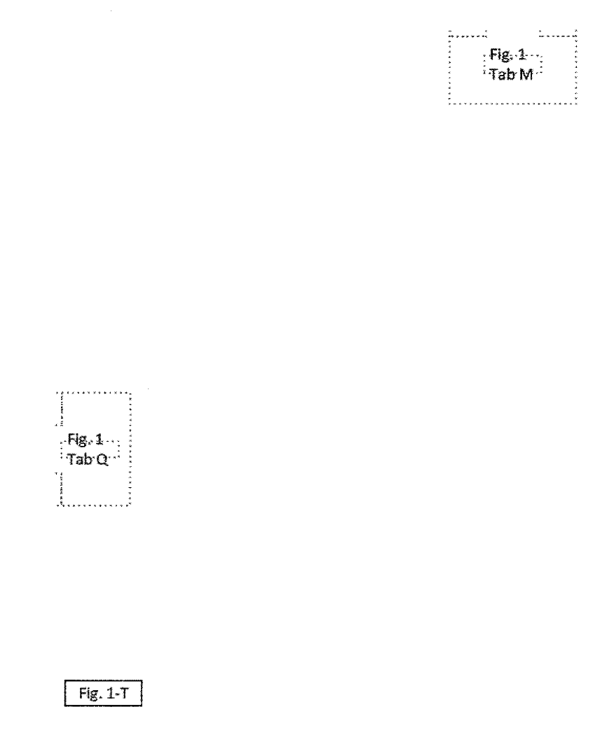

As depicted in FIG. 1, a mobile network system 100 is shown to include a sender device 110 having a user interface 112, a receiver device 114, a base station 116, an intermediate device 118 having a user interface 120, and an intermediate device 122. The sender device 110, the receiver device 114, the intermediate device 118 and/or the intermediate device 122 can include but are not limited to one or more of the following: a mobile device, a tablet, a cell phone, a smart phone, a gaming unit, a laptop, a walkie-talkie, a notebook computer, a phablet, using operating systems including Android, iOS, Win 8 or other operating systems and/or including one or more other types of wireless mobile device. The mobile network system 100 provides for a conventional wireless network mode and also a hot standby point-to-point network mode. In some implementations there can be more intermediate devices than the intermediate device 118 and the intermediate device 122 and in other implementations there can be just the intermediate device 118 in the hot standby network. In some implementations, the sender device 110 can initiate a call or send a message to the receiver device 114 and in other implementations the reverse can occur where the receiver device 114 initiates a call or sends a message to the sender device 110. In implementations, the sender device 110 and the receiver device 114 can be involved with two-way communication where each device both sends messages to and receives messages from each other.

FIG. 1 depicts the conventional wireless network mode with solid arrows and the hot standby point-to-point network mode with dashed arrows. The conventional wireless network is shown supporting communication between the sender device 110 and the receiver device 114 either via the base station 116 or directly between the sender device and the receiver device. The hot standby point-to-point network mode uses one or more of the intermediate devices as in effect a replacement for the base station 116 when the base station becomes occluded to the sender device 110, the receiver device 114, and/or both the sender device and the receiver device. When activated the one or more intermediate devices can be used as in effect mini-base stations for high frequency directional transmissions. Since the communication is generally done through at least fairly directional acting beams, more than one intermediate device may be required to relay communication amongst the intermediate devices and consequently between the sender device 110 and the receiver device 114.

The hot standby point-to-point network in other words can thus be used to relay communication between the sender device 110 and the receiver device 114 when the base station 116 somehow becomes unavailable. The hot standby network is maintained to be continuously available as a backup network in case the conventional wireless network mode becomes unavailable for the sender device 110 and the receiver device 114 to communicate with each other. Part of this maintenance is performed by updating which devices can be used as intermediate devices at a present given moment if called upon at that moment. The devices are enrolled initially and their status is updated regarding their location and accessibility to each other and to the sender device 110 and the receiver device 114.

For instance, one or more at least relatively directional signals can be used to communicate between the sender device 110 and the receiver device 114, such as in the GHz range of frequencies including the 50-70 GHz range, including 60 GHz frequency. It is possible that these at least relatively directional signals can be blocked by physical objects or otherwise occluded so that the conventional mode of communication via the base station 116 may become unavailable to the sender device 110 and/or the receiver device 114. Such occlusive situations can occur more often at times in environments such as in dense urban (city, stadium, etc.) or dense non-urban (warehouses, parks, woods, etc.) environments. One or more intermediate devices can be included in the hot standby network based upon direct line of sight access to them through one or more best path determinations by one or more other devices (such as the sender device 110, the receiver device 114, and/or one or more of the intermediate devices) or alternatively based upon a form of non-direct access that is not line of sight but rather makes use of another means of access such as through one or more paths using one or more bank shots off of objects for the seeking beam and/or the communication beam to take to travel from its respective transmitting device to its respective receiving device.

In some implementations the sender device 110 monitors its accessibility to the base station 116 and reports on its accessibility to the intermediate device(s) in the hot standby network. The sender device 110 can also be used to update which of the intermediate device(s) are used for the hot standby network based upon intermediate device accessibility.

To maintain the hot standby network and accessibility thereof, the sender device 110 and the receiver device 114 (that are part of the hot standby network by virtue of being the continuing end points of the communication) and the one or more intermediate devices (that are at least momentarily also part of the hot standby network by virtue of their at least momentary accessibility to the sender device 110, the receiver device 114, and/or one or more of the other intermediate devices) can use various methods to search for, locate, maintain awareness of, etc., the accessibility of each other in the hot standby network.

In some implementations, the sender device 110 can take more of a management or status reporting role to the other devices of the hot standby network. In other implementations other devices, such as the receiver device 114, can take management or status reporting roles. Depending upon how each of the devices of the hot standby network are so configured one or more them can actively search, locate, maintain awareness, etc. of accessibility of each other by various methods and components. For instance, one or more of the devices such as the sender device 110 and/or the receiver device 114 can use a seeking beam (e.g. multiple beams, switching between single beams, beam diffraction, etc.) to determine which intermediate device(s) are accessible by the sender device 110 and which intermediate device(s) are accessible by the receiver device 114. Upon locating and/or determining one or more accessibilities of various devices such as the sender device 110, the receiver device 114, and/or one or more of the intermediate devices 118, a communication beam can be used for communication between the various devices.

Through these and/or various other measures the seeking beam can be swept or otherwise moved across a region in a rotating, zigzagged, patterned, and/or other fashion. In some implementations multiple seeking beams (e.g. from sender, intermediate, and/or receiver devices) can be moved at different speeds from each other to aid in thoroughly sweeping an area. The speeds used for sweeping the one or more seeking beams generally can be faster than walking speed for instance, but in other implementations speeds can be slowly as well. The one or more seeking beams can be used to also detect people, buildings, and other obstacles to better determine and/or update architecture and/or layout of the hot standby network. In some implementations one or more of the devices of the hot standby network can use one or more spread beams that are gradually narrowed down to optimize gain x bandwidth product for enhanced communication characteristics.

The sender device 110, the receiver device 114, and/or the one or more intermediate devices can use the one or more seeking beams to continually update which intermediate devices are being used for the hot standby network and when the hot standby network is activated for immediate use one or more communication beams can be used for negotiation and/or communication between two or more of the devices of the activated hot standby network. In other words, the one or more seeking beams can be used to acquire a target device as potentially available for immediate use by another device of the hot standby network and then the one or more communication beams can be used to transmit and/or receive one or more communication signals between the associated devices of the hot standby network.

In one or more implementations, the one or more seeking beams and/or the one or more communication beams can include 60 GHz and other frequencies used collectively. The devices of the hot standby network can include disparate devices such that, for example, the sender device 110 can be a smart phone, the intermediate device 118 can be a tablet whereas the intermediate device 122 can be a laptop and the receiver device 114 can be a cell phone. These one or more hybrid systems can all use one or more tokens or other identifiers to recognize the communicating users using the sender device 110 and the receiver device 114. In this manner the one or more hybrid systems of the disparate devices of the hot standby network can rely on other than solely one or more device identifiers but in addition or instead of can rely on one or more identifiers (such as tokens) that are directly associated with the one or more users of the devices (such as the sender device 110 and/or the receiver device 114).

In implementations one or more hybridized systems for the hot standby network can also use multiple different types of handsets hybridized together using different communication protocols such as 802.11 ad, 802.11 ac, 802.11n/g, standard cellular, etc. So in implementations, one or more hybridized systems can simultaneously use cell phone, tablet, TV, smart phone, laptop, etc. to share connectivity relatively seamlessly as an integrated system. One or more hybridized systems can also use one or more hybridized bands (e.g. different frequencies for transmit and receive or for different devices and systems for same or similar functions, etc.). Through one or more hybridized systems the hot standby network can also extend paid or free Wi-Fi, other wireless networks and/or other paid or free networks. Technologies of the hot standby network can also support one or more IP based phone systems with multiple air interfaces. For an IP phone a phone number may be just an IP address rather than a conventional phone number.

To support implementations of one or more seeking beams and/or one or more communication beams by one or more hot standby network devices (such as the sender device 110, the receiver device 114, and/or one or more of the intermediate devices), one or more steerable antennas, one or more directional antennas, one or more omnidirectional antennas, and/or one or more other antennas can be located around one or more perimeters and/or peripherals of one or more of the hot standby devices. In implementations one or more transmitters can be used with changeable antenna architectures that can include various antenna types referenced above.

One or more mesh networks with one or more of the hot standby network devices (such as the sender device 110, the receiver device 114, and/or one or more of the intermediate devices) can each use multiple omnidirectional antennas for multiple simultaneous communication between associated hot standby network devices. Use of one or more mesh networks can allow for small cell size for use in stadiums, etc.

Before or during activation of the hot standby network, one or more of the devices (such as the sender device 110, the receiver device 114, and/or one or more of the intermediate devices) can use either one or more of the seeking beams and/or one or more of the communication beams to dialogue with one or more of the other devices of the hot standby network about how they can assist each other or negotiate with each other, or reform the hot standby network as accessibility between various of the devices or potential devices of the hot standby network may change.

In implementations, the devices of the hot standby network (such as the sender device 110, the receiver device 114, and/or one or more of the intermediate devices) can use vendor specific hardware or firmware rather than using an operating system to perform network administration tasks such as updating which intermediate devices are being used, etc. and/or to transmit and/or to receive communication data.

Other aspects of one or more implementations can include use of high speed data transmission between two or more of the devices of the hot standby network (such as the sender device 110, the receiver device 114, and/or one or more of the intermediate devices) to send information at high bandwidth greater than human bandwidth to cache, and sequentially dump to compensate for connection problems. For instance, the sender device 110 can send ahead communication data to one or more other devices of the hot standby network before a time that communication paths between the sender device 110 and the one or more other devices becomes blocked. This present communication data can then be sent on to the receiver device 114 also at high bandwidth if further blockages near the receiver device are anticipated or at a lesser rate dependent upon the human user operating the receiver device.

In this manner, the communication data is positioned closer to the receiver device 114 ahead of time before the user of the receiver device needs to receive the communication data so that there is still a high likelihood that if at least part of communication pathway to the receiver device is momentarily completely blocked that the communication data will still reach the receiver device in time for the user of the receiver device to not notice any communication problems. The hot standby network can also have more intermediate devices on standby than is necessary for a single path from the sender device 110 to the receiver device 114. Furthermore, the communication data can be positioned forward at multiple of the intermediate devices in case one or more of the multiple intermediate devices becomes blocked from sending the communication data on to the receiver device 114 at the appropriate time. The receiver device 114 could also include a data buffer to receive the forwarded communication data ahead of the time that the user of the receiver device 114 needs to receive the communication data for an additional or alternative way to insure reception of the communication data in time for the user of the receiver device to receive the communication data.

Implementations can also use digital maps either electronically stored internally with one or more of the devices of the hot standby network, or provided by a main device of the hot standby network such as the sender device 110 or the receiver device 114, or accessed online by the devices of the hot standby network, or elsewise acquired to determine hot standby network architecture of which intermediate devices to include in the hot standby network. Additionally or alternatively digital maps can be used to determine when the conventional base station network is available for use at least partially or fully.

Although two intermediate devices, namely the intermediate device 118 and the intermediate device 122, have been depicted in the FIG. 1 as being part of the hot standby network, the number of intermediate devices can change from as few as zero in some implementations if the sender device 110 and the receiver device 114 can communicate directly with each other over the hot standby network to multiple numbers of intermediate devices more than the two depicted. The number of intermediate devices considered part of the hot standby network can change during the time that the hot standby network is considered to be in standby mode wherein the hot standby network is not being used for communication between the sender device 110 and the receiver device 114.

The number of intermediate devices considered part of the hot standby network can change during the time that the hot standby network is considered to be in active mode as well wherein the hot standby network is being used for communication between the sender device 110 and the receiver device 114. Reasons for changes in the numbers of intermediate devices considered to be part of the hot standby network during standby and active modes of the hot standby network can include changes in positioning of the sender device 110, the receiver device 114, and/or one or more of the intermediate devices that are either currently considered or not consider part of the hot standby network. Changes in positioning of other physical objects such as people, vehicles, structures, etc. can also influence how many and which in particular of the intermediate devices that may at any given moment be consider part of the hot standby network.

Other considerations for when a device can be considered as an intermediate that is part of the hot standby network in the standby or active mode of the hot standby network may include situations where users of one or more of the intermediate devices may change their status of how they are using their respective intermediate devices. For instance, the users may start using their intermediate devices to an extent that makes their intermediate devices no longer available for the hot standby network. Or the users may stop using their intermediate devices to an extent that they become available for use by the hot standby network if needed. There may be other considerations involved such as certain payment structures being implemented to pay the users of the intermediate devices thereby stipulating that the intermediate devices only have to be available for a certain length of time, or period of time, or certain days of the week, or only if the devices are located in certain specified locations, etc. Other considerations regarding when the intermediate devices are considered part of the hot standby network can also exist as well such as whether the device's battery power level is above a certain threshold.

At one or more points in time users and/or owners of devices that are potentially capable of being used as intermediate devices can negotiate through their respective intermediate devices, through online internet access, through phone, or other access with one or more base station providers or other entities to become eligible to be an intermediate device. After this negotiation is successful, the device associated with the negotiation can be placed on a list of eligible devices, and/or assigned an access function, etc. so that when the device is in an area to serve as an intermediate device, it can be recognized by devices of the hot network standby network as it becomes accessible to these devices.

With these one or more negotiations various stipulations can be put forth by one or more of the parties involved with the negotiations. Such negotiations can include minimum battery power levels required by the device to be accessible as an intermediate device of the hot standby network. Other stipulations can include various credits to be used by the user of the device being enrolled as a potential intermediate device with the hot standby network and/or one or more conventional carrier networks. Credits can include the device seeking its user's permission to be put in standby mode for air time, system minutes, or other commercial incentive.

As an intermediate device in the hot standby network, the intermediate device can receive status of the sender device's accessibility of its base station. The intermediate device can monitor power levels its battery for performing networking and other communication functions.

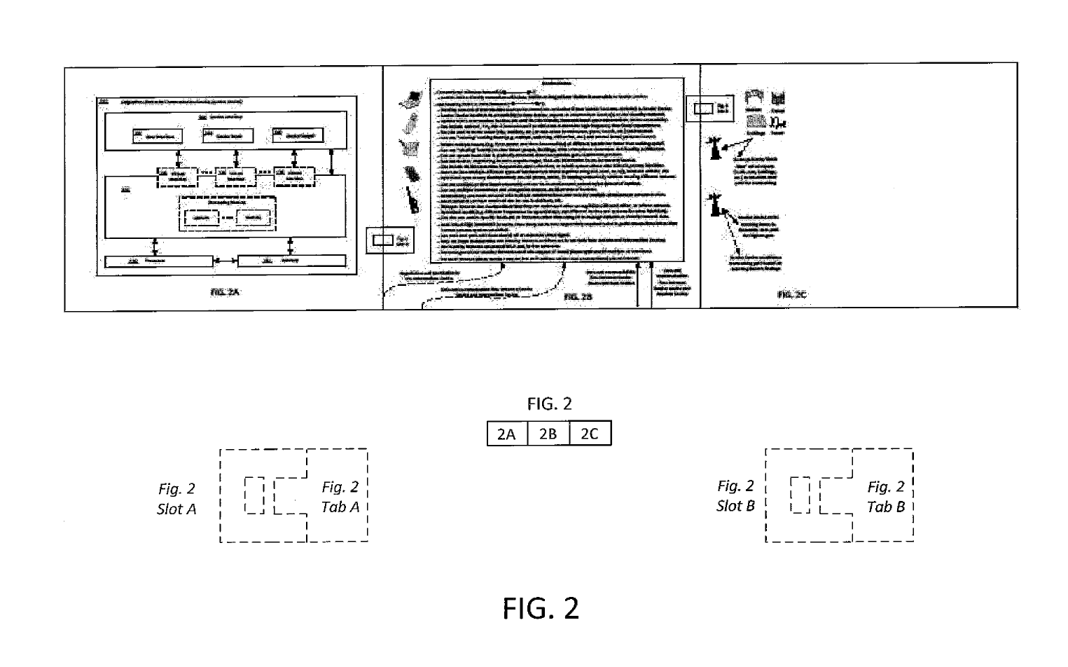

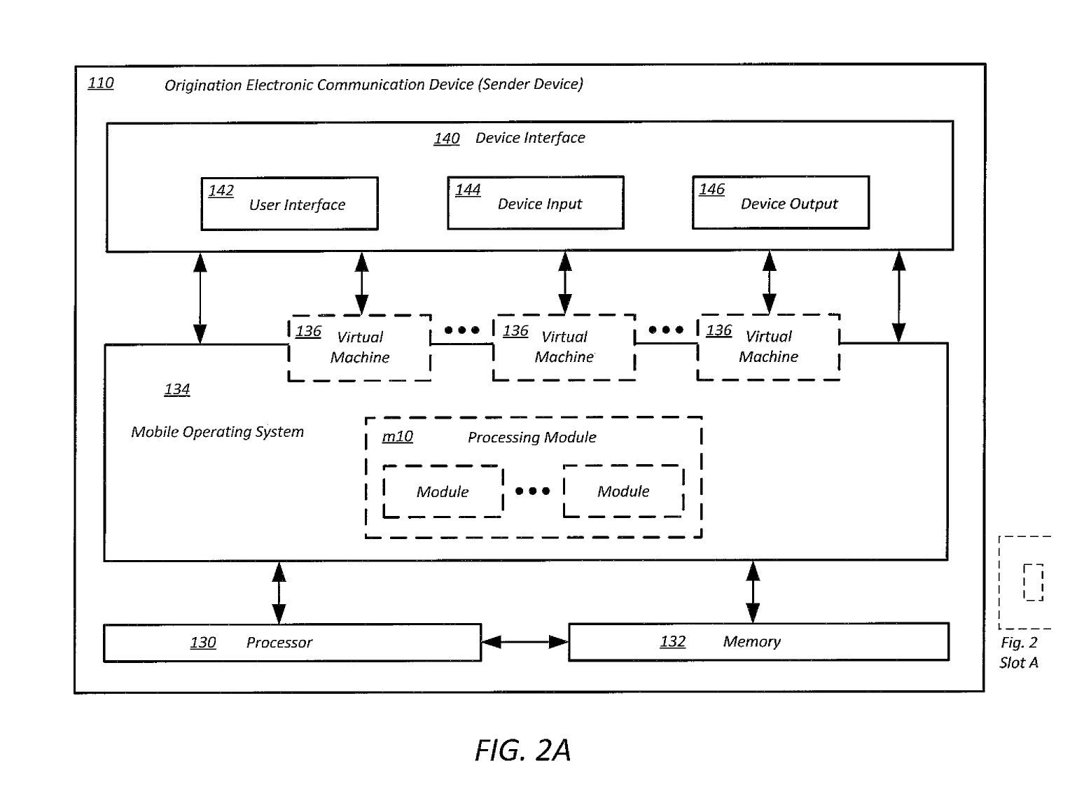

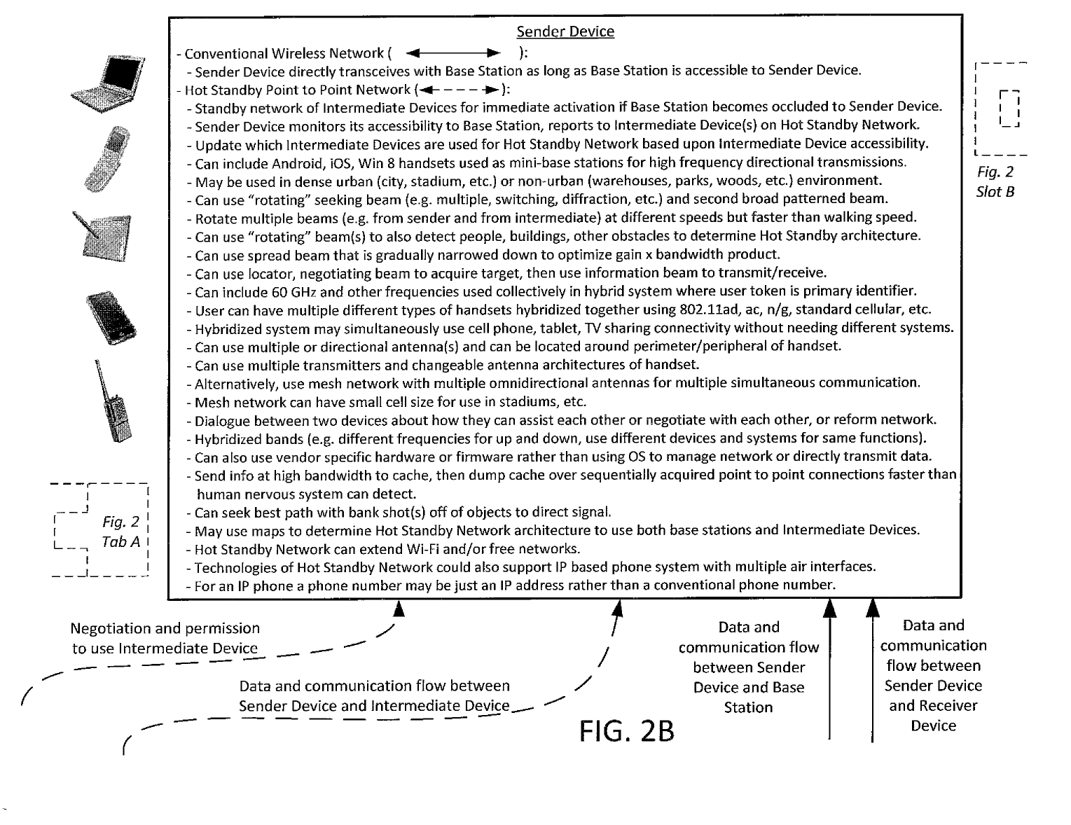

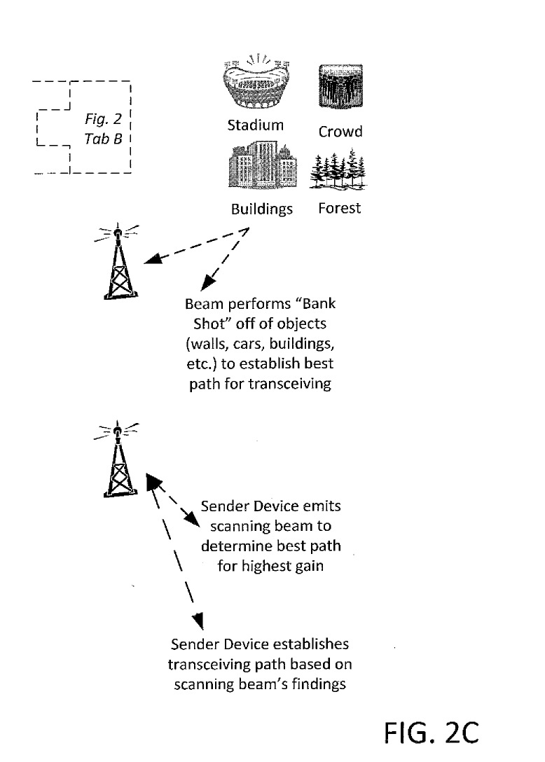

Turning now to FIG. 2, the sender device 110 (also known herein as an origination electronic communication device) is shown in FIG. 2A as an implementation of the sender device shown in FIGS. 1 and 2B. Referring again to FIG. 2B, the origination electronic communication device 110 may include a processor 130, a memory 132, and a mobile operating system 134 communicatively linked thereto. The mobile operating system 134 may include processing module m10, which may further include modules (some of which are described below), and virtual machines 136 (such as process virtual machines, virtual machines of hardware, virtual machines of virtual machines, Java virtual machines, Dalvik virtual machines, virtual machines for use with Android operating systems such as Samsung or Google mobile devices or for use with other mobile operating systems such as Apple iOS on Microsoft Windows based mobile operating systems, etc.). The origination electronic communication device 110 may also include device 140, which may include user interface 142, device input 144, and device output 146.

Implementations of processor 130 may include one or more microprocessors, central processing units, graphics processing units, digital signal processors, network processors, floating point processors, physics processing units, or other processors. Other implementations may include processor 130 as a distributed-core processor, server based processor, as part of multiple processors distributed over one or many other user devices in addition to origination electronic communication device 110. Furthermore processor 130 may execute computer readable instructions to execute one or more operations described herein. In implementations, processor 130 may operate as processing module m10, which may include one or more modules described below.

Implementations of memory 132 may cache memory such as random access memory (RAM), flash memory, synchronous random access memory (SRAM), dynamic random access memory (DRAM), other memory, read only memory (“ROM”), flash memory, hard drives, disk-based media, disc-based media, magnetic storage, optical storage, volatile memory, nonvolatile memory, separated from device 130 (such as on a network, server), mass storage, programmable read-only memory (PROM), erasable programmable read-only memory (EPROM), and/or other types of memory.

Referring again to FIG. 2A, implementations of device interface 140 may include one or more components to provide ways that origination electronic communication device 110 can input and output information with its environment and/or user. These components of device interface 140 may include one or more sensors, e.g., a camera, a microphone, an accelerometer, a thermometer, a satellite positioning system (SPS) sensor, a barometer, a humidity sensor, a compass, a gyroscope, a magnetometer, a pressure sensor, an oscillation detector, a light sensor, an inertial measurement unit (IMU), a tactile sensor, a touch sensor, a flexibility sensor, a microelectromechanical system (MEMS), a radio, including a wireless radio, a transmitter, a receiver, an emitter, a broadcaster, etc. and other components as well to serve input and output functions such as for device input 144 and device output 146.

User interface 142 may include any hardware, software, firmware, and combination thereof to provide capability for a user thereof to interact with origination device 110. Implementations of user interface 142 can include a monitor, screen, touchscreen, liquid crystal display (“LCD”) screen, light emitting diode (“LED”) screen, speaker, handset, earpiece, keyboard, keypad, touchpad, mouse, trackball, remote control, button set, microphone, video camera, still camera, a charge-coupled device (“CCD”) element, a photovoltaic element, etc.

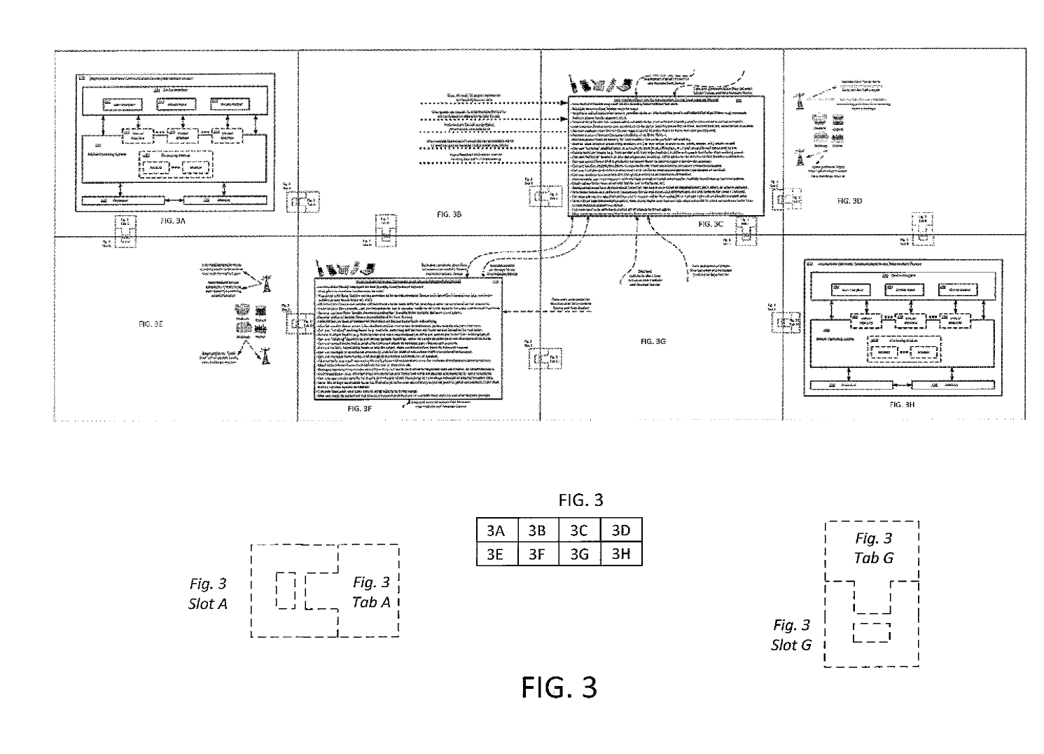

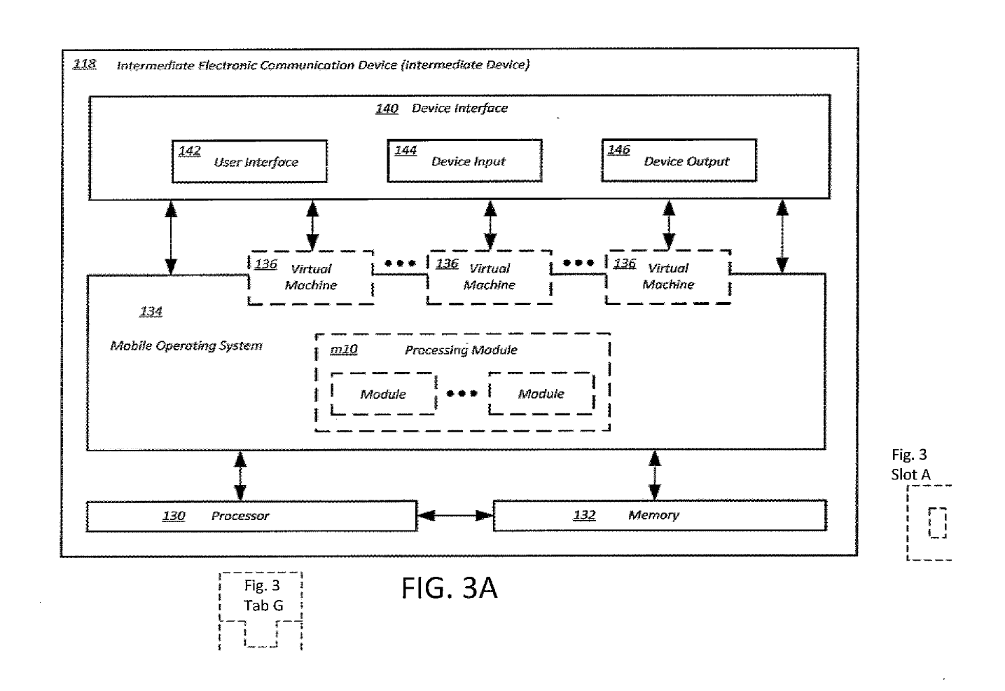

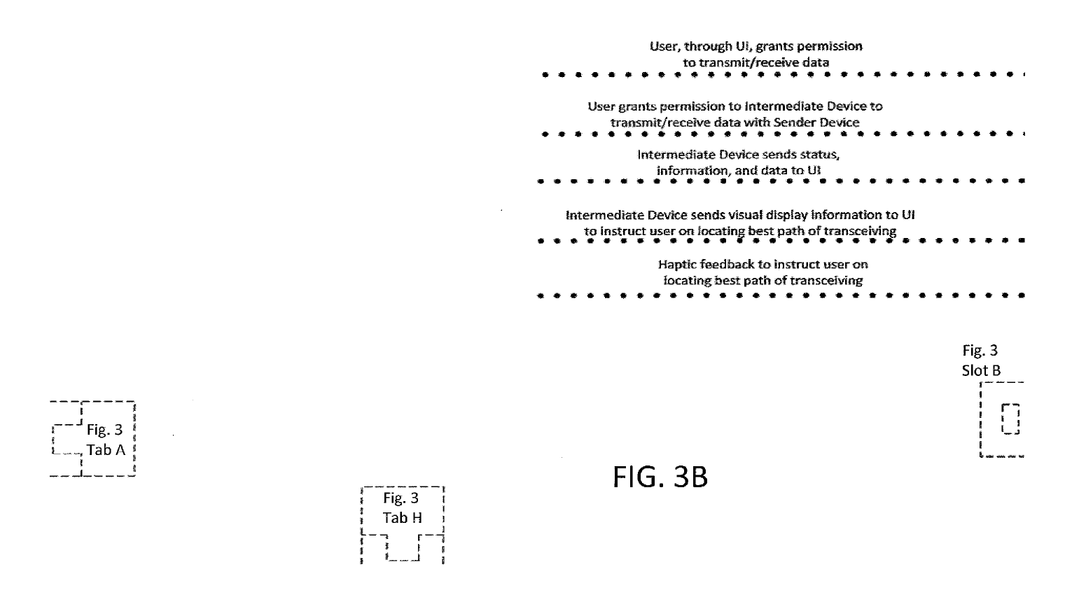

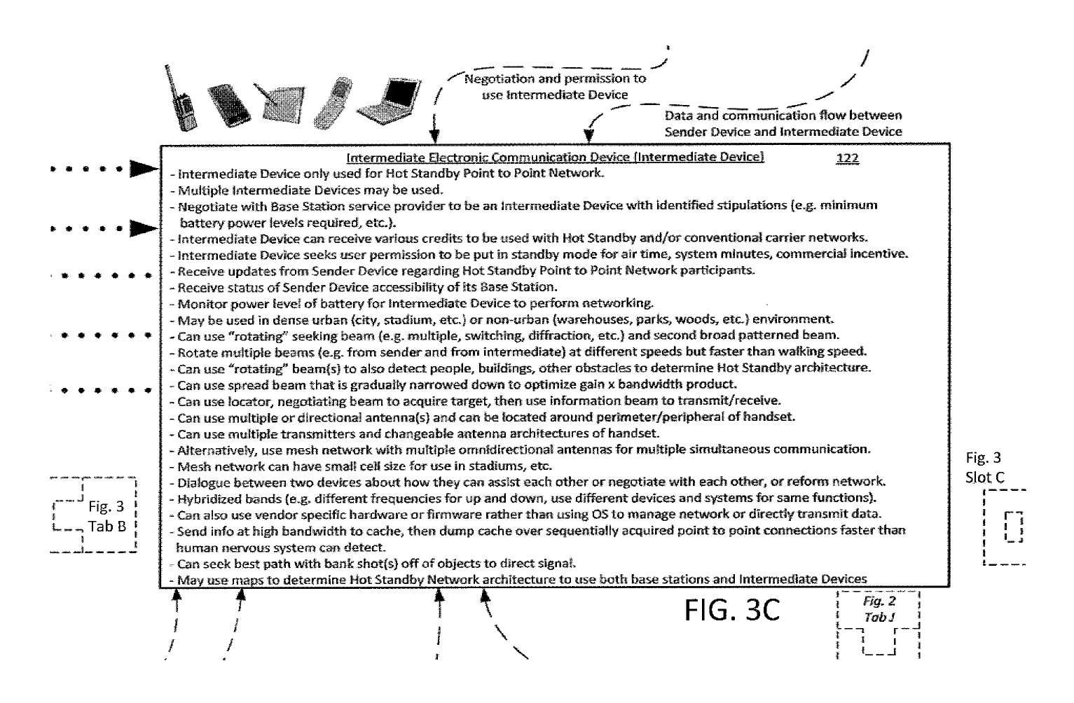

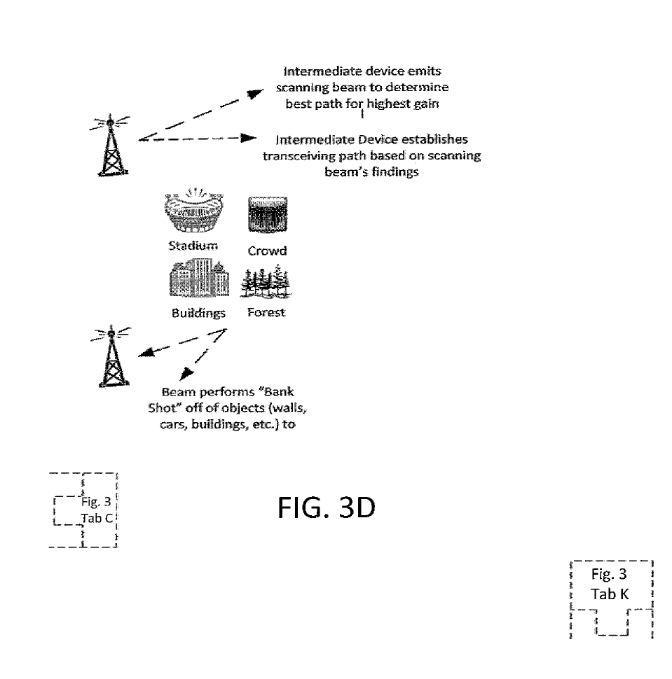

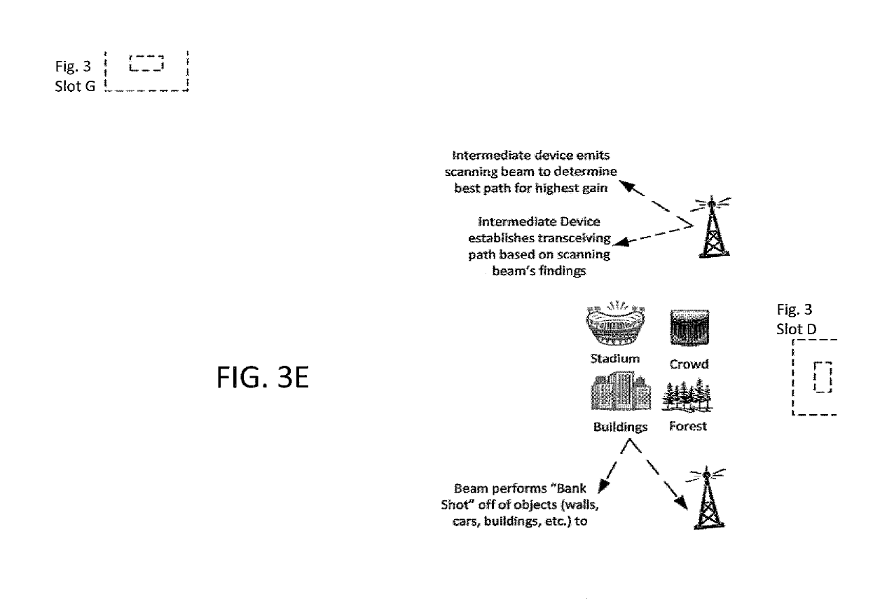

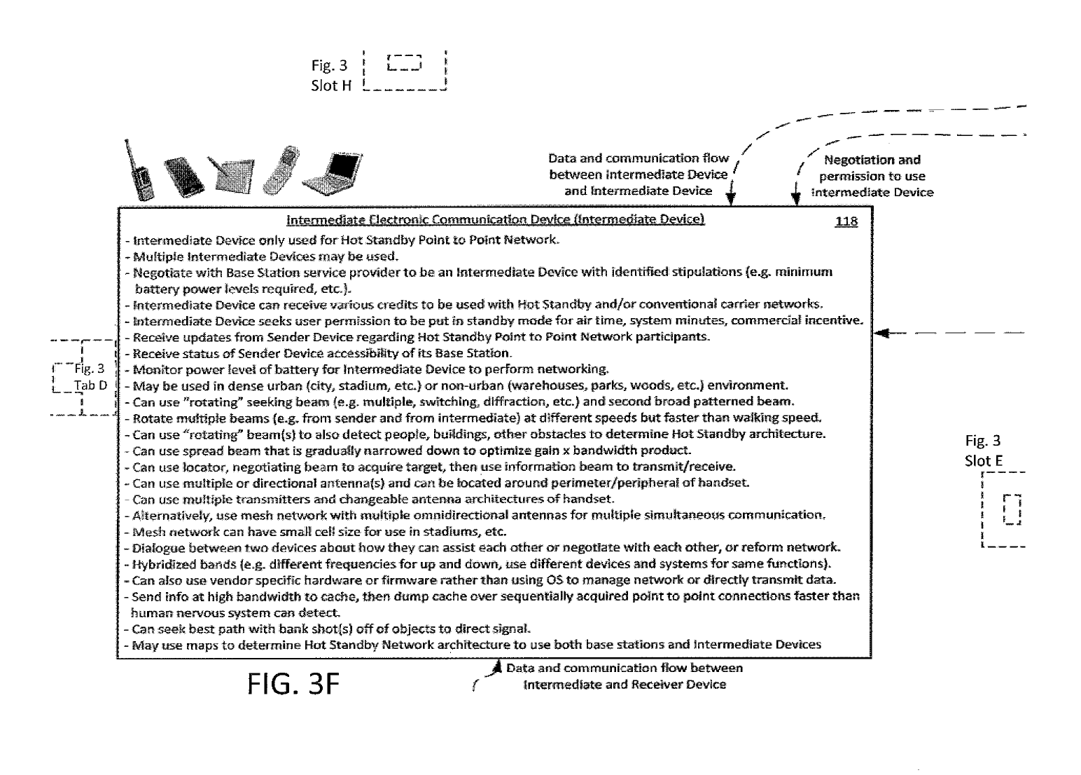

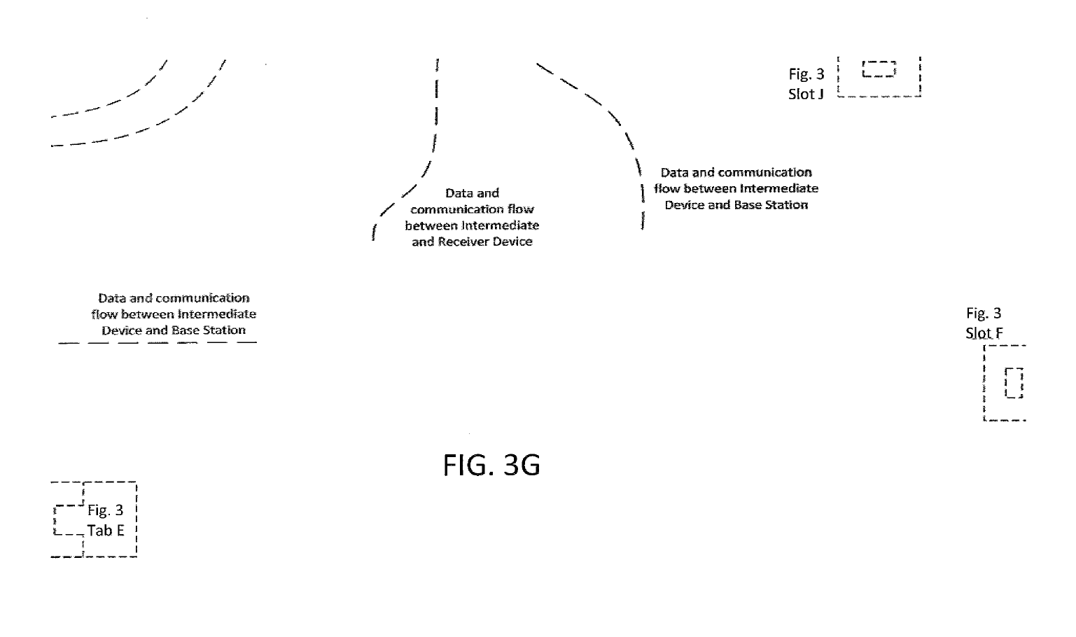

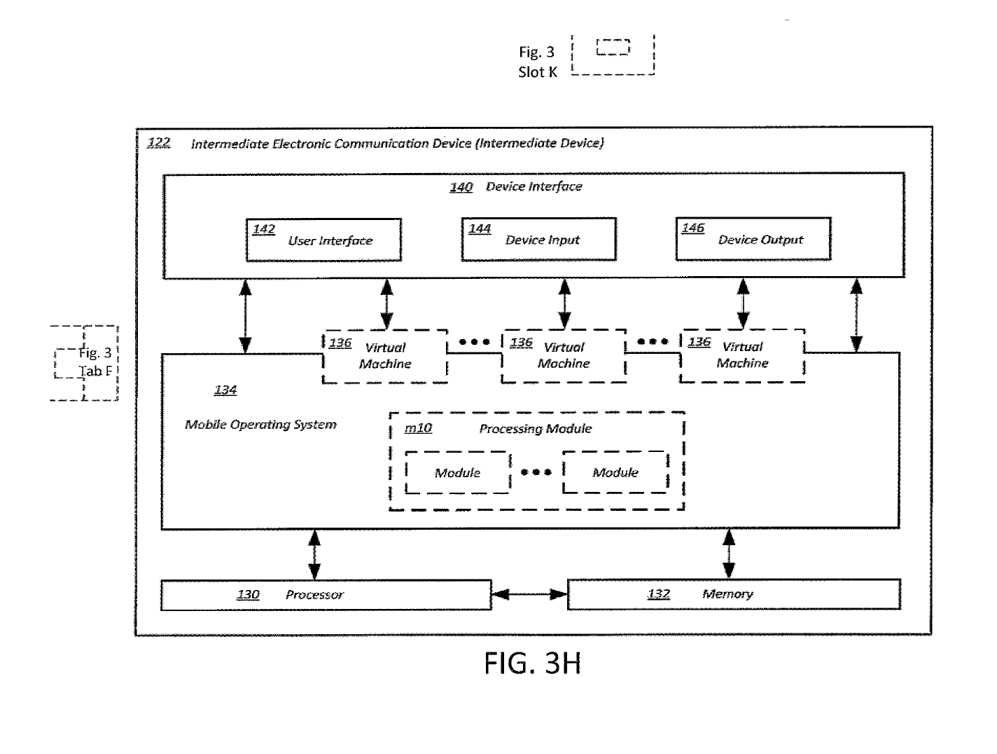

Turning now to FIG. 3, the intermediate device 118 (also known herein as an intermediate electronic communication device) is shown in FIG. 3A as an implementation of the intermediate device shown in FIG. 1. Referring again to FIG. 3A, the intermediate electronic communication device 118 may include a processor 130, a memory 132, and a mobile operating system 134 communicatively linked thereto. The mobile operating system 134 may include processing module m10, which may further include modules (some of which are described below), and virtual machines 136 (such as process virtual machines, virtual machines of hardware, virtual machines of virtual machines, Java virtual machines, Dalvik virtual machines, virtual machines for use with Android operating systems such as Samsung or Google mobile devices or for use with other mobile operating systems such as Apple iOS on Microsoft Windows based mobile operating systems, etc.). The intermediate electronic communication device 118 may also include device 140, which may include user interface 142, device input 144, and device output 146.

Implementations of processor 130 may include one or more microprocessors, central processing units, graphics processing units, digital signal processors, network processors, floating point processors, physics processing units, or other processors. Other implementations may include processor 130 as a distributed-core processor, server based processor, as part of multiple processors distributed over one or many other user devices in addition to intermediate electronic communication device 118. Furthermore processor 130 may execute computer readable instructions to execute one or more operations described herein. In implementations, processor 130 may operate as processing module m10, which may include one or more modules described below.

Implementations of memory 132 may cache memory such as random access memory (RAM), flash memory, synchronous random access memory (SRAM), dynamic random access memory (DRAM), other memory, read only memory (“ROM”), flash memory, hard drives, disk-based media, disc-based media, magnetic storage, optical storage, volatile memory, nonvolatile memory, separated from device 130 (such as on a network, server), mass storage, programmable read-only memory (PROM), erasable programmable read-only memory (EPROM), and/or other types of memory.

Referring again to FIG. 3A, implementations of device interface 140 may include one or more components to provide ways that intermediate electronic communication device 110 can input and output information with its environment and/or user. These components of device interface 140 may include one or more sensors, e.g., a camera, a microphone, an accelerometer, a thermometer, a satellite positioning system (SPS) sensor, a barometer, a humidity sensor, a compass, a gyroscope, a magnetometer, a pressure sensor, an oscillation detector, a light sensor, an inertial measurement unit (IMU), a tactile sensor, a touch sensor, a flexibility sensor, a microelectromechanical system (MEMS), a radio, including a wireless radio, a transmitter, a receiver, an emitter, a broadcaster, etc., and other components as well to serve input and output functions such as for device input 144 and device output 146.

User interface 142 may include any hardware, software, firmware, and combination thereof to provide capability for a user thereof to interact with intermediate device 118. Implementations of user interface 142 can include a monitor, screen, touchscreen, liquid crystal display (“LCD”) screen, light emitting diode (“LED”) screen, speaker, handset, earpiece, keyboard, keypad, touchpad, mouse, trackball, remote control, button set, microphone, video camera, still camera, a charge-coupled device (“CCD”) element, a photovoltaic element, etc.

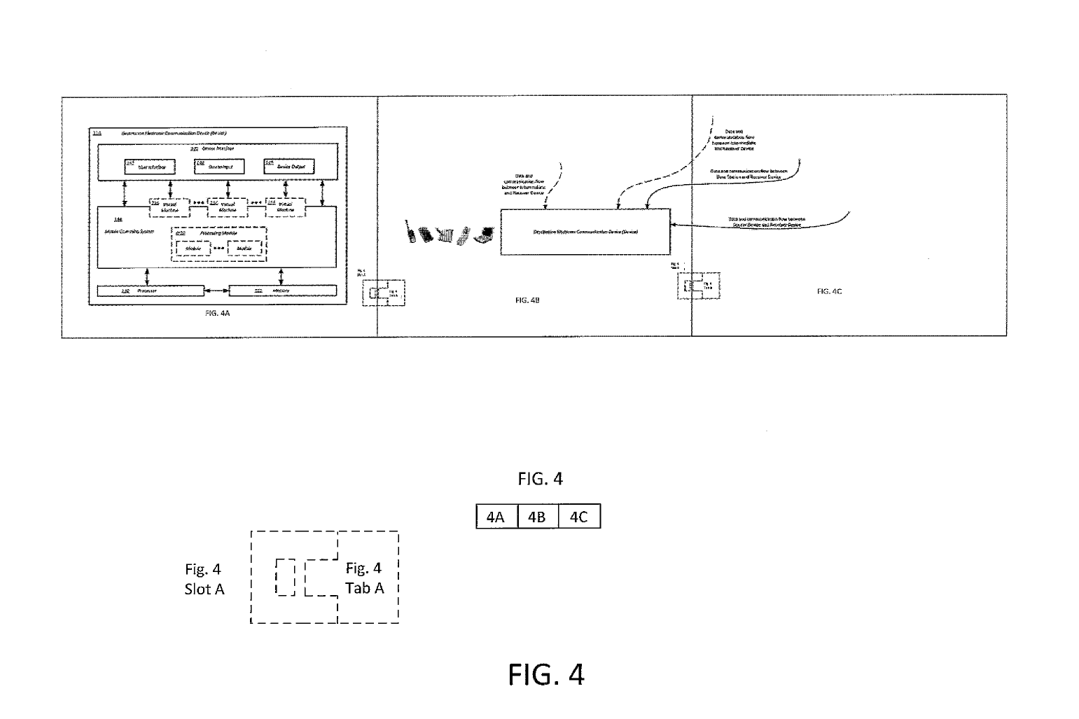

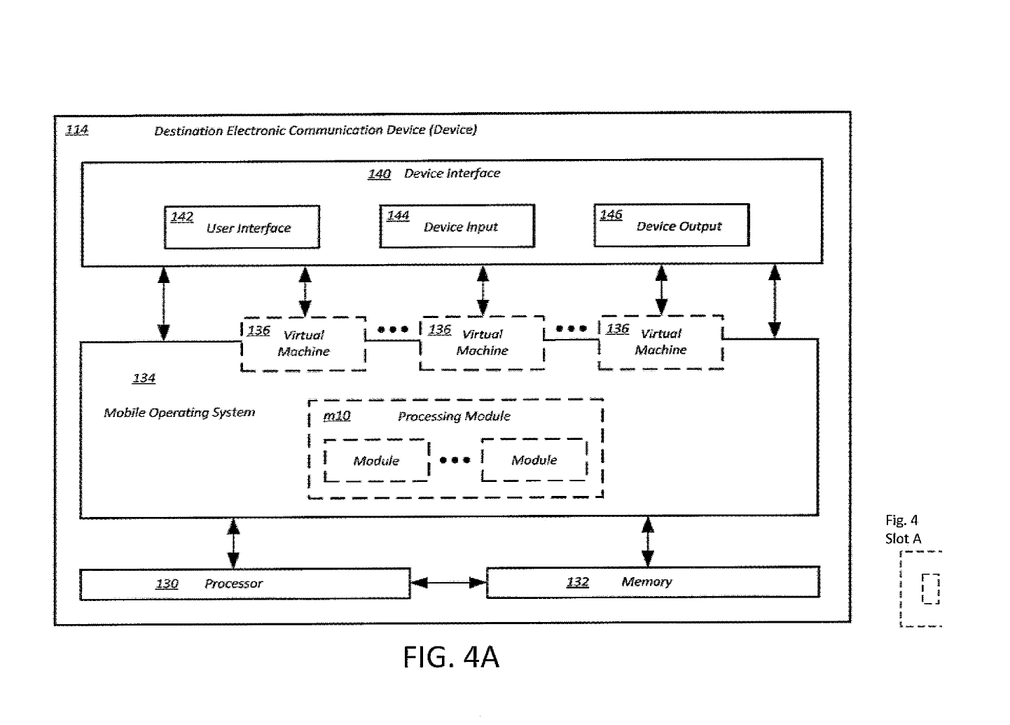

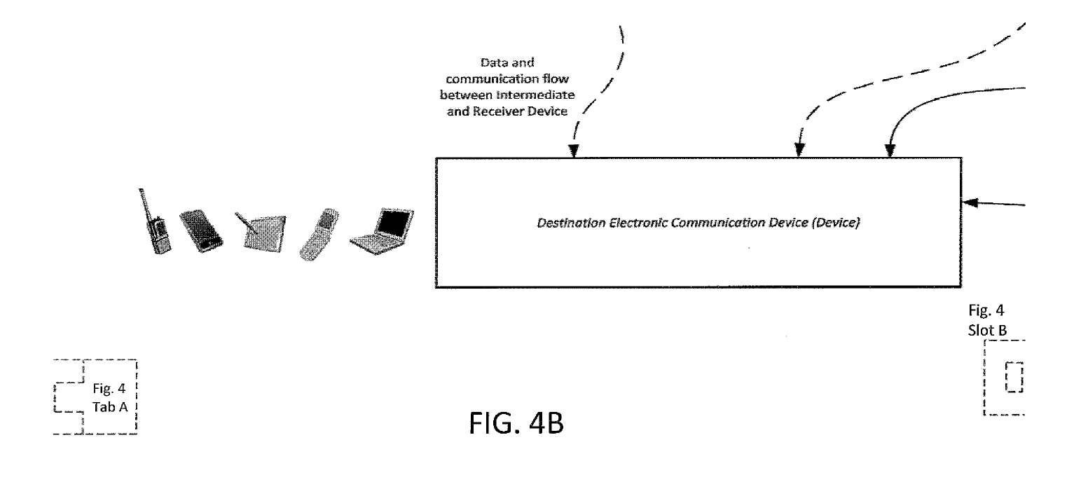

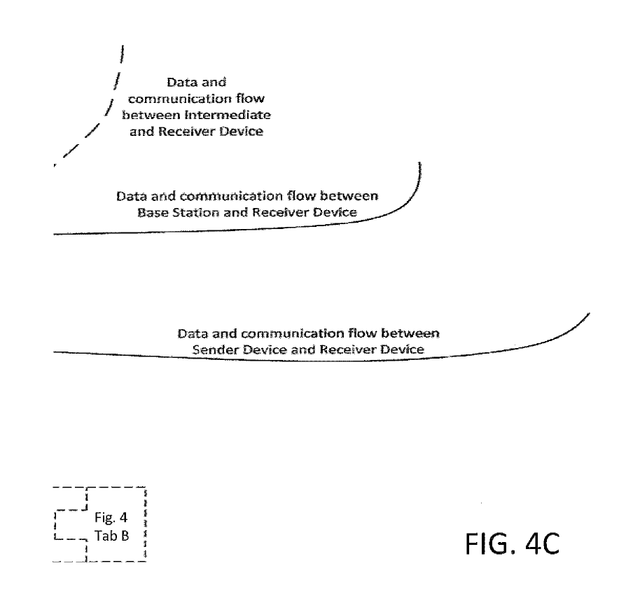

Turning now to FIG. 4, the receiver device 114 (also known herein as a destination electronic communication device) is shown in FIG. 4A as an implementation of the receiver device shown in FIG. 1. Referring again to FIG. 4A, the destination electronic communication device 114 may include a processor 130, a memory 132, and a mobile operating system 134 communicatively linked thereto. The mobile operating system 134 may include processing module m10, which may further include modules (some of which are described below), and virtual machines 136 (such as process virtual machines, virtual machines of hardware, virtual machines of virtual machines, Java virtual machines, Dalvik virtual machines, virtual machines for use with Android operating systems such as Samsung or Google mobile devices or for use with other mobile operating systems such as Apple iOS on Microsoft Windows based mobile operating systems, etc.). The destination electronic communication device 114 may also include device 140, which may include user interface 142, device input 144, and device output 146.

Implementations of processor 130 may include one or more microprocessors, central processing units, graphics processing units, digital signal processors, network processors, floating point processors, physics processing units, or other processors. Other implementations may include processor 130 as a distributed-core processor, server based processor, as part of multiple processors distributed over one or many other user devices in addition to destination electronic communication device 114. Furthermore processor 130 may execute computer readable instructions to execute one or more operations described herein. In implementations, processor 130 may operate as processing module m10, which may include one or more modules described below.

Implementations of memory 132 may cache memory such as random access memory (RAM), flash memory, synchronous random access memory (SRAM), dynamic random access memory (DRAM), other memory, read only memory (“ROM”), flash memory, hard drives, disk-based media, disc-based media, magnetic storage, optical storage, volatile memory, nonvolatile memory, separated from device 130 (such as on a network, server), mass storage, programmable read-only memory (PROM), erasable programmable read-only memory (EPROM), and/or other types of memory.

Referring again to FIG. 4A, implementations of device interface 140 may include one or more components to provide ways that destination electronic communication device 114 can input and output information with its environment and/or user. These components of device interface 140 may include one or more sensors, e.g., a camera, a microphone, an accelerometer, a thermometer, a satellite positioning system (SPS) sensor, a barometer, a humidity sensor, a compass, a gyroscope, a magnetometer, a pressure sensor, an oscillation detector, a light sensor, an inertial measurement unit (IMU), a tactile sensor, a touch sensor, a flexibility sensor, a microelectromechanical system (MEMS), a radio, including a wireless radio, a transmitter, a receiver, an emitter, a broadcaster, etc., and other components as well to serve input and output functions such as for device input 144 and device output 146.

User interface 142 may include any hardware, software, firmware, and combination thereof to provide capability for a user thereof to interact with destination device 114. Implementations of user interface 142 can include a monitor, screen, touchscreen, liquid crystal display (“LCD”) screen, light emitting diode (“LED”) screen, speaker, handset, earpiece, keyboard, keypad, touchpad, mouse, trackball, remote control, button set, microphone, video camera, still camera, a charge-coupled device (“CCD”) element, a photovoltaic element, etc.

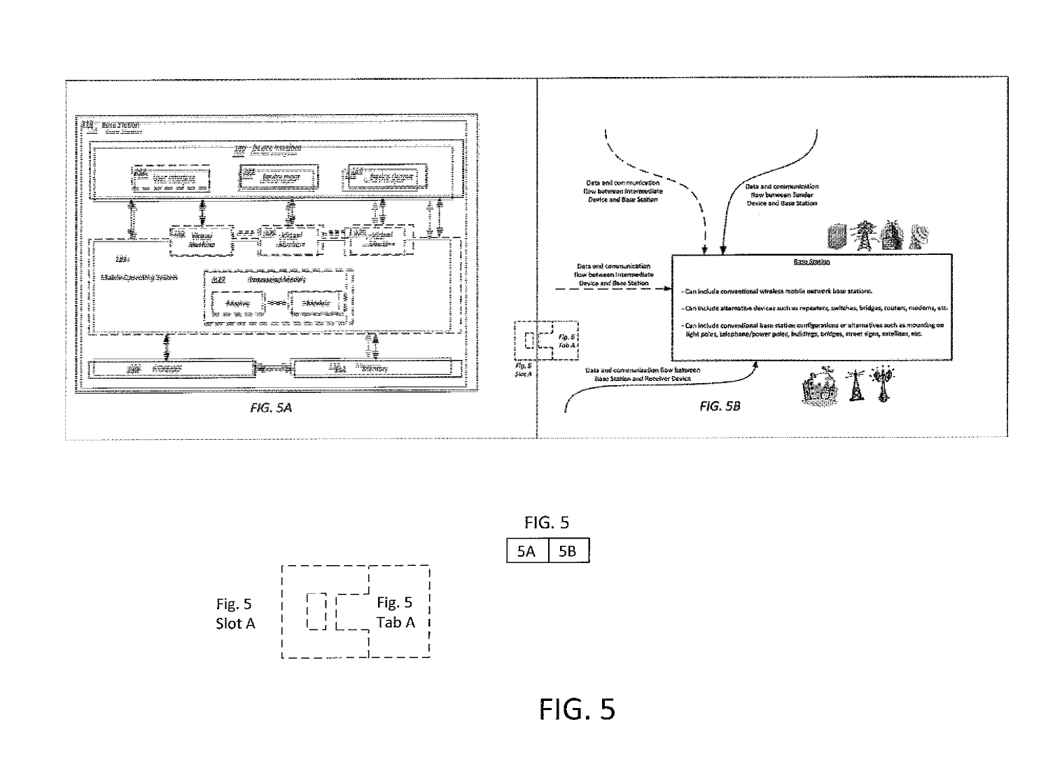

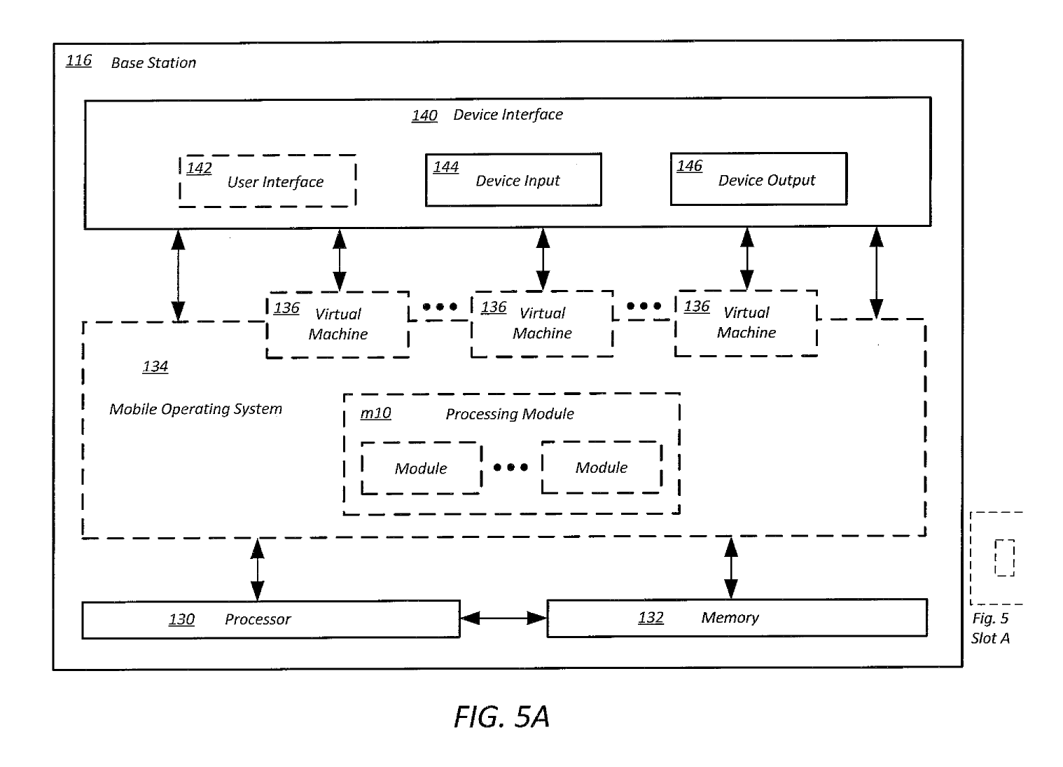

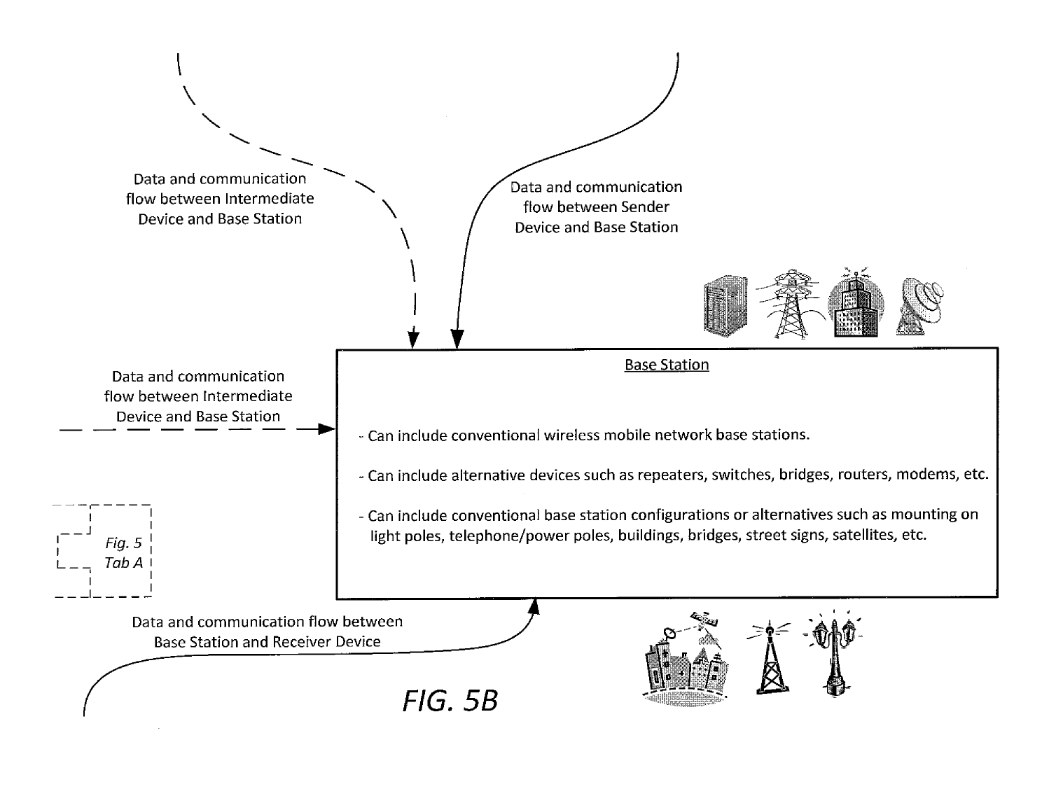

Turning now to FIG. 5, the base station 116 is shown in FIG. 5A as an implementation of the receiver device shown in FIG. 1. Referring again to FIG. 5A, the base station 116 may include a processor 130, a memory 132, and an optional mobile operating system 134 communicatively linked thereto. The optional mobile operating system 134 may include processing module m10, which may further include optional modules (some of which are described below), and optional virtual machines 136 (such as process virtual machines, virtual machines of hardware, virtual machines of virtual machines, Java virtual machines, Dalvik virtual machines, virtual machines for use with Android operating systems such as Samsung or Google mobile devices or for use with other mobile operating systems such as Apple iOS on Microsoft Windows based mobile operating systems, etc.). The base station 116 may also include device 140, which may include optional user interface 142, device input 144, and device output 146.

Implementations of processor 130 may include one or more microprocessors, central processing units, graphics processing units, digital signal processors, network processors, floating point processors, physics processing units, or other processors. Other implementations may include processor 130 as a distributed-core processor, server based processor, as part of multiple processors distributed over one or many other user devices in addition to base station 116. Furthermore processor 130 may execute computer readable instructions to execute one or more operations described herein. In implementations, processor 130 may operate as processing module m10, which may include one or more modules described below.

Implementations of memory 132 may cache memory such as random access memory (RAM), flash memory, synchronous random access memory (SRAM), dynamic random access memory (DRAM), other memory, read only memory (“ROM”), flash memory, hard drives, disk-based media, disc-based media, magnetic storage, optical storage, volatile memory, nonvolatile memory, separated from device 130 (such as on a network, server), mass storage, programmable read-only memory (PROM), erasable programmable read-only memory (EPROM), and/or other types of memory.

Referring again to FIG. 5A, implementations of device interface 140 may include one or more components to provide ways that base station 116 can input and output information with its environment and/or user. These components of device interface 140 may include one or more sensors, e.g., a camera, a microphone, an accelerometer, a thermometer, a satellite positioning system (SPS) sensor, a barometer, a humidity sensor, a compass, a gyroscope, a magnetometer, a pressure sensor, an oscillation detector, a light sensor, an inertial measurement unit (IMU), a tactile sensor, a touch sensor, a flexibility sensor, a microelectromechanical system (MEMS), a radio, including a wireless radio, a transmitter, a receiver, an emitter, a broadcaster, etc., and other components as well to serve input and output functions such as for device input 144 and device output 146.

Optional user interface 142 may include any hardware, software, firmware, and combination thereof to provide capability for a user thereof to interact with base station 116. Implementations of user interface 142 can include a monitor, screen, touchscreen, liquid crystal display (“LCD”) screen, light emitting diode (“LED”) screen, speaker, handset, earpiece, keyboard, keypad, touchpad, mouse, trackball, remote control, button set, microphone, video camera, still camera, a charge-coupled device (“CCD”) element, a photovoltaic element, etc.

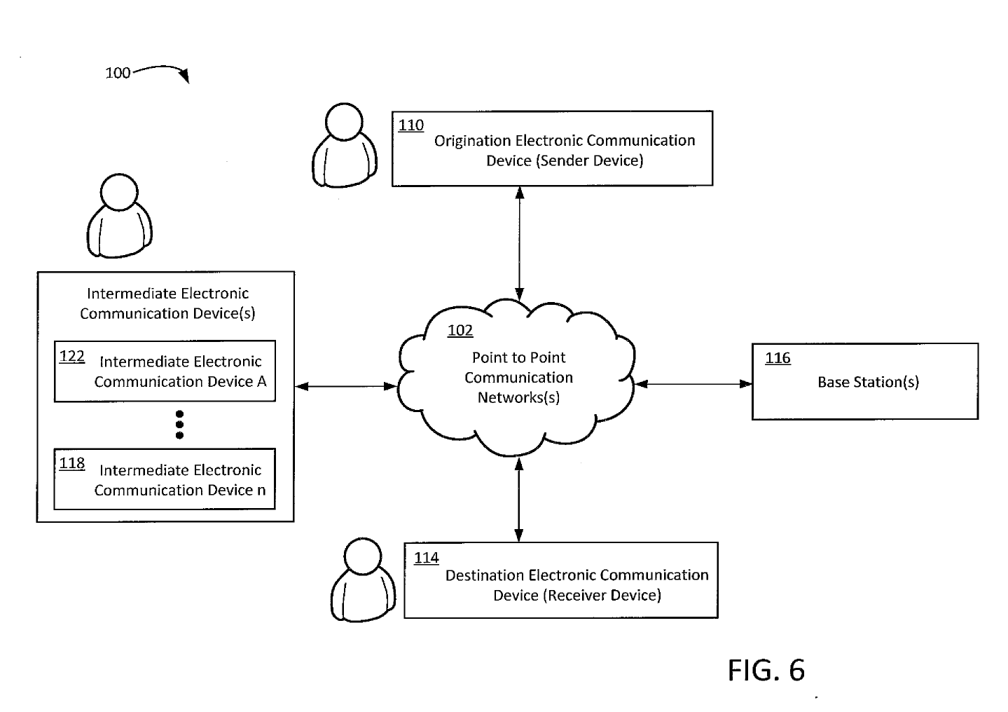

Referring now to FIG. 6, FIG. 6 depicts one or more systems involving base station based networks and standby point-to-point mobile network systems as described above for FIG. 1. As described, sender device 110 (also known herein as “origination electronic communication device”) can communicate with receiver device 114 (also known herein as “destination electronic communication device”) through one or more point-to-point communication networks 102 provided by one or more networked base stations 116 and/or intermediate electronic communication devices (such as intermediate electronic communication devices 118 or 122) dependent upon whether communication with the one or more base stations is occluded. Base station 116 can be fixed in position such as on a cellular tower, wall-mounted base station, etc. A network of a plurality of base stations 116 can provide a cellular communication network or other sort of communication networks.

Implementations of modules can involve different combinations (limited to patentable subject matter under 35 U.S.C. 101) of one or more aspects from one or more electrical circuitry arrangements and/or one or more aspects from one or more instructions.

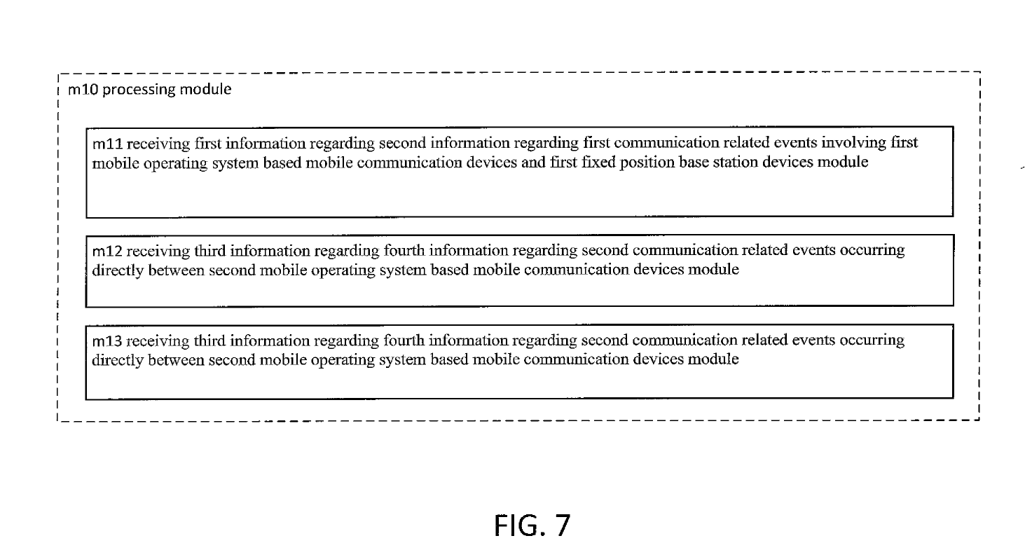

In one or more implementations, as shown in FIG. 7, the processing module m10 may include receiving first information regarding second information regarding first communication related events involving first mobile operating system based mobile communication devices and first fixed position base station devices module m11.

In one or more implementations, as shown in FIG. 7, the processing module m10 may include receiving third information regarding fourth information regarding second communication related events occurring directly between second mobile operating system based mobile communication devices module m12.

In one or more implementations, as shown in FIG. 7, the processing module m10 may include relating first information with third information module m13.

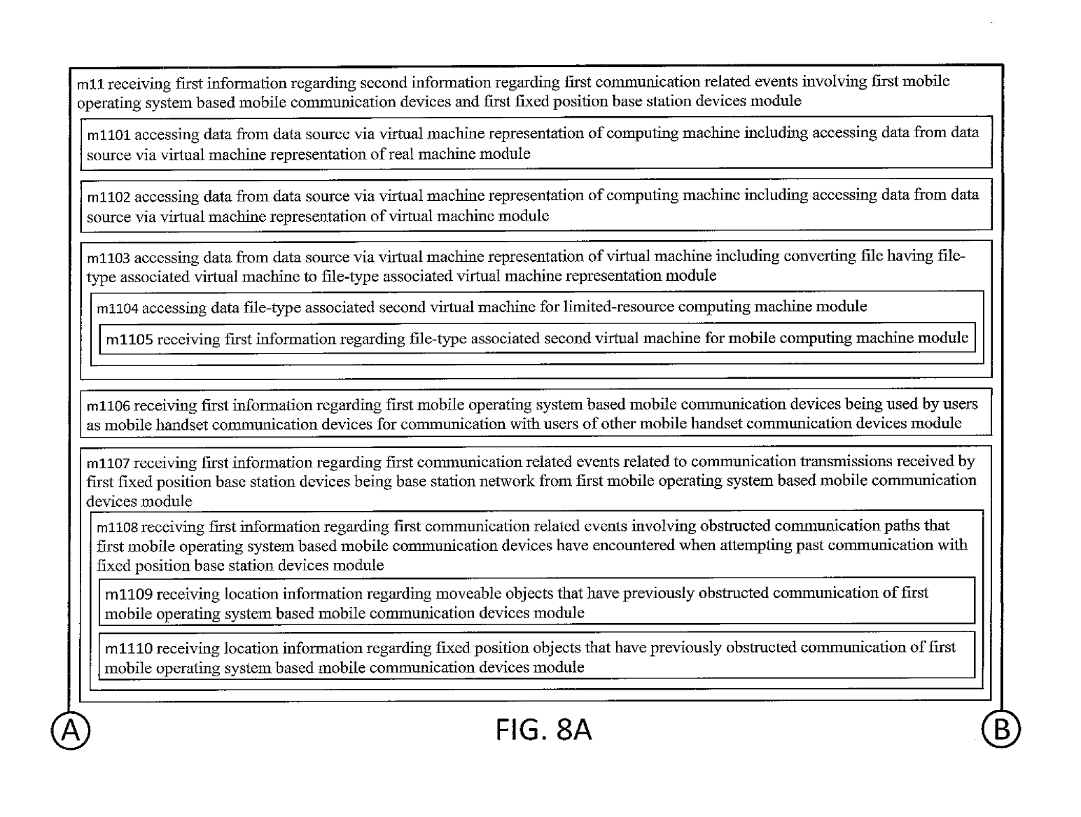

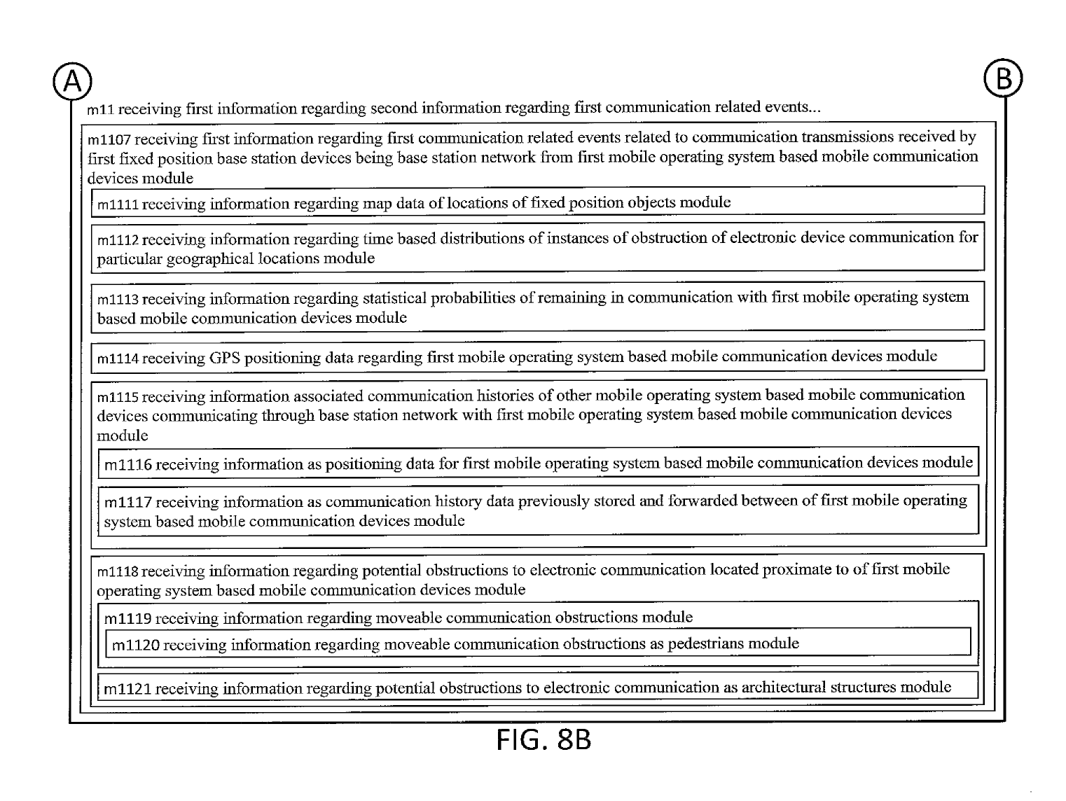

In one or more implementations, as shown in FIG. 8A, module m1100 may include accessing data from data source via virtual machine representation of computing machine including accessing data from data source via virtual machine representation of real machine module m1101.

In one or more implementations, as shown in FIG. 8A, module m1100 may include accessing data from data source via virtual machine representation of computing machine including accessing data from data source via virtual machine representation of virtual machine module m1102.

In one or more implementations, as shown in FIG. 8A, module m1100 may include accessing data from data source via virtual machine representation of virtual machine including converting file having file-type associated virtual machine to file-type associated virtual machine representation module m1103.

In one or more implementations, as shown in FIG. 8A, module m1103 may include accessing data file-type associated second virtual machine for limited-resource computing machine module m1104.

In one or more implementations, as shown in FIG. 8A, module m1104 may include receiving first information regarding file-type associated second virtual machine for mobile computing machine module m1105.

In one or more implementations, as shown in FIG. 8A, module m1100 may include receiving first information regarding first mobile operating system based mobile communication devices being used by users as mobile handset communication devices for communication with users of other mobile handset communication devices module m1106.

In one or more implementations, as shown in FIG. 8A, module m1100 may include receiving first information regarding first communication related events related to communication transmissions received by first fixed position base station devices being base station network from first mobile operating system based mobile communication devices module m1107.

In one or more implementations, as shown in FIG. 8A, module m1107 may include receiving first information regarding first communication related events involving obstructed communication paths that first mobile operating system based mobile communication devices have encountered when attempting past communication with fixed position base station devices module m1108.

In one or more implementations, as shown in FIG. 8A, module m1108 may include receiving location information regarding moveable objects that have previously obstructed communication of first mobile operating system based mobile communication devices module m1109.

In one or more implementations, as shown in FIG. 8A, module m1108 may include receiving location information regarding fixed position objects that have previously obstructed communication of first mobile operating system based mobile communication devices module m1110.

In one or more implementations, as shown in FIG. 8B, module m1107 may include receiving information regarding map data of locations of fixed position objects module m1111.

In one or more implementations, as shown in FIG. 8B, module m1107 may include receiving information regarding time based distributions of instances of obstruction of electronic device communication for particular geographical locations module m1112.

In one or more implementations, as shown in FIG. 8B, module m1107 may include receiving information regarding statistical probabilities of remaining in communication with first mobile operating system based mobile communication devices module m1113.

In one or more implementations, as shown in FIG. 8B, module m1107 may include receiving GPS positioning data regarding first mobile operating system based mobile communication devices module m1114.

In one or more implementations, as shown in FIG. 8B, module m1107 may include receiving information associated communication histories of other mobile operating system based mobile communication devices communicating through base station network with first mobile operating system based mobile communication devices module m1115.

In one or more implementations, as shown in FIG. 8B, module m1115 may include receiving information as positioning data for first mobile operating system based mobile communication devices module m 1116In one or more implementations, as shown in FIG. 8B, module m1115 may include receiving information as communication history data previously stored and forwarded between of first mobile operating system based mobile communication devices module m1117.

In one or more implementations, as shown in FIG. 8B, module m1107 may include receiving information regarding potential obstructions to electronic communication located proximate to of first mobile operating system based mobile communication devices module m1118.

In one or more implementations, as shown in FIG. 8B, module m1118 may include receiving information regarding moveable communication obstructions module m1119.

In one or more implementations, as shown in FIG. 8B, module m1119 may include receiving information regarding moveable communication obstructions as pedestrians module m1120.

In one or more implementations, as shown in FIG. 8B, module m1118 may include receiving information regarding potential obstructions to electronic communication as architectural structures module m1121.

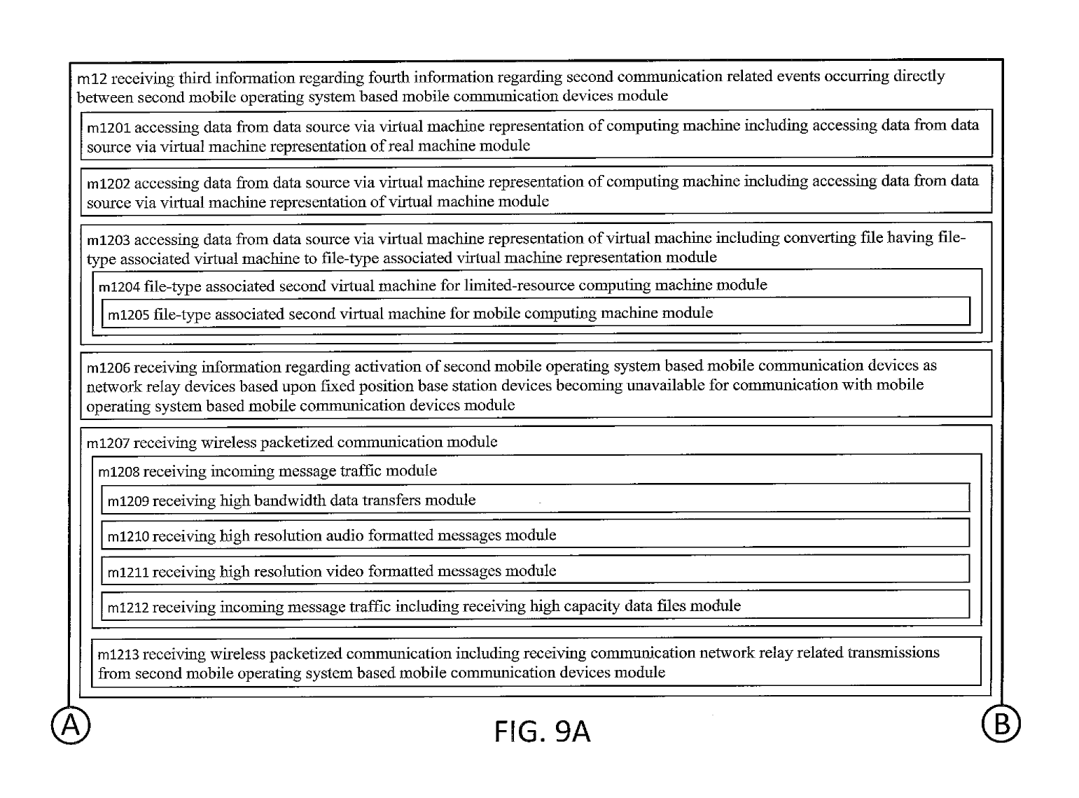

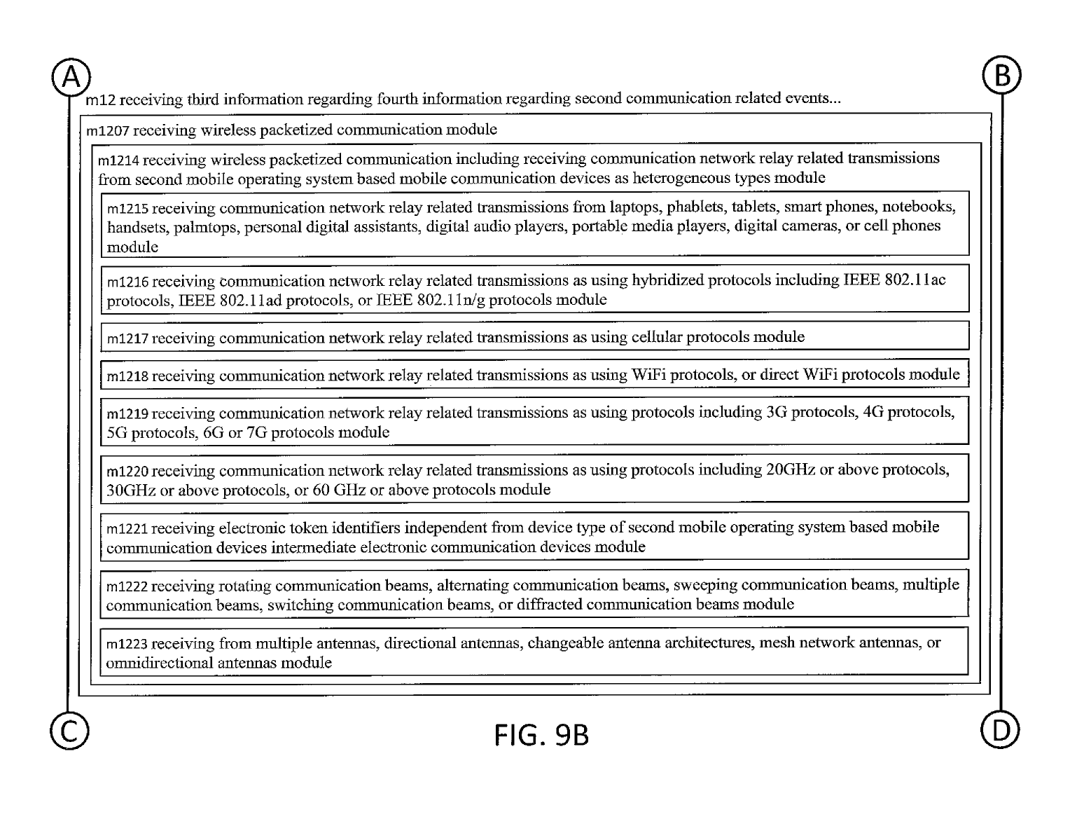

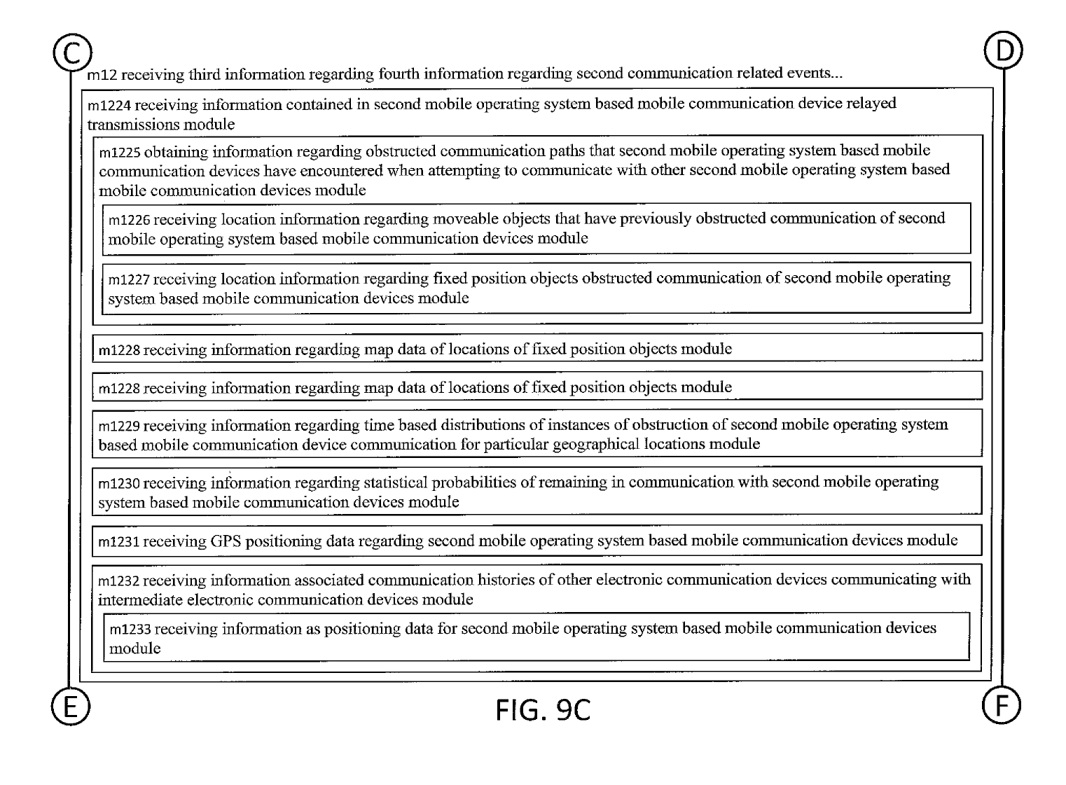

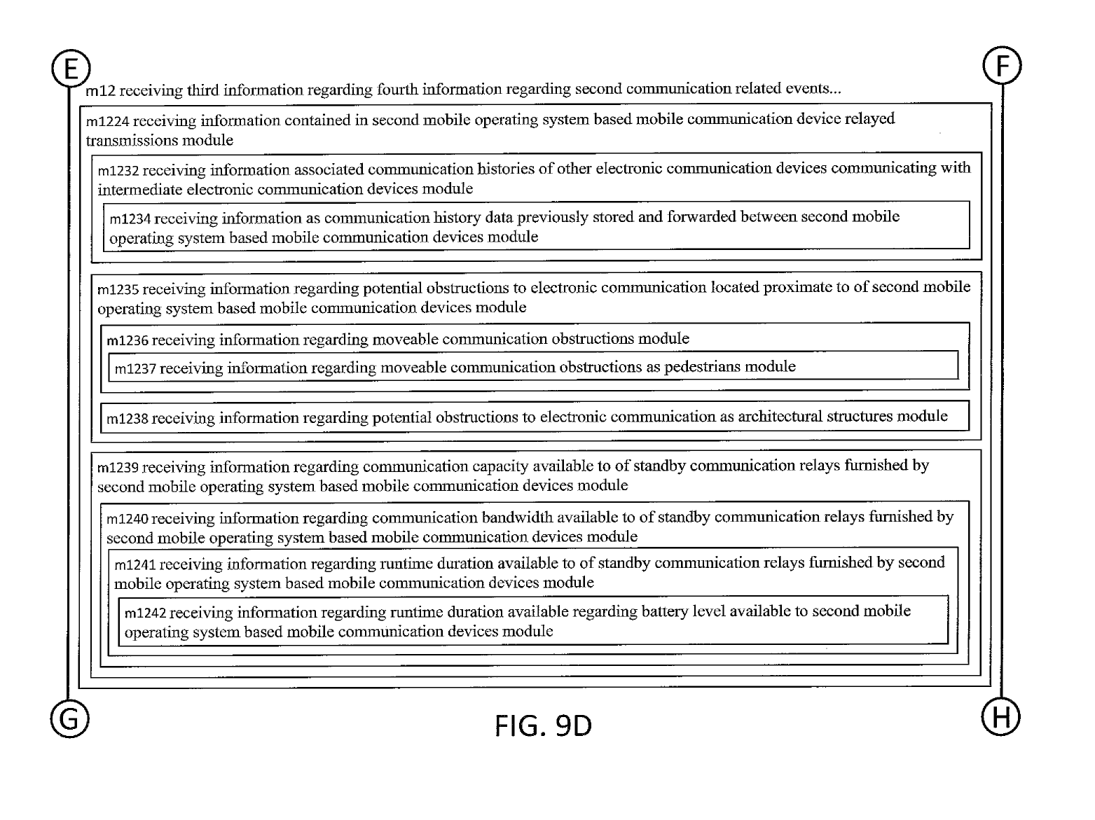

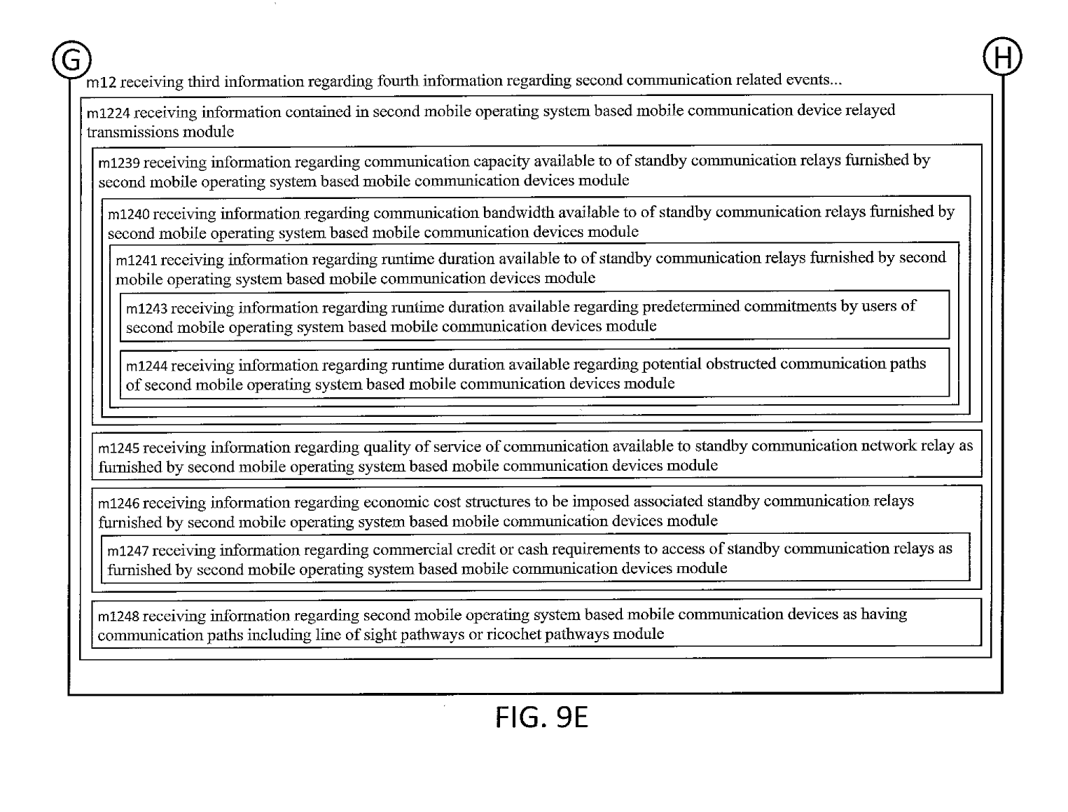

In one or more implementations, as shown in FIG. 9A, module m1179 may include accessing data from data source via virtual machine representation of computing machine including accessing data from data source via virtual machine representation of real machine module m1201.

In one or more implementations, as shown in FIG. 9A, module m1179 may include accessing data from data source via virtual machine representation of computing machine including accessing data from data source via virtual machine representation of virtual machine module m1202.

In one or more implementations, as shown in FIG. 9A, module m1179 may include accessing data from data source via virtual machine representation of virtual machine including converting file having file-type associated virtual machine to file-type associated virtual machine representation module m1203.

In one or more implementations, as shown in FIG. 9A, module m1203 may include file-type associated second virtual machine for limited-resource computing machine module m1204.

In one or more implementations, as shown in FIG. 9A, module m1204 may include file-type associated second virtual machine for mobile computing machine module m1205.

In one or more implementations, as shown in FIG. 9A, module m1179 may include receiving information regarding activation of second mobile operating system based mobile communication devices as network relay devices based upon fixed position base station devices becoming unavailable for communication with mobile operating system based mobile communication devices module m1206.

In one or more implementations, as shown in FIG. 9A, module m1179 may include receiving wireless packetized communication module m1207.

In one or more implementations, as shown in FIG. 9A, module m1207 may include receiving incoming message traffic module m1208.

In one or more implementations, as shown in FIG. 9A, module m1208 may include receiving high bandwidth data transfers module m1209.

In one or more implementations, as shown in FIG. 9A, module m1208 may include receiving high resolution audio formatted messages module m1210.

In one or more implementations, as shown in FIG. 9A, module m1208 may include receiving high resolution video formatted messages module m1211.

In one or more implementations, as shown in FIG. 9A, module m1208 may include receiving incoming message traffic including receiving high capacity data files module m1212.

In one or more implementations, as shown in FIG. 9A, module m1207 may include receiving wireless packetized communication including receiving communication network relay related transmissions from second mobile operating system based mobile communication devices module m1213.

In one or more implementations, as shown in FIG. 9B, module m1207 may include receiving wireless packetized communication including receiving communication network relay related transmissions from second mobile operating system based mobile communication devices as heterogeneous types module m1214.

In one or more implementations, as shown in FIG. 9B, module m1214 may include receiving communication network relay related transmissions from laptops, phablets, tablets, smart phones, notebooks, handsets, palmtops, personal digital assistants, digital audio players, portable media players, digital cameras, or cell phones module m1215.

In one or more implementations, as shown in FIG. 9B, module m1214 may include receiving communication network relay related transmissions as using hybridized protocols including IEEE 802.11ac protocols, IEEE 802.11ad protocols, or IEEE 802.11n/g protocols module m1216.

In one or more implementations, as shown in FIG. 9B, module m1214 may include receiving communication network relay related transmissions as using cellular protocols module m1217.

In one or more implementations, as shown in FIG. 9B, module m1214 may include receiving communication network relay related transmissions as using WiFi protocols, or direct WiFi protocols module m1218.

In one or more implementations, as shown in FIG. 9B, module m1214 may include receiving communication network relay related transmissions as using protocols including 3G protocols, 4G protocols, 5G protocols, 6G or 7G protocols module m1219.

In one or more implementations, as shown in FIG. 9B, module m1214 may include receiving communication network relay related transmissions as using protocols including 20 GHz or above protocols, 30 GHz or above protocols, or 60 GHz or above protocols module m1220.

In one or more implementations, as shown in FIG. 9B, module m1214 may include receiving electronic token identifiers independent from device type of second mobile operating system based mobile communication devices intermediate electronic communication devices module m1221.

In one or more implementations, as shown in FIG. 9B, module m1214 may include receiving rotating communication beams, alternating communication beams, sweeping communication beams, multiple communication beams, switching communication beams, or diffracted communication beams module m1222.

In one or more implementations, as shown in FIG. 9B, module m1214 may include receiving from multiple antennas, directional antennas, changeable antenna architectures, mesh network antennas, or omnidirectional antennas module m1223.

In one or more implementations, as shown in FIG. 9C, module m1179 may include receiving information contained in second mobile operating system based mobile communication device relayed transmissions module m1224.

In one or more implementations, as shown in FIG. 9C, module m1224 may include obtaining information regarding obstructed communication paths that second mobile operating system based mobile communication devices have encountered when attempting to communicate with other second mobile operating system based mobile communication devices module m1225.

In one or more implementations, as shown in FIG. 9C, module m1225 may include receiving location information regarding moveable objects that have previously obstructed communication of second mobile operating system based mobile communication devices module m1226.

In one or more implementations, as shown in FIG. 9C, module m1225 may include receiving location information regarding fixed position objects obstructed communication of second mobile operating system based mobile communication devices module m1227.

In one or more implementations, as shown in FIG. 9C, module m1224 may include receiving information regarding map data of locations of fixed position objects module m1228.

In one or more implementations, as shown in FIG. 9C, module m1224 may include receiving information regarding time based distributions of instances of obstruction of second mobile operating system based mobile communication device communication for particular geographical locations module m1229.

In one or more implementations, as shown in FIG. 9C, module m1224 may include receiving information regarding statistical probabilities of remaining in communication with second mobile operating system based mobile communication devices module m1230.

In one or more implementations, as shown in FIG. 9C, module m1224 may include receiving GPS positioning data regarding second mobile operating system based mobile communication devices module m1231.

In one or more implementations, as shown in FIG. 9C, module m1224 may include receiving information associated communication histories of other electronic communication devices communicating with intermediate electronic communication devices module m1232.

In one or more implementations, as shown in FIG. 9C, module m1232 may include receiving information as positioning data for second mobile operating system based mobile communication devices module m1233.

In one or more implementations, as shown in FIG. 9D, module m1232 may include receiving information as communication history data previously stored and forwarded between second mobile operating system based mobile communication devices module m1234.

In one or more implementations, as shown in FIG. 9D, module m1224 may include receiving information regarding potential obstructions to electronic communication located proximate to of second mobile operating system based mobile communication devices module m1235.

In one or more implementations, as shown in FIG. 9D, module m1235 may include receiving information regarding moveable communication obstructions module m1236.

In one or more implementations, as shown in FIG. 9D, module m1236 may include receiving information regarding moveable communication obstructions as pedestrians module m1237.

In one or more implementations, as shown in FIG. 9D, module m1235 may include receiving information regarding potential obstructions to electronic communication as architectural structures module m1238.

In one or more implementations, as shown in FIG. 9D, module m1224 may include receiving information regarding communication capacity available to of standby communication relays furnished by second mobile operating system based mobile communication devices module m1239.

In one or more implementations, as shown in FIG. 9D, module m1239 may include receiving information regarding communication bandwidth available to of standby communication relays furnished by second mobile operating system based mobile communication devices module m1240.

In one or more implementations, as shown in FIG. 9D, module m1240 may include receiving information regarding runtime duration available to of standby communication relays furnished by second mobile operating system based mobile communication devices module m1241.

In one or more implementations, as shown in FIG. 9D, module m1241 may include receiving information regarding runtime duration available regarding battery level available to second mobile operating system based mobile communication devices module m1242.

In one or more implementations, as shown in FIG. 9E, module m1241 may include receiving information regarding runtime duration available regarding predetermined commitments by users of second mobile operating system based mobile communication devices module m1243.

In one or more implementations, as shown in FIG. 9E, module m1241 may include receiving information regarding runtime duration available regarding potential obstructed communication paths of second mobile operating system based mobile communication devices module m1244.

In one or more implementations, as shown in FIG. 9E, module m1224 may include receiving information regarding quality of service of communication available to standby communication network relay as furnished by second mobile operating system based mobile communication devices module m1245.

In one or more implementations, as shown in FIG. 9E, module m1224 may include receiving information regarding economic cost structures to be imposed associated standby communication relays furnished by second mobile operating system based mobile communication devices module m1246.

In one or more implementations, as shown in FIG. 9E, module m1246 may include receiving information regarding commercial credit or cash requirements to access of standby communication relays as furnished by second mobile operating system based mobile communication devices module m1247.

In one or more implementations, as shown in FIG. 9E, module m1224 may include receiving information regarding second mobile operating system based mobile communication devices as having communication paths including line of sight pathways or ricochet pathways module m1248.

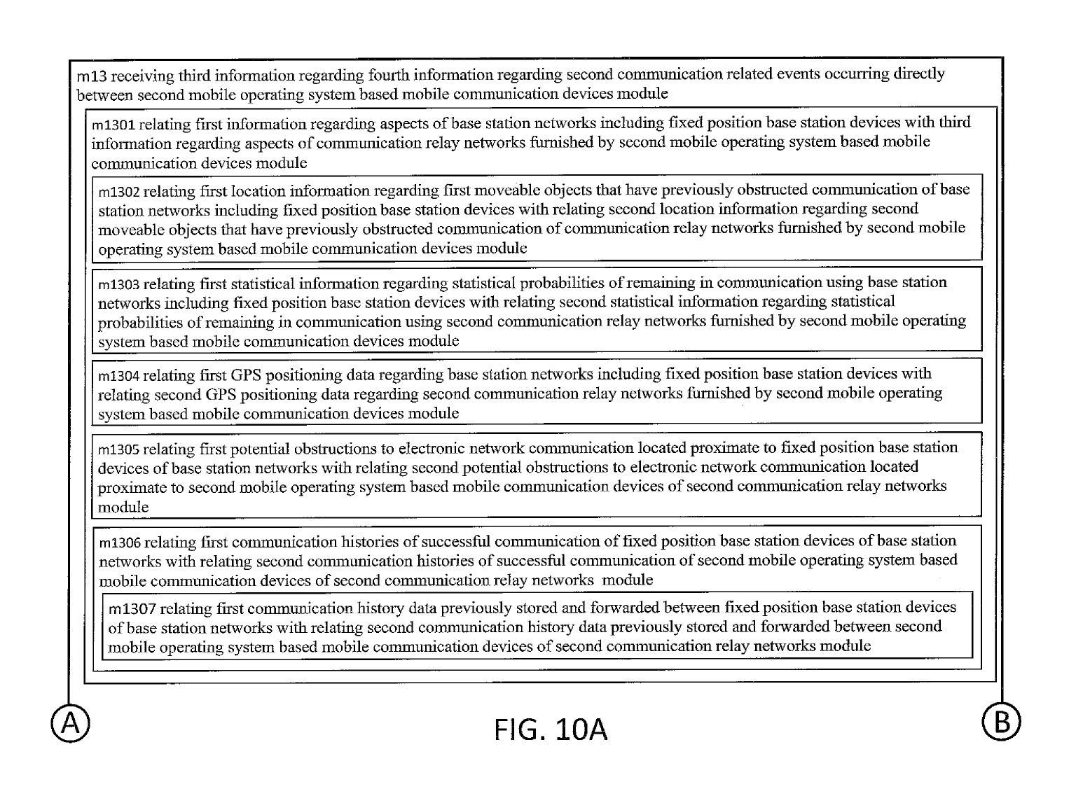

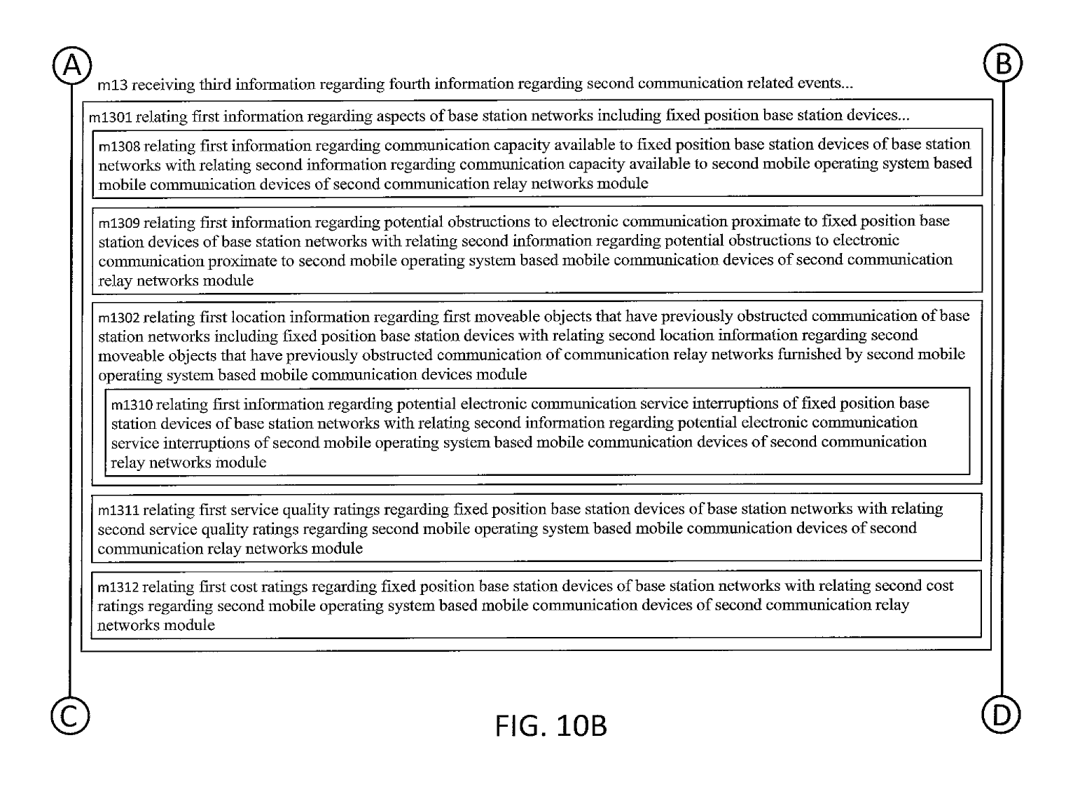

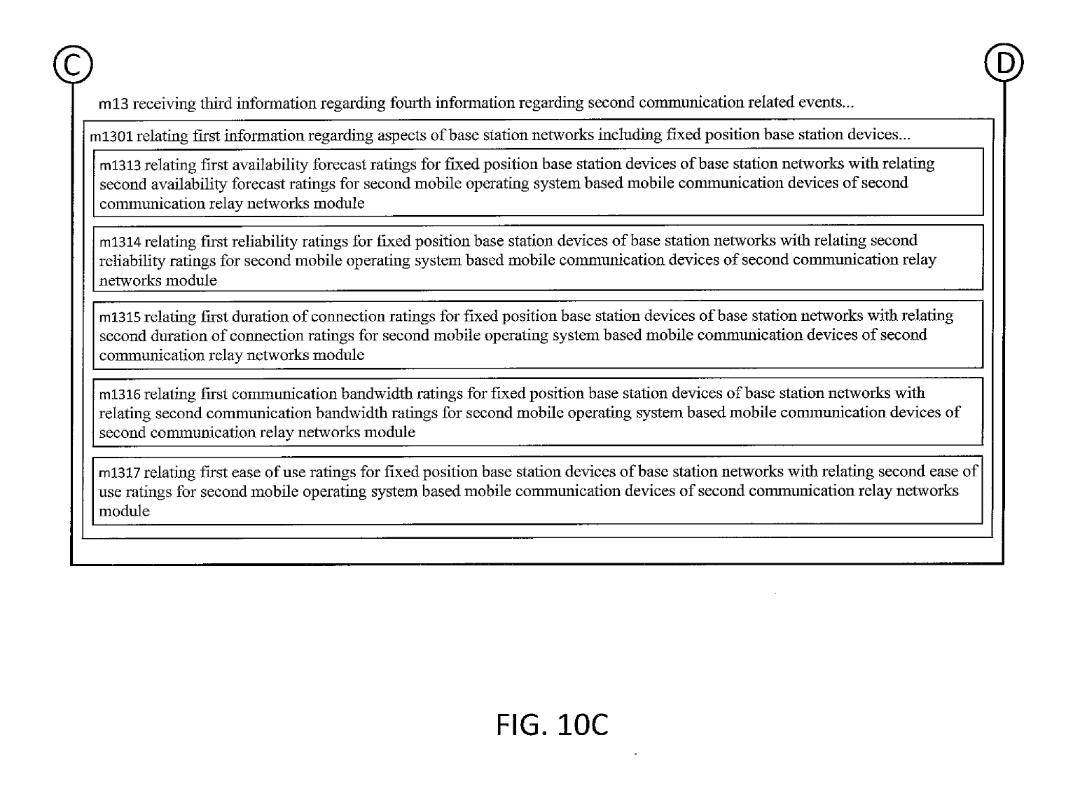

In one or more implementations, as shown in FIG. 10A, module m1231 may include relating first information regarding aspects of base station networks including fixed position base station devices with third information regarding aspects of communication relay networks furnished by second mobile operating system based mobile communication devices module m1301.

In one or more implementations, as shown in FIG. 10A, module m1301 may include relating first location information regarding first moveable objects that have previously obstructed communication of base station networks including fixed position base station devices with relating second location information regarding second moveable objects that have previously obstructed communication of communication relay networks furnished by second mobile operating system based mobile communication devices module m1302.

In one or more implementations, as shown in FIG. 10A, module m1301 may include relating first statistical information regarding statistical probabilities of remaining in communication using base station networks including fixed position base station devices with relating second statistical information regarding statistical probabilities of remaining in communication using second communication relay networks furnished by second mobile operating system based mobile communication devices module m1303.

In one or more implementations, as shown in FIG. 10A, module m1301 may include relating first GPS positioning data regarding base station networks including fixed position base station devices with relating second GPS positioning data regarding second communication relay networks furnished by second mobile operating system based mobile communication devices module m1304.

In one or more implementations, as shown in FIG. 10A, module m1301 may include relating first potential obstructions to electronic network communication located proximate to fixed position base station devices of base station networks with relating second potential obstructions to electronic network communication located proximate to second mobile operating system based mobile communication devices of second communication relay networks module m1305.

In one or more implementations, as shown in FIG. 10A, module m1301 may include relating first communication histories of successful communication of fixed position base station devices of base station networks with relating second communication histories of successful communication of second mobile operating system based mobile communication devices of second communication relay networks module m1306.

In one or more implementations, as shown in FIG. 10A, module m1306 may include relating first communication history data previously stored and forwarded between fixed position base station devices of base station networks with relating second communication history data previously stored and forwarded between second mobile operating system based mobile communication devices of second communication relay networks module m1307.

In one or more implementations, as shown in FIG. 10B, module m1301 may include relating first information regarding communication capacity available to fixed position base station devices of base station networks with relating second information regarding communication capacity available to second mobile operating system based mobile communication devices of second communication relay networks module m1308.

In one or more implementations, as shown in FIG. 10B, module m1301 may include relating first information regarding potential obstructions to electronic communication proximate to fixed position base station devices of base station networks with relating second information regarding potential obstructions to electronic communication proximate to second mobile operating system based mobile communication devices of second communication relay networks module m1309.

In one or more implementations, as shown in FIG. 10B, module m1302 may include relating first information regarding potential electronic communication service interruptions of fixed position base station devices of base station networks with relating second information regarding potential electronic communication service interruptions of second mobile operating system based mobile communication devices of second communication relay networks module m1310.

In one or more implementations, as shown in FIG. 10B, module m1301 may include relating first service quality ratings regarding fixed position base station devices of base station networks with relating second service quality ratings regarding second mobile operating system based mobile communication devices of second communication relay networks module m1311.

In one or more implementations, as shown in FIG. 10B, module m1301 may include relating first cost ratings regarding fixed position base station devices of base station networks with relating second cost ratings regarding second mobile operating system based mobile communication devices of second communication relay networks module m1312.

In one or more implementations, as shown in FIG. 10C, module m1301 may include relating first availability forecast ratings for fixed position base station devices of base station networks with relating second availability forecast ratings for second mobile operating system based mobile communication devices of second communication relay networks module m1313.

In one or more implementations, as shown in FIG. 10C, module m1301 may include relating first reliability ratings for fixed position base station devices of base station networks with relating second reliability ratings for second mobile operating system based mobile communication devices of second communication relay networks module m1314.

In one or more implementations, as shown in FIG. 10C, module m1301 may include relating first duration of connection ratings for fixed position base station devices of base station networks with relating second duration of connection ratings for second mobile operating system based mobile communication devices of second communication relay networks module m1315.

In one or more implementations, as shown in FIG. 10C, module m1301 may include relating first communication bandwidth ratings for fixed position base station devices of base station networks with relating second communication bandwidth ratings for second mobile operating system based mobile communication devices of second communication relay networks module m1316.

In one or more implementations, as shown in FIG. 10C, module m1301 may include relating first ease of use ratings for fixed position base station devices of base station networks with relating second ease of use ratings for second mobile operating system based mobile communication devices of second communication relay networks module m1317.

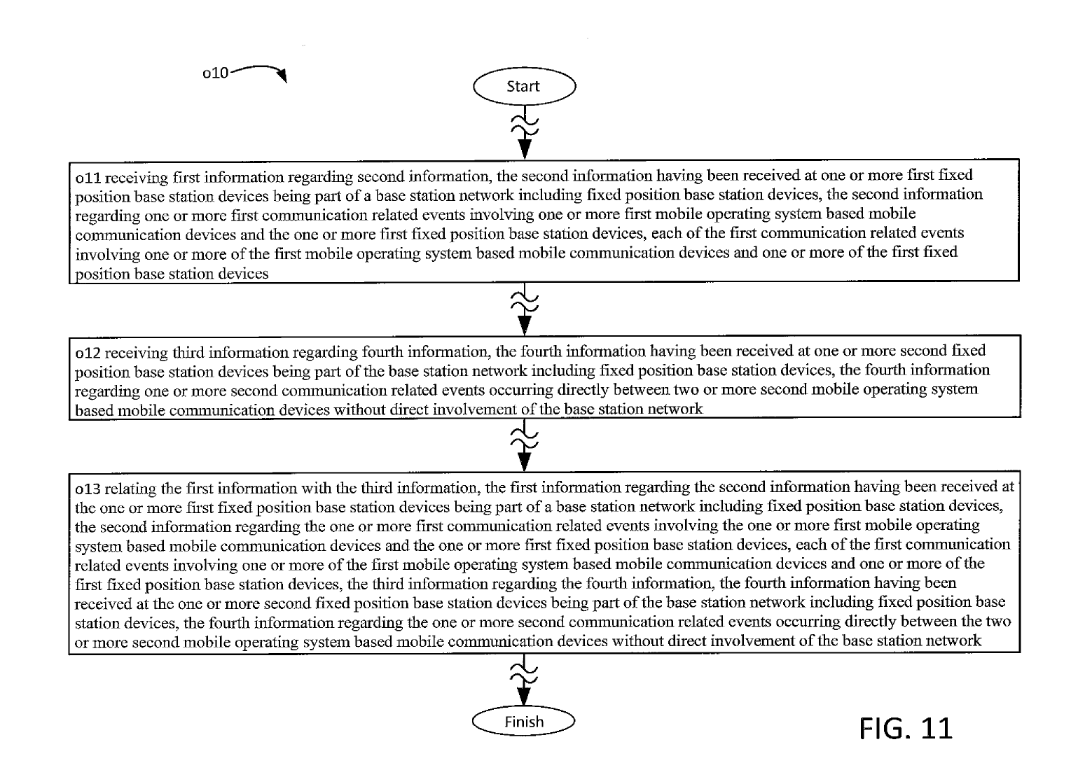

An operational flow o10 as shown in FIG. 11 represents example operations related to receiving first information regarding second information, the second information having been received at one or more first fixed position base station devices being part of a base station network including fixed position base station devices, the second information regarding one or more first communication related events involving one or more first mobile operating system based mobile communication devices and the one or more first fixed position base station devices, each of the first communication related events involving one or more of the first mobile operating system based mobile communication devices and one or more of the first fixed position base station devices; receiving third information regarding fourth information, the fourth information having been received at one or more second fixed position base station devices being part of the base station network including fixed position base station devices, the fourth information regarding one or more second communication related events occurring directly between two or more second mobile operating system based mobile communication devices; and relating the first information with the third information, the first information regarding the second information having been received at the one or more first fixed position base station devices being part of a base station network including fixed position base station devices, the second information regarding the one or more first communication related events involving the one or more first mobile operating system based mobile communication devices and the one or more first fixed position base station devices, each of the first communication related events involving one or more of the first mobile operating system based mobile communication devices and one or more of the first fixed position base station devices, the third information regarding the fourth information the fourth information having been received at the one or more second fixed position base station devices being part of the base station network including fixed position base station devices, the fourth information regarding the one or more second communication related events occurring directly between the two or more second mobile operating system based mobile communication devices.

FIG. 11 and those figures that follow may have various examples of operational flows, and explanation may be provided with respect to the above-described examples and/or with respect to other examples and contexts. Nonetheless, it should be understood that the operational flows may be executed in a number of other environments and contexts, and/or in modified versions. Furthermore, although the various operational flows are presented in the sequence(s) illustrated, it should be understood that the various operations may be performed in other orders than those which are illustrated, or may be performed concurrently.

In FIG. 11 and those figures that follow, various operations may be depicted in a box-within-a-box manner. Such depictions may indicate that an operation in an internal box may comprise an optional exemplary implementation of the operational step illustrated in one or more external boxes. However, it should be understood that internal box operations may be viewed as independent operations separate from any associated external boxes and may be performed in any sequence with respect to all other illustrated operations, or may be performed concurrently.

For ease of understanding, the flowcharts are organized such that the initial flowcharts present implementations via an example implementation and thereafter the following flowcharts present alternate implementations and/or expansions of the initial flowchart(s) as either sub-component operations or additional component operations building on one or more earlier-presented flowcharts. Those having skill in the art will appreciate that the style of presentation utilized herein (e.g., beginning with a presentation of a flowchart(s) presenting an example implementation and thereafter providing additions to and/or further details in subsequent flowcharts) generally allows for a rapid and easy understanding of the various process implementations. In addition, those skilled in the art will further appreciate that the style of presentation used herein also lends itself well to modular and/or object-oriented program design paradigms.

In one or more implementations, as shown in FIG. 11, the operational flow o10 proceeds to operation o11 for receiving first information regarding second information, the second information having been received at one or more first fixed position base station devices being part of a base station network including fixed position base station devices, the second information regarding one or more first communication related events involving one or more first mobile operating system based mobile communication devices and the one or more first fixed position base station devices, each of the first communication related events involving one or more of the first mobile operating system based mobile communication devices and one or more of the first fixed position base station devices. Origination of a physically tangible component group can be accomplished through skilled in the art design choice selection including use of one or more components and/or subsystems explicitly and/or implicitly referred to herein for at least in part implementing execution of one or more instructions i11 of the operation o11, for performance of the operation o11 by an electrical circuitry arrangement e11 as activated thereto, and/or otherwise fulfillment of the operation o11. One or more non-transitory signal bearing physical media can bear the one or more instructions i11 that when executed can direct performance of the operation o11. Furthermore, receiving first information regarding second information regarding first communication related events involving first mobile operating system based mobile communication devices and first fixed position base station devices module m11 depicted in FIG. 7 as being included in the processing module m10, when executed and/or activated, can direct performance of and/or perform the operation o11. Illustratively, in one or more implementations, the operation o11 can be carried out, for example, by receiving (e.g. first reception of electronic transmission, etc.) first information (e.g. statistics, incident data, performance data, topology data, derived or original information etc.) regarding second information (e.g. statistics, incident data, performance data, topology data, derived or original information, etc.), the second information having been received (e.g. second reception of electronic transmission, etc.) at one or more first fixed position base station devices (e.g. cellular towers, etc.) being part of a base station network (e.g. cellular network, etc.) including fixed position base station devices (e.g. other cellular towers, etc.), the second information regarding one or more first communication related events (e.g. successful transmission, unsuccessful transmissions, communication obstruction identification, cost impositions, switch over to back-up network, etc.) involving one or more first mobile operating system based mobile communication devices (e.g. smartphones, etc.) and the one or more first fixed position base station devices (e.g. cellular towers, etc.), each of the first communication related events involving one or more of the first mobile operating system based mobile communication devices (e.g. smartphones, etc.) and one or more of the first fixed position base station devices (e.g. cellular towers, etc.).

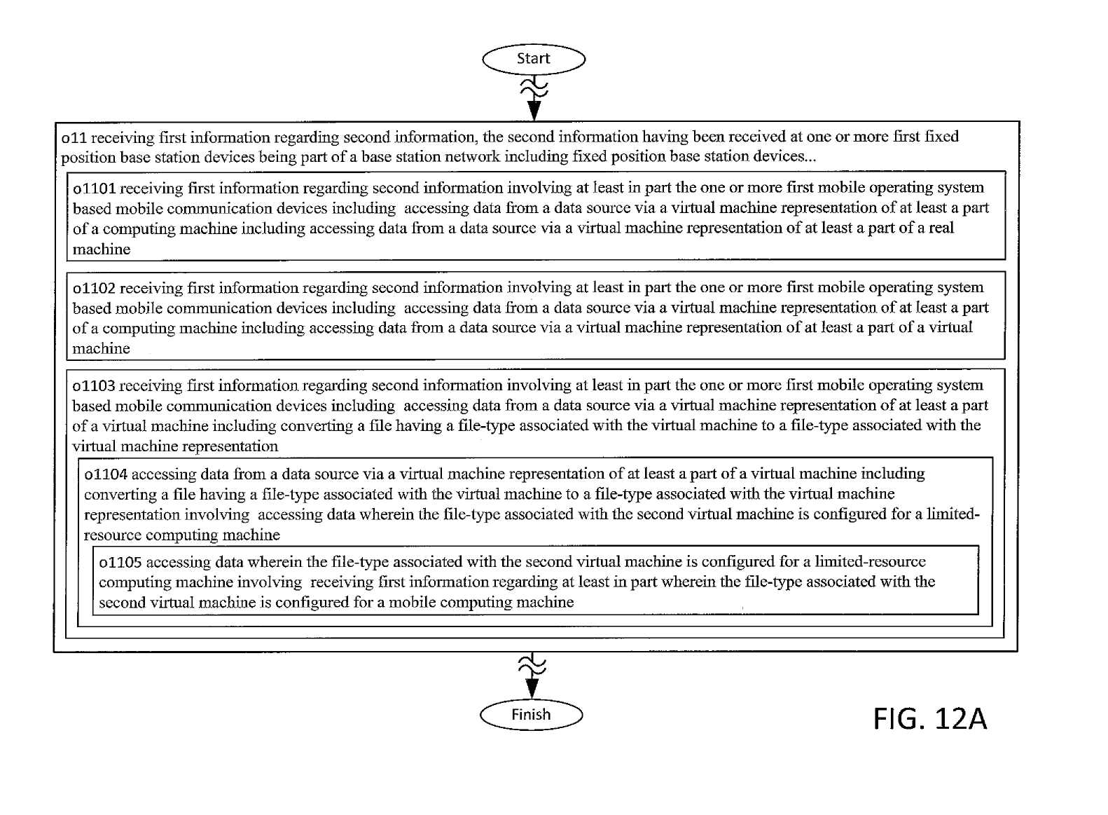

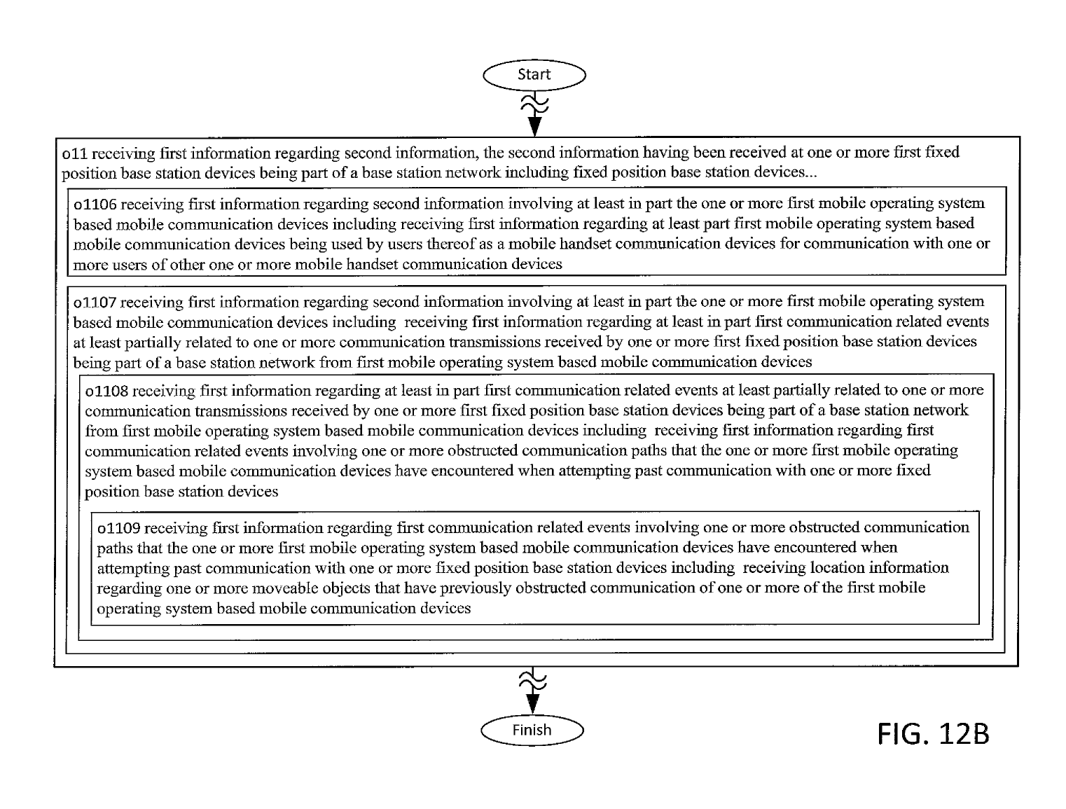

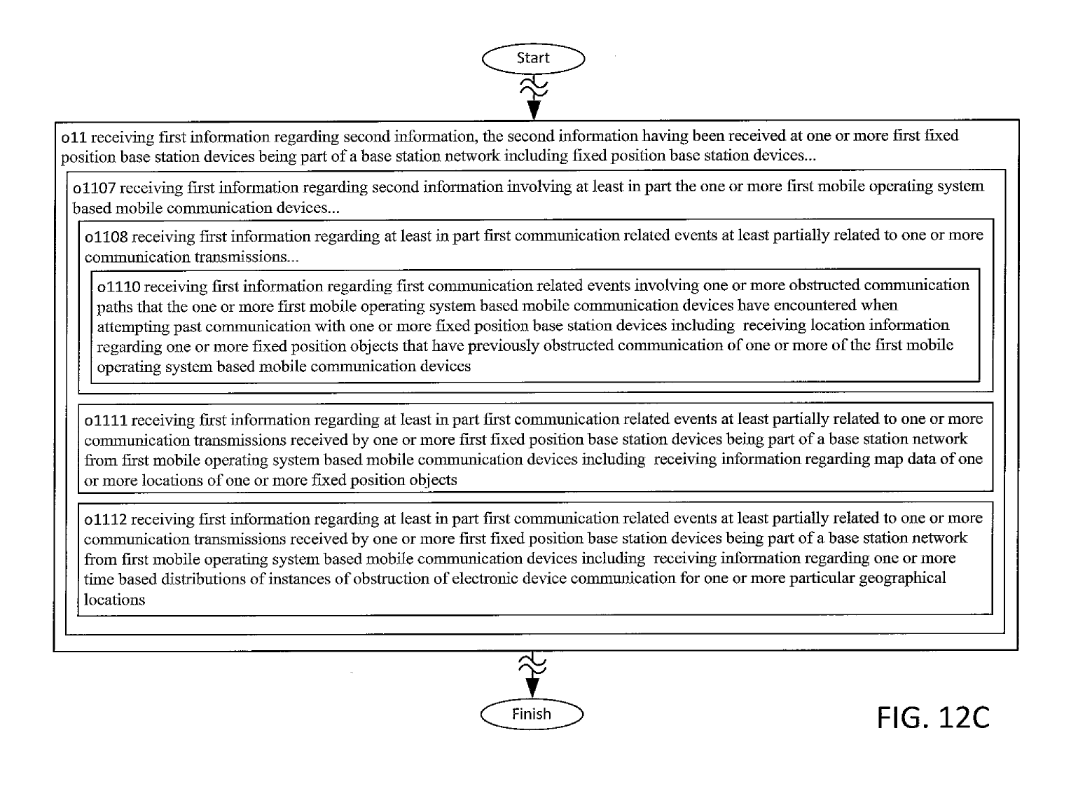

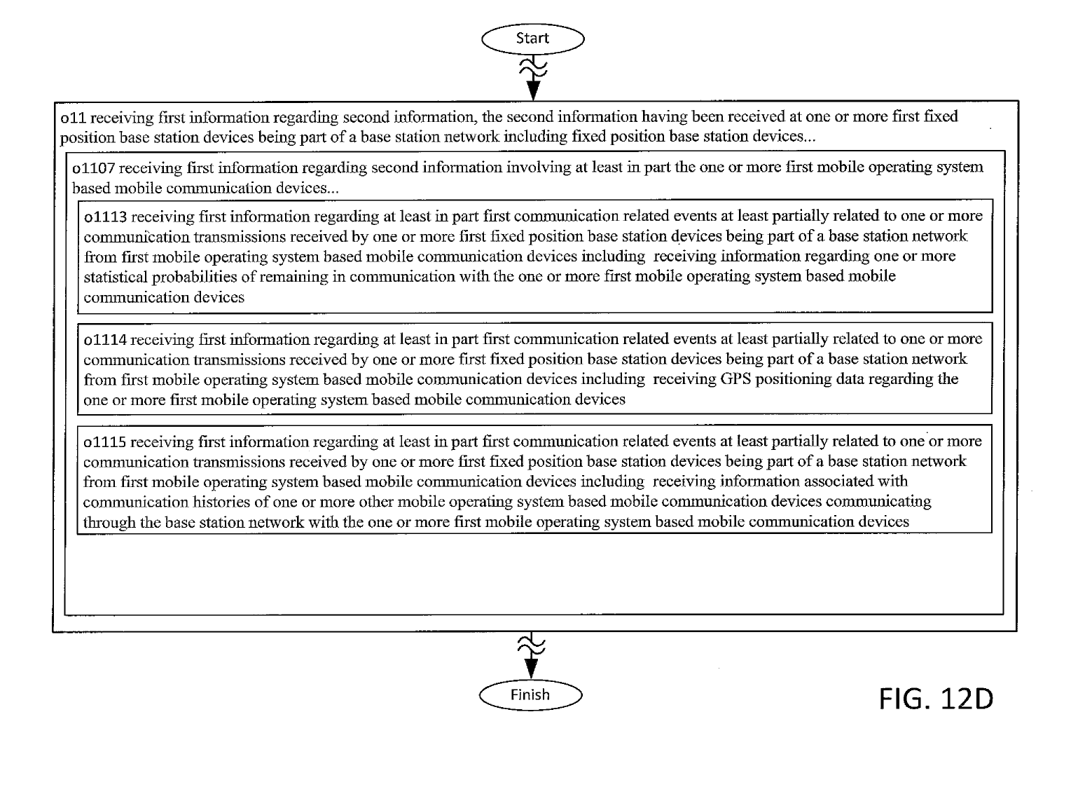

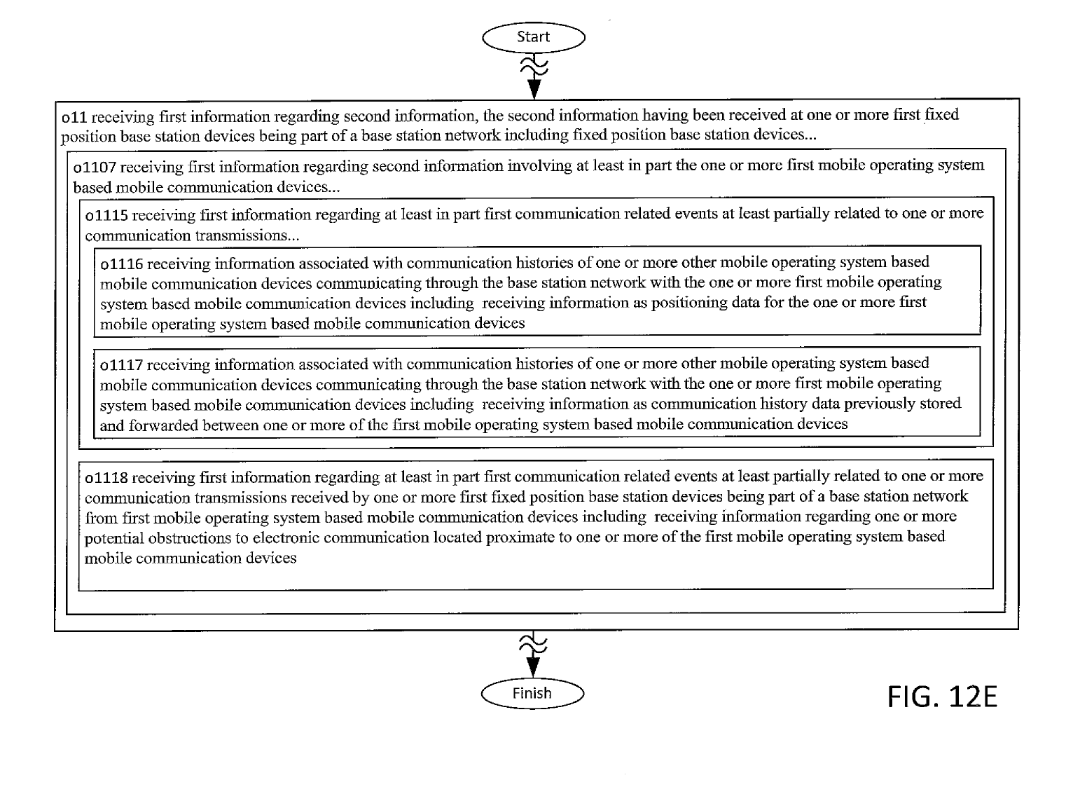

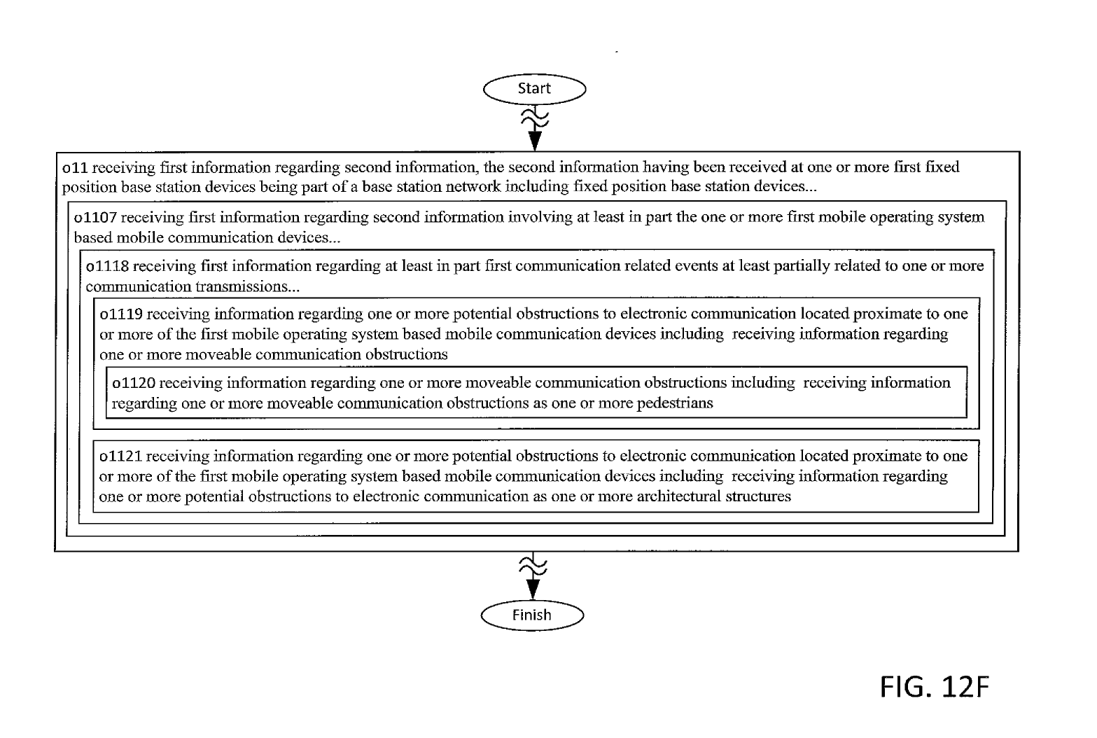

In one or more implementations, as shown in FIG. 12, the operational flow o10 proceeds to operation o12 for receiving third information regarding fourth information, the fourth information having been received at one or more second fixed position base station devices being part of the base station network including fixed position base station devices, the fourth information regarding one or more second communication related events occurring directly between two or more second mobile operating system based mobile communication devices. Origination of a physically tangible component group can be accomplished through skilled in the art design choice selection including use of one or more components and/or subsystems explicitly and/or implicitly referred to herein for at least in part implementing execution of one or more instructions i12 of the operation o12, for performance of the operation o12 by an electrical circuitry arrangement e12 as activated thereto, and/or otherwise fulfillment of the operation o12. One or more non-transitory signal bearing physical media can bear the one or more instructions i12 that when executed can direct performance of the operation o12. Furthermore, receiving third information regarding fourth information regarding second communication related events occurring directly between second mobile operating system based mobile communication devices module m12 depicted in FIG. 7 as being included in the processing module m10, when executed and/or activated, can direct performance of and/or perform the operation o12. Illustratively, in one or more implementations, the operation o12 can be carried out, for example, by receiving (e.g. third reception of cellular transmission, etc.) third information (e.g. statistics, incident data, performance data, topology data, derived and original information, etc.) regarding fourth information (e.g. statistics, incident data, performance data, topology data, derived and original information, etc.), the fourth information having been received (e.g. fourth reception of cellular transmission, etc.) at one or more second fixed position base station devices (e.g. wall mounted cellular base stations, etc.) being part of the base station network (e.g. cellular network, etc.) including fixed position base station devices (e.g. wall mounted cellular base stations, etc.), the fourth information regarding one or more second communication related events (e.g. successful transmissions, unsuccessful transmissions, failed equipment, performance assessment, etc.) occurring directly between two or more second mobile operating system based mobile communication devices (e.g. mobile OS handsets, tablets, phablets, etc.).

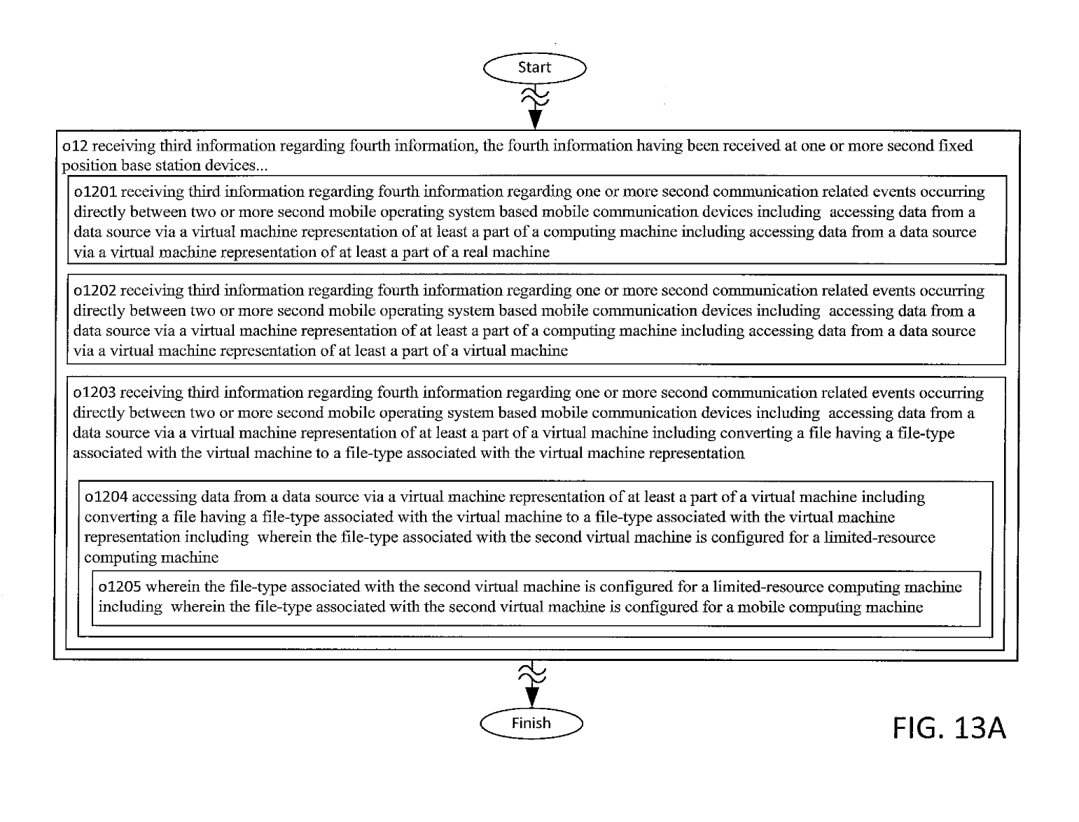

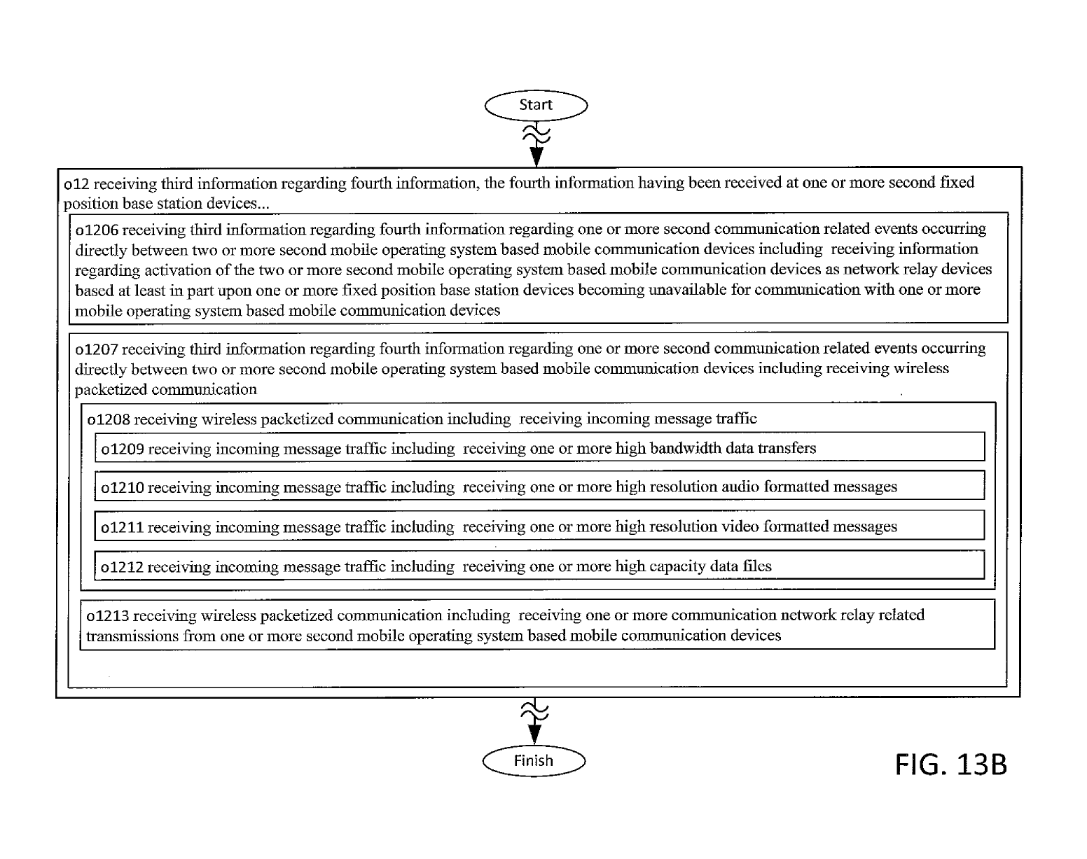

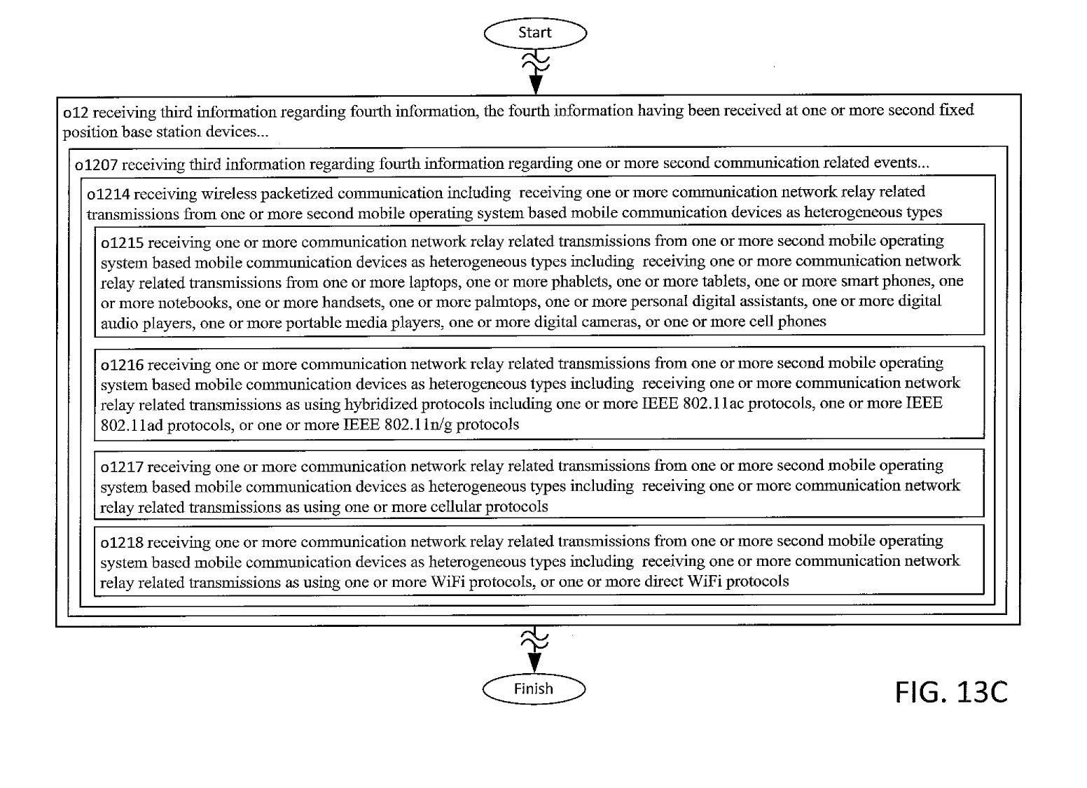

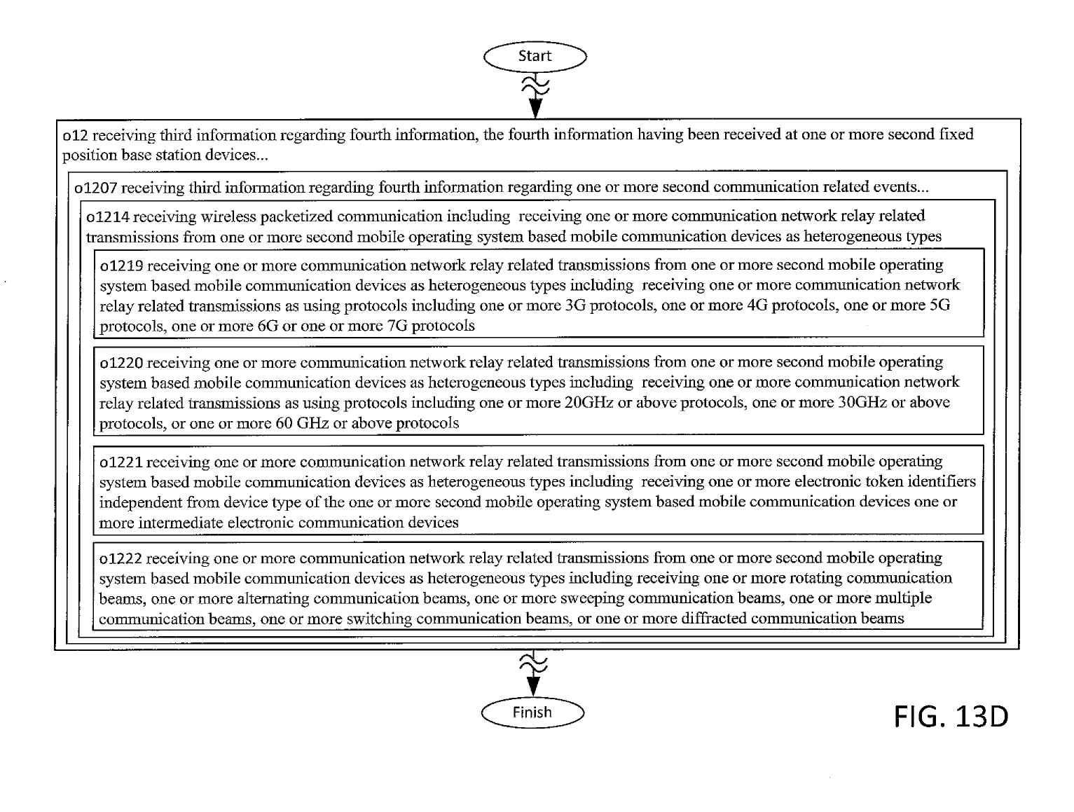

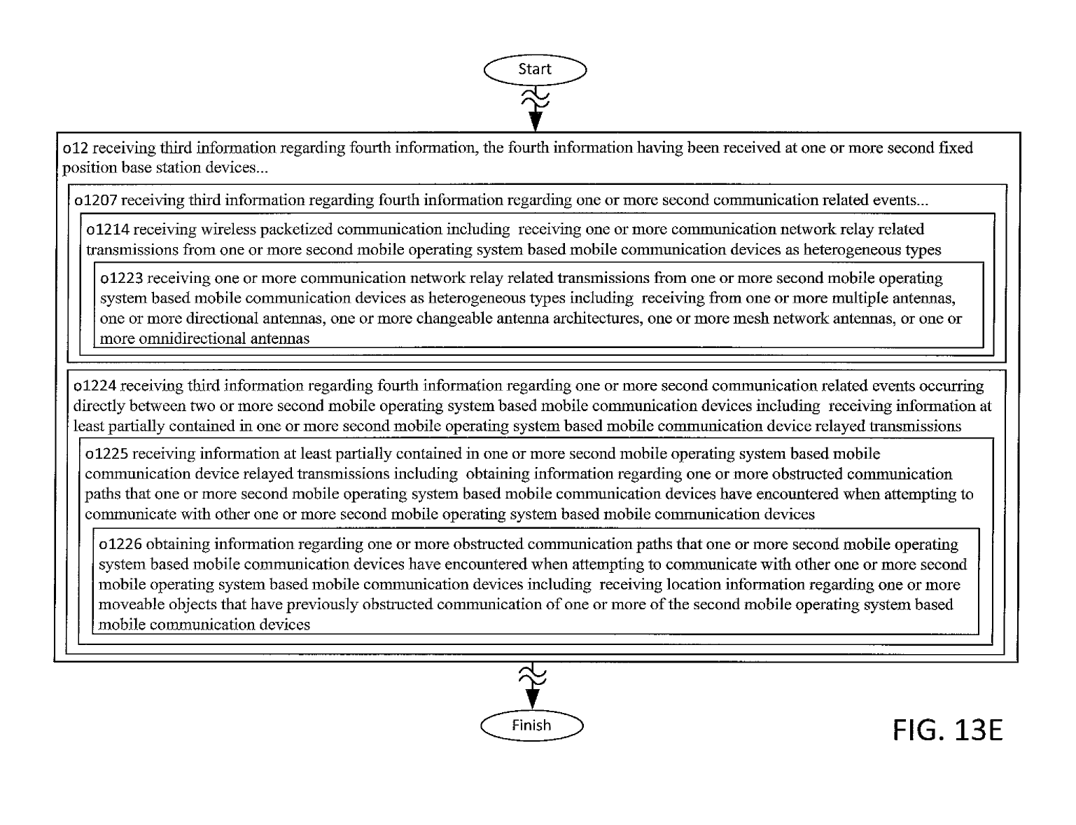

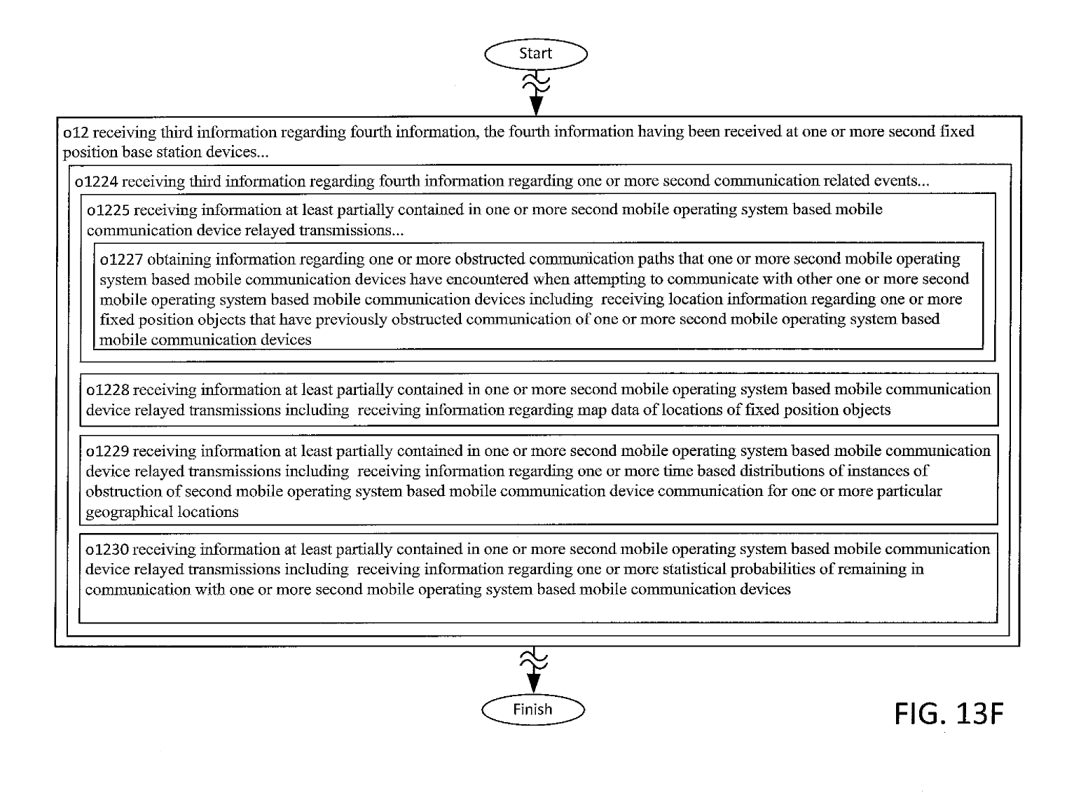

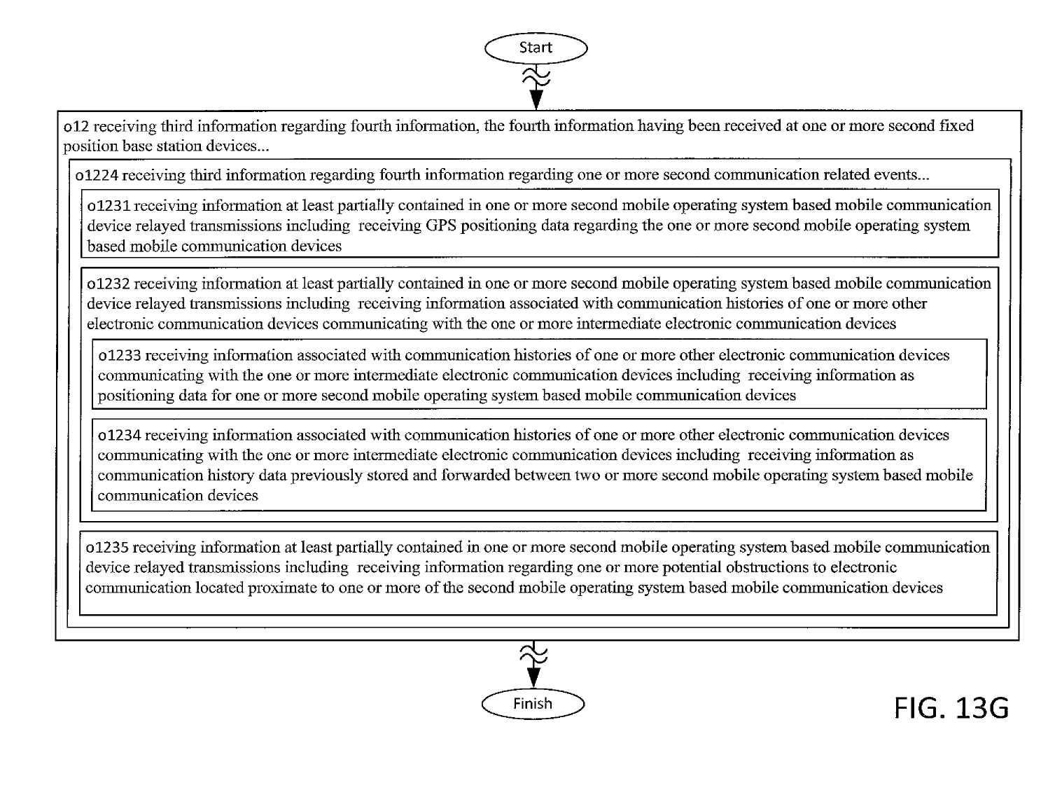

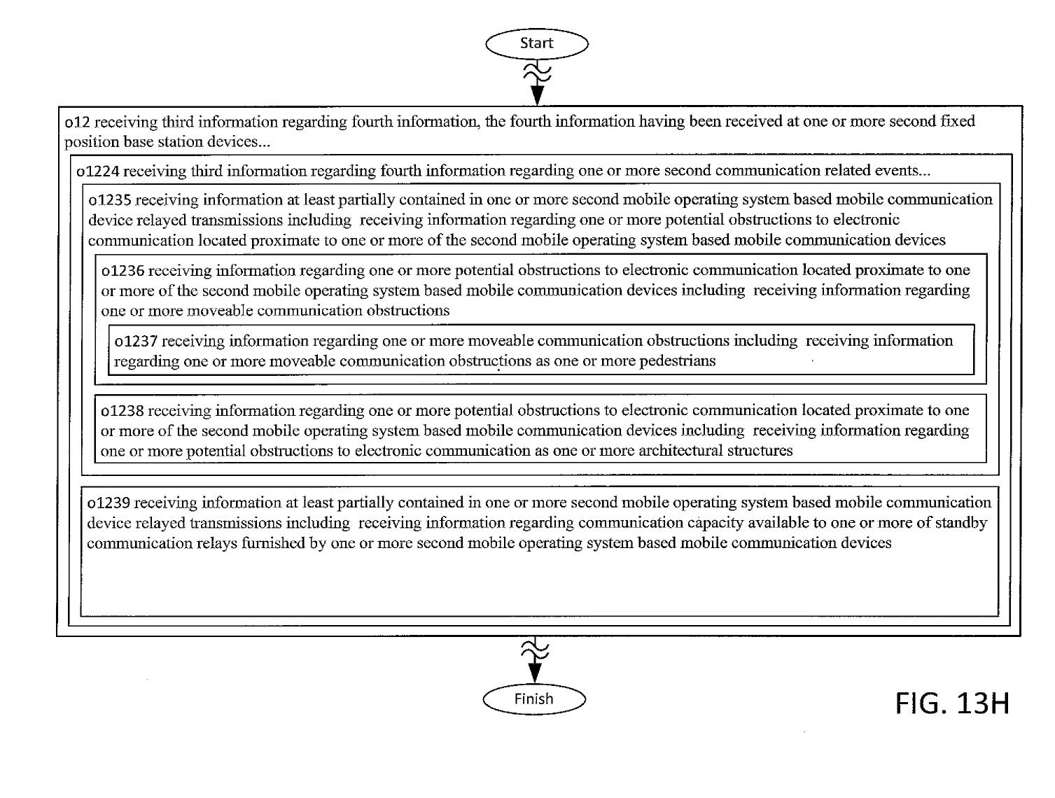

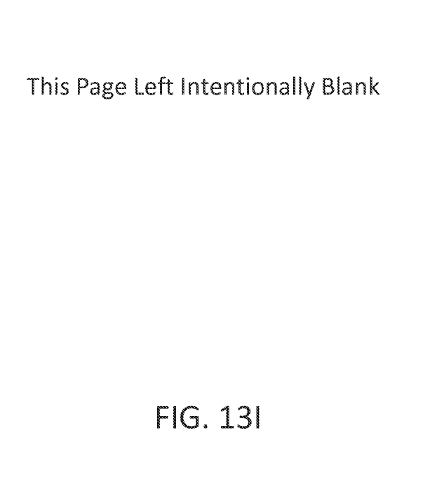

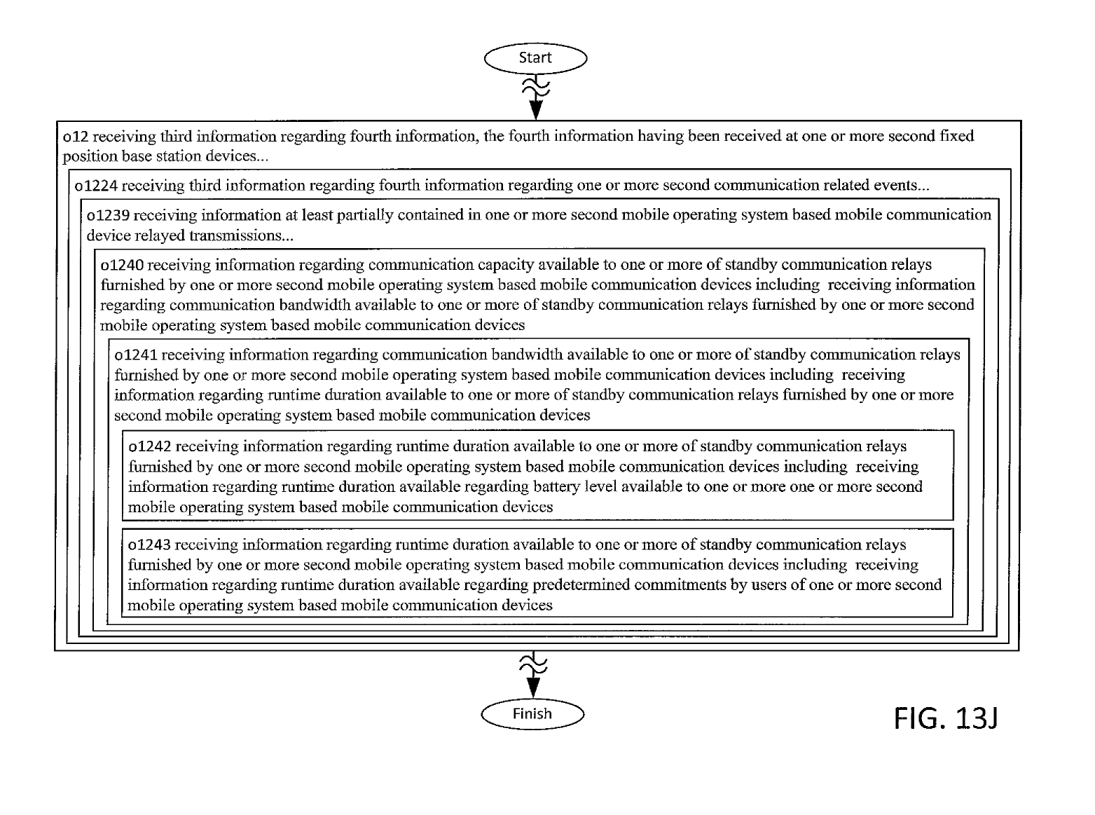

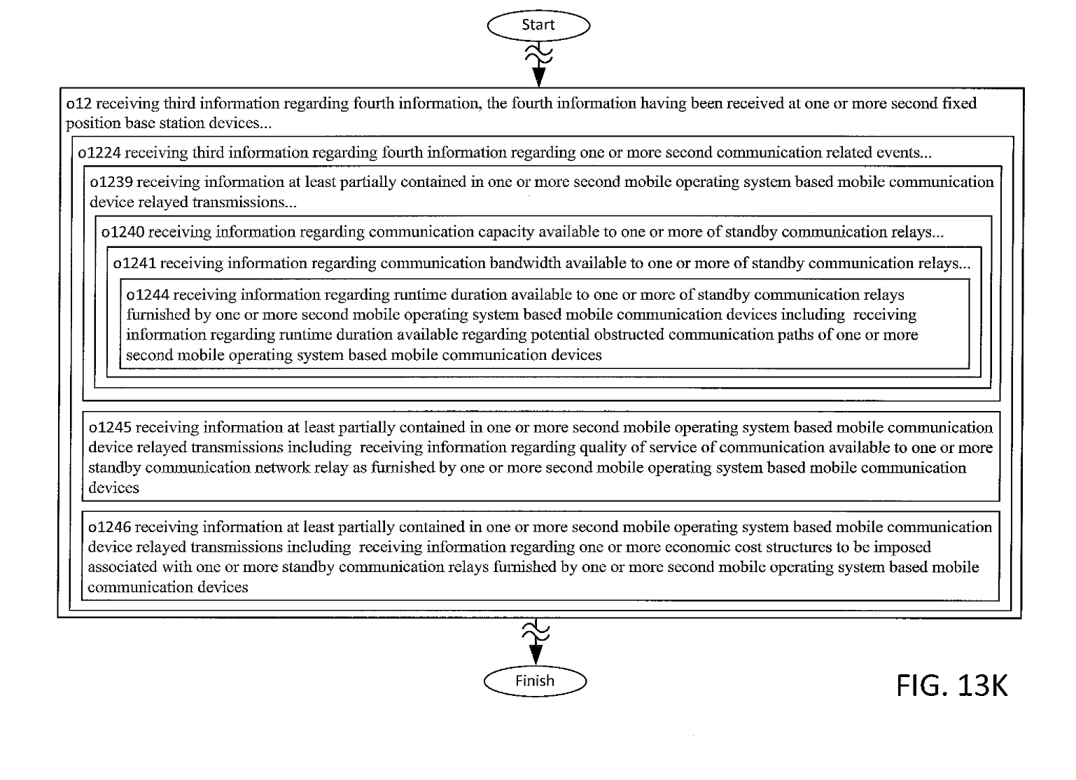

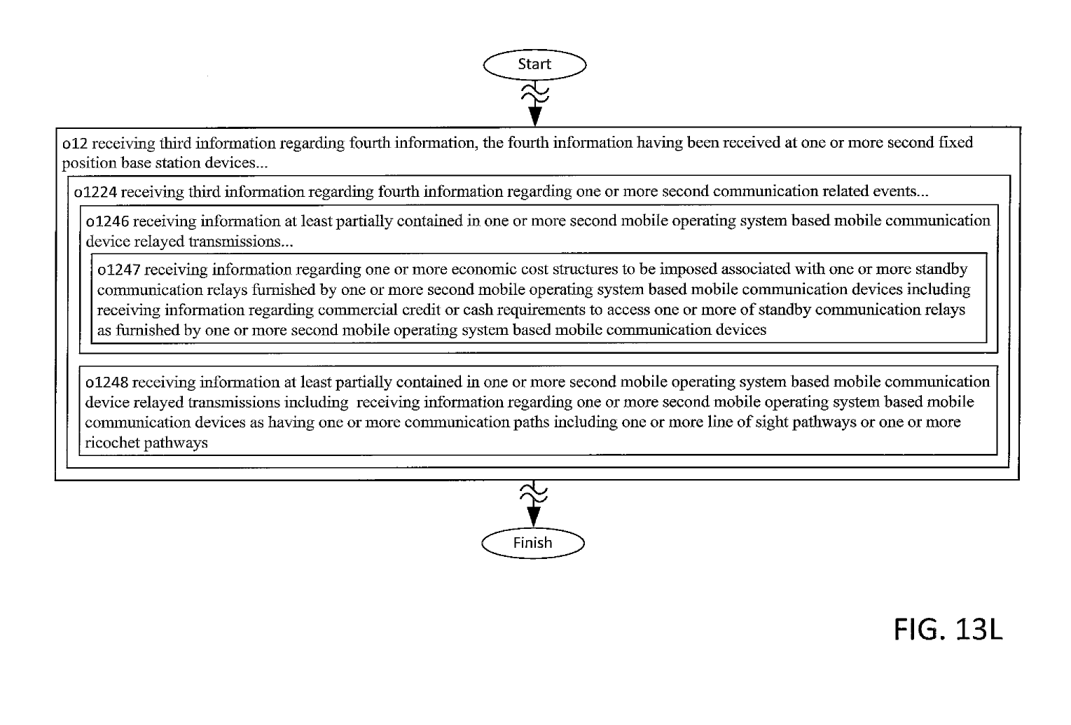

In one or more implementations, as shown in FIG. 13, the operational flow o10 proceeds to operation o13 for relating the first information with the third information, the first information regarding the second information having been received at the one or more first fixed position base station devices being part of a base station network including fixed position base station devices, the second information regarding the one or more first communication related events involving the one or more first mobile operating system based mobile communication devices and the one or more first fixed position base station devices, each of the first communication related events involving one or more of the first mobile operating system based mobile communication devices and one or more of the first fixed position base station devices, the third information regarding the fourth information the fourth information having been received at the one or more second fixed position base station devices being part of the base station network including fixed position base station devices, the fourth information regarding the one or more second communication related events occurring directly between the two or more second mobile operating system based mobile communication devices. Origination of a physically tangible component group can be accomplished through skilled in the art design choice selection including use of one or more components and/or subsystems explicitly and/or implicitly referred to herein for at least in part implementing execution of one or more instructions i13 of the operation o13, for performance of the operation o13 by an electrical circuitry arrangement e13 as activated thereto, and/or otherwise fulfillment of the operation o13. One or more non-transitory signal bearing physical media can bear the one or more instructions i13 that when executed can direct performance of the operation o13. Furthermore, relating first information with third information module m13 depicted in FIG. 7 as being included in the processing module m10, when executed and/or activated, can direct performance of and/or perform the operation o13. Illustratively, in one or more implementations, the operation o13 can be carried out, for example, by relating (e.g. associating, interrelating, comparing, contrasting, summarizing, filtering, condensing, ascribing, connecting, combining, referencing, orienting, etc.) the first information (e.g. statistics, incident data, performance data, topology data, derived or original information, etc.) with the third information (e.g. statistics, incident data, performance data, topology data, derived or original information, etc.), the first information (e.g. statistics, incident data, performance data, topology data, derived or original information, etc.) regarding the second information (e.g. statistics, incident data, performance data, topology data, derived or original information, etc.) having been received (e.g. second reception of electronic transmission, etc.) at the one or more first fixed position base station devices (e.g. cellular towers, etc.) being part of a base station network (e.g. cellular network, etc.) including fixed position base station devices (e.g. other cellular towers, etc.), the second information regarding the one or more first communication related events (e.g. successful transmission, unsuccessful transmissions, communication obstruction identification, cost impositions, switch over to back-up network, etc.) involving the one or more first mobile operating system based mobile communication devices (e.g. smart phones, etc.) and the one or more first fixed position base station devices (e.g. cellular towers, etc.), each of the first communication related events involving one or more of the first mobile operating system based mobile communication devices (e.g. smartphones, etc.) and one or more of the first fixed position base station devices (e.g. cellular towers, etc.), the third information (e.g. statistics, incident data, performance data, topology data, derived or original information, etc.) regarding the fourth information (e.g. statistics, incident data, performance data, topology data, derived or original information, etc.) the fourth information having been received (e.g. fourth reception of cellular transmission, etc.) at the one or more second fixed position base station devices (e.g. wall mounted cellular base stations, etc.) being part of the base station network (e.g. cellular network, etc.) including fixed position base station devices (e.g. wall mounted cellular base stations, etc.), the fourth information regarding the one or more second communication related events (e.g. successful transmissions, unsuccessful transmissions, failed equipment, performance assessment, etc.) occurring directly (e.g. line-of-sight communication, point-to-point communication, one device transmits and the other device receives, etc.) between the two or more second mobile operating system based mobile communication devices.

In one or more implementations, as shown in FIG. 12A, the operation o1100 can include operation o1101 for receiving first information regarding second information involving at least in part the one or more first mobile operating system based mobile communication devices including accessing data from a data source via a virtual machine representation of at least a part of a computing machine including accessing data from a data source via a virtual machine representation of at least a part of a real machine. Origination of a physically tangible component group can be accomplished through skilled in the art design choice selection including use of one or more components and/or subsystems explicitly and/or implicitly referred to herein for at least in part implementing execution of one or more instructions i1101 of the operation o1101, for performance of the operation o1101 by an electrical circuitry arrangement e1101 as activated thereto, and/or otherwise fulfillment of the operation o1101. One or more non-transitory signal bearing physical media can bear the one or more instructions i1101 that when executed can direct performance of the operation o1101. Furthermore, accessing data from data source via virtual machine representation of computing machine including accessing data from data source via virtual machine representation of real machine module m1101 depicted in FIG. 8A as being included in the module m1100, when executed and/or activated, can direct performance of and/or perform the operation o1101. Illustratively, in one or more implementations, the operation o1101 can be carried out, for example, by receiving (e.g. first reception of electronic transmission, etc.) first information (e.g. statistics, incident data, performance data, topology data, derived or original information etc.) regarding second information (e.g. statistics, incident data, performance data, topology data, derived or original information, etc.) involving at least in part the one or more first mobile operating system based mobile communication devices (e.g. smartphones, etc.) including accessing data (e.g. data calls, etc.) from a data source (e.g. electronic memory, etc.) via a virtual machine representation (e.g. process virtual machine, etc.) of at least a part of a computing machine (e.g. mobile OS portion, etc.) including accessing data (e.g. through bus, etc.) from a data source (e.g. hard drive, etc.) via a virtual machine representation (e.g. process virtual machine, etc.) of at least a part of a real machine (e.g. processor hardware, etc.).

In one or more implementations, as shown in FIG. 12A, the operation o1100 can include operation o1102 for receiving first information regarding second information involving at least in part the one or more first mobile operating system based mobile communication devices including accessing data from a data source via a virtual machine representation of at least a part of a computing machine including accessing data from a data source via a virtual machine representation of at least a part of a virtual machine. Origination of a physically tangible component group can be accomplished through skilled in the art design choice selection including use of one or more components and/or subsystems explicitly and/or implicitly referred to herein for at least in part implementing execution of one or more instructions i1102 of the operation o1102, for performance of the operation o1102 by an electrical circuitry arrangement e1102 as activated thereto, and/or otherwise fulfillment of the operation o1102. One or more non-transitory signal bearing physical media can bear the one or more instructions i1102 that when executed can direct performance of the operation o1102. Furthermore, accessing data from data source via virtual machine representation of computing machine including accessing data from data source via virtual machine representation of virtual machine module m1102 depicted in FIG. 8A as being included in the module m1100, when executed and/or activated, can direct performance of and/or perform the operation o1102. Illustratively, in one or more implementations, the operation o1102 can be carried out, for example, by receiving (e.g. first reception of electronic transmission, etc.) first information (e.g. statistics, incident data, performance data, topology data, derived or original information etc.) regarding second information (e.g. statistics, incident data, performance data, topology data, derived or original information, etc.) involving at least in part the one or more first mobile operating system based mobile communication devices (e.g. smartphones, etc.) including accessing data (e.g. data calls, etc.) from a data source (e.g. electronic memory, etc.) via a virtual machine representation (e.g. process virtual machine, etc.) of at least a part of a computing machine (e.g. mobile OS portion, etc.) including accessing data (e.g. through bus, etc.) from a data source (e.g. hard drive, etc.) via a virtual machine representation (e.g. process virtual machine, Android, etc.) of at least a part of a virtual machine (e.g. Java, etc.).

In one or more implementations, as shown in FIG. 12A, the operation o1100 can include operation o1103 for receiving first information regarding second information involving at least in part the one or more first mobile operating system based mobile communication devices including accessing data from a data source via a virtual machine representation of at least a part of a virtual machine including converting a file having a file-type associated with the virtual machine to a file-type associated with the virtual machine representation. Origination of a physically tangible component group can be accomplished through skilled in the art design choice selection including use of one or more components and/or subsystems explicitly and/or implicitly referred to herein for at least in part implementing execution of one or more instructions i1103 of the operation o1103, for performance of the operation o1103 by an electrical circuitry arrangement e1103 as activated thereto, and/or otherwise fulfillment of the operation o1103. One or more non-transitory signal bearing physical media can bear the one or more instructions i1103 that when executed can direct performance of the operation o1103. Furthermore, accessing data from data source via virtual machine representation of virtual machine including converting file having file-type associated virtual machine to file-type associated virtual machine representation module m1103 depicted in FIG. 8A as being included in the module m1100, when executed and/or activated, can direct performance of and/or perform the operation o1103. Illustratively, in one or more implementations, the operation o1103 can be carried out, for example, by receiving (e.g. first reception of electronic transmission, etc.) first information (e.g. statistics, incident data, performance data, topology data, derived or original information etc.) regarding second information (e.g. statistics, incident data, performance data, topology data, derived or original information, etc.) involving at least in part the one or more first mobile operating system based mobile communication devices (e.g. smartphones, etc.) including accessing data (e.g. data queries, etc.) from a data source (e.g. memory, etc.) via a virtual machine representation (e.g. process virtual machine, Android, etc.) of at least a part of a virtual machine including converting a file having a file-type associated with the virtual machine (e.g. class JVM files, etc.) to a file-type associated with the virtual machine representation (e.g. dex Dalvix files, etc.).

In one or more implementations, as shown in FIG. 12A, the operation o1103 can include operation o1104 for accessing data from a data source via a virtual machine representation of at least a part of a virtual machine including converting a file having a file-type associated with the virtual machine to a file-type associated with the virtual machine representation involving accessing data wherein the file-type associated with the second virtual machine is configured for a limited-resource computing machine. Origination of a physically tangible component group can be accomplished through skilled in the art design choice selection including use of one or more components and/or subsystems explicitly and/or implicitly referred to herein for at least in part implementing execution of one or more instructions i1104 of the operation o1104, for performance of the operation o1104 by an electrical circuitry arrangement e1104 as activated thereto, and/or otherwise fulfillment of the operation o1104. One or more non-transitory signal bearing physical media can bear the one or more instructions i1104 that when executed can direct performance of the operation o1104. Furthermore, accessing data file-type associated second virtual machine for limited-resource computing machine module m1104 depicted in FIG. 8A as being included in the module m1103, when executed and/or activated, can direct performance of and/or perform the operation o1104. Illustratively, in one or more implementations, the operation o1104 can be carried out, for example, by receiving (e.g. first reception of electronic transmission, etc.) first information (e.g. statistics, incident data, performance data, topology data, derived or original information etc.) regarding second information (e.g. statistics, incident data, performance data, topology data, derived or original information, etc.) involving at least in part the one or more first mobile operating system based mobile communication devices (e.g. smartphones, etc.) including accessing data (e.g. data queries, etc.) from a data source (e.g. memory, etc.) via a virtual machine representation (e.g. process virtual machine, Android, etc.) of at least a part of a virtual machine including converting a file having a file-type associated with the virtual machine (e.g. class JVM files, etc.) to a file-type associated with the virtual machine representation (e.g. dex Dalvix files, etc.) accessing data (data transmission, etc.) wherein the file-type associated with the second virtual machine (e.g. dex Dalvix files, etc.) is configured for a limited-resource computing machine (e.g. Android operating system device, etc.).

In one or more implementations, as shown in FIG. 12A, the operation o1104 can include operation o1105 for accessing data wherein the file-type associated with the second virtual machine is configured for a limited-resource computing machine involving receiving first information regarding at least in part wherein the file-type associated with the second virtual machine is configured for a mobile computing machine. Origination of a physically tangible component group can be accomplished through skilled in the art design choice selection including use of one or more components and/or subsystems explicitly and/or implicitly referred to herein for at least in part implementing execution of one or more instructions i1105 of the operation o1105, for performance of the operation o1105 by an electrical circuitry arrangement e1105 as activated thereto, and/or otherwise fulfillment of the operation o1105. One or more non-transitory signal bearing physical media can bear the one or more instructions i1105 that when executed can direct performance of the operation o1105. Furthermore, receiving first information regarding file-type associated second virtual machine for mobile computing machine module m1105 depicted in FIG. 8A as being included in the module m1104, when executed and/or activated, can direct performance of and/or perform the operation o1105. Illustratively, in one or more implementations, the operation o1105 can be carried out, for example, by receiving (e.g. first reception of electronic transmission, etc.) first information (e.g. statistics, incident data, performance data, topology data, derived or original information etc.) regarding second information (e.g. statistics, incident data, performance data, topology data, derived or original information, etc.) involving at least in part the one or more first mobile operating system based mobile communication devices (e.g. smartphones, etc.) including accessing data (e.g. data queries, etc.) from a data source (e.g. memory, etc.) via a virtual machine representation (e.g. process virtual machine, Android, etc.) of at least a part of a virtual machine including converting a file having a file-type associated with the virtual machine (e.g. class JVM files, etc.) to a file-type associated with the virtual machine representation (e.g. dex Dalvix files, etc.) accessing data (data transmission, etc.) wherein the file-type associated with the second virtual machine (e.g. dex Dalvix files, etc.) is configured for a limited-resource computing machine (e.g. Android operating system device, etc.) receiving first information regarding at least in part wherein the file-type associated with the second virtual machine is configured for a mobile computing machine (e.g. mobile devices such as Samsung mobile devices, Google mobile devices, etc.).

In one or more implementations, as shown in FIG. 12B, the operation o1100 can include operation o1106 for receiving first information regarding second information involving at least in part the one or more first mobile operating system based mobile communication devices including receiving first information regarding at least part first mobile operating system based mobile communication devices (e.g. Android tablet, Samsung smartphone, etc.) being used by users (e.g. businessperson, etc.) thereof as a mobile handset communication devices (e.g. phablet, etc.) for communication with one or more users of other one or more mobile handset communication devices (e.g. Apple iPhones, etc.). Origination of a physically tangible component group can be accomplished through skilled in the art design choice selection including use of one or more components and/or subsystems explicitly and/or implicitly referred to herein for at least in part implementing execution of one or more instructions i1106 of the operation o1106, for performance of the operation o1106 by an electrical circuitry arrangement e1106 as activated thereto, and/or otherwise fulfillment of the operation o1106. One or more non-transitory signal bearing physical media can bear the one or more instructions i1106 that when executed can direct performance of the operation o1106. Furthermore, receiving first information regarding first mobile operating system based mobile communication devices being used by users as mobile handset communication devices for communication with users of other mobile handset communication devices module m1106 depicted in FIG. 8A as being included in the module m1100, when executed and/or activated, can direct performance of and/or perform the operation o1106. Illustratively, in one or more implementations, the operation o1106 can be carried out, for example, by receiving (e.g. first reception of electronic transmission, etc.) first information (e.g. statistics, incident data, performance data, topology data, derived or original information etc.) regarding second information (e.g. statistics, incident data, performance data, topology data, derived or original information, etc.) involving at least in part the one or more first mobile operating system based mobile communication devices (e.g. smartphones, etc.) including receiving first information regarding at least part first mobile operating system based mobile communication devices (e.g. Android tablet, Samsung smartphone, etc.) being used by users (e.g. businessperson, etc.) thereof as a mobile handset communication devices (e.g. phablet, etc.) for communication with one or more users of other one or more mobile handset communication devices (e.g. Apple iPhones, etc.).

In one or more implementations, as shown in FIG. 12B, the operation o1100 can include operation o1107 for receiving first information regarding second information involving at least in part the one or more first mobile operating system based mobile communication devices including receiving first information regarding at least in part first communication related events at least partially related to one or more communication transmissions received by one or more first fixed position base station devices being part of a base station network from first mobile operating system based mobile communication devices. Origination of a physically tangible component group can be accomplished through skilled in the art design choice selection including use of one or more components and/or subsystems explicitly and/or implicitly referred to herein for at least in part implementing execution of one or more instructions i1107 of the operation o1107, for performance of the operation o1107 by an electrical circuitry arrangement e1107 as activated thereto, and/or otherwise fulfillment of the operation o1107. One or more non-transitory signal bearing physical media can bear the one or more instructions i1107 that when executed can direct performance of the operation o1107. Furthermore, receiving first information regarding first communication related events related to communication transmissions received by first fixed position base station devices being base station network from first mobile operating system based mobile communication devices module m1107 depicted in FIG. 8A as being included in the module m1100, when executed and/or activated, can direct performance of and/or perform the operation o1107. Illustratively, in one or more implementations, the operation o1107 can be carried out, for example, by receiving (e.g. first reception of electronic transmission, etc.) first information (e.g. statistics, incident data, performance data, topology data, derived or original information etc.) regarding second information (e.g. statistics, incident data, performance data, topology data, derived or original information, etc.) involving at least in part the one or more first mobile operating system based mobile communication devices (e.g. smartphones, etc.) including receiving first information (e.g. data calculation, electronic signal reception, etc.) regarding at least in part first communication related events at least partially related to one or more communication transmissions received by one or more first fixed position base station devices (e.g. portable computers, etc.) being part of a base station network from first mobile operating system based mobile communication devices.

In one or more implementations, as shown in FIG. 12B, the operation o1107 can include operation o1108 for receiving first information regarding at least in part first communication related events at least partially related to one or more communication transmissions received by one or more first fixed position base station devices being part of a base station network from first mobile operating system based mobile communication devices including receiving first information regarding first communication related events involving one or more obstructed communication paths that the one or more first mobile operating system based mobile communication devices have encountered when attempting past communication with one or more fixed position base station devices. Origination of a physically tangible component group can be accomplished through skilled in the art design choice selection including use of one or more components and/or subsystems explicitly and/or implicitly referred to herein for at least in part implementing execution of one or more instructions i1108 of the operation o1108, for performance of the operation o1108 by an electrical circuitry arrangement e1108 as activated thereto, and/or otherwise fulfillment of the operation o1108. One or more non-transitory signal bearing physical media can bear the one or more instructions i1108 that when executed can direct performance of the operation o1108. Furthermore, receiving first information regarding first communication related events involving obstructed communication paths that first mobile operating system based mobile communication devices have encountered when attempting past communication with fixed position base station devices module m1108 depicted in FIG. 8A as being included in the module m1107, when executed and/or activated, can direct performance of and/or perform the operation o1108. Illustratively, in one or more implementations, the operation o1108 can be carried out, for example, by receiving (e.g. first reception of electronic transmission, etc.) first information (e.g. statistics, incident data, performance data, topology data, derived or original information etc.) regarding second information (e.g. statistics, incident data, performance data, topology data, derived or original information, etc.) involving at least in part the one or more first mobile operating system based mobile communication devices (e.g. smartphones, etc.) including receiving first information (e.g. data calculation, electronic signal reception, etc.) regarding at least in part first communication related events at least partially related to one or more communication transmissions received by one or more first fixed position base station devices (e.g. portable computers, etc.) being part of a base station network from first mobile operating system based mobile communication devices receiving first information (e.g. send query to data base, etc.) regarding first communication related events involving one or more obstructed communication paths (e.g. transmission blocked by physical object for more than a predetermined amount of time, etc.) that the one or more first mobile operating system based mobile communication devices (e.g. handset, other mobile devices, etc.) have encountered (e.g. for 10 minutes, etc.) when attempting past communication (e.g. in middle of a call, etc.) with one or more fixed position base station devices (e.g. iPhone, etc.).

In one or more implementations, as shown in FIG. 12B, the operation o1108 can include operation o1109 for receiving first information regarding first communication related events involving one or more obstructed communication paths that the one or more first mobile operating system based mobile communication devices have encountered when attempting past communication with one or more fixed position base station devices including receiving location information regarding one or more moveable objects that have previously obstructed communication of one or more of the first mobile operating system based mobile communication devices. Origination of a physically tangible component group can be accomplished through skilled in the art design choice selection including use of one or more components and/or subsystems explicitly and/or implicitly referred to herein for at least in part implementing execution of one or more instructions i1109 of the operation o1109, for performance of the operation o1109 by an electrical circuitry arrangement e1109 as activated thereto, and/or otherwise fulfillment of the operation o1109. One or more non-transitory signal bearing physical media can bear the one or more instructions i1109 that when executed can direct performance of the operation o1109. Furthermore, receiving location information regarding moveable objects that have previously obstructed communication of first mobile operating system based mobile communication devices module m1109 depicted in FIG. 8A as being included in the module m1108, when executed and/or activated, can direct performance of and/or perform the operation o1109. Illustratively, in one or more implementations, the operation o1109 can be carried out, for example, by receiving (e.g. first reception of electronic transmission, etc.) first information (e.g. statistics, incident data, performance data, topology data, derived or original information etc.) regarding second information (e.g. statistics, incident data, performance data, topology data, derived or original information, etc.) involving at least in part the one or more first mobile operating system based mobile communication devices (e.g. smartphones, etc.) including receiving first information (e.g. data calculation, electronic signal reception, etc.) regarding at least in part first communication related events at least partially related to one or more communication transmissions received by one or more first fixed position base station devices (e.g. portable computers, etc.) being part of a base station network from first mobile operating system based mobile communication devices receiving first information (e.g. send query to data base, etc.) regarding first communication related events involving one or more obstructed communication paths (e.g. transmission blocked by physical object for more than a predetermined amount of time, etc.) that the one or more first mobile operating system based mobile communication devices (e.g. handset, other mobile devices, etc.) have encountered (e.g. for 10 minutes, etc.) when attempting past communication (e.g. in middle of a call, etc.) with one or more fixed position base station devices (e.g. iPhone, etc.) receiving location information (e.g. relative geographical coordinates, etc.) regarding one or more moveable objects (e.g. industrial construction equipment, etc.) that have previously obstructed communication (e.g. less than a day of obstruction, etc.) of one or more of the first mobile operating system based mobile communication devices (e.g. iPad, etc.).

In one or more implementations, as shown in FIG. 12C, the operation o1108 can include operation o1110 for receiving first information regarding first communication related events involving one or more obstructed communication paths that the one or more first mobile operating system based mobile communication devices have encountered when attempting past communication with one or more fixed position base station devices including receiving location information regarding one or more fixed position objects that have previously obstructed communication of one or more of the first mobile operating system based mobile communication devices. Origination of a physically tangible component group can be accomplished through skilled in the art design choice selection including use of one or more components and/or subsystems explicitly and/or implicitly referred to herein for at least in part implementing execution of one or more instructions i1110 of the operation o1110, for performance of the operation o1110 by an electrical circuitry arrangement e1110 as activated thereto, and/or otherwise fulfillment of the operation o1110. One or more non-transitory signal bearing physical media can bear the one or more instructions i1110 that when executed can direct performance of the operation o1110. Furthermore, receiving location information regarding fixed position objects that have previously obstructed communication of first mobile operating system based mobile communication devices module m1110 depicted in FIG. 8A as being included in the module m1108, when executed and/or activated, can direct performance of and/or perform the operation o1110. Illustratively, in one or more implementations, the operation o1110 can be carried out, for example, by receiving (e.g. first reception of electronic transmission, etc.) first information (e.g. statistics, incident data, performance data, topology data, derived or original information etc.) regarding second information (e.g. statistics, incident data, performance data, topology data, derived or original information, etc.) involving at least in part the one or more first mobile operating system based mobile communication devices (e.g. smartphones, etc.) including receiving first information (e.g. data calculation, electronic signal reception, etc.) regarding at least in part first communication related events at least partially related to one or more communication transmissions received by one or more first fixed position base station devices (e.g. portable computers, etc.) being part of a base station network from first mobile operating system based mobile communication devices receiving first information (e.g. send query to data base, etc.) regarding first communication related events involving one or more obstructed communication paths (e.g. transmission blocked by physical object for more than a predetermined amount of time, etc.) that the one or more first mobile operating system based mobile communication devices (e.g. handset, other mobile devices, etc.) have encountered (e.g. for 10 minutes, etc.) when attempting past communication (e.g. in middle of a call, etc.) with one or more fixed position base station devices (e.g. iPhone, etc.) receiving location information regarding one or more fixed position objects (e.g. hills, trees, etc.) that have previously obstructed communication (e.g. blocked one or more attempted calls for a least a portion of the attempts, etc.) of one or more of the first mobile operating system based mobile communication devices (e.g. mobile handsets, etc.).

In one or more implementations, as shown in FIG. 12C, the operation o1107 can include operation o1111 for receiving first information regarding at least in part first communication related events at least partially related to one or more communication transmissions received by one or more first fixed position base station devices being part of a base station network from first mobile operating system based mobile communication devices including receiving information regarding map data of one or more locations of one or more fixed position objects. Origination of a physically tangible component group can be accomplished through skilled in the art design choice selection including use of one or more components and/or subsystems explicitly and/or implicitly referred to herein for at least in part implementing execution of one or more instructions i1111 of the operation o1111, for performance of the operation o1111 by an electrical circuitry arrangement e1111 as activated thereto, and/or otherwise fulfillment of the operation o1111. One or more non-transitory signal bearing physical media can bear the one or more instructions i1111 that when executed can direct performance of the operation o1111. Furthermore, receiving information regarding map data of locations of fixed position objects module m1111 depicted in FIG. 8B as being included in the module m1107, when executed and/or activated, can direct performance of and/or perform the operation o1111. Illustratively, in one or more implementations, the operation o1111 can be carried out, for example, by receiving (e.g. first reception of electronic transmission, etc.) first information (e.g. statistics, incident data, performance data, topology data, derived or original information etc.) regarding second information (e.g. statistics, incident data, performance data, topology data, derived or original information, etc.) involving at least in part the one or more first mobile operating system based mobile communication devices (e.g. smartphones, etc.) including receiving first information (e.g. data calculation, electronic signal reception, etc.) regarding at least in part first communication related events at least partially related to one or more communication transmissions received by one or more first fixed position base station devices (e.g. portable computers, etc.) being part of a base station network from first mobile operating system based mobile communication devices receiving information regarding map data (e.g. Google maps, other web-based map service, map database calls, etc.) of one or more locations of one or more fixed position objects (e.g. roadway signs, etc.).

In one or more implementations, as shown in FIG. 12C, the operation o1107 can include operation o1112 for receiving first information regarding at least in part first communication related events at least partially related to one or more communication transmissions received by one or more first fixed position base station devices being part of a base station network from first mobile operating system based mobile communication devices including receiving information regarding one or more time based distributions of instances of obstruction of electronic device communication for one or more particular geographical locations. Origination of a physically tangible component group can be accomplished through skilled in the art design choice selection including use of one or more components and/or subsystems explicitly and/or implicitly referred to herein for at least in part implementing execution of one or more instructions i1112 of the operation o1112, for performance of the operation o1112 by an electrical circuitry arrangement e1112 as activated thereto, and/or otherwise fulfillment of the operation o1112. One or more non-transitory signal bearing physical media can bear the one or more instructions i1112 that when executed can direct performance of the operation o1112. Furthermore, receiving information regarding time based distributions of instances of obstruction of electronic device communication for particular geographical locations module m1112 depicted in FIG. 8B as being included in the module m1107, when executed and/or activated, can direct performance of and/or perform the operation o1112. Illustratively, in one or more implementations, the operation o1112 can be carried out, for example, by receiving (e.g. first reception of electronic transmission, etc.) first information (e.g. statistics, incident data, performance data, topology data, derived or original information etc.) regarding second information (e.g. statistics, incident data, performance data, topology data, derived or original information, etc.) involving at least in part the one or more first mobile operating system based mobile communication devices (e.g. smartphones, etc.) including receiving first information (e.g. data calculation, electronic signal reception, etc.) regarding at least in part first communication related events at least partially related to one or more communication transmissions received by one or more first fixed position base station devices (e.g. portable computers, etc.) being part of a base station network from first mobile operating system based mobile communication devices receiving information regarding one or more time based distributions of instances of obstruction (e.g. frequency occurrences regarding days of week, holidays, seasonal events, months of year, institutional calendars, etc.) of electronic device communication (e.g. cellular, mesh network, etc.) for one or more particular geographical locations (e.g. cities, parks, downtowns, buildings, etc.).

In one or more implementations, as shown in FIG. 12D, the operation o1107 can include operation o1113 for receiving first information regarding at least in part first communication related events at least partially related to one or more communication transmissions received by one or more first fixed position base station devices being part of a base station network from first mobile operating system based mobile communication devices including receiving information regarding one or more statistical probabilities of remaining in communication with the one or more first mobile operating system based mobile communication devices. Origination of a physically tangible component group can be accomplished through skilled in the art design choice selection including use of one or more components and/or subsystems explicitly and/or implicitly referred to herein for at least in part implementing execution of one or more instructions i1113 of the operation o1113, for performance of the operation o1113 by an electrical circuitry arrangement e1113 as activated thereto, and/or otherwise fulfillment of the operation o1113. One or more non-transitory signal bearing physical media can bear the one or more instructions i1113 that when executed can direct performance of the operation o1113. Furthermore, receiving information regarding statistical probabilities of remaining in communication with first mobile operating system based mobile communication devices module m1113 depicted in FIG. 8B as being included in the module m1107, when executed and/or activated, can direct performance of and/or perform the operation o1113. Illustratively, in one or more implementations, the operation o1113 can be carried out, for example, by receiving (e.g. first reception of electronic transmission, etc.) first information (e.g. statistics, incident data, performance data, topology data, derived or original information etc.) regarding second information (e.g. statistics, incident data, performance data, topology data, derived or original information, etc.) involving at least in part the one or more first mobile operating system based mobile communication devices (e.g. smartphones, etc.) including receiving first information (e.g. data calculation, electronic signal reception, etc.) regarding at least in part first communication related events at least partially related to one or more communication transmissions received by one or more first fixed position base station devices (e.g. portable computers, etc.) being part of a base station network from first mobile operating system based mobile communication devices receiving information regarding one or more statistical probabilities (e.g. Gaussian distribution, manual surveys, user surveys, automated surveys, etc.) of remaining in communication (e.g. call not dropped, data transmission complete, no delays in transmission, etc.) with the one or more first mobile operating system based mobile communication devices (e.g. handset, etc.).

In one or more implementations, as shown in FIG. 12D, the operation o1107 can include operation o1114 for receiving first information regarding at least in part first communication related events at least partially related to one or more communication transmissions received by one or more first fixed position base station devices being part of a base station network from first mobile operating system based mobile communication devices including receiving GPS positioning data regarding the one or more first mobile operating system based mobile communication devices. Origination of a physically tangible component group can be accomplished through skilled in the art design choice selection including use of one or more components and/or subsystems explicitly and/or implicitly referred to herein for at least in part implementing execution of one or more instructions i1114 of the operation o1114, for performance of the operation o1114 by an electrical circuitry arrangement e1114 as activated thereto, and/or otherwise fulfillment of the operation o1114. One or more non-transitory signal bearing physical media can bear the one or more instructions i1114 that when executed can direct performance of the operation o1114. Furthermore, receiving GPS positioning data regarding first mobile operating system based mobile communication devices module m1114 depicted in FIG. 8B as being included in the module m1107, when executed and/or activated, can direct performance of and/or perform the operation o1114. Illustratively, in one or more implementations, the operation o1114 can be carried out, for example, by receiving (e.g. first reception of electronic transmission, etc.) first information (e.g. statistics, incident data, performance data, topology data, derived or original information etc.) regarding second information (e.g. statistics, incident data, performance data, topology data, derived or original information, etc.) involving at least in part the one or more first mobile operating system based mobile communication devices (e.g. smartphones, etc.) including receiving first information (e.g. data calculation, electronic signal reception, etc.) regarding at least in part first communication related events at least partially related to one or more communication transmissions received by one or more first fixed position base station devices (e.g. portable computers, etc.) being part of a base station network from first mobile operating system based mobile communication devices receiving GPS positioning data (e.g. global positioning system satellite data, chipset information, data base inquiry, etc.) regarding the one or more first mobile operating system based mobile communication devices (e.g. phablet, etc.).

In one or more implementations, as shown in FIG. 12D, the operation o1107 can include operation o1115 for receiving first information regarding at least in part first communication related events at least partially related to one or more communication transmissions received by one or more first fixed position base station devices being part of a base station network from first mobile operating system based mobile communication devices including receiving information associated with communication histories of one or more other mobile operating system based mobile communication devices communicating through the base station network with the one or more first mobile operating system based mobile communication devices. Origination of a physically tangible component group can be accomplished through skilled in the art design choice selection including use of one or more components and/or subsystems explicitly and/or implicitly referred to herein for at least in part implementing execution of one or more instructions i1115 of the operation o1115, for performance of the operation o1115 by an electrical circuitry arrangement e1115 as activated thereto, and/or otherwise fulfillment of the operation o1115. One or more non-transitory signal bearing physical media can bear the one or more instructions i1115 that when executed can direct performance of the operation o1115. Furthermore, receiving information associated communication histories of other mobile operating system based mobile communication devices communicating through base station network with first mobile operating system based mobile communication devices module m1115 depicted in FIG. 8B as being included in the module m1107, when executed and/or activated, can direct performance of and/or perform the operation o1115. Illustratively, in one or more implementations, the operation o1115 can be carried out, for example, by receiving (e.g. first reception of electronic transmission, etc.) first information (e.g. statistics, incident data, performance data, topology data, derived or original information etc.) regarding second information (e.g. statistics, incident data, performance data, topology data, derived or original information, etc.) involving at least in part the one or more first mobile operating system based mobile communication devices (e.g. smartphones, etc.) including receiving first information (e.g. data calculation, electronic signal reception, etc.) regarding at least in part first communication related events at least partially related to one or more communication transmissions received by one or more first fixed position base station devices (e.g. portable computers, etc.) being part of a base station network from first mobile operating system based mobile communication devices receiving information associated with communication histories (e.g. data base records of call duration, time of call, call locations, associated transmission issues, network systems used, etc.) of one or more other mobile operating system based mobile communication devices (e.g. laptop, etc.) communicating through the base station network with the one or more first mobile operating system based mobile communication devices (e.g. smartphone, etc.).

In one or more implementations, as shown in FIG. 12E, the operation o1115 can include operation o1116 for receiving information associated with communication histories of one or more other mobile operating system based mobile communication devices communicating through the base station network with the one or more first mobile operating system based mobile communication devices including receiving information as positioning data for the one or more first mobile operating system based mobile communication devices. Origination of a physically tangible component group can be accomplished through skilled in the art design choice selection including use of one or more components and/or subsystems explicitly and/or implicitly referred to herein for at least in part implementing execution of one or more instructions i1116 of the operation o1116, for performance of the operation o1116 by an electrical circuitry arrangement e1116 as activated thereto, and/or otherwise fulfillment of the operation o1116. One or more non-transitory signal bearing physical media can bear the one or more instructions i1116 that when executed can direct performance of the operation o1116. Furthermore, receiving information as positioning data for first mobile operating system based mobile communication devices module m1116 depicted in FIG. 8B as being included in the module m1115, when executed and/or activated, can direct performance of and/or perform the operation o1116. Illustratively, in one or more implementations, the operation o1116 can be carried out, for example, by receiving (e.g. first reception of electronic transmission, etc.) first information (e.g. statistics, incident data, performance data, topology data, derived or original information etc.) regarding second information (e.g. statistics, incident data, performance data, topology data, derived or original information, etc.) involving at least in part the one or more first mobile operating system based mobile communication devices (e.g. smartphones, etc.) including receiving first information (e.g. data calculation, electronic signal reception, etc.) regarding at least in part first communication related events at least partially related to one or more communication transmissions received by one or more first fixed position base station devices (e.g. portable computers, etc.) being part of a base station network from first mobile operating system based mobile communication devices receiving information associated with communication histories (e.g. data base records of call duration, time of call, call locations, associated transmission issues, network systems used, etc.) of one or more other mobile operating system based mobile communication devices (e.g. laptop, etc.) communicating through the base station network with the one or more first mobile operating system based mobile communication devices (e.g. smartphone, etc.) receiving information as positioning data (e.g. data describing location in relation to fixed objects, data describing location in relation to fixed base stations, data describing location in relation to environmental interference such as water falls, etc.) for the one or more first mobile operating system based mobile communication devices (e.g. smartphones, etc.).

In one or more implementations, as shown in FIG. 12E, the operation o1115 can include operation o1117 for receiving information associated with communication histories of one or more other mobile operating system based mobile communication devices communicating through the base station network with the one or more first mobile operating system based mobile communication devices including receiving information as communication history data previously stored and forwarded between one or more of the first mobile operating system based mobile communication devices. Origination of a physically tangible component group can be accomplished through skilled in the art design choice selection including use of one or more components and/or subsystems explicitly and/or implicitly referred to herein for at least in part implementing execution of one or more instructions i1117 of the operation o1117, for performance of the operation o1117 by an electrical circuitry arrangement e1117 as activated thereto, and/or otherwise fulfillment of the operation o1117. One or more non-transitory signal bearing physical media can bear the one or more instructions i1117 that when executed can direct performance of the operation o1117. Furthermore, receiving information as communication history data previously stored and forwarded between of first mobile operating system based mobile communication devices module m1117 depicted in FIG. 8B as being included in the module m1115, when executed and/or activated, can direct performance of and/or perform the operation o1117. Illustratively, in one or more implementations, the operation o1117 can be carried out, for example, by receiving (e.g. first reception of electronic transmission, etc.) first information (e.g. statistics, incident data, performance data, topology data, derived or original information etc.) regarding second information (e.g. statistics, incident data, performance data, topology data, derived or original information, etc.) involving at least in part the one or more first mobile operating system based mobile communication devices (e.g. smartphones, etc.) including receiving first information (e.g. data calculation, electronic signal reception, etc.) regarding at least in part first communication related events at least partially related to one or more communication transmissions received by one or more first fixed position base station devices (e.g. portable computers, etc.) being part of a base station network from first mobile operating system based mobile communication devices receiving information associated with communication histories (e.g. data base records of call duration, time of call, call locations, associated transmission issues, network systems used, etc.) of one or more other mobile operating system based mobile communication devices (e.g. laptop, etc.) communicating through the base station network with the one or more first mobile operating system based mobile communication devices (e.g. smartphone, etc.) receiving information as communication history data (e.g. successful communication versus communication problems with maintaining communication links, transmission dropout, degradation of transmission speed, etc.) previously stored and forwarded (e.g. temporarily held in device memory and then retransmitted, etc.) between one or more of the first mobile operating system based mobile communication devices (e.g. iPad, etc.).

In one or more implementations, as shown in FIG. 12E, the operation o1107 can include operation o1118 for receiving first information regarding at least in part first communication related events at least partially related to one or more communication transmissions received by one or more first fixed position base station devices being part of a base station network from first mobile operating system based mobile communication devices including receiving information regarding one or more potential obstructions to electronic communication located proximate to one or more of the first mobile operating system based mobile communication devices. Origination of a physically tangible component group can be accomplished through skilled in the art design choice selection including use of one or more components and/or subsystems explicitly and/or implicitly referred to herein for at least in part implementing execution of one or more instructions i1118 of the operation o1118, for performance of the operation o1118 by an electrical circuitry arrangement e1118 as activated thereto, and/or otherwise fulfillment of the operation o1118. One or more non-transitory signal bearing physical media can bear the one or more instructions i1118 that when executed can direct performance of the operation o1118. Furthermore, receiving information regarding potential obstructions to electronic communication located proximate to of first mobile operating system based mobile communication devices module m1118 depicted in FIG. 8B as being included in the module m1107, when executed and/or activated, can direct performance of and/or perform the operation o1118. Illustratively, in one or more implementations, the operation o1118 can be carried out, for example, by receiving (e.g. first reception of electronic transmission, etc.) first information (e.g. statistics, incident data, performance data, topology data, derived or original information etc.) regarding second information (e.g. statistics, incident data, performance data, topology data, derived or original information, etc.) involving at least in part the one or more first mobile operating system based mobile communication devices (e.g. smartphones, etc.) including receiving first information (e.g. data calculation, electronic signal reception, etc.) regarding at least in part first communication related events at least partially related to one or more communication transmissions received by one or more first fixed position base station devices (e.g. portable computers, etc.) being part of a base station network from first mobile operating system based mobile communication devices receiving information regarding one or more potential obstructions (e.g. thunderstorm cells, etc.) to electronic communication (e.g. above 50 GHz, etc.) located proximate (e.g. within one mile, etc.) to one or more of the first mobile operating system based mobile communication devices (e.g. tablet computers, etc.).

In one or more implementations, as shown in FIG. 12F, the operation o1118 can include operation o1119 for receiving information regarding one or more potential obstructions to electronic communication located proximate to one or more of the first mobile operating system based mobile communication devices including receiving information regarding one or more moveable communication obstructions. Origination of a physically tangible component group can be accomplished through skilled in the art design choice selection including use of one or more components and/or subsystems explicitly and/or implicitly referred to herein for at least in part implementing execution of one or more instructions i1119 of the operation o1119, for performance of the operation o1119 by an electrical circuitry arrangement e1119 as activated thereto, and/or otherwise fulfillment of the operation o1119. One or more non-transitory signal bearing physical media can bear the one or more instructions i1119 that when executed can direct performance of the operation o1119. Furthermore, receiving information regarding moveable communication obstructions module m1119 depicted in FIG. 8B as being included in the module m1118, when executed and/or activated, can direct performance of and/or perform the operation o1119. Illustratively, in one or more implementations, the operation o1119 can be carried out, for example, by receiving (e.g. first reception of electronic transmission, etc.) first information (e.g. statistics, incident data, performance data, topology data, derived or original information etc.) regarding second information (e.g. statistics, incident data, performance data, topology data, derived or original information, etc.) involving at least in part the one or more first mobile operating system based mobile communication devices (e.g. smartphones, etc.) including receiving first information (e.g. data calculation, electronic signal reception, etc.) regarding at least in part first communication related events at least partially related to one or more communication transmissions received by one or more first fixed position base station devices (e.g. portable computers, etc.) being part of a base station network from first mobile operating system based mobile communication devices receiving information regarding one or more potential obstructions (e.g. thunderstorm cells, etc.) to electronic communication (e.g. above 50 GHz, etc.) located proximate (e.g. within one mile, etc.) to one or more of the first mobile operating system based mobile communication devices (e.g. tablet computers, etc.) receiving information regarding one or more moveable communication obstructions (e.g. ship container traffic in relation to ferry traffic, etc.).

In one or more implementations, as shown in FIG. 12F, the operation o1119 can include operation o1120 for receiving information regarding one or more moveable communication obstructions including receiving information regarding one or more moveable communication obstructions as one or more pedestrians. Origination of a physically tangible component group can be accomplished through skilled in the art design choice selection including use of one or more components and/or subsystems explicitly and/or implicitly referred to herein for at least in part implementing execution of one or more instructions i1120 of the operation o1120, for performance of the operation o1120 by an electrical circuitry arrangement e1120 as activated thereto, and/or otherwise fulfillment of the operation o1120. One or more non-transitory signal bearing physical media can bear the one or more instructions i1120 that when executed can direct performance of the operation o1120. Furthermore, receiving information regarding moveable communication obstructions as pedestrians module m1120 depicted in FIG. 8B as being included in the module m1119, when executed and/or activated, can direct performance of and/or perform the operation o1120. Illustratively, in one or more implementations, the operation o1120 can be carried out, for example, by receiving (e.g. first reception of electronic transmission, etc.) first information (e.g. statistics, incident data, performance data, topology data, derived or original information etc.) regarding second information (e.g. statistics, incident data, performance data, topology data, derived or original information, etc.) involving at least in part the one or more first mobile operating system based mobile communication devices (e.g. smartphones, etc.) including receiving first information (e.g. data calculation, electronic signal reception, etc.) regarding at least in part first communication related events at least partially related to one or more communication transmissions received by one or more first fixed position base station devices (e.g. portable computers, etc.) being part of a base station network from first mobile operating system based mobile communication devices receiving information regarding one or more potential obstructions (e.g. thunderstorm cells, etc.) to electronic communication (e.g. above 50 GHz, etc.) located proximate (e.g. within one mile, etc.) to one or more of the first mobile operating system based mobile communication devices (e.g. tablet computers, etc.) receiving information regarding one or more moveable communication obstructions (e.g. ship container traffic in relation to ferry traffic, etc.) receiving information regarding one or more moveable communication obstructions as one or more pedestrians (e.g. pedestrians on the ship containers or ferry traffic, pedestrians having health issues regarding high frequency electronic communications, etc.).

In one or more implementations, as shown in FIG. 12F, the operation o1118 can include operation o1121 for receiving information regarding one or more potential obstructions to electronic communication located proximate to one or more of the first mobile operating system based mobile communication devices including receiving information regarding one or more potential obstructions to electronic communication as one or more architectural structures. Origination of a physically tangible component group can be accomplished through skilled in the art design choice selection including use of one or more components and/or subsystems explicitly and/or implicitly referred to herein for at least in part implementing execution of one or more instructions i1121 of the operation o1121, for performance of the operation o1121 by an electrical circuitry arrangement e1121 as activated thereto, and/or otherwise fulfillment of the operation o1121. One or more non-transitory signal bearing physical media can bear the one or more instructions i1121 that when executed can direct performance of the operation o1121. Furthermore, receiving information regarding potential obstructions to electronic communication as architectural structures module m1121 depicted in FIG. 8B as being included in the module m1118, when executed and/or activated, can direct performance of and/or perform the operation o1121. Illustratively, in one or more implementations, the operation o1121 can be carried out, for example, by receiving (e.g. first reception of electronic transmission, etc.) first information (e.g. statistics, incident data, performance data, topology data, derived or original information etc.) regarding second information (e.g. statistics, incident data, performance data, topology data, derived or original information, etc.) involving at least in part the one or more first mobile operating system based mobile communication devices (e.g. smartphones, etc.) including receiving first information (e.g. data calculation, electronic signal reception, etc.) regarding at least in part first communication related events at least partially related to one or more communication transmissions received by one or more first fixed position base station devices (e.g. portable computers, etc.) being part of a base station network from first mobile operating system based mobile communication devices receiving information regarding one or more potential obstructions (e.g. thunderstorm cells, etc.) to electronic communication (e.g. above 50 GHz, etc.) located proximate (e.g. within one mile, etc.) to one or more of the first mobile operating system based mobile communication devices (e.g. tablet computers, etc.) receiving information regarding one or more potential obstructions (e.g. 50% percent probability of greater than 5% of a period of time that communication is blocked, etc.) to electronic communication as one or more architectural structures (e.g. warehouses, airport centers, etc.).

In one or more implementations, as shown in FIG. 13A, the operation o1179 can include operation o1201 for receiving third information regarding fourth information regarding one or more second communication related events occurring directly between two or more second mobile operating system based mobile communication devices including accessing data from a data source via a virtual machine representation of at least a part of a computing machine including accessing data from a data source via a virtual machine representation of at least a part of a real machine. Origination of a physically tangible component group can be accomplished through skilled in the art design choice selection including use of one or more components and/or subsystems explicitly and/or implicitly referred to herein for at least in part implementing execution of one or more instructions i1201 of the operation o1201, for performance of the operation o1201 by an electrical circuitry arrangement e1201 as activated thereto, and/or otherwise fulfillment of the operation o1201. One or more non-transitory signal bearing physical media can bear the one or more instructions i1201 that when executed can direct performance of the operation o1201. Furthermore, accessing data from data source via virtual machine representation of computing machine including accessing data from data source via virtual machine representation of real machine module m1201 depicted in FIG. 9A as being included in the module m1179, when executed and/or activated, can direct performance of and/or perform the operation o1201. Illustratively, in one or more implementations, the operation o1201 can be carried out, for example, by receiving (e.g. third reception of cellular transmission, etc.) third information (e.g. statistics, incident data, performance data, topology data, derived and original information, etc.) regarding fourth information (e.g. statistics, incident data, performance data, topology data, derived and original information, etc.) regarding one or more second communication related events (e.g. successful transmissions, unsuccessful transmissions, failed equipment, performance assessment, etc.) occurring directly between two or more second mobile operating system based mobile communication devices (e.g. mobile OS handsets, tablets, phablets, etc.) including accessing data (e.g. data calls, etc.) from a data source (e.g. electronic memory, etc.) via a virtual machine representation (e.g. process virtual machine, etc.) of at least a part of a computing machine (e.g. mobile OS portion, etc.) including accessing data (e.g. through bus, etc.) from a data source (e.g. hard drive, etc.) via a virtual machine representation (e.g. process virtual machine, etc.) of at least a part of a real machine (e.g. processor hardware, etc.).

In one or more implementations, as shown in FIG. 13A, the operation o1179 can include operation o1202 for receiving third information regarding fourth information regarding one or more second communication related events occurring directly between two or more second mobile operating system based mobile communication devices including accessing data from a data source via a virtual machine representation of at least a part of a computing machine including accessing data from a data source via a virtual machine representation of at least a part of a virtual machine. Origination of a physically tangible component group can be accomplished through skilled in the art design choice selection including use of one or more components and/or subsystems explicitly and/or implicitly referred to herein for at least in part implementing execution of one or more instructions i1202 of the operation o1202, for performance of the operation o1202 by an electrical circuitry arrangement e1202 as activated thereto, and/or otherwise fulfillment of the operation o1202. One or more non-transitory signal bearing physical media can bear the one or more instructions i1202 that when executed can direct performance of the operation o1202. Furthermore, accessing data from data source via virtual machine representation of computing machine including accessing data from data source via virtual machine representation of virtual machine module m1202 depicted in FIG. 9A as being included in the module m1179, when executed and/or activated, can direct performance of and/or perform the operation o1202. Illustratively, in one or more implementations, the operation o1202 can be carried out, for example, by receiving (e.g. third reception of cellular transmission, etc.) third information (e.g. statistics, incident data, performance data, topology data, derived and original information, etc.) regarding fourth information (e.g. statistics, incident data, performance data, topology data, derived and original information, etc.) regarding one or more second communication related events (e.g. successful transmissions, unsuccessful transmissions, failed equipment, performance assessment, etc.) occurring directly between two or more second mobile operating system based mobile communication devices (e.g. mobile OS handsets, tablets, phablets, etc.) including accessing data (e.g. data calls, etc.) from a data source (e.g. electronic memory, etc.) via a virtual machine representation (e.g. process virtual machine, etc.) of at least a part of a computing machine (e.g. mobile OS portion, etc.) including accessing data (e.g. through bus, etc.) from a data source (e.g. hard drive, etc.) via a virtual machine representation (e.g. process virtual machine, Android, etc.) of at least a part of a virtual machine (e.g. Java, etc.).

In one or more implementations, as shown in FIG. 13A, the operation o1179 can include operation o1203 for receiving third information regarding fourth information regarding one or more second communication related events occurring directly between two or more second mobile operating system based mobile communication devices including accessing data from a data source via a virtual machine representation of at least a part of a virtual machine including converting a file having a file-type associated with the virtual machine to a file-type associated with the virtual machine representation. Origination of a physically tangible component group can be accomplished through skilled in the art design choice selection including use of one or more components and/or subsystems explicitly and/or implicitly referred to herein for at least in part implementing execution of one or more instructions i1203 of the operation o1203, for performance of the operation o1203 by an electrical circuitry arrangement e1203 as activated thereto, and/or otherwise fulfillment of the operation o1203. One or more non-transitory signal bearing physical media can bear the one or more instructions i1203 that when executed can direct performance of the operation o1203. Furthermore, accessing data from data source via virtual machine representation of virtual machine including converting file having file-type associated virtual machine to file-type associated virtual machine representation module m1203 depicted in FIG. 9A as being included in the module m1179, when executed and/or activated, can direct performance of and/or perform the operation o1203. Illustratively, in one or more implementations, the operation o1203 can be carried out, for example, by receiving (e.g. third reception of cellular transmission, etc.) third information (e.g. statistics, incident data, performance data, topology data, derived and original information, etc.) regarding fourth information (e.g. statistics, incident data, performance data, topology data, derived and original information, etc.) regarding one or more second communication related events (e.g. successful transmissions, unsuccessful transmissions, failed equipment, performance assessment, etc.) occurring directly between two or more second mobile operating system based mobile communication devices (e.g. mobile OS handsets, tablets, phablets, etc.) including accessing data from a data source (e.g. memory, etc.) via a virtual machine representation (e.g. process virtual machine, Android, etc.) of at least a part of a virtual machine including converting a file having a file-type associated with the virtual machine (e.g. class JVM files, etc.) to a file-type associated with the virtual machine representation (e.g. dex Dalvix files, etc.).

In one or more implementations, as shown in FIG. 13A, the operation o1203 can include operation o1204 for accessing data from a data source via a virtual machine representation of at least a part of a virtual machine including converting a file having a file-type associated with the virtual machine to a file-type associated with the virtual machine representation including wherein the file-type associated with the second virtual machine is configured for a limited-resource computing machine. Origination of a physically tangible component group can be accomplished through skilled in the art design choice selection including use of one or more components and/or subsystems explicitly and/or implicitly referred to herein for at least in part implementing execution of one or more instructions i1204 of the operation o1204, for performance of the operation o1204 by an electrical circuitry arrangement e1204 as activated thereto, and/or otherwise fulfillment of the operation o1204. One or more non-transitory signal bearing physical media can bear the one or more instructions i1204 that when executed can direct performance of the operation o1204. Furthermore, file-type associated second virtual machine for limited-resource computing machine module m1204 depicted in FIG. 9A as being included in the module m1203, when executed and/or activated, can direct performance of and/or perform the operation o1204. Illustratively, in one or more implementations, the operation o1204 can be carried out, for example, by receiving (e.g. third reception of cellular transmission, etc.) third information (e.g. statistics, incident data, performance data, topology data, derived and original information, etc.) regarding fourth information (e.g. statistics, incident data, performance data, topology data, derived and original information, etc.) regarding one or more second communication related events (e.g. successful transmissions, unsuccessful transmissions, failed equipment, performance assessment, etc.) occurring directly between two or more second mobile operating system based mobile communication devices (e.g. mobile OS handsets, tablets, phablets, etc.) including accessing data from a data source (e.g. memory, etc.) via a virtual machine representation (e.g. process virtual machine, Android, etc.) of at least a part of a virtual machine including converting a file having a file-type associated with the virtual machine (e.g. class JVM files, etc.) to a file-type associated with the virtual machine representation (e.g. dex Dalvix files, etc.) wherein the file-type associated with the second virtual machine (e.g. dex Dalvix files, etc.) is configured for a limited-resource computing machine (e.g. Android operating system device, etc.).

In one or more implementations, as shown in FIG. 13A, the operation o1204 can include operation o1205 for wherein the file-type associated with the second virtual machine is configured for a limited-resource computing machine including wherein the file-type associated with the second virtual machine is configured for a mobile computing machine. Origination of a physically tangible component group can be accomplished through skilled in the art design choice selection including use of one or more components and/or subsystems explicitly and/or implicitly referred to herein for at least in part implementing execution of one or more instructions i1205 of the operation o1205, for performance of the operation o1205 by an electrical circuitry arrangement e1205 as activated thereto, and/or otherwise fulfillment of the operation o1205. One or more non-transitory signal bearing physical media can bear the one or more instructions i1205 that when executed can direct performance of the operation o1205. Furthermore, file-type associated second virtual machine for mobile computing machine module m1205 depicted in FIG. 9A as being included in the module m1204, when executed and/or activated, can direct performance of and/or perform the operation o1205. Illustratively, in one or more implementations, the operation o1205 can be carried out, for example, by receiving (e.g. third reception of cellular transmission, etc.) third information (e.g. statistics, incident data, performance data, topology data, derived and original information, etc.) regarding fourth information (e.g. statistics, incident data, performance data, topology data, derived and original information, etc.) regarding one or more second communication related events (e.g. successful transmissions, unsuccessful transmissions, failed equipment, performance assessment, etc.) occurring directly between two or more second mobile operating system based mobile communication devices (e.g. mobile OS handsets, tablets, phablets, etc.) including accessing data from a data source (e.g. memory, etc.) via a virtual machine representation (e.g. process virtual machine, Android, etc.) of at least a part of a virtual machine including converting a file having a file-type associated with the virtual machine (e.g. class JVM files, etc.) to a file-type associated with the virtual machine representation (e.g. dex Dalvix files, etc.) wherein the file-type associated with the second virtual machine (e.g. dex Dalvix files, etc.) is configured for a limited-resource computing machine (e.g. Android operating system device, etc.) wherein the file-type associated with the second virtual machine is configured for a mobile computing machine (e.g. mobile devices such as Samsung mobile devices, Google mobile devices, etc.).

In one or more implementations, as shown in FIG. 13B, the operation o1179 can include operation o1206 for receiving third information regarding fourth information regarding one or more second communication related events occurring directly between two or more second mobile operating system based mobile communication devices including receiving information regarding activation of the two or more second mobile operating system based mobile communication devices as network relay devices based at least in part upon one or more fixed position base station devices becoming unavailable for communication with one or more mobile operating system based mobile communication devices. Origination of a physically tangible component group can be accomplished through skilled in the art design choice selection including use of one or more components and/or subsystems explicitly and/or implicitly referred to herein for at least in part implementing execution of one or more instructions i1206 of the operation o1206, for performance of the operation o1206 by an electrical circuitry arrangement e1206 as activated thereto, and/or otherwise fulfillment of the operation o1206. One or more non-transitory signal bearing physical media can bear the one or more instructions i1206 that when executed can direct performance of the operation o1206. Furthermore, receiving information regarding activation of second mobile operating system based mobile communication devices as network relay devices based upon fixed position base station devices becoming unavailable for communication with mobile operating system based mobile communication devices module m1206 depicted in FIG. 9A as being included in the module m1179, when executed and/or activated, can direct performance of and/or perform the operation o1206. Illustratively, in one or more implementations, the operation o1206 can be carried out, for example, by receiving (e.g. third reception of cellular transmission, etc.) third information (e.g. statistics, incident data, performance data, topology data, derived and original information, etc.) regarding fourth information (e.g. statistics, incident data, performance data, topology data, derived and original information, etc.) regarding one or more second communication related events (e.g. successful transmissions, unsuccessful transmissions, failed equipment, performance assessment, etc.) occurring directly between two or more second mobile operating system based mobile communication devices (e.g. mobile OS handsets, tablets, phablets, etc.) including receiving (e.g. third reception of cellular transmission, etc.) third information (e.g. statistics, incident data, performance data, topology data, derived and original information, etc.) regarding fourth information (e.g. statistics, incident data, performance data, topology data, derived and original information, etc.), the fourth information having been received (e.g. fourth reception of cellular transmission, etc.) at one or more second fixed position base station devices (e.g. wall mounted cellular base stations, etc.) being part of the base station network (e.g. cellular network, etc.) including fixed position base station devices (e.g. wall mounted cellular base stations, etc.), the fourth information regarding one or more second communication related events (e.g. successful transmissions, unsuccessful transmissions, failed equipment, performance assessment, etc.) occurring directly between two or more second mobile operating system based mobile communication devices (e.g. mobile OS handsets, tablets, phablets, etc.) receiving information regarding activation of the two or more second mobile operating system based mobile communication devices (e.g. smart phones, etc.) as network relay devices based at least in part upon one or more fixed position base station devices (e.g. one or more fixed position cell towers, network routers, network switches, network relay, base transceiver stations, mobile switching centers, macrocells, microcells, picocells, femtocells, access point base stations, cell sites, repeaters, etc.) becoming unavailable for communication with one or more mobile operating system based mobile communication devices (e.g. laptop, etc.).

In one or more implementations, as shown in FIG. 13B, the operation o1179 can include operation o1207 for receiving third information regarding fourth information regarding one or more second communication related events occurring directly between two or more second mobile operating system based mobile communication devices including receiving wireless packetized communication. Origination of a physically tangible component group can be accomplished through skilled in the art design choice selection including use of one or more components and/or subsystems explicitly and/or implicitly referred to herein for at least in part implementing execution of one or more instructions i1207 of the operation o1207, for performance of the operation o1207 by an electrical circuitry arrangement e1207 as activated thereto, and/or otherwise fulfillment of the operation o1207. One or more non-transitory signal bearing physical media can bear the one or more instructions i1207 that when executed can direct performance of the operation o1207. Furthermore, receiving wireless packetized communication module m1207 depicted in FIG. 9A as being included in the module m1179, when executed and/or activated, can direct performance of and/or perform the operation o1207. Illustratively, in one or more implementations, the operation o1207 can be carried out, for example, by receiving (e.g. third reception of cellular transmission, etc.) third information (e.g. statistics, incident data, performance data, topology data, derived and original information, etc.) regarding fourth information (e.g. statistics, incident data, performance data, topology data, derived and original information, etc.) regarding one or more second communication related events (e.g. successful transmissions, unsuccessful transmissions, failed equipment, performance assessment, etc.) occurring directly between two or more second mobile operating system based mobile communication devices (e.g. mobile OS handsets, tablets, phablets, etc.) receiving wireless packetized communication (e.g. IEEE 802.11 packets, cellular packets, etc.).

In one or more implementations, as shown in FIG. 13B, the operation o1207 can include operation o1208 for receiving wireless packetized communication including receiving incoming message traffic. Origination of a physically tangible component group can be accomplished through skilled in the art design choice selection including use of one or more components and/or subsystems explicitly and/or implicitly referred to herein for at least in part implementing execution of one or more instructions i1208 of the operation o1208, for performance of the operation o1208 by an electrical circuitry arrangement e1208 as activated thereto, and/or otherwise fulfillment of the operation o1208. One or more non-transitory signal bearing physical media can bear the one or more instructions i1208 that when executed can direct performance of the operation o1208. Furthermore, receiving incoming message traffic module m1208 depicted in FIG. 9A as being included in the module m1207, when executed and/or activated, can direct performance of and/or perform the operation o1208. Illustratively, in one or more implementations, the operation o1208 can be carried out, for example, by receiving (e.g. third reception of cellular transmission, etc.) third information (e.g. statistics, incident data, performance data, topology data, derived and original information, etc.) regarding fourth information (e.g. statistics, incident data, performance data, topology data, derived and original information, etc.) regarding one or more second communication related events (e.g. successful transmissions, unsuccessful transmissions, failed equipment, performance assessment, etc.) occurring directly between two or more second mobile operating system based mobile communication devices (e.g. mobile OS handsets, tablets, phablets, etc.) receiving wireless packetized communication (e.g. IEEE 802.11 packets, cellular packets, etc.) receiving incoming message traffic (e.g. text messages, voice calls, etc.).

In one or more implementations, as shown in FIG. 13B, the operation o1208 can include operation o1209 for receiving incoming message traffic including receiving one or more high bandwidth data transfers. Origination of a physically tangible component group can be accomplished through skilled in the art design choice selection including use of one or more components and/or subsystems explicitly and/or implicitly referred to herein for at least in part implementing execution of one or more instructions i1209 of the operation o1209, for performance of the operation o1209 by an electrical circuitry arrangement e1209 as activated thereto, and/or otherwise fulfillment of the operation o1209. One or more non-transitory signal bearing physical media can bear the one or more instructions i1209 that when executed can direct performance of the operation o1209. Furthermore, receiving high bandwidth data transfers module m1209 depicted in FIG. 9A as being included in the module m1208, when executed and/or activated, can direct performance of and/or perform the operation o1209. Illustratively, in one or more implementations, the operation o1209 can be carried out, for example, by receiving (e.g. third reception of cellular transmission, etc.) third information (e.g. statistics, incident data, performance data, topology data, derived and original information, etc.) regarding fourth information (e.g. statistics, incident data, performance data, topology data, derived and original information, etc.) regarding one or more second communication related events (e.g. successful transmissions, unsuccessful transmissions, failed equipment, performance assessment, etc.) occurring directly between two or more second mobile operating system based mobile communication devices (e.g. mobile OS handsets, tablets, phablets, etc.) receiving wireless packetized communication (e.g. IEEE 802.11 packets, cellular packets, etc.) receiving incoming message traffic (e.g. text messages, voice calls, etc.) receiving one or more high bandwidth data transfers (e.g. high resolution video calls, large capacity data files, etc.).

In one or more implementations, as shown in FIG. 13B, the operation o1208 can include operation o1210 for receiving incoming message traffic including receiving one or more high resolution audio formatted messages. Origination of a physically tangible component group can be accomplished through skilled in the art design choice selection including use of one or more components and/or subsystems explicitly and/or implicitly referred to herein for at least in part implementing execution of one or more instructions i1210 of the operation o1210, for performance of the operation o1210 by an electrical circuitry arrangement e1210 as activated thereto, and/or otherwise fulfillment of the operation o1210. One or more non-transitory signal bearing physical media can bear the one or more instructions i1210 that when executed can direct performance of the operation o1210. Furthermore, receiving high resolution audio formatted messages module m1210 depicted in FIG. 9A as being included in the module m1208, when executed and/or activated, can direct performance of and/or perform the operation o1210. Illustratively, in one or more implementations, the operation o1210 can be carried out, for example, by receiving (e.g. third reception of cellular transmission, etc.) third information (e.g. statistics, incident data, performance data, topology data, derived and original information, etc.) regarding fourth information (e.g. statistics, incident data, performance data, topology data, derived and original information, etc.) regarding one or more second communication related events (e.g. successful transmissions, unsuccessful transmissions, failed equipment, performance assessment, etc.) occurring directly between two or more second mobile operating system based mobile communication devices (e.g. mobile OS handsets, tablets, phablets, etc.) receiving wireless packetized communication (e.g. IEEE 802.11 packets, cellular packets, etc.) receiving incoming message traffic (e.g. text messages, voice calls, etc.) receiving one or more high resolution audio formatted messages (e.g. FLAC formatted, Pono formatted, etc.).

In one or more implementations, as shown in FIG. 13B, the operation o1208 can include operation o1211 for receiving incoming message traffic including receiving one or more high resolution video formatted messages. Origination of a physically tangible component group can be accomplished through skilled in the art design choice selection including use of one or more components and/or subsystems explicitly and/or implicitly referred to herein for at least in part implementing execution of one or more instructions i1211 of the operation o1211, for performance of the operation o1211 by an electrical circuitry arrangement e1211 as activated thereto, and/or otherwise fulfillment of the operation o1211. One or more non-transitory signal bearing physical media can bear the one or more instructions i1211 that when executed can direct performance of the operation o1211. Furthermore, receiving high resolution video formatted messages module m1211 depicted in FIG. 9A as being included in the module m1208, when executed and/or activated, can direct performance of and/or perform the operation o1211. Illustratively, in one or more implementations, the operation o1211 can be carried out, for example, by receiving (e.g. third reception of cellular transmission, etc.) third information (e.g. statistics, incident data, performance data, topology data, derived and original information, etc.) regarding fourth information (e.g. statistics, incident data, performance data, topology data, derived and original information, etc.) regarding one or more second communication related events (e.g. successful transmissions, unsuccessful transmissions, failed equipment, performance assessment, etc.) occurring directly between two or more second mobile operating system based mobile communication devices (e.g. mobile OS handsets, tablets, phablets, etc.) receiving wireless packetized communication (e.g. IEEE 802.11 packets, cellular packets, etc.) receiving incoming message traffic (e.g. text messages, voice calls, etc.) receiving one or more high resolution video formatted messages (e.g. ultra high definition format, 4K UHD (2160 p), 8K UHD (4320 p), etc.).

In one or more implementations, as shown in FIG. 13B, the operation o1208 can include operation o1212 for receiving incoming message traffic including receiving one or more high capacity data files. Origination of a physically tangible component group can be accomplished through skilled in the art design choice selection including use of one or more components and/or subsystems explicitly and/or implicitly referred to herein for at least in part implementing execution of one or more instructions i1212 of the operation o1212, for performance of the operation o1212 by an electrical circuitry arrangement e1212 as activated thereto, and/or otherwise fulfillment of the operation o1212. One or more non-transitory signal bearing physical media can bear the one or more instructions i1212 that when executed can direct performance of the operation o1212. Furthermore, receiving incoming message traffic including receiving high capacity data files module m1212 depicted in FIG. 9A as being included in the module m1208, when executed and/or activated, can direct performance of and/or perform the operation o1212. Illustratively, in one or more implementations, the operation o1212 can be carried out, for example, by receiving (e.g. third reception of cellular transmission, etc.) third information (e.g. statistics, incident data, performance data, topology data, derived and original information, etc.) regarding fourth information (e.g. statistics, incident data, performance data, topology data, derived and original information, etc.) regarding one or more second communication related events (e.g. successful transmissions, unsuccessful transmissions, failed equipment, performance assessment, etc.) occurring directly between two or more second mobile operating system based mobile communication devices (e.g. mobile OS handsets, tablets, phablets, etc.) receiving wireless packetized communication (e.g. IEEE 802.11 packets, cellular packets, etc.) receiving incoming message traffic (e.g. text messages, voice calls, etc.) receiving one or more high capacity data files (e.g. over one Terabyte sized file, etc.).

In one or more implementations, as shown in FIG. 13B, the operation o1207 can include operation o1213 for receiving wireless packetized communication including receiving one or more communication network relay related transmissions from one or more second mobile operating system based mobile communication devices. Origination of a physically tangible component group can be accomplished through skilled in the art design choice selection including use of one or more components and/or subsystems explicitly and/or implicitly referred to herein for at least in part implementing execution of one or more instructions i1213 of the operation o1213, for performance of the operation o1213 by an electrical circuitry arrangement e1213 as activated thereto, and/or otherwise fulfillment of the operation o1213. One or more non-transitory signal bearing physical media can bear the one or more instructions i1213 that when executed can direct performance of the operation o1213. Furthermore, receiving wireless packetized communication including receiving communication network relay related transmissions from second mobile operating system based mobile communication devices module m1213 depicted in FIG. 9A as being included in the module m1207, when executed and/or activated, can direct performance of and/or perform the operation o1213. Illustratively, in one or more implementations, the operation o1213 can be carried out, for example, by receiving (e.g. third reception of cellular transmission, etc.) third information (e.g. statistics, incident data, performance data, topology data, derived and original information, etc.) regarding fourth information (e.g. statistics, incident data, performance data, topology data, derived and original information, etc.) regarding one or more second communication related events (e.g. successful transmissions, unsuccessful transmissions, failed equipment, performance assessment, etc.) occurring directly between two or more second mobile operating system based mobile communication devices (e.g. mobile OS handsets, tablets, phablets, etc.) receiving wireless packetized communication (e.g. IEEE 802.11 packets, cellular packets, etc.) receiving one or more communication network relay related transmissions (e.g. one or more status inquiries from sweeping beam low bandwidth probing communication, etc.) from one or more second mobile operating system based mobile communication devices (e.g. Research In Motion PDA device, etc.).

In one or more implementations, as shown in FIG. 13C, the operation o1207 can include operation o1214 for receiving wireless packetized communication including receiving one or more communication network relay related transmissions from one or more second mobile operating system based mobile communication devices as heterogeneous types. Origination of a physically tangible component group can be accomplished through skilled in the art design choice selection including use of one or more components and/or subsystems explicitly and/or implicitly referred to herein for at least in part implementing execution of one or more instructions i1214 of the operation o1214, for performance of the operation o1214 by an electrical circuitry arrangement e1214 as activated thereto, and/or otherwise fulfillment of the operation o1214. One or more non-transitory signal bearing physical media can bear the one or more instructions i1214 that when executed can direct performance of the operation o1214. Furthermore, receiving wireless packetized communication including receiving communication network relay related transmissions from second mobile operating system based mobile communication devices as heterogeneous types module m1214 depicted in FIG. 9B as being included in the module m1207, when executed and/or activated, can direct performance of and/or perform the operation o1214. Illustratively, in one or more implementations, the operation o1214 can be carried out, for example, by receiving (e.g. third reception of cellular transmission, etc.) third information (e.g. statistics, incident data, performance data, topology data, derived and original information, etc.) regarding fourth information (e.g. statistics, incident data, performance data, topology data, derived and original information, etc.) regarding one or more second communication related events (e.g. successful transmissions, unsuccessful transmissions, failed equipment, performance assessment, etc.) occurring directly between two or more second mobile operating system based mobile communication devices (e.g. mobile OS handsets, tablets, phablets, etc.) receiving wireless packetized communication (e.g. IEEE 802.11 packets, cellular packets, etc.) receiving one or more communication network relay related transmissions from one or more second mobile operating system based mobile communication devices as heterogeneous types (e.g. mixtures of laptops, phablets, smartphones, etc.).

In one or more implementations, as shown in FIG. 13C, the operation o1214 can include operation o1215 for receiving one or more communication network relay related transmissions from one or more second mobile operating system based mobile communication devices as heterogeneous types including receiving one or more communication network relay related transmissions from one or more laptops, one or more phablets, one or more tablets, one or more smart phones, one or more notebooks, one or more handsets, one or more palmtops, one or more personal digital assistants, one or more digital audio players, one or more portable media players, one or more digital cameras, or one or more cell phones. Origination of a physically tangible component group can be accomplished through skilled in the art design choice selection including use of one or more components and/or subsystems explicitly and/or implicitly referred to herein for at least in part implementing execution of one or more instructions i1215 of the operation o1215, for performance of the operation o1215 by an electrical circuitry arrangement e1215 as activated thereto, and/or otherwise fulfillment of the operation o1215. One or more non-transitory signal bearing physical media can bear the one or more instructions i1215 that when executed can direct performance of the operation o1215. Furthermore, receiving communication network relay related transmissions from laptops, phablets, tablets, smart phones, notebooks, handsets, palmtops, personal digital assistants, digital audio players, portable media players, digital cameras, or cell phones module m1215 depicted in FIG. 9B as being included in the module m1214, when executed and/or activated, can direct performance of and/or perform the operation o1215. Illustratively, in one or more implementations, the operation o1215 can be carried out, for example, by receiving (e.g. third reception of cellular transmission, etc.) third information (e.g. statistics, incident data, performance data, topology data, derived and original information, etc.) regarding fourth information (e.g. statistics, incident data, performance data, topology data, derived and original information, etc.) regarding one or more second communication related events (e.g. successful transmissions, unsuccessful transmissions, failed equipment, performance assessment, etc.) occurring directly between two or more second mobile operating system based mobile communication devices (e.g. mobile OS handsets, tablets, phablets, etc.) receiving wireless packetized communication (e.g. IEEE 802.11 packets, cellular packets, etc.) receiving one or more communication network relay related transmissions from one or more second mobile operating system based mobile communication devices as heterogeneous types (e.g. mixtures of laptops, phablets, smartphones, etc.) receiving one or more communication network relay related transmissions from one or more laptops (e.g. Sony Vaio, etc.), one or more phablets (e.g. Samsung Galaxy, etc.), one or more tablets (e.g. Toshiba tablets, etc.), one or more smart phones (e.g. Verizon smartphones, etc.), one or more notebooks (e.g. Thinkpad notebooks, etc.), one or more handsets (e.g. Google Android handset, etc.), one or more palmtops (e.g. HP next generation palmtop, etc.), one or more personal digital assistants (e.g. Blackberry PDA, etc.), one or more digital audio players (e.g. satellite radio mp3 receivers, etc.), one or more portable media players (e.g. downloading involving direct WiFi, etc.), one or more digital cameras (e.g. communicating cellular network, etc.), or one or more cell phones (e.g. Sprint network, etc.).

In one or more implementations, as shown in FIG. 13C, the operation o1214 can include operation o1216 for receiving one or more communication network relay related transmissions from one or more second mobile operating system based mobile communication devices as heterogeneous types including receiving one or more communication network relay related transmissions as using hybridized protocols including one or more IEEE 802.11ac protocols, one or more IEEE 802.11ad protocols, or one or more IEEE 802.11n/g protocols. Origination of a physically tangible component group can be accomplished through skilled in the art design choice selection including use of one or more components and/or subsystems explicitly and/or implicitly referred to herein for at least in part implementing execution of one or more instructions i1216 of the operation o1216, for performance of the operation o1216 by an electrical circuitry arrangement e1216 as activated thereto, and/or otherwise fulfillment of the operation o1216. One or more non-transitory signal bearing physical media can bear the one or more instructions i1216 that when executed can direct performance of the operation o1216. Furthermore, receiving communication network relay related transmissions as using hybridized protocols including IEEE 802.11 ac protocols, IEEE 802.11 ad protocols, or IEEE 802.11n/g protocols module m1216 depicted in FIG. 9B as being included in the module m1214, when executed and/or activated, can direct performance of and/or perform the operation o1216. Illustratively, in one or more implementations, the operation o1216 can be carried out, for example, by receiving (e.g. third reception of cellular transmission, etc.) third information (e.g. statistics, incident data, performance data, topology data, derived and original information, etc.) regarding fourth information (e.g. statistics, incident data, performance data, topology data, derived and original information, etc.) regarding one or more second communication related events (e.g. successful transmissions, unsuccessful transmissions, failed equipment, performance assessment, etc.) occurring directly between two or more second mobile operating system based mobile communication devices (e.g. mobile OS handsets, tablets, phablets, etc.) receiving wireless packetized communication (e.g. IEEE 802.11 packets, cellular packets, etc.) receiving one or more communication network relay related transmissions from one or more second mobile operating system based mobile communication devices as heterogeneous types (e.g. mixtures of laptops, phablets, smartphones, etc.) receiving one or more communication network relay related transmissions as using hybridized protocols including one or more IEEE 802.11 ac protocols, one or more IEEE 802.11 ad protocols, or one or more IEEE 802.11n/g protocols (e.g. IEEE 802 protocols used together by intermediate electronic communication devices, etc.).

In one or more implementations, as shown in FIG. 13C, the operation o1214 can include operation o1217 for receiving one or more communication network relay related transmissions from one or more second mobile operating system based mobile communication devices as heterogeneous types including receiving one or more communication network relay related transmissions as using one or more cellular protocols. Origination of a physically tangible component group can be accomplished through skilled in the art design choice selection including use of one or more components and/or subsystems explicitly and/or implicitly referred to herein for at least in part implementing execution of one or more instructions i1217 of the operation o1217, for performance of the operation o1217 by an electrical circuitry arrangement e1217 as activated thereto, and/or otherwise fulfillment of the operation o1217. One or more non-transitory signal bearing physical media can bear the one or more instructions i1217 that when executed can direct performance of the operation o1217. Furthermore, receiving communication network relay related transmissions as using cellular protocols module m1217 depicted in FIG. 9B as being included in the module m1214, when executed and/or activated, can direct performance of and/or perform the operation o1217. Illustratively, in one or more implementations, the operation o1217 can be carried out, for example, by receiving (e.g. third reception of cellular transmission, etc.) third information (e.g. statistics, incident data, performance data, topology data, derived and original information, etc.) regarding fourth information (e.g. statistics, incident data, performance data, topology data, derived and original information, etc.) regarding one or more second communication related events (e.g. successful transmissions, unsuccessful transmissions, failed equipment, performance assessment, etc.) occurring directly between two or more second mobile operating system based mobile communication devices (e.g. mobile OS handsets, tablets, phablets, etc.) receiving wireless packetized communication (e.g. IEEE 802.11 packets, cellular packets, etc.) receiving one or more communication network relay related transmissions from one or more second mobile operating system based mobile communication devices as heterogeneous types (e.g. mixtures of laptops, phablets, smartphones, etc.) receiving one or more communication network relay related transmissions as using one or more cellular protocols (e.g. IEEE 802 protocols used together by intermediate electronic communication devices, etc.).

In one or more implementations, as shown in FIG. 13C, the operation o1214 can include operation o1218 for receiving one or more communication network relay related transmissions from one or more second mobile operating system based mobile communication devices as heterogeneous types including receiving one or more communication network relay related transmissions as using one or more WiFi protocols, or one or more direct WiFi protocols. Origination of a physically tangible component group can be accomplished through skilled in the art design choice selection including use of one or more components and/or subsystems explicitly and/or implicitly referred to herein for at least in part implementing execution of one or more instructions i1218 of the operation o1218, for performance of the operation o1218 by an electrical circuitry arrangement e1218 as activated thereto, and/or otherwise fulfillment of the operation o1218. One or more non-transitory signal bearing physical media can bear the one or more instructions i1218 that when executed can direct performance of the operation o1218. Furthermore, receiving communication network relay related transmissions as using WiFi protocols, or direct WiFi protocols module m1218 depicted in FIG. 9B as being included in the module m1214, when executed and/or activated, can direct performance of and/or perform the operation o1218. Illustratively, in one or more implementations, the operation o1218 can be carried out, for example, by receiving (e.g. third reception of cellular transmission, etc.) third information (e.g. statistics, incident data, performance data, topology data, derived and original information, etc.) regarding fourth information (e.g. statistics, incident data, performance data, topology data, derived and original information, etc.) regarding one or more second communication related events (e.g. successful transmissions, unsuccessful transmissions, failed equipment, performance assessment, etc.) occurring directly between two or more second mobile operating system based mobile communication devices (e.g. mobile OS handsets, tablets, phablets, etc.) receiving wireless packetized communication (e.g. IEEE 802.11 packets, cellular packets, etc.) receiving one or more communication network relay related transmissions from one or more second mobile operating system based mobile communication devices as heterogeneous types (e.g. mixtures of laptops, phablets, smartphones, etc.) receiving one or more communication network relay related transmissions as using one or more WiFi protocols, or one or more direct WiFi protocols (e.g. IEEE 802 protocols used together by intermediate electronic communication devices, etc.).

In one or more implementations, as shown in FIG. 13D, the operation o1214 can include operation o1219 for receiving one or more communication network relay related transmissions from one or more second mobile operating system based mobile communication devices as heterogeneous types including receiving one or more communication network relay related transmissions as using protocols including one or more 3G protocols, one or more 4G protocols, one or more 5G protocols, one or more 6G or one or more 7G protocols. Origination of a physically tangible component group can be accomplished through skilled in the art design choice selection including use of one or more components and/or subsystems explicitly and/or implicitly referred to herein for at least in part implementing execution of one or more instructions i1219 of the operation o1219, for performance of the operation o1219 by an electrical circuitry arrangement e1219 as activated thereto, and/or otherwise fulfillment of the operation o1219. One or more non-transitory signal bearing physical media can bear the one or more instructions i1219 that when executed can direct performance of the operation o1219. Furthermore, receiving communication network relay related transmissions as using protocols including 3G protocols, 4G protocols, 5G protocols, 6G or 7G protocols module m1219 depicted in FIG. 9B as being included in the module m1214, when executed and/or activated, can direct performance of and/or perform the operation o1219. Illustratively, in one or more implementations, the operation o1219 can be carried out, for example, by receiving (e.g. third reception of cellular transmission, etc.) third information (e.g. statistics, incident data, performance data, topology data, derived and original information, etc.) regarding fourth information (e.g. statistics, incident data, performance data, topology data, derived and original information, etc.) regarding one or more second communication related events (e.g. successful transmissions, unsuccessful transmissions, failed equipment, performance assessment, etc.) occurring directly between two or more second mobile operating system based mobile communication devices (e.g. mobile OS handsets, tablets, phablets, etc.) receiving wireless packetized communication (e.g. IEEE 802.11 packets, cellular packets, etc.) receiving one or more communication network relay related transmissions from one or more second mobile operating system based mobile communication devices as heterogeneous types (e.g. mixtures of laptops, phablets, smartphones, etc.) receiving one or more communication network relay related transmissions as using protocols (e.g. IEEE 802 protocols used together by intermediate electronic communication devices, etc.) including one or more 3G protocols, one or more 4G protocols, one or more 5G protocols, one or more 6G or one or more 7G protocols.

In one or more implementations, as shown in FIG. 13D, the operation o1214 can include operation o1220 for receiving one or more communication network relay related transmissions from one or more second mobile operating system based mobile communication devices as heterogeneous types including receiving one or more communication network relay related transmissions as using protocols including one or more 20 GHz or above protocols, one or more 30 GHz or above protocols, or one or more 60 GHz or above protocols. Origination of a physically tangible component group can be accomplished through skilled in the art design choice selection including use of one or more components and/or subsystems explicitly and/or implicitly referred to herein for at least in part implementing execution of one or more instructions i1220 of the operation o1220, for performance of the operation o1220 by an electrical circuitry arrangement e1220 as activated thereto, and/or otherwise fulfillment of the operation o1220. One or more non-transitory signal bearing physical media can bear the one or more instructions i1220 that when executed can direct performance of the operation o1220. Furthermore, receiving communication network relay related transmissions as using protocols including 20 GHz or above protocols, 30 GHz or above protocols, or 60 GHz or above protocols module m1220 depicted in FIG. 9B as being included in the module m1214, when executed and/or activated, can direct performance of and/or perform the operation o1220. Illustratively, in one or more implementations, the operation o1220 can be carried out, for example, by receiving (e.g. third reception of cellular transmission, etc.) third information (e.g. statistics, incident data, performance data, topology data, derived and original information, etc.) regarding fourth information (e.g. statistics, incident data, performance data, topology data, derived and original information, etc.) regarding one or more second communication related events (e.g. successful transmissions, unsuccessful transmissions, failed equipment, performance assessment, etc.) occurring directly between two or more second mobile operating system based mobile communication devices (e.g. mobile OS handsets, tablets, phablets, etc.) receiving wireless packetized communication (e.g. IEEE 802.11 packets, cellular packets, etc.) receiving one or more communication network relay related transmissions from one or more second mobile operating system based mobile communication devices as heterogeneous types (e.g. mixtures of laptops, phablets, smartphones, etc.) receiving one or more communication network relay related transmissions (e.g. high definition gaming data being shared between multiple high-end performance mobile computers, etc.) as using protocols including one or more 20 GHz or above protocols, one or more 30 GHz or above protocols, or one or more 60 GHz or above protocols (e.g. Samsung advanced protocol sets, etc.).

In one or more implementations, as shown in FIG. 13D, the operation o1214 can include operation o1221 for receiving one or more communication network relay related transmissions from one or more second mobile operating system based mobile communication devices as heterogeneous types including receiving one or more electronic token identifiers independent from device type of the one or more second mobile operating system based mobile communication devices one or more intermediate electronic communication devices. Origination of a physically tangible component group can be accomplished through skilled in the art design choice selection including use of one or more components and/or subsystems explicitly and/or implicitly referred to herein for at least in part implementing execution of one or more instructions i1221 of the operation o1221, for performance of the operation o1221 by an electrical circuitry arrangement e1221 as activated thereto, and/or otherwise fulfillment of the operation o1221. One or more non-transitory signal bearing physical media can bear the one or more instructions i1221 that when executed can direct performance of the operation o1221. Furthermore, receiving electronic token identifiers independent from device type of second mobile operating system based mobile communication devices intermediate electronic communication devices module m1221 depicted in FIG. 9B as being included in the module m1214, when executed and/or activated, can direct performance of and/or perform the operation o1221. Illustratively, in one or more implementations, the operation o1221 can be carried out, for example, by receiving (e.g. third reception of cellular transmission, etc.) third information (e.g. statistics, incident data, performance data, topology data, derived and original information, etc.) regarding fourth information (e.g. statistics, incident data, performance data, topology data, derived and original information, etc.) regarding one or more second communication related events (e.g. successful transmissions, unsuccessful transmissions, failed equipment, performance assessment, etc.) occurring directly between two or more second mobile operating system based mobile communication devices (e.g. mobile OS handsets, tablets, phablets, etc.) receiving wireless packetized communication (e.g. IEEE 802.11 packets, cellular packets, etc.) receiving one or more communication network relay related transmissions from one or more second mobile operating system based mobile communication devices as heterogeneous types (e.g. mixtures of laptops, phablets, smartphones, etc.) receiving one or more electronic token identifiers (e.g. token identifiers as part of packet header information, etc.) independent from device type (e.g. cell phone versus tablet, etc.) of the one or more second mobile operating system based mobile communication devices one or more intermediate electronic communication devices (e.g. mobile communication devices, etc.).

In one or more implementations, as shown in FIG. 13D, the operation o1214 can include operation o1222 for receiving one or more communication network relay related transmissions from one or more second mobile operating system based mobile communication devices as heterogeneous types including receiving one or more rotating communication beams, one or more alternating communication beams, one or more sweeping communication beams, one or more multiple communication beams, one or more switching communication beams, or one or more diffracted communication beams. Origination of a physically tangible component group can be accomplished through skilled in the art design choice selection including use of one or more components and/or subsystems explicitly and/or implicitly referred to herein for at least in part implementing execution of one or more instructions i1222 of the operation o1222, for performance of the operation o1222 by an electrical circuitry arrangement e1222 as activated thereto, and/or otherwise fulfillment of the operation o1222. One or more non-transitory signal bearing physical media can bear the one or more instructions i1222 that when executed can direct performance of the operation o1222. Furthermore, receiving rotating communication beams, alternating communication beams, sweeping communication beams, multiple communication beams, switching communication beams, or diffracted communication beams module m1222 depicted in FIG. 9B as being included in the module m1214, when executed and/or activated, can direct performance of and/or perform the operation o1222. Illustratively, in one or more implementations, the operation o1222 can be carried out, for example, by receiving (e.g. third reception of cellular transmission, etc.) third information (e.g. statistics, incident data, performance data, topology data, derived and original information, etc.) regarding fourth information (e.g. statistics, incident data, performance data, topology data, derived and original information, etc.) regarding one or more second communication related events (e.g. successful transmissions, unsuccessful transmissions, failed equipment, performance assessment, etc.) occurring directly between two or more second mobile operating system based mobile communication devices (e.g. mobile OS handsets, tablets, phablets, etc.) receiving wireless packetized communication (e.g. IEEE 802.11 packets, cellular packets, etc.) receiving one or more communication network relay related transmissions from one or more second mobile operating system based mobile communication devices as heterogeneous types (e.g. mixtures of laptops, phablets, smartphones, etc.) receiving one or more rotating communication beams (e.g. involving array antenna, etc.), one or more alternating communication beams (e.g. involving switched antennas, etc.), one or more sweeping communication beams (e.g. involving change of phase, etc.), one or more multiple communication beams (e.g. involving mesh antennas, etc.), one or more switching communication beams (e.g. involving switching antennas, etc.), or one or more diffracted communication beams (e.g. involving diffracted transmission, etc.).

In one or more implementations, as shown in FIG. 13E, the operation o1214 can include operation o1223 for receiving one or more communication network relay related transmissions from one or more second mobile operating system based mobile communication devices as heterogeneous types including receiving from one or more multiple antennas, one or more directional antennas, one or more changeable antenna architectures, one or more mesh network antennas, or one or more omnidirectional antennas. Origination of a physically tangible component group can be accomplished through skilled in the art design choice selection including use of one or more components and/or subsystems explicitly and/or implicitly referred to herein for at least in part implementing execution of one or more instructions i1223 of the operation o1223, for performance of the operation o1223 by an electrical circuitry arrangement e1223 as activated thereto, and/or otherwise fulfillment of the operation o1223. One or more non-transitory signal bearing physical media can bear the one or more instructions i1223 that when executed can direct performance of the operation o1223. Furthermore, receiving from multiple antennas, directional antennas, changeable antenna architectures, mesh network antennas, or omnidirectional antennas module m1223 depicted in FIG. 9B as being included in the module m1214, when executed and/or activated, can direct performance of and/or perform the operation o1223. Illustratively, in one or more implementations, the operation o1223 can be carried out, for example, by receiving (e.g. third reception of cellular transmission, etc.) third information (e.g. statistics, incident data, performance data, topology data, derived and original information, etc.) regarding fourth information (e.g. statistics, incident data, performance data, topology data, derived and original information, etc.) regarding one or more second communication related events (e.g. successful transmissions, unsuccessful transmissions, failed equipment, performance assessment, etc.) occurring directly between two or more second mobile operating system based mobile communication devices (e.g. mobile OS handsets, tablets, phablets, etc.) receiving wireless packetized communication (e.g. IEEE 802.11 packets, cellular packets, etc.) receiving one or more communication network relay related transmissions from one or more second mobile operating system based mobile communication devices as heterogeneous types (e.g. mixtures of laptops, phablets, smartphones, etc.) receiving from one or more multiple antennas (e.g. located along perimeter of mobile handset, etc.), one or more directional antennas (e.g. incorporated into laptop, etc.), one or more changeable antenna architectures (e.g. as controlled by mobile OS, etc.), one or more mesh network antennas (e.g. to integrate as a mesh network node, etc.), or one or more omnidirectional antennas (e.g. incorporated into smartphone handset, etc.).

In one or more implementations, as shown in FIG. 13E, the operation o1179 can include operation o1224 for receiving third information regarding fourth information regarding one or more second communication related events occurring directly between two or more second mobile operating system based mobile communication devices including receiving information at least partially contained in one or more second mobile operating system based mobile communication device relayed transmissions. Origination of a physically tangible component group can be accomplished through skilled in the art design choice selection including use of one or more components and/or subsystems explicitly and/or implicitly referred to herein for at least in part implementing execution of one or more instructions i1224 of the operation o1224, for performance of the operation o1224 by an electrical circuitry arrangement e1224 as activated thereto, and/or otherwise fulfillment of the operation o1224. One or more non-transitory signal bearing physical media can bear the one or more instructions i1224 that when executed can direct performance of the operation o1224. Furthermore, receiving information contained in second mobile operating system based mobile communication device relayed transmissions module m1224 depicted in FIG. 9C as being included in the module m1179, when executed and/or activated, can direct performance of and/or perform the operation o1224. Illustratively, in one or more implementations, the operation o1224 can be carried out, for example, by receiving (e.g. third reception of cellular transmission, etc.) third information (e.g. statistics, incident data, performance data, topology data, derived and original information, etc.) regarding fourth information (e.g. statistics, incident data, performance data, topology data, derived and original information, etc.) regarding one or more second communication related events (e.g. successful transmissions, unsuccessful transmissions, failed equipment, performance assessment, etc.) occurring directly between two or more second mobile operating system based mobile communication devices (e.g. mobile OS handsets, tablets, phablets, etc.) receiving information (e.g. data calculation, electronic signal reception, etc.) at least partially contained in one or more second mobile operating system based mobile communication device (e.g. portable computers, etc.) relayed transmissions.

In one or more implementations, as shown in FIG. 13E, the operation o1224 can include operation o1225 for receiving information at least partially contained in one or more second mobile operating system based mobile communication device relayed transmissions including obtaining information regarding one or more obstructed communication paths that one or more second mobile operating system based mobile communication devices have encountered when attempting to communicate with other one or more second mobile operating system based mobile communication devices. Origination of a physically tangible component group can be accomplished through skilled in the art design choice selection including use of one or more components and/or subsystems explicitly and/or implicitly referred to herein for at least in part implementing execution of one or more instructions i1225 of the operation o1225, for performance of the operation o1225 by an electrical circuitry arrangement e1225 as activated thereto, and/or otherwise fulfillment of the operation o1225. One or more non-transitory signal bearing physical media can bear the one or more instructions i1225 that when executed can direct performance of the operation o1225. Furthermore, obtaining information regarding obstructed communication paths that second mobile operating system based mobile communication devices have encountered when attempting to communicate with other second mobile operating system based mobile communication devices module m1225 depicted in FIG. 9C as being included in the module m1224, when executed and/or activated, can direct performance of and/or perform the operation o1225. Illustratively, in one or more implementations, the operation o1225 can be carried out, for example, by receiving (e.g. third reception of cellular transmission, etc.) third information (e.g. statistics, incident data, performance data, topology data, derived and original information, etc.) regarding fourth information (e.g. statistics, incident data, performance data, topology data, derived and original information, etc.) regarding one or more second communication related events (e.g. successful transmissions, unsuccessful transmissions, failed equipment, performance assessment, etc.) occurring directly between two or more second mobile operating system based mobile communication devices (e.g. mobile OS handsets, tablets, phablets, etc.) receiving information (e.g. data calculation, electronic signal reception, etc.) at least partially contained in one or more second mobile operating system based mobile communication device (e.g. portable computers, etc.) relayed transmissions obtaining information (e.g. send query to data base, etc.) regarding one or more obstructed communication paths (e.g. transmission blocked by physical object for more than a predetermined amount of time, etc.) that one or more second mobile operating system based mobile communication devices (e.g. handset, etc.) have encountered (e.g. for 10 minutes, etc.) when attempting to communicate (e.g. in middle of a call, etc.) with other one or more second mobile operating system based mobile communication devices (e.g. iPhone, etc.).

In one or more implementations, as shown in FIG. 13E, the operation o1225 can include operation o1226 for obtaining information regarding one or more obstructed communication paths that one or more second mobile operating system based mobile communication devices have encountered when attempting to communicate with other one or more second mobile operating system based mobile communication devices including receiving location information regarding one or more moveable objects that have previously obstructed communication of one or more of the second mobile operating system based mobile communication devices. Origination of a physically tangible component group can be accomplished through skilled in the art design choice selection including use of one or more components and/or subsystems explicitly and/or implicitly referred to herein for at least in part implementing execution of one or more instructions i1226 of the operation o1226, for performance of the operation o1226 by an electrical circuitry arrangement e1226 as activated thereto, and/or otherwise fulfillment of the operation o1226. One or more non-transitory signal bearing physical media can bear the one or more instructions i1226 that when executed can direct performance of the operation o1226. Furthermore, receiving location information regarding moveable objects that have previously obstructed communication of second mobile operating system based mobile communication devices module m1226 depicted in FIG. 9C as being included in the module m1225, when executed and/or activated, can direct performance of and/or perform the operation o1226. Illustratively, in one or more implementations, the operation o1226 can be carried out, for example, by receiving (e.g. third reception of cellular transmission, etc.) third information (e.g. statistics, incident data, performance data, topology data, derived and original information, etc.) regarding fourth information (e.g. statistics, incident data, performance data, topology data, derived and original information, etc.) regarding one or more second communication related events (e.g. successful transmissions, unsuccessful transmissions, failed equipment, performance assessment, etc.) occurring directly between two or more second mobile operating system based mobile communication devices (e.g. mobile OS handsets, tablets, phablets, etc.) receiving information (e.g. data calculation, electronic signal reception, etc.) at least partially contained in one or more second mobile operating system based mobile communication device (e.g. portable computers, etc.) relayed transmissions obtaining information (e.g. send query to data base, etc.) regarding one or more obstructed communication paths (e.g. transmission blocked by physical object for more than a predetermined amount of time, etc.) that one or more second mobile operating system based mobile communication devices (e.g. handset, etc.) have encountered (e.g. for 10 minutes, etc.) when attempting to communicate (e.g. in middle of a call, etc.) with other one or more second mobile operating system based mobile communication devices (e.g. iPhone, etc.) receiving location information (e.g. relative geographical coordinates, etc.) regarding one or more moveable objects (e.g. industrial construction equipment, etc.) that have previously obstructed communication (e.g. less than a day of obstruction, etc.) of one or more of the second mobile operating system based mobile communication devices (e.g. iPad, etc.).

In one or more implementations, as shown in FIG. 13F, the operation o1225 can include operation o1227 for obtaining information regarding one or more obstructed communication paths that one or more second mobile operating system based mobile communication devices have encountered when attempting to communicate with other one or more second mobile operating system based mobile communication devices including receiving location information regarding one or more fixed position objects that have previously obstructed communication of one or more second mobile operating system based mobile communication devices. Origination of a physically tangible component group can be accomplished through skilled in the art design choice selection including use of one or more components and/or subsystems explicitly and/or implicitly referred to herein for at least in part implementing execution of one or more instructions i1227 of the operation o1227, for performance of the operation o1227 by an electrical circuitry arrangement e1227 as activated thereto, and/or otherwise fulfillment of the operation o1227. One or more non-transitory signal bearing physical media can bear the one or more instructions i1227 that when executed can direct performance of the operation o1227. Furthermore, receiving location information regarding fixed position objects obstructed communication of second mobile operating system based mobile communication devices module m1227 depicted in FIG. 9C as being included in the module m1225, when executed and/or activated, can direct performance of and/or perform the operation o1227. Illustratively, in one or more implementations, the operation o1227 can be carried out, for example, by receiving (e.g. third reception of cellular transmission, etc.) third information (e.g. statistics, incident data, performance data, topology data, derived and original information, etc.) regarding fourth information (e.g. statistics, incident data, performance data, topology data, derived and original information, etc.) regarding one or more second communication related events (e.g. successful transmissions, unsuccessful transmissions, failed equipment, performance assessment, etc.) occurring directly between two or more second mobile operating system based mobile communication devices (e.g. mobile OS handsets, tablets, phablets, etc.) receiving information (e.g. data calculation, electronic signal reception, etc.) at least partially contained in one or more second mobile operating system based mobile communication device (e.g. portable computers, etc.) relayed transmissions obtaining information (e.g. send query to data base, etc.) regarding one or more obstructed communication paths (e.g. transmission blocked by physical object for more than a predetermined amount of time, etc.) that one or more second mobile operating system based mobile communication devices (e.g. handset, etc.) have encountered (e.g. for 10 minutes, etc.) when attempting to communicate (e.g. in middle of a call, etc.) with other one or more second mobile operating system based mobile communication devices (e.g. iPhone, etc.) receiving location information regarding one or more fixed position objects (e.g. hills, trees, etc.) that have previously obstructed communication (e.g. blocked one or more attempted calls for a least a portion of the attempts, etc.) of one or more second mobile operating system based mobile communication devices (e.g. mobile handsets, etc.).

In one or more implementations, as shown in FIG. 13F, the operation o1224 can include operation o1228 for receiving information at least partially contained in one or more second mobile operating system based mobile communication device relayed transmissions including receiving information regarding map data of locations of fixed position objects. Origination of a physically tangible component group can be accomplished through skilled in the art design choice selection including use of one or more components and/or subsystems explicitly and/or implicitly referred to herein for at least in part implementing execution of one or more instructions i1228 of the operation o1228, for performance of the operation o1228 by an electrical circuitry arrangement e1228 as activated thereto, and/or otherwise fulfillment of the operation o1228. One or more non-transitory signal bearing physical media can bear the one or more instructions i1228 that when executed can direct performance of the operation o1228. Furthermore, receiving information regarding map data of locations of fixed position objects module m1228 depicted in FIG. 9C as being included in the module m1224, when executed and/or activated, can direct performance of and/or perform the operation o1228. Illustratively, in one or more implementations, the operation o1228 can be carried out, for example, by receiving (e.g. third reception of cellular transmission, etc.) third information (e.g. statistics, incident data, performance data, topology data, derived and original information, etc.) regarding fourth information (e.g. statistics, incident data, performance data, topology data, derived and original information, etc.) regarding one or more second communication related events (e.g. successful transmissions, unsuccessful transmissions, failed equipment, performance assessment, etc.) occurring directly between two or more second mobile operating system based mobile communication devices (e.g. mobile OS handsets, tablets, phablets, etc.) receiving information (e.g. data calculation, electronic signal reception, etc.) at least partially contained in one or more second mobile operating system based mobile communication device (e.g. portable computers, etc.) relayed transmissions receiving information regarding map data (e.g. Google maps, other web-based map service, map database calls, etc.) of locations of fixed position objects (e.g. roadway signs, etc.).

In one or more implementations, as shown in FIG. 13F, the operation o1224 can include operation o1229 for receiving information at least partially contained in one or more second mobile operating system based mobile communication device relayed transmissions including receiving information regarding one or more time based distributions of instances of obstruction of second mobile operating system based mobile communication device communication for one or more particular geographical locations. Origination of a physically tangible component group can be accomplished through skilled in the art design choice selection including use of one or more components and/or subsystems explicitly and/or implicitly referred to herein for at least in part implementing execution of one or more instructions i1229 of the operation o1229, for performance of the operation o1229 by an electrical circuitry arrangement e1229 as activated thereto, and/or otherwise fulfillment of the operation o1229. One or more non-transitory signal bearing physical media can bear the one or more instructions i1229 that when executed can direct performance of the operation o1229. Furthermore, receiving information regarding time based distributions of instances of obstruction of second mobile operating system based mobile communication device communication for particular geographical locations module m1229 depicted in FIG. 9C as being included in the module m1224, when executed and/or activated, can direct performance of and/or perform the operation o1229. Illustratively, in one or more implementations, the operation o1229 can be carried out, for example, by receiving (e.g. third reception of cellular transmission, etc.) third information (e.g. statistics, incident data, performance data, topology data, derived and original information, etc.) regarding fourth information (e.g. statistics, incident data, performance data, topology data, derived and original information, etc.) regarding one or more second communication related events (e.g. successful transmissions, unsuccessful transmissions, failed equipment, performance assessment, etc.) occurring directly between two or more second mobile operating system based mobile communication devices (e.g. mobile OS handsets, tablets, phablets, etc.) receiving information (e.g. data calculation, electronic signal reception, etc.) at least partially contained in one or more second mobile operating system based mobile communication device (e.g. portable computers, etc.) relayed transmissions receiving information regarding one or more time based distributions of instances of obstruction (e.g. frequency occurrences regarding days of week, holidays, seasonal events, months of year, institutional calendars, etc.) of second mobile operating system based mobile communication device (e.g. cellular, mesh network, etc.) communication for one or more particular geographical locations (e.g. cities, parks, downtowns, buildings, etc.).

In one or more implementations, as shown in FIG. 13F, the operation o1224 can include operation o1230 for receiving information at least partially contained in one or more second mobile operating system based mobile communication device relayed transmissions including receiving information regarding one or more statistical probabilities of remaining in communication with one or more second mobile operating system based mobile communication devices. Origination of a physically tangible component group can be accomplished through skilled in the art design choice selection including use of one or more components and/or subsystems explicitly and/or implicitly referred to herein for at least in part implementing execution of one or more instructions i1230 of the operation o1230, for performance of the operation o1230 by an electrical circuitry arrangement e1230 as activated thereto, and/or otherwise fulfillment of the operation o1230. One or more non-transitory signal bearing physical media can bear the one or more instructions i1230 that when executed can direct performance of the operation o1230. Furthermore, receiving information regarding statistical probabilities of remaining in communication with second mobile operating system based mobile communication devices module m1230 depicted in FIG. 9C as being included in the module m1224, when executed and/or activated, can direct performance of and/or perform the operation o1230. Illustratively, in one or more implementations, the operation o1230 can be carried out, for example, by receiving (e.g. third reception of cellular transmission, etc.) third information (e.g. statistics, incident data, performance data, topology data, derived and original information, etc.) regarding fourth information (e.g. statistics, incident data, performance data, topology data, derived and original information, etc.) regarding one or more second communication related events (e.g. successful transmissions, unsuccessful transmissions, failed equipment, performance assessment, etc.) occurring directly between two or more second mobile operating system based mobile communication devices (e.g. mobile OS handsets, tablets, phablets, etc.) receiving information (e.g. data calculation, electronic signal reception, etc.) at least partially contained in one or more second mobile operating system based mobile communication device (e.g. portable computers, etc.) relayed transmissions receiving information regarding one or more statistical probabilities (e.g. Gaussian distribution, manual surveys, user surveys, automated surveys, etc.) of remaining in communication (e.g. call not dropped, data transmission complete, no delays in transmission, etc.) with one or more second mobile operating system based mobile communication devices (e.g. handset, etc.).

In one or more implementations, as shown in FIG. 13G, the operation o1224 can include operation o1231 for receiving information at least partially contained in one or more second mobile operating system based mobile communication device relayed transmissions including receiving GPS positioning data regarding the one or more second mobile operating system based mobile communication devices. Origination of a physically tangible component group can be accomplished through skilled in the art design choice selection including use of one or more components and/or subsystems explicitly and/or implicitly referred to herein for at least in part implementing execution of one or more instructions i1231 of the operation o1231, for performance of the operation o1231 by an electrical circuitry arrangement e1231 as activated thereto, and/or otherwise fulfillment of the operation o1231. One or more non-transitory signal bearing physical media can bear the one or more instructions i1231 that when executed can direct performance of the operation o1231. Furthermore, receiving GPS positioning data regarding second mobile operating system based mobile communication devices module m1231 depicted in FIG. 9C as being included in the module m1224, when executed and/or activated, can direct performance of and/or perform the operation o1231. Illustratively, in one or more implementations, the operation o1231 can be carried out, for example, by receiving (e.g. third reception of cellular transmission, etc.) third information (e.g. statistics, incident data, performance data, topology data, derived and original information, etc.) regarding fourth information (e.g. statistics, incident data, performance data, topology data, derived and original information, etc.) regarding one or more second communication related events (e.g. successful transmissions, unsuccessful transmissions, failed equipment, performance assessment, etc.) occurring directly between two or more second mobile operating system based mobile communication devices (e.g. mobile OS handsets, tablets, phablets, etc.) receiving information (e.g. data calculation, electronic signal reception, etc.) at least partially contained in one or more second mobile operating system based mobile communication device (e.g. portable computers, etc.) relayed transmissions receiving GPS positioning data (e.g. global positioning system satellite data, chipset information, data base inquiry, etc.) regarding the one or more second mobile operating system based mobile communication devices (e.g. phablet, etc.).

In one or more implementations, as shown in FIG. 13G, the operation o1224 can include operation o1232 for receiving information at least partially contained in one or more second mobile operating system based mobile communication device relayed transmissions including receiving information associated with communication histories of one or more other electronic communication devices communicating with the one or more intermediate electronic communication devices. Origination of a physically tangible component group can be accomplished through skilled in the art design choice selection including use of one or more components and/or subsystems explicitly and/or implicitly referred to herein for at least in part implementing execution of one or more instructions i1232 of the operation o1232, for performance of the operation o1232 by an electrical circuitry arrangement e1232 as activated thereto, and/or otherwise fulfillment of the operation o1232. One or more non-transitory signal bearing physical media can bear the one or more instructions i1232 that when executed can direct performance of the operation o1232. Furthermore, receiving information associated communication histories of other electronic communication devices communicating with intermediate electronic communication devices module m1232 depicted in FIG. 9C as being included in the module m1224, when executed and/or activated, can direct performance of and/or perform the operation o1232. Illustratively, in one or more implementations, the operation o1232 can be carried out, for example, by receiving (e.g. third reception of cellular transmission, etc.) third information (e.g. statistics, incident data, performance data, topology data, derived and original information, etc.) regarding fourth information (e.g. statistics, incident data, performance data, topology data, derived and original information, etc.) regarding one or more second communication related events (e.g. successful transmissions, unsuccessful transmissions, failed equipment, performance assessment, etc.) occurring directly between two or more second mobile operating system based mobile communication devices (e.g. mobile OS handsets, tablets, phablets, etc.) receiving information (e.g. data calculation, electronic signal reception, etc.) at least partially contained in one or more second mobile operating system based mobile communication device (e.g. portable computers, etc.) relayed transmissions receiving information associated with communication histories (e.g. data base records of call duration, time of call, call locations, associated transmission issues, network systems used, etc.) of one or more other electronic communication devices (e.g. mobile cellular communication devices, etc.) communicating with the one or more intermediate electronic communication devices (e.g. mobile communication computer devices, etc.).

In one or more implementations, as shown in FIG. 13G, the operation o1232 can include operation o1233 for receiving information associated with communication histories of one or more other electronic communication devices communicating with the one or more intermediate electronic communication devices including receiving information as positioning data for one or more second mobile operating system based mobile communication devices. Origination of a physically tangible component group can be accomplished through skilled in the art design choice selection including use of one or more components and/or subsystems explicitly and/or implicitly referred to herein for at least in part implementing execution of one or more instructions i1233 of the operation o1233, for performance of the operation o1233 by an electrical circuitry arrangement e1233 as activated thereto, and/or otherwise fulfillment of the operation o1233. One or more non-transitory signal bearing physical media can bear the one or more instructions i1233 that when executed can direct performance of the operation o1233. Furthermore, receiving information as positioning data for second mobile operating system based mobile communication devices module m1233 depicted in FIG. 9C as being included in the module m1232, when executed and/or activated, can direct performance of and/or perform the operation o1233. Illustratively, in one or more implementations, the operation o1233 can be carried out, for example, by receiving (e.g. third reception of cellular transmission, etc.) third information (e.g. statistics, incident data, performance data, topology data, derived and original information, etc.) regarding fourth information (e.g. statistics, incident data, performance data, topology data, derived and original information, etc.) regarding one or more second communication related events (e.g. successful transmissions, unsuccessful transmissions, failed equipment, performance assessment, etc.) occurring directly between two or more second mobile operating system based mobile communication devices (e.g. mobile OS handsets, tablets, phablets, etc.) receiving information (e.g. data calculation, electronic signal reception, etc.) at least partially contained in one or more second mobile operating system based mobile communication device (e.g. portable computers, etc.) relayed transmissions receiving information associated with communication histories (e.g. data base records of call duration, time of call, call locations, associated transmission issues, network systems used, etc.) of one or more other electronic communication devices (e.g. mobile cellular communication devices, etc.) communicating with the one or more intermediate electronic communication devices (e.g. mobile communication computer devices, etc.) receiving information as positioning data (e.g. data describing location in relation to fixed objects, data describing location in relation to fixed base stations, data describing location in relation to environmental interference such as water falls, etc.) for one or more second mobile operating system based mobile communication devices (e.g. smartphones, etc.).

In one or more implementations, as shown in FIG. 13G, the operation o1232 can include operation o1234 for receiving information associated with communication histories of one or more other electronic communication devices communicating with the one or more intermediate electronic communication devices including receiving information as communication history data previously stored and forwarded between two or more second mobile operating system based mobile communication devices. Origination of a physically tangible component group can be accomplished through skilled in the art design choice selection including use of one or more components and/or subsystems explicitly and/or implicitly referred to herein for at least in part implementing execution of one or more instructions i1234 of the operation o1234, for performance of the operation o1234 by an electrical circuitry arrangement e1234 as activated thereto, and/or otherwise fulfillment of the operation o1234. One or more non-transitory signal bearing physical media can bear the one or more instructions i1234 that when executed can direct performance of the operation o1234. Furthermore, receiving information as communication history data previously stored and forwarded between second mobile operating system based mobile communication devices module m1234 depicted in FIG. 9D as being included in the module m1232, when executed and/or activated, can direct performance of and/or perform the operation o1234. Illustratively, in one or more implementations, the operation o1234 can be carried out, for example, by receiving (e.g. third reception of cellular transmission, etc.) third information (e.g. statistics, incident data, performance data, topology data, derived and original information, etc.) regarding fourth information (e.g. statistics, incident data, performance data, topology data, derived and original information, etc.) regarding one or more second communication related events (e.g. successful transmissions, unsuccessful transmissions, failed equipment, performance assessment, etc.) occurring directly between two or more second mobile operating system based mobile communication devices (e.g. mobile OS handsets, tablets, phablets, etc.) receiving information (e.g. data calculation, electronic signal reception, etc.) at least partially contained in one or more second mobile operating system based mobile communication device (e.g. portable computers, etc.) relayed transmissions receiving information associated with communication histories (e.g. data base records of call duration, time of call, call locations, associated transmission issues, network systems used, etc.) of one or more other electronic communication devices (e.g. mobile cellular communication devices, etc.) communicating with the one or more intermediate electronic communication devices (e.g. mobile communication computer devices, etc.) receiving information as communication history data (e.g. successful communication versus communication problems with maintaining communication links, transmission dropout, degradation of transmission speed, etc.) previously stored and forwarded (e.g. temporarily held in device memory and then retransmitted, etc.) between two or more second mobile operating system based mobile communication devices (e.g. handheld computers, etc.).

In one or more implementations, as shown in FIG. 13G, the operation o1224 can include operation o1235 for receiving information at least partially contained in one or more second mobile operating system based mobile communication device relayed transmissions including receiving information regarding one or more potential obstructions to electronic communication located proximate to one or more of the second mobile operating system based mobile communication devices. Origination of a physically tangible component group can be accomplished through skilled in the art design choice selection including use of one or more components and/or subsystems explicitly and/or implicitly referred to herein for at least in part implementing execution of one or more instructions i1235 of the operation o1235, for performance of the operation o1235 by an electrical circuitry arrangement e1235 as activated thereto, and/or otherwise fulfillment of the operation o1235. One or more non-transitory signal bearing physical media can bear the one or more instructions i1235 that when executed can direct performance of the operation o1235. Furthermore, receiving information regarding potential obstructions to electronic communication located proximate to of second mobile operating system based mobile communication devices module m1235 depicted in FIG. 9D as being included in the module m1224, when executed and/or activated, can direct performance of and/or perform the operation o1235. Illustratively, in one or more implementations, the operation o1235 can be carried out, for example, by receiving (e.g. third reception of cellular transmission, etc.) third information (e.g. statistics, incident data, performance data, topology data, derived and original information, etc.) regarding fourth information (e.g. statistics, incident data, performance data, topology data, derived and original information, etc.) regarding one or more second communication related events (e.g. successful transmissions, unsuccessful transmissions, failed equipment, performance assessment, etc.) occurring directly between two or more second mobile operating system based mobile communication devices (e.g. mobile OS handsets, tablets, phablets, etc.) receiving information (e.g. data calculation, electronic signal reception, etc.) at least partially contained in one or more second mobile operating system based mobile communication device (e.g. portable computers, etc.) relayed transmissions receiving information regarding one or more potential obstructions (e.g. thunderstorm cells, etc.) to electronic communication (e.g. above 50 GHz, etc.) located proximate (e.g. within one mile, etc.) to one or more of the second mobile operating system based mobile communication devices (e.g. tablet computers, etc.).

In one or more implementations, as shown in FIG. 13H, the operation o1235 can include operation o1236 for receiving information regarding one or more potential obstructions to electronic communication located proximate to one or more of the second mobile operating system based mobile communication devices including receiving information regarding one or more moveable communication obstructions. Origination of a physically tangible component group can be accomplished through skilled in the art design choice selection including use of one or more components and/or subsystems explicitly and/or implicitly referred to herein for at least in part implementing execution of one or more instructions i1236 of the operation o1236, for performance of the operation o1236 by an electrical circuitry arrangement e1236 as activated thereto, and/or otherwise fulfillment of the operation o1236. One or more non-transitory signal bearing physical media can bear the one or more instructions i1236 that when executed can direct performance of the operation o1236. Furthermore, receiving information regarding moveable communication obstructions module m1236 depicted in FIG. 9D as being included in the module m1235, when executed and/or activated, can direct performance of and/or perform the operation o1236. Illustratively, in one or more implementations, the operation o1236 can be carried out, for example, by receiving (e.g. third reception of cellular transmission, etc.) third information (e.g. statistics, incident data, performance data, topology data, derived and original information, etc.) regarding fourth information (e.g. statistics, incident data, performance data, topology data, derived and original information, etc.) regarding one or more second communication related events (e.g. successful transmissions, unsuccessful transmissions, failed equipment, performance assessment, etc.) occurring directly between two or more second mobile operating system based mobile communication devices (e.g. mobile OS handsets, tablets, phablets, etc.) receiving information (e.g. data calculation, electronic signal reception, etc.) at least partially contained in one or more second mobile operating system based mobile communication device (e.g. portable computers, etc.) relayed transmissions receiving information regarding one or more potential obstructions (e.g. thunderstorm cells, etc.) to electronic communication (e.g. above 50 GHz, etc.) located proximate (e.g. within one mile, etc.) to one or more of the second mobile operating system based mobile communication devices (e.g. tablet computers, etc.) receiving information regarding one or more moveable communication obstructions (e.g. ship container traffic in relation to ferry traffic, etc.).

In one or more implementations, as shown in FIG. 13H, the operation o1236 can include operation o1237 for receiving information regarding one or more moveable communication obstructions including receiving information regarding one or more moveable communication obstructions as one or more pedestrians. Origination of a physically tangible component group can be accomplished through skilled in the art design choice selection including use of one or more components and/or subsystems explicitly and/or implicitly referred to herein for at least in part implementing execution of one or more instructions i1237 of the operation o1237, for performance of the operation o1237 by an electrical circuitry arrangement e1237 as activated thereto, and/or otherwise fulfillment of the operation o1237. One or more non-transitory signal bearing physical media can bear the one or more instructions i1237 that when executed can direct performance of the operation o1237. Furthermore, receiving information regarding moveable communication obstructions as pedestrians module m1237 depicted in FIG. 9D as being included in the module m1236, when executed and/or activated, can direct performance of and/or perform the operation o1237. Illustratively, in one or more implementations, the operation o1237 can be carried out, for example, by receiving (e.g. third reception of cellular transmission, etc.) third information (e.g. statistics, incident data, performance data, topology data, derived and original information, etc.) regarding fourth information (e.g. statistics, incident data, performance data, topology data, derived and original information, etc.) regarding one or more second communication related events (e.g. successful transmissions, unsuccessful transmissions, failed equipment, performance assessment, etc.) occurring directly between two or more second mobile operating system based mobile communication devices (e.g. mobile OS handsets, tablets, phablets, etc.) receiving information (e.g. data calculation, electronic signal reception, etc.) at least partially contained in one or more second mobile operating system based mobile communication device (e.g. portable computers, etc.) relayed transmissions receiving information regarding one or more potential obstructions (e.g. thunderstorm cells, etc.) to electronic communication (e.g. above 50 GHz, etc.) located proximate (e.g. within one mile, etc.) to one or more of the second mobile operating system based mobile communication devices (e.g. tablet computers, etc.) receiving information regarding one or more moveable communication obstructions (e.g. ship container traffic in relation to ferry traffic, etc.) receiving information regarding one or more moveable communication obstructions as one or more pedestrians (e.g. pedestrians on the ship containers or ferry traffic, pedestrians having health issues regarding high frequency electronic communications, etc.).

In one or more implementations, as shown in FIG. 13H, the operation o1235 can include operation o1238 for receiving information regarding one or more potential obstructions to electronic communication located proximate to one or more of the second mobile operating system based mobile communication devices including receiving information regarding one or more potential obstructions to electronic communication as one or more architectural structures. Origination of a physically tangible component group can be accomplished through skilled in the art design choice selection including use of one or more components and/or subsystems explicitly and/or implicitly referred to herein for at least in part implementing execution of one or more instructions i1238 of the operation o1238, for performance of the operation o1238 by an electrical circuitry arrangement e1238 as activated thereto, and/or otherwise fulfillment of the operation o1238. One or more non-transitory signal bearing physical media can bear the one or more instructions i1238 that when executed can direct performance of the operation o1238. Furthermore, receiving information regarding potential obstructions to electronic communication as architectural structures module m1238 depicted in FIG. 9D as being included in the module m1235, when executed and/or activated, can direct performance of and/or perform the operation o1238. Illustratively, in one or more implementations, the operation o1238 can be carried out, for example, by receiving (e.g. third reception of cellular transmission, etc.) third information (e.g. statistics, incident data, performance data, topology data, derived and original information, etc.) regarding fourth information (e.g. statistics, incident data, performance data, topology data, derived and original information, etc.) regarding one or more second communication related events (e.g. successful transmissions, unsuccessful transmissions, failed equipment, performance assessment, etc.) occurring directly between two or more second mobile operating system based mobile communication devices (e.g. mobile OS handsets, tablets, phablets, etc.) receiving information (e.g. data calculation, electronic signal reception, etc.) at least partially contained in one or more second mobile operating system based mobile communication device (e.g. portable computers, etc.) relayed transmissions receiving information regarding one or more potential obstructions (e.g. thunderstorm cells, etc.) to electronic communication (e.g. above 50 GHz, etc.) located proximate (e.g. within one mile, etc.) to one or more of the second mobile operating system based mobile communication devices (e.g. tablet computers, etc.) receiving information regarding one or more potential obstructions (e.g. 50% percent probability of greater than 5% of a period of time that communication is blocked, etc.) to electronic communication as one or more architectural structures (e.g. warehouses, airport centers, etc.).

In one or more implementations, as shown in FIG. 13H, the operation o1224 can include operation o1239 for receiving information at least partially contained in one or more second mobile operating system based mobile communication device relayed transmissions including receiving information regarding communication capacity available to one or more of standby communication relays furnished by one or more second mobile operating system based mobile communication devices. Origination of a physically tangible component group can be accomplished through skilled in the art design choice selection including use of one or more components and/or subsystems explicitly and/or implicitly referred to herein for at least in part implementing execution of one or more instructions i1239 of the operation o1239, for performance of the operation o1239 by an electrical circuitry arrangement e1239 as activated thereto, and/or otherwise fulfillment of the operation o1239. One or more non-transitory signal bearing physical media can bear the one or more instructions i1239 that when executed can direct performance of the operation o1239. Furthermore, receiving information regarding communication capacity available to of standby communication relays furnished by second mobile operating system based mobile communication devices module m1239 depicted in FIG. 9D as being included in the module m1224, when executed and/or activated, can direct performance of and/or perform the operation o1239. Illustratively, in one or more implementations, the operation o1239 can be carried out, for example, by receiving (e.g. third reception of cellular transmission, etc.) third information (e.g. statistics, incident data, performance data, topology data, derived and original information, etc.) regarding fourth information (e.g. statistics, incident data, performance data, topology data, derived and original information, etc.) regarding one or more second communication related events (e.g. successful transmissions, unsuccessful transmissions, failed equipment, performance assessment, etc.) occurring directly between two or more second mobile operating system based mobile communication devices (e.g. mobile OS handsets, tablets, phablets, etc.) receiving information (e.g. data calculation, electronic signal reception, etc.) at least partially contained in one or more second mobile operating system based mobile communication device (e.g. portable computers, etc.) relayed transmissions receiving information regarding communication capacity (e.g. gigabit per second rates, etc.) available (e.g. end-users of intermediate electronic communication devices have signed up to have their devices provide standby service, etc.) to one or more of standby communication relays (e.g. relays can have one or more intermediate devices and can share one or more intermediate devices, etc.) furnished by one or more second mobile operating system based mobile communication devices (e.g. mobile communication devices, etc.).

In one or more implementations, as shown in FIG. 13J, the operation o1239 can include operation o1240 for receiving information regarding communication capacity available to one or more of standby communication relays furnished by one or more second mobile operating system based mobile communication devices including receiving information regarding communication bandwidth available to one or more of standby communication relays furnished by one or more second mobile operating system based mobile communication devices. Origination of a physically tangible component group can be accomplished through skilled in the art design choice selection including use of one or more components and/or subsystems explicitly and/or implicitly referred to herein for at least in part implementing execution of one or more instructions i1240 of the operation o1240, for performance of the operation o1240 by an electrical circuitry arrangement e1240 as activated thereto, and/or otherwise fulfillment of the operation o1240. One or more non-transitory signal bearing physical media can bear the one or more instructions i1240 that when executed can direct performance of the operation o1240. Furthermore, receiving information regarding communication bandwidth available to of standby communication relays furnished by second mobile operating system based mobile communication devices module m1240 depicted in FIG. 9D as being included in the module m1239, when executed and/or activated, can direct performance of and/or perform the operation o1240. Illustratively, in one or more implementations, the operation o1240 can be carried out, for example, by receiving (e.g. third reception of cellular transmission, etc.) third information (e.g. statistics, incident data, performance data, topology data, derived and original information, etc.) regarding fourth information (e.g. statistics, incident data, performance data, topology data, derived and original information, etc.) regarding one or more second communication related events (e.g. successful transmissions, unsuccessful transmissions, failed equipment, performance assessment, etc.) occurring directly between two or more second mobile operating system based mobile communication devices (e.g. mobile OS handsets, tablets, phablets, etc.) receiving information (e.g. data calculation, electronic signal reception, etc.) at least partially contained in one or more second mobile operating system based mobile communication device (e.g. portable computers, etc.) relayed transmissions receiving information regarding communication capacity (e.g. gigabit per second rates, etc.) available (e.g. end-users of intermediate electronic communication devices have signed up to have their devices provide standby service, etc.) to one or more of standby communication relays (e.g. relays can have one or more intermediate devices and can share one or more intermediate devices, etc.) furnished by one or more second mobile operating system based mobile communication devices (e.g. mobile communication devices, etc.) receiving information regarding communication bandwidth available (e.g. bit per second rates maximum or sustained, etc.) to one or more of standby communication relays (e.g. available for immediate activation, etc.) furnished by one or more second mobile operating system based mobile communication devices (e.g. laptops, etc.).

In one or more implementations, as shown in FIG. 13J, the operation o1240 can include operation o1241 for receiving information regarding communication bandwidth available to one or more of standby communication relays furnished by one or more second mobile operating system based mobile communication devices including receiving information regarding runtime duration available to one or more of standby communication relays furnished by one or more second mobile operating system based mobile communication devices. Origination of a physically tangible component group can be accomplished through skilled in the art design choice selection including use of one or more components and/or subsystems explicitly and/or implicitly referred to herein for at least in part implementing execution of one or more instructions i1241 of the operation o1241, for performance of the operation o1241 by an electrical circuitry arrangement e1241 as activated thereto, and/or otherwise fulfillment of the operation o1241. One or more non-transitory signal bearing physical media can bear the one or more instructions i1241 that when executed can direct performance of the operation o1241. Furthermore, receiving information regarding runtime duration available to of standby communication relays furnished by second mobile operating system based mobile communication devices module m1241 depicted in FIG. 9D as being included in the module m1240, when executed and/or activated, can direct performance of and/or perform the operation o1241. Illustratively, in one or more implementations, the operation o1241 can be carried out, for example, by receiving (e.g. third reception of cellular transmission, etc.) third information (e.g. statistics, incident data, performance data, topology data, derived and original information, etc.) regarding fourth information (e.g. statistics, incident data, performance data, topology data, derived and original information, etc.) regarding one or more second communication related events (e.g. successful transmissions, unsuccessful transmissions, failed equipment, performance assessment, etc.) occurring directly between two or more second mobile operating system based mobile communication devices (e.g. mobile OS handsets, tablets, phablets, etc.) receiving information (e.g. data calculation, electronic signal reception, etc.) at least partially contained in one or more second mobile operating system based mobile communication device (e.g. portable computers, etc.) relayed transmissions receiving information regarding communication capacity (e.g. gigabit per second rates, etc.) available (e.g. end-users of intermediate electronic communication devices have signed up to have their devices provide standby service, etc.) to one or more of standby communication relays (e.g. relays can have one or more intermediate devices and can share one or more intermediate devices, etc.) furnished by one or more second mobile operating system based mobile communication devices (e.g. mobile communication devices, etc.) receiving information regarding communication bandwidth available (e.g. bit per second rates maximum or sustained, etc.) to one or more of standby communication relays (e.g. available for immediate activation, etc.) furnished by one or more second mobile operating system based mobile communication devices (e.g. laptops, etc.) receiving information regarding runtime duration (e.g. length of time a call can be maintained, etc.) available to one or more of standby communication relays (e.g. available as contingency backup for standby network, etc.) furnished by one or more second mobile operating system based mobile communication devices (e.g. mobile communication devices, etc.).

In one or more implementations, as shown in FIG. 13J, the operation o1241 can include operation o1242 for receiving information regarding runtime duration available to one or more of standby communication relays furnished by one or more second mobile operating system based mobile communication devices including receiving information regarding runtime duration available regarding battery level available to one or more one or more second mobile operating system based mobile communication devices. Origination of a physically tangible component group can be accomplished through skilled in the art design choice selection including use of one or more components and/or subsystems explicitly and/or implicitly referred to herein for at least in part implementing execution of one or more instructions i1242 of the operation o1242, for performance of the operation o1242 by an electrical circuitry arrangement e1242 as activated thereto, and/or otherwise fulfillment of the operation o1242. One or more non-transitory signal bearing physical media can bear the one or more instructions i1242 that when executed can direct performance of the operation o1242. Furthermore, receiving information regarding runtime duration available regarding battery level available to second mobile operating system based mobile communication devices module m1242 depicted in FIG. 9D as being included in the module m1241, when executed and/or activated, can direct performance of and/or perform the operation o1242. Illustratively, in one or more implementations, the operation o1242 can be carried out, for example, by receiving (e.g. third reception of cellular transmission, etc.) third information (e.g. statistics, incident data, performance data, topology data, derived and original information, etc.) regarding fourth information (e.g. statistics, incident data, performance data, topology data, derived and original information, etc.) regarding one or more second communication related events (e.g. successful transmissions, unsuccessful transmissions, failed equipment, performance assessment, etc.) occurring directly between two or more second mobile operating system based mobile communication devices (e.g. mobile OS handsets, tablets, phablets, etc.) receiving information (e.g. data calculation, electronic signal reception, etc.) at least partially contained in one or more second mobile operating system based mobile communication device (e.g. portable computers, etc.) relayed transmissions receiving information regarding communication capacity (e.g. gigabit per second rates, etc.) available (e.g. end-users of intermediate electronic communication devices have signed up to have their devices provide standby service, etc.) to one or more of standby communication relays (e.g. relays can have one or more intermediate devices and can share one or more intermediate devices, etc.) furnished by one or more second mobile operating system based mobile communication devices (e.g. mobile communication devices, etc.) receiving information regarding communication bandwidth available (e.g. bit per second rates maximum or sustained, etc.) to one or more of standby communication relays (e.g. available for immediate activation, etc.) furnished by one or more second mobile operating system based mobile communication devices (e.g. laptops, etc.) receiving information regarding runtime duration (e.g. length of time a call can be maintained, etc.) available to one or more of standby communication relays (e.g. available as contingency backup for standby network, etc.) furnished by one or more second mobile operating system based mobile communication devices (e.g. mobile communication devices, etc.) receiving information regarding runtime duration available regarding battery level (e.g. hours remaining, percentage power level above a minimum threshold, etc.) available to one or more one or more second mobile operating system based mobile communication devices (e.g. smartphones, etc.).

In one or more implementations, as shown in FIG. 13J, the operation o1241 can include operation o1243 for receiving information regarding runtime duration available to one or more of standby communication relays furnished by one or more second mobile operating system based mobile communication devices including receiving information regarding runtime duration available regarding predetermined commitments by users of one or more second mobile operating system based mobile communication devices. Origination of a physically tangible component group can be accomplished through skilled in the art design choice selection including use of one or more components and/or subsystems explicitly and/or implicitly referred to herein for at least in part implementing execution of one or more instructions i1243 of the operation o1243, for performance of the operation o1243 by an electrical circuitry arrangement e1243 as activated thereto, and/or otherwise fulfillment of the operation o1243. One or more non-transitory signal bearing physical media can bear the one or more instructions i1243 that when executed can direct performance of the operation o1243. Furthermore, receiving information regarding runtime duration available regarding predetermined commitments by users of second mobile operating system based mobile communication devices module m1243 depicted in FIG. 9E as being included in the module m1241, when executed and/or activated, can direct performance of and/or perform the operation o1243. Illustratively, in one or more implementations, the operation o1243 can be carried out, for example, by receiving (e.g. third reception of cellular transmission, etc.) third information (e.g. statistics, incident data, performance data, topology data, derived and original information, etc.) regarding fourth information (e.g. statistics, incident data, performance data, topology data, derived and original information, etc.) regarding one or more second communication related events (e.g. successful transmissions, unsuccessful transmissions, failed equipment, performance assessment, etc.) occurring directly between two or more second mobile operating system based mobile communication devices (e.g. mobile OS handsets, tablets, phablets, etc.) receiving information (e.g. data calculation, electronic signal reception, etc.) at least partially contained in one or more second mobile operating system based mobile communication device (e.g. portable computers, etc.) relayed transmissions receiving information regarding communication capacity (e.g. gigabit per second rates, etc.) available (e.g. end-users of intermediate electronic communication devices have signed up to have their devices provide standby service, etc.) to one or more of standby communication relays (e.g. relays can have one or more intermediate devices and can share one or more intermediate devices, etc.) furnished by one or more second mobile operating system based mobile communication devices (e.g. mobile communication devices, etc.) receiving information regarding communication bandwidth available (e.g. bit per second rates maximum or sustained, etc.) to one or more of standby communication relays (e.g. available for immediate activation, etc.) furnished by one or more second mobile operating system based mobile communication devices (e.g. laptops, etc.) receiving information regarding runtime duration (e.g. length of time a call can be maintained, etc.) available to one or more of standby communication relays (e.g. available as contingency backup for standby network, etc.) furnished by one or more second mobile operating system based mobile communication devices (e.g. mobile communication devices, etc.) receiving information regarding runtime duration available regarding predetermined commitments by users (e.g. number of standby communication networks a device is committed to support, etc.) of one or more second mobile operating system based mobile communication devices (e.g. phablets, etc.).

In one or more implementations, as shown in FIG. 13K, the operation o1241 can include operation o1244 for receiving information regarding runtime duration available to one or more of standby communication relays furnished by one or more second mobile operating system based mobile communication devices including receiving information regarding runtime duration available regarding potential obstructed communication paths of one or more second mobile operating system based mobile communication devices. Origination of a physically tangible component group can be accomplished through skilled in the art design choice selection including use of one or more components and/or subsystems explicitly and/or implicitly referred to herein for at least in part implementing execution of one or more instructions i1244 of the operation o1244, for performance of the operation o1244 by an electrical circuitry arrangement e1244 as activated thereto, and/or otherwise fulfillment of the operation o1244. One or more non-transitory signal bearing physical media can bear the one or more instructions i1244 that when executed can direct performance of the operation o1244. Furthermore, receiving information regarding runtime duration available regarding potential obstructed communication paths of second mobile operating system based mobile communication devices module m1244 depicted in FIG. 9E as being included in the module m1241, when executed and/or activated, can direct performance of and/or perform the operation o1244. Illustratively, in one or more implementations, the operation o1244 can be carried out, for example, by receiving (e.g. third reception of cellular transmission, etc.) third information (e.g. statistics, incident data, performance data, topology data, derived and original information, etc.) regarding fourth information (e.g. statistics, incident data, performance data, topology data, derived and original information, etc.) regarding one or more second communication related events (e.g. successful transmissions, unsuccessful transmissions, failed equipment, performance assessment, etc.) occurring directly between two or more second mobile operating system based mobile communication devices (e.g. mobile OS handsets, tablets, phablets, etc.) receiving information (e.g. data calculation, electronic signal reception, etc.) at least partially contained in one or more second mobile operating system based mobile communication device (e.g. portable computers, etc.) relayed transmissions receiving information regarding communication capacity (e.g. gigabit per second rates, etc.) available (e.g. end-users of intermediate electronic communication devices have signed up to have their devices provide standby service, etc.) to one or more of standby communication relays (e.g. relays can have one or more intermediate devices and can share one or more intermediate devices, etc.) furnished by one or more second mobile operating system based mobile communication devices (e.g. mobile communication devices, etc.) receiving information regarding communication bandwidth available (e.g. bit per second rates maximum or sustained, etc.) to one or more of standby communication relays (e.g. available for immediate activation, etc.) furnished by one or more second mobile operating system based mobile communication devices (e.g. laptops, etc.) receiving information regarding runtime duration (e.g. length of time a call can be maintained, etc.) available to one or more of standby communication relays (e.g. available as contingency backup for standby network, etc.) furnished by one or more second mobile operating system based mobile communication devices (e.g. mobile communication devices, etc.) receiving information regarding runtime duration available regarding potential obstructed communication paths (e.g. based on location or projected path of intermediate device, etc.) of one or more second mobile operating system based mobile communication devices (e.g. laptops, etc.).

In one or more implementations, as shown in FIG. 13K, the operation o1224 can include operation o1245 for receiving information at least partially contained in one or more second mobile operating system based mobile communication device relayed transmissions including receiving information regarding quality of service of communication available to one or more standby communication network relay as furnished by one or more second mobile operating system based mobile communication devices. Origination of a physically tangible component group can be accomplished through skilled in the art design choice selection including use of one or more components and/or subsystems explicitly and/or implicitly referred to herein for at least in part implementing execution of one or more instructions i1245 of the operation o1245, for performance of the operation o1245 by an electrical circuitry arrangement e1245 as activated thereto, and/or otherwise fulfillment of the operation o1245. One or more non-transitory signal bearing physical media can bear the one or more instructions i1245 that when executed can direct performance of the operation o1245. Furthermore, receiving information regarding quality of service of communication available to standby communication network relay as furnished by second mobile operating system based mobile communication devices module m1245 depicted in FIG. 9E as being included in the module m1224, when executed and/or activated, can direct performance of and/or perform the operation o1245. Illustratively, in one or more implementations, the operation o1245 can be carried out, for example, by receiving (e.g. third reception of cellular transmission, etc.) third information (e.g. statistics, incident data, performance data, topology data, derived and original information, etc.) regarding fourth information (e.g. statistics, incident data, performance data, topology data, derived and original information, etc.) regarding one or more second communication related events (e.g. successful transmissions, unsuccessful transmissions, failed equipment, performance assessment, etc.) occurring directly between two or more second mobile operating system based mobile communication devices (e.g. mobile OS handsets, tablets, phablets, etc.) receiving information (e.g. data calculation, electronic signal reception, etc.) at least partially contained in one or more second mobile operating system based mobile communication device (e.g. portable computers, etc.) relayed transmissions receiving information regarding quality of service of communication available (e.g. regularly sustained high definition service, etc.) to one or more standby communication network relay (e.g. standby for immediate cutover if base station is occluded to origination device, etc.) as furnished by one or more second mobile operating system based mobile communication devices (e.g. handsets, etc.).

In one or more implementations, as shown in FIG. 13K, the operation o1224 can include operation o1246 for receiving information at least partially contained in one or more second mobile operating system based mobile communication device relayed transmissions including receiving information regarding one or more economic cost structures to be imposed associated with one or more standby communication relays furnished by one or more second mobile operating system based mobile communication devices. Origination of a physically tangible component group can be accomplished through skilled in the art design choice selection including use of one or more components and/or subsystems explicitly and/or implicitly referred to herein for at least in part implementing execution of one or more instructions i1246 of the operation o1246, for performance of the operation o1246 by an electrical circuitry arrangement e1246 as activated thereto, and/or otherwise fulfillment of the operation o1246. One or more non-transitory signal bearing physical media can bear the one or more instructions i1246 that when executed can direct performance of the operation o1246. Furthermore, receiving information regarding economic cost structures to be imposed associated standby communication relays furnished by second mobile operating system based mobile communication devices module m1246 depicted in FIG. 9E as being included in the module m1224, when executed and/or activated, can direct performance of and/or perform the operation o1246. Illustratively, in one or more implementations, the operation o1246 can be carried out, for example, by receiving (e.g. third reception of cellular transmission, etc.) third information (e.g. statistics, incident data, performance data, topology data, derived and original information, etc.) regarding fourth information (e.g. statistics, incident data, performance data, topology data, derived and original information, etc.) regarding one or more second communication related events (e.g. successful transmissions, unsuccessful transmissions, failed equipment, performance assessment, etc.) occurring directly between two or more second mobile operating system based mobile communication devices (e.g. mobile OS handsets, tablets, phablets, etc.) receiving information (e.g. data calculation, electronic signal reception, etc.) at least partially contained in one or more second mobile operating system based mobile communication device (e.g. portable computers, etc.) relayed transmissions receiving information regarding one or more economic cost structures to be imposed (e.g. network credits, cash incentives, coupons, rebates earned, awarded for being available to provide standby capabilities, etc.) associated with one or more standby communication relays (e.g. on-call service available for immediate activation, etc.) furnished by one or more second mobile operating system based mobile communication devices (e.g. smartphones, etc.).

In one or more implementations, as shown in FIG. 13L, the operation o1246 can include operation o1247 for receiving information regarding one or more economic cost structures to be imposed associated with one or more standby communication relays furnished by one or more second mobile operating system based mobile communication devices including receiving information regarding commercial credit or cash requirements to access one or more of standby communication relays as furnished by one or more second mobile operating system based mobile communication devices. Origination of a physically tangible component group can be accomplished through skilled in the art design choice selection including use of one or more components and/or subsystems explicitly and/or implicitly referred to herein for at least in part implementing execution of one or more instructions i1247 of the operation o1247, for performance of the operation o1247 by an electrical circuitry arrangement e1247 as activated thereto, and/or otherwise fulfillment of the operation o1247. One or more non-transitory signal bearing physical media can bear the one or more instructions i1247 that when executed can direct performance of the operation o1247. Furthermore, receiving information regarding commercial credit or cash requirements to access of standby communication relays as furnished by second mobile operating system based mobile communication devices module m1247 depicted in FIG. 9E as being included in the module m1246, when executed and/or activated, can direct performance of and/or perform the operation o1247. Illustratively, in one or more implementations, the operation o1247 can be carried out, for example, by receiving (e.g. third reception of cellular transmission, etc.) third information (e.g. statistics, incident data, performance data, topology data, derived and original information, etc.) regarding fourth information (e.g. statistics, incident data, performance data, topology data, derived and original information, etc.) regarding one or more second communication related events (e.g. successful transmissions, unsuccessful transmissions, failed equipment, performance assessment, etc.) occurring directly between two or more second mobile operating system based mobile communication devices (e.g. mobile OS handsets, tablets, phablets, etc.) receiving information (e.g. data calculation, electronic signal reception, etc.) at least partially contained in one or more second mobile operating system based mobile communication device (e.g. portable computers, etc.) relayed transmissions receiving information regarding one or more economic cost structures to be imposed (e.g. network credits, cash incentives, coupons, rebates earned, awarded for being available to provide standby capabilities, etc.) associated with one or more standby communication relays (e.g. on-call service available for immediate activation, etc.) furnished by one or more second mobile operating system based mobile communication devices (e.g. smartphones, etc.) receiving information regarding commercial credit or cash requirements (e.g. based on obligations imposed by intermediate devices onto each other or onto the origination device or onto the service plan provider of the standby network service, etc.) to access (e.g. various levels of use by the origination device based on time of day, amount of traffic required, quality requirements, etc.) one or more of standby communication relays (e.g. hot-swap network service, etc.) as furnished by one or more second mobile operating system based mobile communication devices.

In one or more implementations, as shown in FIG. 13L, the operation o1224 can include operation o1248 for receiving information at least partially contained in one or more second mobile operating system based mobile communication device relayed transmissions including receiving information regarding one or more second mobile operating system based mobile communication devices as having one or more communication paths including one or more line of sight pathways or one or more ricochet pathways. Origination of a physically tangible component group can be accomplished through skilled in the art design choice selection including use of one or more components and/or subsystems explicitly and/or implicitly referred to herein for at least in part implementing execution of one or more instructions i1248 of the operation o1248, for performance of the operation o1248 by an electrical circuitry arrangement e1248 as activated thereto, and/or otherwise fulfillment of the operation o1248. One or more non-transitory signal bearing physical media can bear the one or more instructions i1248 that when executed can direct performance of the operation o1248. Furthermore, receiving information regarding second mobile operating system based mobile communication devices as having communication paths including line of sight pathways or ricochet pathways module m1248 depicted in FIG. 9E as being included in the module m1224, when executed and/or activated, can direct performance of and/or perform the operation o1248. Illustratively, in one or more implementations, the operation o1248 can be carried out, for example, by receiving (e.g. third reception of cellular transmission, etc.) third information (e.g. statistics, incident data, performance data, topology data, derived and original information, etc.) regarding fourth information (e.g. statistics, incident data, performance data, topology data, derived and original information, etc.) regarding one or more second communication related events (e.g. successful transmissions, unsuccessful transmissions, failed equipment, performance assessment, etc.) occurring directly between two or more second mobile operating system based mobile communication devices (e.g. mobile OS handsets, tablets, phablets, etc.) receiving information (e.g. data calculation, electronic signal reception, etc.) at least partially contained in one or more second mobile operating system based mobile communication device (e.g. portable computers, etc.) relayed transmissions receiving information regarding one or more second mobile operating system based mobile communication devices as having one or more communication paths including one or more line of sight pathways or one or more ricochet pathways (e.g. communication pathways can be rated by likelihood they will become occluded, communication pathways can include combinations of line-of-sight segments as well as ricochet segments in which one or more communication beams can be bounced off of buildings or objects that may otherwise become obstructions to communication, etc.).

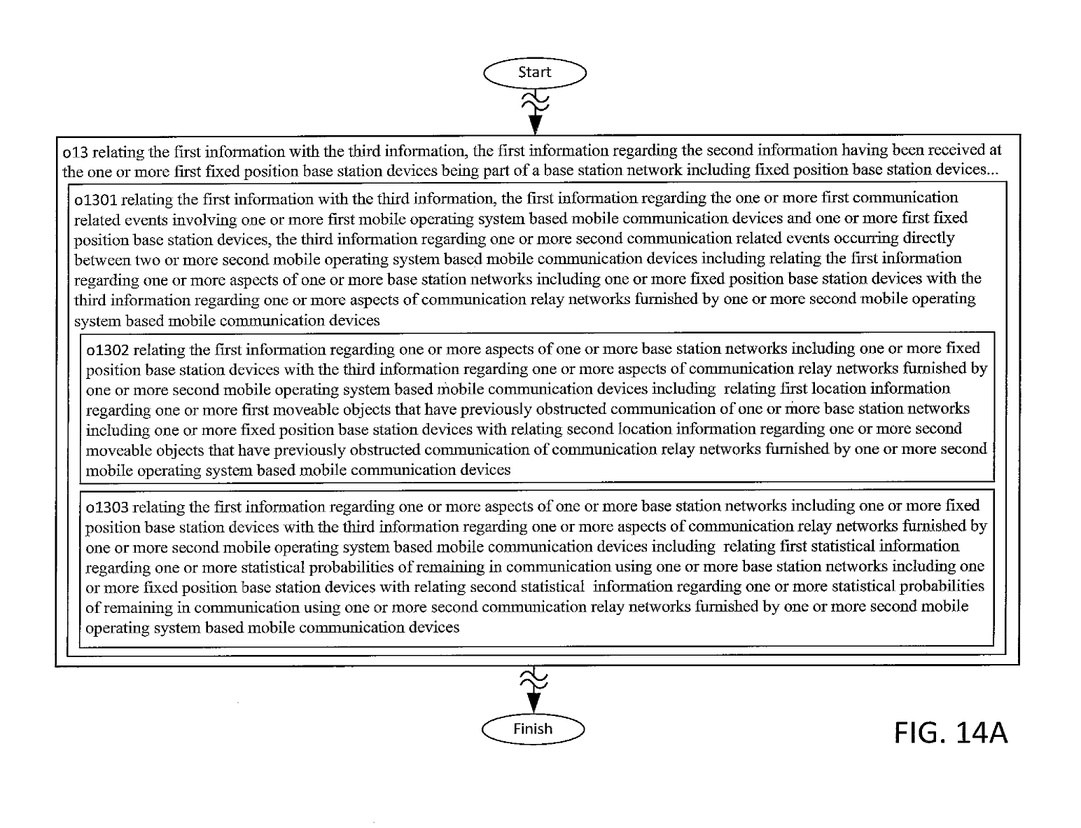

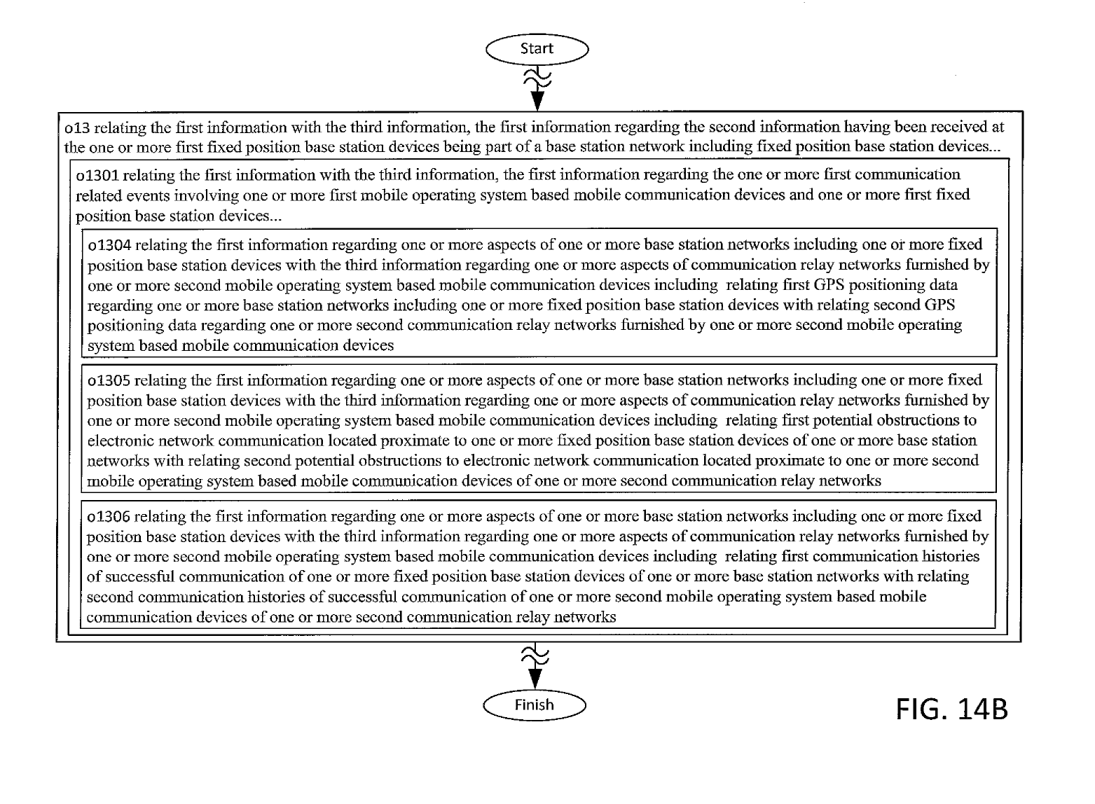

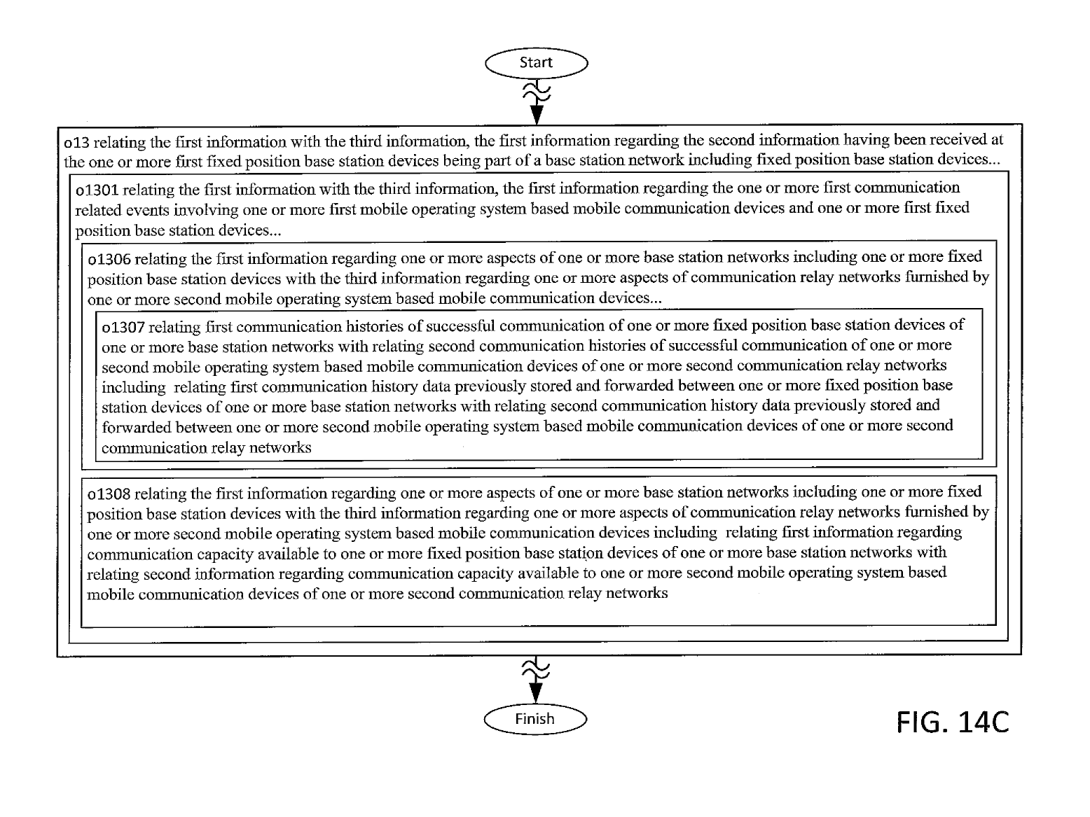

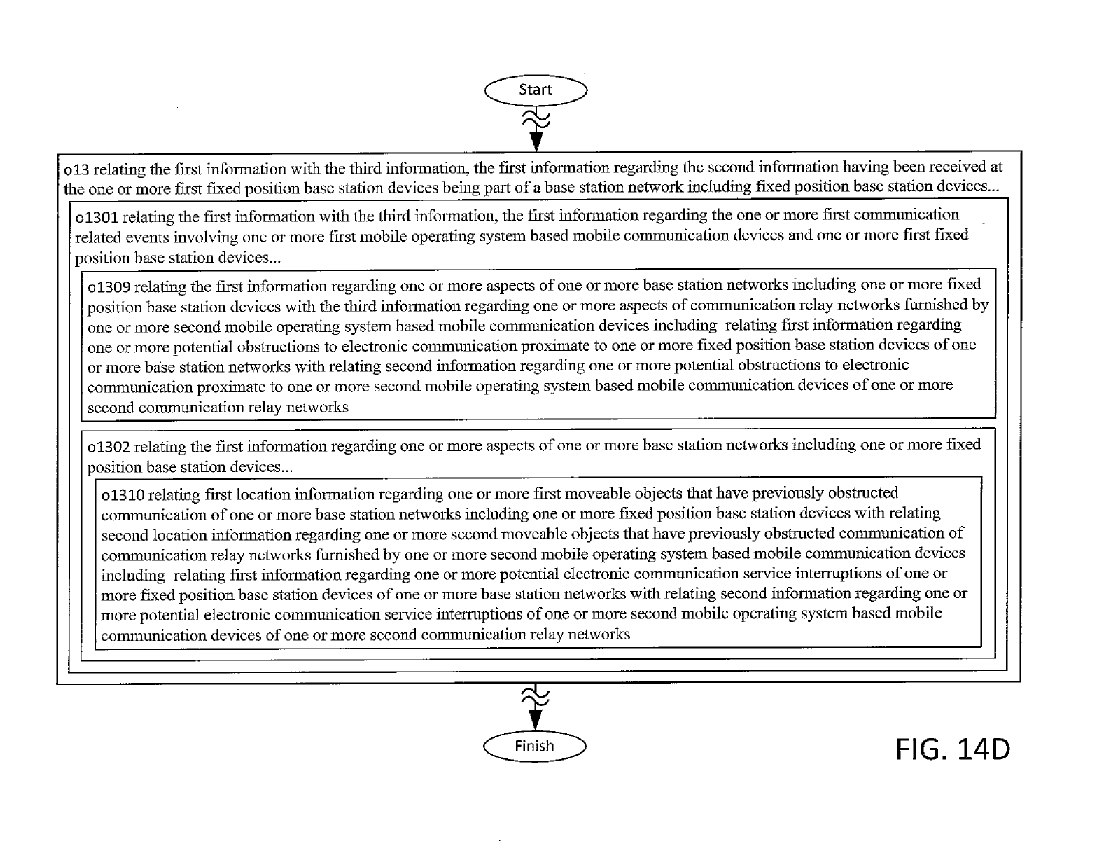

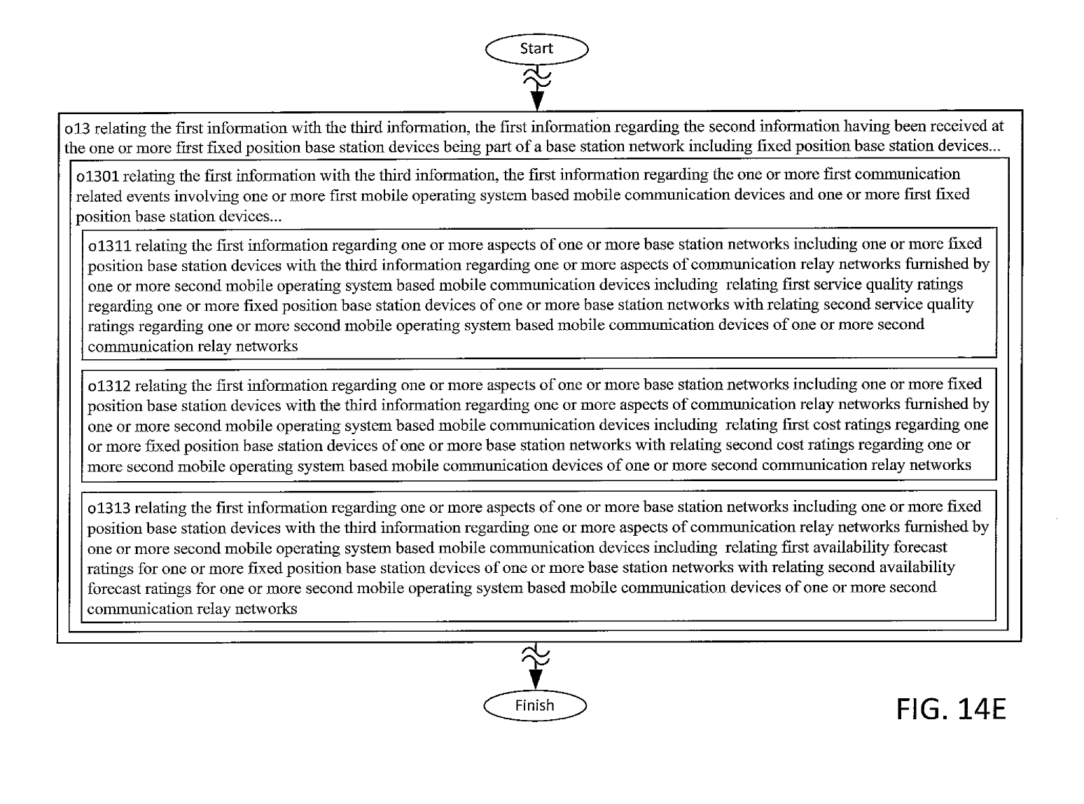

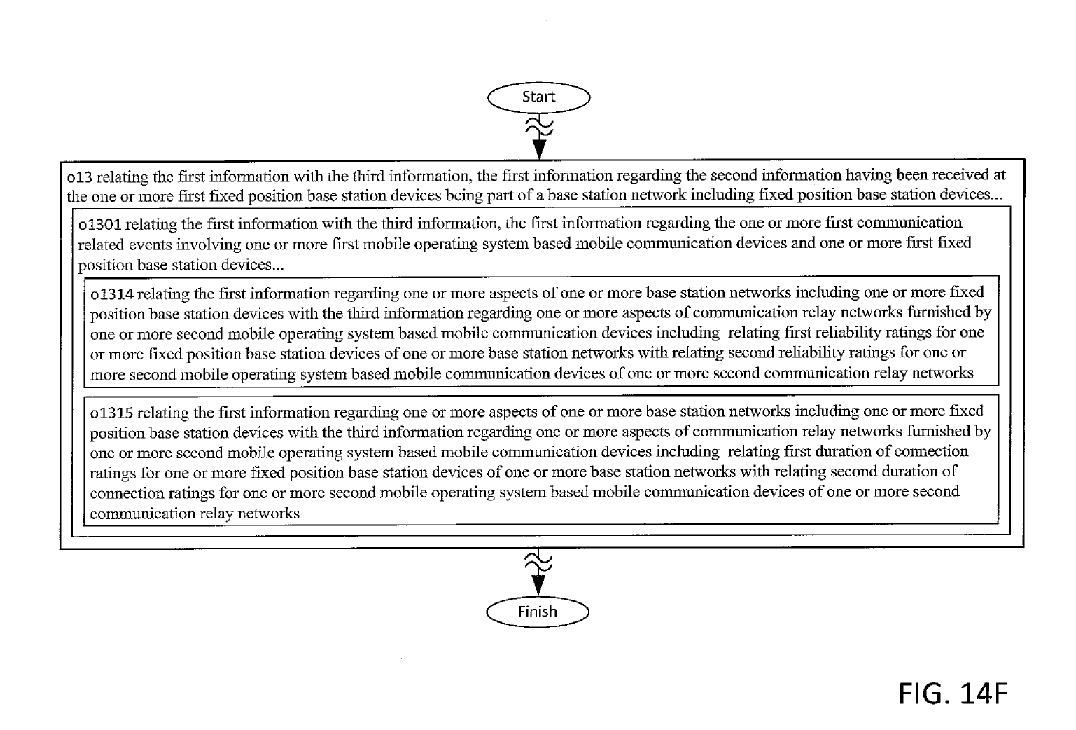

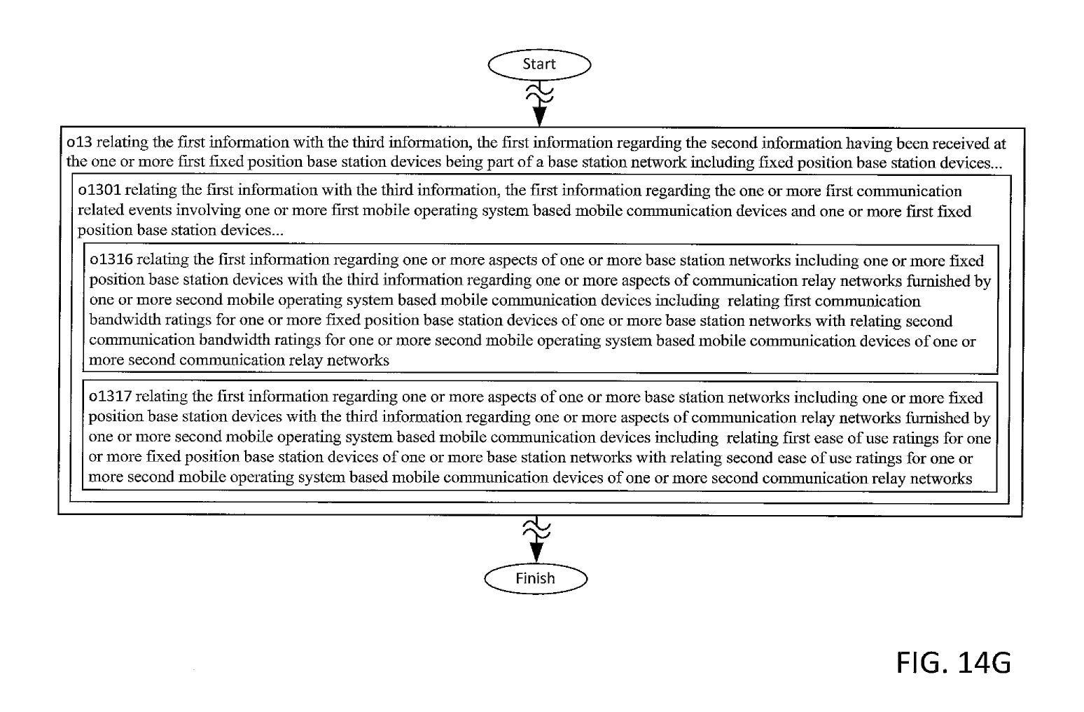

In one or more implementations, as shown in FIG. 14A, the operation o1231 can include operation o1301 for relating the first information with the third information, the first information regarding the one or more first communication related events involving one or more first mobile operating system based mobile communication devices and one or more first fixed position base station devices, the third information regarding one or more second communication related events occurring directly between two or more second mobile operating system based mobile communication devices including relating the first information regarding one or more aspects of one or more base station networks including one or more fixed position base station devices with the third information regarding one or more aspects of communication relay networks furnished by one or more second mobile operating system based mobile communication devices. Origination of a physically tangible component group can be accomplished through skilled in the art design choice selection including use of one or more components and/or subsystems explicitly and/or implicitly referred to herein for at least in part implementing execution of one or more instructions i1301 of the operation o1301, for performance of the operation o1301 by an electrical circuitry arrangement e1301 as activated thereto, and/or otherwise fulfillment of the operation o1301. One or more non-transitory signal bearing physical media can bear the one or more instructions i1301 that when executed can direct performance of the operation o1301. Furthermore, relating first information regarding aspects of base station networks including fixed position base station devices with third information regarding aspects of communication relay networks furnished by second mobile operating system based mobile communication devices module m1301 depicted in FIG. 10A as being included in the module m1231, when executed and/or activated, can direct performance of and/or perform the operation o1301. Illustratively, in one or more implementations, the operation o1301 can be carried out, for example, by relating (e.g. associating, interrelating, comparing, contrasting, summarizing, filtering, condensing, ascribing, connecting, combining, referencing, orienting, etc.) the first information (e.g. statistics, incident data, performance data, topology data, derived or original information, etc.) with the third information (e.g. statistics, incident data, performance data, topology data, derived or original information, etc.), the first information (e.g. statistics, incident data, performance data, topology data, derived or original information, etc.) regarding the second information (e.g. statistics, incident data, performance data, topology data, derived or original information, etc.) having been received (e.g. second reception of electronic transmission, etc.) at the one or more first fixed position base station devices (e.g. cellular towers, etc.) being part of a base station network (e.g. cellular network, etc.) including fixed position base station devices (e.g. other cellular towers, etc.), the second information regarding the one or more first communication related events (e.g. successful transmission, unsuccessful transmissions, communication obstruction identification, cost impositions, switch over to back-up network, etc.) involving the one or more first mobile operating system based mobile communication devices (e.g. smart phones, etc.) and the one or more first fixed position base station devices (e.g. cellular towers, etc.), each of the first communication related events involving one or more of the first mobile operating system based mobile communication devices (e.g. smartphones, etc.) and one or more of the first fixed position base station devices (e.g. cellular towers, etc.), the third information (e.g. statistics, incident data, performance data, topology data, derived or original information, etc.) regarding the fourth information (e.g. statistics, incident data, performance data, topology data, derived or original information, etc.) the fourth information having been received (e.g. fourth reception of cellular transmission, etc.) at the one or more second fixed position base station devices (e.g. wall mounted cellular base stations, etc.) being part of the base station network (e.g. cellular network, etc.) including fixed position base station devices (e.g. wall mounted cellular base stations, etc.), the fourth information regarding the one or more second communication related events (e.g. successful transmissions, unsuccessful transmissions, failed equipment, performance assessment, etc.) occurring directly (e.g. line-of-sight communication, point-to-point communication, one device transmits and the other device receives, etc.) between the two or more second mobile operating system based mobile communication devices relating (e.g. determining, concluding, calculating, comparing, etc.) the first information regarding one or more aspects of one or more base station networks including one or more fixed position base station devices with the third information regarding one or more aspects of communication relay networks (e.g. receiving through network packet traffic, etc.) furnished by one or more second mobile operating system based mobile communication devices.

In one or more implementations, as shown in FIG. 14A, the operation o1301 can include operation o1302 for relating the first information regarding one or more aspects of one or more base station networks including one or more fixed position base station devices with the third information regarding one or more aspects of communication relay networks furnished by one or more second mobile operating system based mobile communication devices including relating first location information regarding one or more first moveable objects that have previously obstructed communication of one or more base station networks including one or more fixed position base station devices with relating second location information regarding one or more second moveable objects that have previously obstructed communication of communication relay networks furnished by one or more second mobile operating system based mobile communication devices. Origination of a physically tangible component group can be accomplished through skilled in the art design choice selection including use of one or more components and/or subsystems explicitly and/or implicitly referred to herein for at least in part implementing execution of one or more instructions i1302 of the operation o1302, for performance of the operation o1302 by an electrical circuitry arrangement e1302 as activated thereto, and/or otherwise fulfillment of the operation o1302. One or more non-transitory signal bearing physical media can bear the one or more instructions i1302 that when executed can direct performance of the operation o1302. Furthermore, relating first location information regarding first moveable objects that have previously obstructed communication of base station networks including fixed position base station devices with relating second location information regarding second moveable objects that have previously obstructed communication of communication relay networks furnished by second mobile operating system based mobile communication devices module m1302 depicted in FIG. 10A as being included in the module m1301, when executed and/or activated, can direct performance of and/or perform the operation o1302. Illustratively, in one or more implementations, the operation o1302 can be carried out, for example, by relating (e.g. associating, interrelating, comparing, contrasting, summarizing, filtering, condensing, ascribing, connecting, combining, referencing, orienting, etc.) the first information (e.g. statistics, incident data, performance data, topology data, derived or original information, etc.) with the third information (e.g. statistics, incident data, performance data, topology data, derived or original information, etc.), the first information (e.g. statistics, incident data, performance data, topology data, derived or original information, etc.) regarding the second information (e.g. statistics, incident data, performance data, topology data, derived or original information, etc.) having been received (e.g. second reception of electronic transmission, etc.) at the one or more first fixed position base station devices (e.g. cellular towers, etc.) being part of a base station network (e.g. cellular network, etc.) including fixed position base station devices (e.g. other cellular towers, etc.), the second information regarding the one or more first communication related events (e.g. successful transmission, unsuccessful transmissions, communication obstruction identification, cost impositions, switch over to back-up network, etc.) involving the one or more first mobile operating system based mobile communication devices (e.g. smart phones, etc.) and the one or more first fixed position base station devices (e.g. cellular towers, etc.), each of the first communication related events involving one or more of the first mobile operating system based mobile communication devices (e.g. smartphones, etc.) and one or more of the first fixed position base station devices (e.g. cellular towers, etc.), the third information (e.g. statistics, incident data, performance data, topology data, derived or original information, etc.) regarding the fourth information (e.g. statistics, incident data, performance data, topology data, derived or original information, etc.) the fourth information having been received (e.g. fourth reception of cellular transmission, etc.) at the one or more second fixed position base station devices (e.g. wall mounted cellular base stations, etc.) being part of the base station network (e.g. cellular network, etc.) including fixed position base station devices (e.g. wall mounted cellular base stations, etc.), the fourth information regarding the one or more second communication related events (e.g. successful transmissions, unsuccessful transmissions, failed equipment, performance assessment, etc.) occurring directly (e.g. line-of-sight communication, point-to-point communication, one device transmits and the other device receives, etc.) between the two or more second mobile operating system based mobile communication devices relating (e.g. determining, concluding, calculating, comparing, etc.) the first information regarding one or more aspects of one or more base station networks including one or more fixed position base station devices with the third information regarding one or more aspects of communication relay networks (e.g. receiving through network packet traffic, etc.) furnished by one or more second mobile operating system based mobile communication devices relating first location information (e.g. relative geographical coordinates, etc.) regarding one or more first moveable objects (e.g. industrial construction equipment, etc.) that have previously obstructed communication (e.g. less than a day of obstruction, etc.) of one or more base station networks including one or more fixed position base station devices with relating second location information regarding one or more second moveable objects that have previously obstructed communication of communication relay networks furnished by one or more second mobile operating system based mobile communication devices (e.g. iPad, etc.).

In one or more implementations, as shown in FIG. 14A, the operation o1301 can include operation o1303 for relating the first information regarding one or more aspects of one or more base station networks including one or more fixed position base station devices with the third information regarding one or more aspects of communication relay networks furnished by one or more second mobile operating system based mobile communication devices including relating first statistical information regarding one or more statistical probabilities of remaining in communication using one or more base station networks including one or more fixed position base station devices with relating second statistical information regarding one or more statistical probabilities of remaining in communication using one or more second communication relay networks furnished by one or more second mobile operating system based mobile communication devices. Origination of a physically tangible component group can be accomplished through skilled in the art design choice selection including use of one or more components and/or subsystems explicitly and/or implicitly referred to herein for at least in part implementing execution of one or more instructions i1303 of the operation o1303, for performance of the operation o1303 by an electrical circuitry arrangement e1303 as activated thereto, and/or otherwise fulfillment of the operation o1303. One or more non-transitory signal bearing physical media can bear the one or more instructions i1303 that when executed can direct performance of the operation o1303. Furthermore, relating first statistical information regarding statistical probabilities of remaining in communication using base station networks including fixed position base station devices with relating second statistical information regarding statistical probabilities of remaining in communication using second communication relay networks furnished by second mobile operating system based mobile communication devices module m1303 depicted in FIG. 10A as being included in the module m1301, when executed and/or activated, can direct performance of and/or perform the operation o1303. Illustratively, in one or more implementations, the operation o1303 can be carried out, for example, by relating (e.g. associating, interrelating, comparing, contrasting, summarizing, filtering, condensing, ascribing, connecting, combining, referencing, orienting, etc.) the first information (e.g. statistics, incident data, performance data, topology data, derived or original information, etc.) with the third information (e.g. statistics, incident data, performance data, topology data, derived or original information, etc.), the first information (e.g. statistics, incident data, performance data, topology data, derived or original information, etc.) regarding the second information (e.g. statistics, incident data, performance data, topology data, derived or original information, etc.) having been received (e.g. second reception of electronic transmission, etc.) at the one or more first fixed position base station devices (e.g. cellular towers, etc.) being part of a base station network (e.g. cellular network, etc.) including fixed position base station devices (e.g. other cellular towers, etc.), the second information regarding the one or more first communication related events (e.g. successful transmission, unsuccessful transmissions, communication obstruction identification, cost impositions, switch over to back-up network, etc.) involving the one or more first mobile operating system based mobile communication devices (e.g. smart phones, etc.) and the one or more first fixed position base station devices (e.g. cellular towers, etc.), each of the first communication related events involving one or more of the first mobile operating system based mobile communication devices (e.g. smartphones, etc.) and one or more of the first fixed position base station devices (e.g. cellular towers, etc.), the third information (e.g. statistics, incident data, performance data, topology data, derived or original information, etc.) regarding the fourth information (e.g. statistics, incident data, performance data, topology data, derived or original information, etc.) the fourth information having been received (e.g. fourth reception of cellular transmission, etc.) at the one or more second fixed position base station devices (e.g. wall mounted cellular base stations, etc.) being part of the base station network (e.g. cellular network, etc.) including fixed position base station devices (e.g. wall mounted cellular base stations, etc.), the fourth information regarding the one or more second communication related events (e.g. successful transmissions, unsuccessful transmissions, failed equipment, performance assessment, etc.) occurring directly (e.g. line-of-sight communication, point-to-point communication, one device transmits and the other device receives, etc.) between the two or more second mobile operating system based mobile communication devices relating (e.g. determining, concluding, calculating, comparing, etc.) the first information regarding one or more aspects of one or more base station networks including one or more fixed position base station devices with the third information regarding one or more aspects of communication relay networks (e.g. receiving through network packet traffic, etc.) furnished by one or more second mobile operating system based mobile communication devices relating first statistical information regarding one or more statistical probabilities (e.g. Gaussian distribution, manual surveys, user surveys, automated surveys, etc.) of remaining in communication (e.g. call not dropped, data transmission complete, no delays in transmission, etc.) using one or more base station networks including one or more fixed position base station devices with relating second statistical information regarding one or more statistical probabilities of remaining in communication using one or more second communication relay networks (e.g. network repeaters, etc.) furnished by one or more second mobile operating system based mobile communication devices (e.g. iPhone, etc.).

In one or more implementations, as shown in FIG. 14B, the operation o1301 can include operation o1304 for relating the first information regarding one or more aspects of one or more base station networks including one or more fixed position base station devices with the third information regarding one or more aspects of communication relay networks furnished by one or more second mobile operating system based mobile communication devices including relating first GPS positioning data regarding one or more base station networks including one or more fixed position base station devices with relating second GPS positioning data regarding one or more second communication relay networks furnished by one or more second mobile operating system based mobile communication devices. Origination of a physically tangible component group can be accomplished through skilled in the art design choice selection including use of one or more components and/or subsystems explicitly and/or implicitly referred to herein for at least in part implementing execution of one or more instructions i1304 of the operation o1304, for performance of the operation o1304 by an electrical circuitry arrangement e1304 as activated thereto, and/or otherwise fulfillment of the operation o1304. One or more non-transitory signal bearing physical media can bear the one or more instructions i1304 that when executed can direct performance of the operation o1304. Furthermore, relating first GPS positioning data regarding base station networks including fixed position base station devices with relating second GPS positioning data regarding second communication relay networks furnished by second mobile operating system based mobile communication devices module m1304 depicted in FIG. 10A as being included in the module m1301, when executed and/or activated, can direct performance of and/or perform the operation o1304. Illustratively, in one or more implementations, the operation o1304 can be carried out, for example, by relating (e.g. associating, interrelating, comparing, contrasting, summarizing, filtering, condensing, ascribing, connecting, combining, referencing, orienting, etc.) the first information (e.g. statistics, incident data, performance data, topology data, derived or original information, etc.) with the third information (e.g. statistics, incident data, performance data, topology data, derived or original information, etc.), the first information (e.g. statistics, incident data, performance data, topology data, derived or original information, etc.) regarding the second information (e.g. statistics, incident data, performance data, topology data, derived or original information, etc.) having been received (e.g. second reception of electronic transmission, etc.) at the one or more first fixed position base station devices (e.g. cellular towers, etc.) being part of a base station network (e.g. cellular network, etc.) including fixed position base station devices (e.g. other cellular towers, etc.), the second information regarding the one or more first communication related events (e.g. successful transmission, unsuccessful transmissions, communication obstruction identification, cost impositions, switch over to back-up network, etc.) involving the one or more first mobile operating system based mobile communication devices (e.g. smart phones, etc.) and the one or more first fixed position base station devices (e.g. cellular towers, etc.), each of the first communication related events involving one or more of the first mobile operating system based mobile communication devices (e.g. smartphones, etc.) and one or more of the first fixed position base station devices (e.g. cellular towers, etc.), the third information (e.g. statistics, incident data, performance data, topology data, derived or original information, etc.) regarding the fourth information (e.g. statistics, incident data, performance data, topology data, derived or original information, etc.) the fourth information having been received (e.g. fourth reception of cellular transmission, etc.) at the one or more second fixed position base station devices (e.g. wall mounted cellular base stations, etc.) being part of the base station network (e.g. cellular network, etc.) including fixed position base station devices (e.g. wall mounted cellular base stations, etc.), the fourth information regarding the one or more second communication related events (e.g. successful transmissions, unsuccessful transmissions, failed equipment, performance assessment, etc.) occurring directly (e.g. line-of-sight communication, point-to-point communication, one device transmits and the other device receives, etc.) between the two or more second mobile operating system based mobile communication devices relating (e.g. determining, concluding, calculating, comparing, etc.) the first information regarding one or more aspects of one or more base station networks including one or more fixed position base station devices with the third information regarding one or more aspects of communication relay networks (e.g. receiving through network packet traffic, etc.) furnished by one or more second mobile operating system based mobile communication devices relating first GPS positioning data (e.g. global positioning system satellite data, chipset information, data base inquiry, etc.) regarding one or more base station networks including one or more fixed position base station devices with relating second GPS positioning data regarding one or more second communication relay networks furnished by one or more second mobile operating system based mobile communication devices (e.g. phablet, etc.).

In one or more implementations, as shown in FIG. 14B, the operation o1301 can include operation o1305 for relating the first information regarding one or more aspects of one or more base station networks including one or more fixed position base station devices with the third information regarding one or more aspects of communication relay networks furnished by one or more second mobile operating system based mobile communication devices including relating first potential obstructions to electronic network communication located proximate to one or more fixed position base station devices of one or more base station networks with relating second potential obstructions to electronic network communication located proximate to one or more second mobile operating system based mobile communication devices of one or more second communication relay networks. Origination of a physically tangible component group can be accomplished through skilled in the art design choice selection including use of one or more components and/or subsystems explicitly and/or implicitly referred to herein for at least in part implementing execution of one or more instructions i1305 of the operation o1305, for performance of the operation o1305 by an electrical circuitry arrangement e1305 as activated thereto, and/or otherwise fulfillment of the operation o1305. One or more non-transitory signal bearing physical media can bear the one or more instructions i1305 that when executed can direct performance of the operation o1305. Furthermore, relating first potential obstructions to electronic network communication located proximate to fixed position base station devices of base station networks with relating second potential obstructions to electronic network communication located proximate to second mobile operating system based mobile communication devices of second communication relay networks module m1305 depicted in FIG. 10A as being included in the module m1301, when executed and/or activated, can direct performance of and/or perform the operation o1305. Illustratively, in one or more implementations, the operation o1305 can be carried out, for example, by relating (e.g. associating, interrelating, comparing, contrasting, summarizing, filtering, condensing, ascribing, connecting, combining, referencing, orienting, etc.) the first information (e.g. statistics, incident data, performance data, topology data, derived or original information, etc.) with the third information (e.g. statistics, incident data, performance data, topology data, derived or original information, etc.), the first information (e.g. statistics, incident data, performance data, topology data, derived or original information, etc.) regarding the second information (e.g. statistics, incident data, performance data, topology data, derived or original information, etc.) having been received (e.g. second reception of electronic transmission, etc.) at the one or more first fixed position base station devices (e.g. cellular towers, etc.) being part of a base station network (e.g. cellular network, etc.) including fixed position base station devices (e.g. other cellular towers, etc.), the second information regarding the one or more first communication related events (e.g. successful transmission, unsuccessful transmissions, communication obstruction identification, cost impositions, switch over to back-up network, etc.) involving the one or more first mobile operating system based mobile communication devices (e.g. smart phones, etc.) and the one or more first fixed position base station devices (e.g. cellular towers, etc.), each of the first communication related events involving one or more of the first mobile operating system based mobile communication devices (e.g. smartphones, etc.) and one or more of the first fixed position base station devices (e.g. cellular towers, etc.), the third information (e.g. statistics, incident data, performance data, topology data, derived or original information, etc.) regarding the fourth information (e.g. statistics, incident data, performance data, topology data, derived or original information, etc.) the fourth information having been received (e.g. fourth reception of cellular transmission, etc.) at the one or more second fixed position base station devices (e.g. wall mounted cellular base stations, etc.) being part of the base station network (e.g. cellular network, etc.) including fixed position base station devices (e.g. wall mounted cellular base stations, etc.), the fourth information regarding the one or more second communication related events (e.g. successful transmissions, unsuccessful transmissions, failed equipment, performance assessment, etc.) occurring directly (e.g. line-of-sight communication, point-to-point communication, one device transmits and the other device receives, etc.) between the two or more second mobile operating system based mobile communication devices relating (e.g. determining, concluding, calculating, comparing, etc.) the first information regarding one or more aspects of one or more base station networks including one or more fixed position base station devices with the third information regarding one or more aspects of communication relay networks (e.g. receiving through network packet traffic, etc.) furnished by one or more second mobile operating system based mobile communication devices relating (e.g. comparing, etc.) first potential obstructions to electronic network communication (e.g. office buildings, etc.) located proximate (e.g. less than three city blocks, etc.) to one or more fixed position base station devices (e.g. cell tower, etc.) of one or more base station networks (e.g. cellular network, etc.) with relating second potential obstructions to electronic network communication (e.g. skyscrapers, etc.) located proximate (e.g. less than half mile, etc.) to one or more second mobile operating system based mobile communication devices (e.g. smartphone, etc.) of one or more second communication relay networks (e.g. relay capable smartphones, etc.).

In one or more implementations, as shown in FIG. 14B, the operation o1301 can include operation o1306 for relating the first information regarding one or more aspects of one or more base station networks including one or more fixed position base station devices with the third information regarding one or more aspects of communication relay networks furnished by one or more second mobile operating system based mobile communication devices including relating first communication histories of successful communication of one or more fixed position base station devices of one or more base station networks with relating second communication histories of successful communication of one or more second mobile operating system based mobile communication devices of one or more second communication relay networks. Origination of a physically tangible component group can be accomplished through skilled in the art design choice selection including use of one or more components and/or subsystems explicitly and/or implicitly referred to herein for at least in part implementing execution of one or more instructions i1306 of the operation o1306, for performance of the operation o1306 by an electrical circuitry arrangement e1306 as activated thereto, and/or otherwise fulfillment of the operation o1306. One or more non-transitory signal bearing physical media can bear the one or more instructions i1306 that when executed can direct performance of the operation o1306. Furthermore, relating first communication histories of successful communication of fixed position base station devices of base station networks with relating second communication histories of successful communication of second mobile operating system based mobile communication devices of second communication relay networks module m1306 depicted in FIG. 10A as being included in the module m1301, when executed and/or activated, can direct performance of and/or perform the operation o1306. Illustratively, in one or more implementations, the operation o1306 can be carried out, for example, by relating (e.g. associating, interrelating, comparing, contrasting, summarizing, filtering, condensing, ascribing, connecting, combining, referencing, orienting, etc.) the first information (e.g. statistics, incident data, performance data, topology data, derived or original information, etc.) with the third information (e.g. statistics, incident data, performance data, topology data, derived or original information, etc.), the first information (e.g. statistics, incident data, performance data, topology data, derived or original information, etc.) regarding the second information (e.g. statistics, incident data, performance data, topology data, derived or original information, etc.) having been received (e.g. second reception of electronic transmission, etc.) at the one or more first fixed position base station devices (e.g. cellular towers, etc.) being part of a base station network (e.g. cellular network, etc.) including fixed position base station devices (e.g. other cellular towers, etc.), the second information regarding the one or more first communication related events (e.g. successful transmission, unsuccessful transmissions, communication obstruction identification, cost impositions, switch over to back-up network, etc.) involving the one or more first mobile operating system based mobile communication devices (e.g. smart phones, etc.) and the one or more first fixed position base station devices (e.g. cellular towers, etc.), each of the first communication related events involving one or more of the first mobile operating system based mobile communication devices (e.g. smartphones, etc.) and one or more of the first fixed position base station devices (e.g. cellular towers, etc.), the third information (e.g. statistics, incident data, performance data, topology data, derived or original information, etc.) regarding the fourth information (e.g. statistics, incident data, performance data, topology data, derived or original information, etc.) the fourth information having been received (e.g. fourth reception of cellular transmission, etc.) at the one or more second fixed position base station devices (e.g. wall mounted cellular base stations, etc.) being part of the base station network (e.g. cellular network, etc.) including fixed position base station devices (e.g. wall mounted cellular base stations, etc.), the fourth information regarding the one or more second communication related events (e.g. successful transmissions, unsuccessful transmissions, failed equipment, performance assessment, etc.) occurring directly (e.g. line-of-sight communication, point-to-point communication, one device transmits and the other device receives, etc.) between the two or more second mobile operating system based mobile communication devices relating (e.g. determining, concluding, calculating, comparing, etc.) the first information regarding one or more aspects of one or more base station networks including one or more fixed position base station devices with the third information regarding one or more aspects of communication relay networks (e.g. receiving through network packet traffic, etc.) furnished by one or more second mobile operating system based mobile communication devices relating first communication histories of successful communication (e.g. call not dropped, communication bandwidth above designated threshold, meet or exceed service quality thresholds for data transmission or media presentation quality, etc.) of one or more fixed position base station devices (e.g. routers, etc.) of one or more base station networks with relating second communication histories of successful communication of one or more second mobile operating system based mobile communication devices of one or more second communication relay networks (e.g. data communication network, etc.).

In one or more implementations, as shown in FIG. 14C, the operation o1306 can include operation o1307 for relating first communication histories of successful communication of one or more fixed position base station devices of one or more base station networks with relating second communication histories of successful communication of one or more second mobile operating system based mobile communication devices of one or more second communication relay networks including relating first communication history data previously stored and forwarded between one or more fixed position base station devices of one or more base station networks with relating second communication history data previously stored and forwarded between one or more second mobile operating system based mobile communication devices of one or more second communication relay networks. Origination of a physically tangible component group can be accomplished through skilled in the art design choice selection including use of one or more components and/or subsystems explicitly and/or implicitly referred to herein for at least in part implementing execution of one or more instructions i1307 of the operation o1307, for performance of the operation o1307 by an electrical circuitry arrangement e1307 as activated thereto, and/or otherwise fulfillment of the operation o1307. One or more non-transitory signal bearing physical media can bear the one or more instructions i1307 that when executed can direct performance of the operation o1307. Furthermore, relating first communication history data previously stored and forwarded between fixed position base station devices of base station networks with relating second communication history data previously stored and forwarded between second mobile operating system based mobile communication devices of second communication relay networks module m1307 depicted in FIG. 10A as being included in the module m1306, when executed and/or activated, can direct performance of and/or perform the operation o1307. Illustratively, in one or more implementations, the operation o1307 can be carried out, for example, by relating (e.g. associating, interrelating, comparing, contrasting, summarizing, filtering, condensing, ascribing, connecting, combining, referencing, orienting, etc.) the first information (e.g. statistics, incident data, performance data, topology data, derived or original information, etc.) with the third information (e.g. statistics, incident data, performance data, topology data, derived or original information, etc.), the first information (e.g. statistics, incident data, performance data, topology data, derived or original information, etc.) regarding the second information (e.g. statistics, incident data, performance data, topology data, derived or original information, etc.) having been received (e.g. second reception of electronic transmission, etc.) at the one or more first fixed position base station devices (e.g. cellular towers, etc.) being part of a base station network (e.g. cellular network, etc.) including fixed position base station devices (e.g. other cellular towers, etc.), the second information regarding the one or more first communication related events (e.g. successful transmission, unsuccessful transmissions, communication obstruction identification, cost impositions, switch over to back-up network, etc.) involving the one or more first mobile operating system based mobile communication devices (e.g. smart phones, etc.) and the one or more first fixed position base station devices (e.g. cellular towers, etc.), each of the first communication related events involving one or more of the first mobile operating system based mobile communication devices (e.g. smartphones, etc.) and one or more of the first fixed position base station devices (e.g. cellular towers, etc.), the third information (e.g. statistics, incident data, performance data, topology data, derived or original information, etc.) regarding the fourth information (e.g. statistics, incident data, performance data, topology data, derived or original information, etc.) the fourth information having been received (e.g. fourth reception of cellular transmission, etc.) at the one or more second fixed position base station devices (e.g. wall mounted cellular base stations, etc.) being part of the base station network (e.g. cellular network, etc.) including fixed position base station devices (e.g. wall mounted cellular base stations, etc.), the fourth information regarding the one or more second communication related events (e.g. successful transmissions, unsuccessful transmissions, failed equipment, performance assessment, etc.) occurring directly (e.g. line-of-sight communication, point-to-point communication, one device transmits and the other device receives, etc.) between the two or more second mobile operating system based mobile communication devices relating (e.g. determining, concluding, calculating, comparing, etc.) the first information regarding one or more aspects of one or more base station networks including one or more fixed position base station devices with the third information regarding one or more aspects of communication relay networks (e.g. receiving through network packet traffic, etc.) furnished by one or more second mobile operating system based mobile communication devices relating first communication histories of successful communication (e.g. call not dropped, communication bandwidth above designated threshold, meet or exceed service quality thresholds for data transmission or media presentation quality, etc.) of one or more fixed position base station devices (e.g. routers, etc.) of one or more base station networks with relating second communication histories of successful communication of one or more second mobile operating system based mobile communication devices of one or more second communication relay networks (e.g. data communication network, etc.) relating first communication history data (e.g. successful communication versus communication problems with maintaining communication links, transmission dropout, degradation of transmission speed, etc.) previously stored and forwarded (e.g. temporarily held in device memory and then retransmitted, etc.) between one or more fixed position base station devices (e.g. cellular tower, etc.) of one or more base station networks with relating second communication history data previously stored and forwarded (e.g. stored in memory and retransmitted without user perceived delay, etc.) between one or more second mobile operating system based mobile communication devices (e.g. android mobile handsets, etc.) of one or more second communication relay networks (e.g. packet network, etc.).

In one or more implementations, as shown in FIG. 14C, the operation o1301 can include operation o1308 for relating the first information regarding one or more aspects of one or more base station networks including one or more fixed position base station devices with the third information regarding one or more aspects of communication relay networks furnished by one or more second mobile operating system based mobile communication devices including relating first information regarding communication capacity available to one or more fixed position base station devices of one or more base station networks with relating second information regarding communication capacity available to one or more second mobile operating system based mobile communication devices of one or more second communication relay networks. Origination of a physically tangible component group can be accomplished through skilled in the art design choice selection including use of one or more components and/or subsystems explicitly and/or implicitly referred to herein for at least in part implementing execution of one or more instructions i1308 of the operation o1308, for performance of the operation o1308 by an electrical circuitry arrangement e1308 as activated thereto, and/or otherwise fulfillment of the operation o1308. One or more non-transitory signal bearing physical media can bear the one or more instructions i1308 that when executed can direct performance of the operation o1308. Furthermore, relating first information regarding communication capacity available to fixed position base station devices of base station networks with relating second information regarding communication capacity available to second mobile operating system based mobile communication devices of second communication relay networks module m1308 depicted in FIG. 10B as being included in the module m1301, when executed and/or activated, can direct performance of and/or perform the operation o1308. Illustratively, in one or more implementations, the operation o1308 can be carried out, for example, by relating (e.g. determining, concluding, calculating, comparing, etc.) the first information regarding one or more aspects of one or more base station networks including one or more fixed position base station devices with the third information regarding one or more aspects of communication relay networks (e.g. receiving through network packet traffic, etc.) furnished by one or more second mobile operating system based mobile communication devices relating first information regarding communication capacity (e.g. gigabit per second rates, etc.) available (e.g. end-users of intermediate electronic communication devices have signed up to have their devices provide standby service, etc.) to one or more fixed position base station devices of one or more base station networks (e.g. network relay, etc.) with relating second information regarding communication capacity available (e.g. maximum bit-rate available, etc.) to one or more second mobile operating system based mobile communication devices (e.g. windows OS smartphones, etc.) of one or more second communication relay networks (e.g. backup networks, etc.).

In one or more implementations, as shown in FIG. 14D, the operation o1301 can include operation o1309 for relating the first information regarding one or more aspects of one or more base station networks including one or more fixed position base station devices with the third information regarding one or more aspects of communication relay networks furnished by one or more second mobile operating system based mobile communication devices including relating first information regarding one or more potential obstructions to electronic communication proximate to one or more fixed position base station devices of one or more base station networks with relating second information regarding one or more potential obstructions to electronic communication proximate to one or more second mobile operating system based mobile communication devices of one or more second communication relay networks. Origination of a physically tangible component group can be accomplished through skilled in the art design choice selection including use of one or more components and/or subsystems explicitly and/or implicitly referred to herein for at least in part implementing execution of one or more instructions i1309 of the operation o1309, for performance of the operation o1309 by an electrical circuitry arrangement e1309 as activated thereto, and/or otherwise fulfillment of the operation o1309. One or more non-transitory signal bearing physical media can bear the one or more instructions i1309 that when executed can direct performance of the operation o1309. Furthermore, relating first information regarding potential obstructions to electronic communication proximate to fixed position base station devices of base station networks with relating second information regarding potential obstructions to electronic communication proximate to second mobile operating system based mobile communication devices of second communication relay networks module m1309 depicted in FIG. 10B as being included in the module m1301, when executed and/or activated, can direct performance of and/or perform the operation o1309. Illustratively, in one or more implementations, the operation o1309 can be carried out, for example, by relating (e.g. associating, interrelating, comparing, contrasting, summarizing, filtering, condensing, ascribing, connecting, combining, referencing, orienting, etc.) the first information (e.g. statistics, incident data, performance data, topology data, derived or original information, etc.) with the third information (e.g. statistics, incident data, performance data, topology data, derived or original information, etc.), the first information (e.g. statistics, incident data, performance data, topology data, derived or original information, etc.) regarding the second information (e.g. statistics, incident data, performance data, topology data, derived or original information, etc.) having been received (e.g. second reception of electronic transmission, etc.) at the one or more first fixed position base station devices (e.g. cellular towers, etc.) being part of a base station network (e.g. cellular network, etc.) including fixed position base station devices (e.g. other cellular towers, etc.), the second information regarding the one or more first communication related events (e.g. successful transmission, unsuccessful transmissions, communication obstruction identification, cost impositions, switch over to back-up network, etc.) involving the one or more first mobile operating system based mobile communication devices (e.g. smart phones, etc.) and the one or more first fixed position base station devices (e.g. cellular towers, etc.), each of the first communication related events involving one or more of the first mobile operating system based mobile communication devices (e.g. smartphones, etc.) and one or more of the first fixed position base station devices (e.g. cellular towers, etc.), the third information (e.g. statistics, incident data, performance data, topology data, derived or original information, etc.) regarding the fourth information (e.g. statistics, incident data, performance data, topology data, derived or original information, etc.) the fourth information having been received (e.g. fourth reception of cellular transmission, etc.) at the one or more second fixed position base station devices (e.g. wall mounted cellular base stations, etc.) being part of the base station network (e.g. cellular network, etc.) including fixed position base station devices (e.g. wall mounted cellular base stations, etc.), the fourth information regarding the one or more second communication related events (e.g. successful transmissions, unsuccessful transmissions, failed equipment, performance assessment, etc.) occurring directly (e.g. line-of-sight communication, point-to-point communication, one device transmits and the other device receives, etc.) between the two or more second mobile operating system based mobile communication devices relating (e.g. determining, concluding, calculating, comparing, etc.) the first information regarding one or more aspects of one or more base station networks including one or more fixed position base station devices with the third information regarding one or more aspects of communication relay networks (e.g. receiving through network packet traffic, etc.) furnished by one or more second mobile operating system based mobile communication devices relating first information regarding one or more potential obstructions (e.g. totally block communication in one or more directions of communication, etc.) to electronic communication (e.g. line of sight, etc.) proximate to one or more fixed position base station devices of one or more base station networks with relating second information regarding one or more potential obstructions to electronic communication (e.g. line of sight, etc.) proximate to one or more second mobile operating system based mobile communication devices (e.g. Apple iOS smartphone, etc.) of one or more second communication relay networks (e.g. temporary networks, etc.).

In one or more implementations, as shown in FIG. 14D, the operation o1302 can include operation o1310 for relating first location information regarding one or more first moveable objects that have previously obstructed communication of one or more base station networks including one or more fixed position base station devices with relating second location information regarding one or more second moveable objects that have previously obstructed communication of communication relay networks furnished by one or more second mobile operating system based mobile communication devices including relating first information regarding one or more potential electronic communication service interruptions of one or more fixed position base station devices of one or more base station networks with relating second information regarding one or more potential electronic communication service interruptions of one or more second mobile operating system based mobile communication devices of one or more second communication relay networks. Origination of a physically tangible component group can be accomplished through skilled in the art design choice selection including use of one or more components and/or subsystems explicitly and/or implicitly referred to herein for at least in part implementing execution of one or more instructions i1310 of the operation o1310, for performance of the operation o1310 by an electrical circuitry arrangement e1310 as activated thereto, and/or otherwise fulfillment of the operation o1310. One or more non-transitory signal bearing physical media can bear the one or more instructions i1310 that when executed can direct performance of the operation o1310. Furthermore, relating first information regarding potential electronic communication service interruptions of fixed position base station devices of base station networks with relating second information regarding potential electronic communication service interruptions of second mobile operating system based mobile communication devices of second communication relay networks module m1310 depicted in FIG. 10B as being included in the module m1302, when executed and/or activated, can direct performance of and/or perform the operation o1310. Illustratively, in one or more implementations, the operation o1310 can be carried out, for example, by relating (e.g. associating, interrelating, comparing, contrasting, summarizing, filtering, condensing, ascribing, connecting, combining, referencing, orienting, etc.) the first information (e.g. statistics, incident data, performance data, topology data, derived or original information, etc.) with the third information (e.g. statistics, incident data, performance data, topology data, derived or original information, etc.), the first information (e.g. statistics, incident data, performance data, topology data, derived or original information, etc.) regarding the second information (e.g. statistics, incident data, performance data, topology data, derived or original information, etc.) having been received (e.g. second reception of electronic transmission, etc.) at the one or more first fixed position base station devices (e.g. cellular towers, etc.) being part of a base station network (e.g. cellular network, etc.) including fixed position base station devices (e.g. other cellular towers, etc.), the second information regarding the one or more first communication related events (e.g. successful transmission, unsuccessful transmissions, communication obstruction identification, cost impositions, switch over to back-up network, etc.) involving the one or more first mobile operating system based mobile communication devices (e.g. smart phones, etc.) and the one or more first fixed position base station devices (e.g. cellular towers, etc.), each of the first communication related events involving one or more of the first mobile operating system based mobile communication devices (e.g. smartphones, etc.) and one or more of the first fixed position base station devices (e.g. cellular towers, etc.), the third information (e.g. statistics, incident data, performance data, topology data, derived or original information, etc.) regarding the fourth information (e.g. statistics, incident data, performance data, topology data, derived or original information, etc.) the fourth information having been received (e.g. fourth reception of cellular transmission, etc.) at the one or more second fixed position base station devices (e.g. wall mounted cellular base stations, etc.) being part of the base station network (e.g. cellular network, etc.) including fixed position base station devices (e.g. wall mounted cellular base stations, etc.), the fourth information regarding the one or more second communication related events (e.g. successful transmissions, unsuccessful transmissions, failed equipment, performance assessment, etc.) occurring directly (e.g. line-of-sight communication, point-to-point communication, one device transmits and the other device receives, etc.) between the two or more second mobile operating system based mobile communication devices relating (e.g. determining, concluding, calculating, comparing, etc.) the first information regarding one or more aspects of one or more base station networks including one or more fixed position base station devices with the third information regarding one or more aspects of communication relay networks (e.g. receiving through network packet traffic, etc.) furnished by one or more second mobile operating system based mobile communication devices relating first location information (e.g. relative geographical coordinates, etc.) regarding one or more first moveable objects (e.g. industrial construction equipment, etc.) that have previously obstructed communication (e.g. less than a day of obstruction, etc.) of one or more base station networks including one or more fixed position base station devices with relating second location information regarding one or more second moveable objects that have previously obstructed communication of communication relay networks furnished by one or more second mobile operating system based mobile communication devices (e.g. iPad, etc.) relating first information regarding one or more potential electronic communication service interruptions (e.g. less than three minute duration, etc.) of one or more fixed position base station devices (e.g. routers, etc.) of one or more base station networks with relating second information regarding one or more potential electronic communication service interruptions (e.g. less than three minute duration, etc.) of one or more second mobile operating system based mobile communication devices (e.g. tablet computers, etc.) of one or more second communication relay networks (e.g. backup networks, etc.).

In one or more implementations, as shown in FIG. 14E, the operation o1301 can include operation o1311 for relating the first information regarding one or more aspects of one or more base station networks including one or more fixed position base station devices with the third information regarding one or more aspects of communication relay networks furnished by one or more second mobile operating system based mobile communication devices including relating first service quality ratings regarding one or more fixed position base station devices of one or more base station networks with relating second service quality ratings regarding one or more second mobile operating system based mobile communication devices of one or more second communication relay networks. Origination of a physically tangible component group can be accomplished through skilled in the art design choice selection including use of one or more components and/or subsystems explicitly and/or implicitly referred to herein for at least in part implementing execution of one or more instructions i1311 of the operation o1311, for performance of the operation o1311 by an electrical circuitry arrangement e1311 as activated thereto, and/or otherwise fulfillment of the operation o1311. One or more non-transitory signal bearing physical media can bear the one or more instructions i1311 that when executed can direct performance of the operation o1311. Furthermore, relating first service quality ratings regarding fixed position base station devices of base station networks with relating second service quality ratings regarding second mobile operating system based mobile communication devices of second communication relay networks module m1311 depicted in FIG. 10B as being included in the module m1301, when executed and/or activated, can direct performance of and/or perform the operation o1311. Illustratively, in one or more implementations, the operation o1311 can be carried out, for example, by relating (e.g. associating, interrelating, comparing, contrasting, summarizing, filtering, condensing, ascribing, connecting, combining, referencing, orienting, etc.) the first information (e.g. statistics, incident data, performance data, topology data, derived or original information, etc.) with the third information (e.g. statistics, incident data, performance data, topology data, derived or original information, etc.), the first information (e.g. statistics, incident data, performance data, topology data, derived or original information, etc.) regarding the second information (e.g. statistics, incident data, performance data, topology data, derived or original information, etc.) having been received (e.g. second reception of electronic transmission, etc.) at the one or more first fixed position base station devices (e.g. cellular towers, etc.) being part of a base station network (e.g. cellular network, etc.) including fixed position base station devices (e.g. other cellular towers, etc.), the second information regarding the one or more first communication related events (e.g. successful transmission, unsuccessful transmissions, communication obstruction identification, cost impositions, switch over to back-up network, etc.) involving the one or more first mobile operating system based mobile communication devices (e.g. smart phones, etc.) and the one or more first fixed position base station devices (e.g. cellular towers, etc.), each of the first communication related events involving one or more of the first mobile operating system based mobile communication devices (e.g. smartphones, etc.) and one or more of the first fixed position base station devices (e.g. cellular towers, etc.), the third information (e.g. statistics, incident data, performance data, topology data, derived or original information, etc.) regarding the fourth information (e.g. statistics, incident data, performance data, topology data, derived or original information, etc.) the fourth information having been received (e.g. fourth reception of cellular transmission, etc.) at the one or more second fixed position base station devices (e.g. wall mounted cellular base stations, etc.) being part of the base station network (e.g. cellular network, etc.) including fixed position base station devices (e.g. wall mounted cellular base stations, etc.), the fourth information regarding the one or more second communication related events (e.g. successful transmissions, unsuccessful transmissions, failed equipment, performance assessment, etc.) occurring directly (e.g. line-of-sight communication, point-to-point communication, one device transmits and the other device receives, etc.) between the two or more second mobile operating system based mobile communication devices relating (e.g. determining, concluding, calculating, comparing, etc.) the first information regarding one or more aspects of one or more base station networks including one or more fixed position base station devices with the third information regarding one or more aspects of communication relay networks (e.g. receiving through network packet traffic, etc.) furnished by one or more second mobile operating system based mobile communication devices relating first service quality ratings (e.g. service quality ratings to take into consideration weighted evaluations of a plurality of aspects that can include communication speed, uptime availability, transmission reliability, etc.) regarding one or more fixed position base station devices (e.g. cellular base station, etc.) of one or more base station networks (e.g. cellular networks, etc.) with relating second service quality ratings (e.g. service quality ratings to take into consideration weighted evaluations of a plurality of aspects that can include communication speed, uptime availability, transmission reliability, etc.) regarding one or more second mobile operating system based mobile communication devices (e.g. phablets, etc.) of one or more second communication relay networks (e.g. temporary network, etc.).

In one or more implementations, as shown in FIG. 14E, the operation o1301 can include operation o1312 for relating the first information regarding one or more aspects of one or more base station networks including one or more fixed position base station devices with the third information regarding one or more aspects of communication relay networks furnished by one or more second mobile operating system based mobile communication devices including relating first cost ratings regarding one or more fixed position base station devices of one or more base station networks with relating second cost ratings regarding one or more second mobile operating system based mobile communication devices of one or more second communication relay networks. Origination of a physically tangible component group can be accomplished through skilled in the art design choice selection including use of one or more components and/or subsystems explicitly and/or implicitly referred to herein for at least in part implementing execution of one or more instructions i1312 of the operation o1312, for performance of the operation o1312 by an electrical circuitry arrangement e1312 as activated thereto, and/or otherwise fulfillment of the operation o1312. One or more non-transitory signal bearing physical media can bear the one or more instructions i1312 that when executed can direct performance of the operation o1312. Furthermore, relating first cost ratings regarding fixed position base station devices of base station networks with relating second cost ratings regarding second mobile operating system based mobile communication devices of second communication relay networks module m1312 depicted in FIG. 10B as being included in the module m1301, when executed and/or activated, can direct performance of and/or perform the operation o1312. Illustratively, in one or more implementations, the operation o1312 can be carried out, for example, by relating (e.g. associating, interrelating, comparing, contrasting, summarizing, filtering, condensing, ascribing, connecting, combining, referencing, orienting, etc.) the first information (e.g. statistics, incident data, performance data, topology data, derived or original information, etc.) with the third information (e.g. statistics, incident data, performance data, topology data, derived or original information, etc.), the first information (e.g. statistics, incident data, performance data, topology data, derived or original information, etc.) regarding the second information (e.g. statistics, incident data, performance data, topology data, derived or original information, etc.) having been received (e.g. second reception of electronic transmission, etc.) at the one or more first fixed position base station devices (e.g. cellular towers, etc.) being part of a base station network (e.g. cellular network, etc.) including fixed position base station devices (e.g. other cellular towers, etc.), the second information regarding the one or more first communication related events (e.g. successful transmission, unsuccessful transmissions, communication obstruction identification, cost impositions, switch over to back-up network, etc.) involving the one or more first mobile operating system based mobile communication devices (e.g. smart phones, etc.) and the one or more first fixed position base station devices (e.g. cellular towers, etc.), each of the first communication related events involving one or more of the first mobile operating system based mobile communication devices (e.g. smartphones, etc.) and one or more of the first fixed position base station devices (e.g. cellular towers, etc.), the third information (e.g. statistics, incident data, performance data, topology data, derived or original information, etc.) regarding the fourth information (e.g. statistics, incident data, performance data, topology data, derived or original information, etc.) the fourth information having been received (e.g. fourth reception of cellular transmission, etc.) at the one or more second fixed position base station devices (e.g. wall mounted cellular base stations, etc.) being part of the base station network (e.g. cellular network, etc.) including fixed position base station devices (e.g. wall mounted cellular base stations, etc.), the fourth information regarding the one or more second communication related events (e.g. successful transmissions, unsuccessful transmissions, failed equipment, performance assessment, etc.) occurring directly (e.g. line-of-sight communication, point-to-point communication, one device transmits and the other device receives, etc.) between the two or more second mobile operating system based mobile communication devices relating (e.g. determining, concluding, calculating, comparing, etc.) the first information regarding one or more aspects of one or more base station networks including one or more fixed position base station devices with the third information regarding one or more aspects of communication relay networks (e.g. receiving through network packet traffic, etc.) furnished by one or more second mobile operating system based mobile communication devices relating first cost ratings (e.g. cost per 100 minutes of airtime, etc.) regarding one or more fixed position base station devices (e.g. cellular relay device, etc.) of one or more base station networks (e.g. cellular networks, etc.) with relating second cost ratings (e.g. cost per 100 minutes of airtime, etc.) regarding one or more second mobile operating system based mobile communication devices (e.g. Android handset, etc.) of one or more second communication relay networks (e.g. backup networks, etc.).

In one or more implementations, as shown in FIG. 14E, the operation o1301 can include operation o1313 for relating the first information regarding one or more aspects of one or more base station networks including one or more fixed position base station devices with the third information regarding one or more aspects of communication relay networks furnished by one or more second mobile operating system based mobile communication devices including relating first availability forecast ratings for one or more fixed position base station devices of one or more base station networks with relating second availability forecast ratings for one or more second mobile operating system based mobile communication devices of one or more second communication relay networks. Origination of a physically tangible component group can be accomplished through skilled in the art design choice selection including use of one or more components and/or subsystems explicitly and/or implicitly referred to herein for at least in part implementing execution of one or more instructions i1313 of the operation o1313, for performance of the operation o1313 by an electrical circuitry arrangement e1313 as activated thereto, and/or otherwise fulfillment of the operation o1313. One or more non-transitory signal bearing physical media can bear the one or more instructions i1313 that when executed can direct performance of the operation o1313. Furthermore, relating first availability forecast ratings for fixed position base station devices of base station networks with relating second availability forecast ratings for second mobile operating system based mobile communication devices of second communication relay networks module m1313 depicted in FIG. 10C as being included in the module m1301, when executed and/or activated, can direct performance of and/or perform the operation o1313. Illustratively, in one or more implementations, the operation o1313 can be carried out, for example, by relating (e.g. associating, interrelating, comparing, contrasting, summarizing, filtering, condensing, ascribing, connecting, combining, referencing, orienting, etc.) the first information (e.g. statistics, incident data, performance data, topology data, derived or original information, etc.) with the third information (e.g. statistics, incident data, performance data, topology data, derived or original information, etc.), the first information (e.g. statistics, incident data, performance data, topology data, derived or original information, etc.) regarding the second information (e.g. statistics, incident data, performance data, topology data, derived or original information, etc.) having been received (e.g. second reception of electronic transmission, etc.) at the one or more first fixed position base station devices (e.g. cellular towers, etc.) being part of a base station network (e.g. cellular network, etc.) including fixed position base station devices (e.g. other cellular towers, etc.), the second information regarding the one or more first communication related events (e.g. successful transmission, unsuccessful transmissions, communication obstruction identification, cost impositions, switch over to back-up network, etc.) involving the one or more first mobile operating system based mobile communication devices (e.g. smart phones, etc.) and the one or more first fixed position base station devices (e.g. cellular towers, etc.), each of the first communication related events involving one or more of the first mobile operating system based mobile communication devices (e.g. smartphones, etc.) and one or more of the first fixed position base station devices (e.g. cellular towers, etc.), the third information (e.g. statistics, incident data, performance data, topology data, derived or original information, etc.) regarding the fourth information (e.g. statistics, incident data, performance data, topology data, derived or original information, etc.) the fourth information having been received (e.g. fourth reception of cellular transmission, etc.) at the one or more second fixed position base station devices (e.g. wall mounted cellular base stations, etc.) being part of the base station network (e.g. cellular network, etc.) including fixed position base station devices (e.g. wall mounted cellular base stations, etc.), the fourth information regarding the one or more second communication related events (e.g. successful transmissions, unsuccessful transmissions, failed equipment, performance assessment, etc.) occurring directly (e.g. line-of-sight communication, point-to-point communication, one device transmits and the other device receives, etc.) between the two or more second mobile operating system based mobile communication devices relating (e.g. determining, concluding, calculating, comparing, etc.) the first information regarding one or more aspects of one or more base station networks including one or more fixed position base station devices with the third information regarding one or more aspects of communication relay networks (e.g. receiving through network packet traffic, etc.) furnished by one or more second mobile operating system based mobile communication devices relating first availability forecast ratings (e.g. based upon forecasted use by the end-users, planned travel locations in relation to known potential obstructions, etc.) for one or more fixed position base station devices (e.g. cellular relay device, etc.) of one or more base station networks (e.g. cellular networks, etc.) with relating second availability forecast ratings (e.g. percent overall access availability, etc.) for one or more second mobile operating system based mobile communication devices (e.g. tablet, etc.) of one or more second communication relay networks (e.g. temporary network, etc.).

In one or more implementations, as shown in FIG. 14F, the operation o1301 can include operation o1314 for relating the first information regarding one or more aspects of one or more base station networks including one or more fixed position base station devices with the third information regarding one or more aspects of communication relay networks furnished by one or more second mobile operating system based mobile communication devices including relating first reliability ratings for one or more fixed position base station devices of one or more base station networks with relating second reliability ratings for one or more second mobile operating system based mobile communication devices of one or more second communication relay networks. Origination of a physically tangible component group can be accomplished through skilled in the art design choice selection including use of one or more components and/or subsystems explicitly and/or implicitly referred to herein for at least in part implementing execution of one or more instructions i1314 of the operation o1314, for performance of the operation o1314 by an electrical circuitry arrangement e1314 as activated thereto, and/or otherwise fulfillment of the operation o1314. One or more non-transitory signal bearing physical media can bear the one or more instructions i1314 that when executed can direct performance of the operation o1314. Furthermore, relating first reliability ratings for fixed position base station devices of base station networks with relating second reliability ratings for second mobile operating system based mobile communication devices of second communication relay networks module m1314 depicted in FIG. 10C as being included in the module m1301, when executed and/or activated, can direct performance of and/or perform the operation o1314. Illustratively, in one or more implementations, the operation o1314 can be carried out, for example, by relating (e.g. associating, interrelating, comparing, contrasting, summarizing, filtering, condensing, ascribing, connecting, combining, referencing, orienting, etc.) the first information (e.g. statistics, incident data, performance data, topology data, derived or original information, etc.) with the third information (e.g. statistics, incident data, performance data, topology data, derived or original information, etc.), the first information (e.g. statistics, incident data, performance data, topology data, derived or original information, etc.) regarding the second information (e.g. statistics, incident data, performance data, topology data, derived or original information, etc.) having been received (e.g. second reception of electronic transmission, etc.) at the one or more first fixed position base station devices (e.g. cellular towers, etc.) being part of a base station network (e.g. cellular network, etc.) including fixed position base station devices (e.g. other cellular towers, etc.), the second information regarding the one or more first communication related events (e.g. successful transmission, unsuccessful transmissions, communication obstruction identification, cost impositions, switch over to back-up network, etc.) involving the one or more first mobile operating system based mobile communication devices (e.g. smart phones, etc.) and the one or more first fixed position base station devices (e.g. cellular towers, etc.), each of the first communication related events involving one or more of the first mobile operating system based mobile communication devices (e.g. smartphones, etc.) and one or more of the first fixed position base station devices (e.g. cellular towers, etc.), the third information (e.g. statistics, incident data, performance data, topology data, derived or original information, etc.) regarding the fourth information (e.g. statistics, incident data, performance data, topology data, derived or original information, etc.) the fourth information having been received (e.g. fourth reception of cellular transmission, etc.) at the one or more second fixed position base station devices (e.g. wall mounted cellular base stations, etc.) being part of the base station network (e.g. cellular network, etc.) including fixed position base station devices (e.g. wall mounted cellular base stations, etc.), the fourth information regarding the one or more second communication related events (e.g. successful transmissions, unsuccessful transmissions, failed equipment, performance assessment, etc.) occurring directly (e.g. line-of-sight communication, point-to-point communication, one device transmits and the other device receives, etc.) between the two or more second mobile operating system based mobile communication devices relating (e.g. determining, concluding, calculating, comparing, etc.) the first information regarding one or more aspects of one or more base station networks including one or more fixed position base station devices with the third information regarding one or more aspects of communication relay networks (e.g. receiving through network packet traffic, etc.) furnished by one or more second mobile operating system based mobile communication devices relating first reliability ratings (e.g. accounts of down time, lack of capacity, etc. of past networks involved with the intermediate electronic communication devices, etc.) for one or more fixed position base station devices (e.g. cellular tower, etc.) of one or more base station networks (e.g. cellular phone networks, etc.) with relating second reliability ratings (e.g. accounts of down time, lack of capacity, etc. of past networks involved with the intermediate electronic communication devices, etc.) for one or more second mobile operating system based mobile communication devices (e.g. smartphones, etc.) of one or more second communication relay networks (e.g. cellular networks, etc.).

In one or more implementations, as shown in FIG. 14F, the operation o1301 can include operation o1315 for relating the first information regarding one or more aspects of one or more base station networks including one or more fixed position base station devices with the third information regarding one or more aspects of communication relay networks furnished by one or more second mobile operating system based mobile communication devices including relating first duration of connection ratings for one or more fixed position base station devices of one or more base station networks with relating second duration of connection ratings for one or more second mobile operating system based mobile communication devices of one or more second communication relay networks. Origination of a physically tangible component group can be accomplished through skilled in the art design choice selection including use of one or more components and/or subsystems explicitly and/or implicitly referred to herein for at least in part implementing execution of one or more instructions i1315 of the operation o1315, for performance of the operation o1315 by an electrical circuitry arrangement e1315 as activated thereto, and/or otherwise fulfillment of the operation o1315. One or more non-transitory signal bearing physical media can bear the one or more instructions i1315 that when executed can direct performance of the operation o1315. Furthermore, relating first duration of connection ratings for fixed position base station devices of base station networks with relating second duration of connection ratings for second mobile operating system based mobile communication devices of second communication relay networks module m1315 depicted in FIG. 10C as being included in the module m1301, when executed and/or activated, can direct performance of and/or perform the operation o1315. Illustratively, in one or more implementations, the operation o1315 can be carried out, for example, by relating (e.g. associating, interrelating, comparing, contrasting, summarizing, filtering, condensing, ascribing, connecting, combining, referencing, orienting, etc.) the first information (e.g. statistics, incident data, performance data, topology data, derived or original information, etc.) with the third information (e.g. statistics, incident data, performance data, topology data, derived or original information, etc.), the first information (e.g. statistics, incident data, performance data, topology data, derived or original information, etc.) regarding the second information (e.g. statistics, incident data, performance data, topology data, derived or original information, etc.) having been received (e.g. second reception of electronic transmission, etc.) at the one or more first fixed position base station devices (e.g. cellular towers, etc.) being part of a base station network (e.g. cellular network, etc.) including fixed position base station devices (e.g. other cellular towers, etc.), the second information regarding the one or more first communication related events (e.g. successful transmission, unsuccessful transmissions, communication obstruction identification, cost impositions, switch over to back-up network, etc.) involving the one or more first mobile operating system based mobile communication devices (e.g. smart phones, etc.) and the one or more first fixed position base station devices (e.g. cellular towers, etc.), each of the first communication related events involving one or more of the first mobile operating system based mobile communication devices (e.g. smartphones, etc.) and one or more of the first fixed position base station devices (e.g. cellular towers, etc.), the third information (e.g. statistics, incident data, performance data, topology data, derived or original information, etc.) regarding the fourth information (e.g. statistics, incident data, performance data, topology data, derived or original information, etc.) the fourth information having been received (e.g. fourth reception of cellular transmission, etc.) at the one or more second fixed position base station devices (e.g. wall mounted cellular base stations, etc.) being part of the base station network (e.g. cellular network, etc.) including fixed position base station devices (e.g. wall mounted cellular base stations, etc.), the fourth information regarding the one or more second communication related events (e.g. successful transmissions, unsuccessful transmissions, failed equipment, performance assessment, etc.) occurring directly (e.g. line-of-sight communication, point-to-point communication, one device transmits and the other device receives, etc.) between the two or more second mobile operating system based mobile communication devices relating (e.g. determining, concluding, calculating, comparing, etc.) the first information regarding one or more aspects of one or more base station networks including one or more fixed position base station devices with the third information regarding one or more aspects of communication relay networks (e.g. receiving through network packet traffic, etc.) furnished by one or more second mobile operating system based mobile communication devices relating first duration of connection ratings (e.g. percentage of online network time compared with total time attempted to be online associated with general communication activities or particular communication activities as standby network nodes regarding the intermediate electronic communication devices, etc.) for one or more fixed position base station devices (e.g. cellular base station, etc.) of one or more base station networks (e.g. cellular networks, etc.) with relating second duration of connection ratings (e.g. percentage of online network time compared with total time attempted to be online associated with general communication activities or particular communication activities as standby network nodes regarding the intermediate electronic communication devices, etc.) for one or more second mobile operating system based mobile communication devices (e.g. smartphone, etc.) of one or more second communication relay networks (e.g. backup networks, etc.).

In one or more implementations, as shown in FIG. 14G, the operation o1301 can include operation o1316 for relating the first information regarding one or more aspects of one or more base station networks including one or more fixed position base station devices with the third information regarding one or more aspects of communication relay networks furnished by one or more second mobile operating system based mobile communication devices including relating first communication bandwidth ratings for one or more fixed position base station devices of one or more base station networks with relating second communication bandwidth ratings for one or more second mobile operating system based mobile communication devices of one or more second communication relay networks. Origination of a physically tangible component group can be accomplished through skilled in the art design choice selection including use of one or more components and/or subsystems explicitly and/or implicitly referred to herein for at least in part implementing execution of one or more instructions i1316 of the operation o1316, for performance of the operation o1316 by an electrical circuitry arrangement e1316 as activated thereto, and/or otherwise fulfillment of the operation o1316. One or more non-transitory signal bearing physical media can bear the one or more instructions i1316 that when executed can direct performance of the operation o1316. Furthermore, relating first communication bandwidth ratings for fixed position base station devices of base station networks with relating second communication bandwidth ratings for second mobile operating system based mobile communication devices of second communication relay networks module m1316 depicted in FIG. 10C as being included in the module m1301, when executed and/or activated, can direct performance of and/or perform the operation o1316. Illustratively, in one or more implementations, the operation o1316 can be carried out, for example, by relating (e.g. associating, interrelating, comparing, contrasting, summarizing, filtering, condensing, ascribing, connecting, combining, referencing, orienting, etc.) the first information (e.g. statistics, incident data, performance data, topology data, derived or original information, etc.) with the third information (e.g. statistics, incident data, performance data, topology data, derived or original information, etc.), the first information (e.g. statistics, incident data, performance data, topology data, derived or original information, etc.) regarding the second information (e.g. statistics, incident data, performance data, topology data, derived or original information, etc.) having been received (e.g. second reception of electronic transmission, etc.) at the one or more first fixed position base station devices (e.g. cellular towers, etc.) being part of a base station network (e.g. cellular network, etc.) including fixed position base station devices (e.g. other cellular towers, etc.), the second information regarding the one or more first communication related events (e.g. successful transmission, unsuccessful transmissions, communication obstruction identification, cost impositions, switch over to back-up network, etc.) involving the one or more first mobile operating system based mobile communication devices (e.g. smart phones, etc.) and the one or more first fixed position base station devices (e.g. cellular towers, etc.), each of the first communication related events involving one or more of the first mobile operating system based mobile communication devices (e.g. smartphones, etc.) and one or more of the first fixed position base station devices (e.g. cellular towers, etc.), the third information (e.g. statistics, incident data, performance data, topology data, derived or original information, etc.) regarding the fourth information (e.g. statistics, incident data, performance data, topology data, derived or original information, etc.) the fourth information having been received (e.g. fourth reception of cellular transmission, etc.) at the one or more second fixed position base station devices (e.g. wall mounted cellular base stations, etc.) being part of the base station network (e.g. cellular network, etc.) including fixed position base station devices (e.g. wall mounted cellular base stations, etc.), the fourth information regarding the one or more second communication related events (e.g. successful transmissions, unsuccessful transmissions, failed equipment, performance assessment, etc.) occurring directly (e.g. line-of-sight communication, point-to-point communication, one device transmits and the other device receives, etc.) between the two or more second mobile operating system based mobile communication devices relating (e.g. determining, concluding, calculating, comparing, etc.) the first information regarding one or more aspects of one or more base station networks including one or more fixed position base station devices with the third information regarding one or more aspects of communication relay networks (e.g. receiving through network packet traffic, etc.) furnished by one or more second mobile operating system based mobile communication devices relating first communication bandwidth ratings (e.g. communication speed such as in gigabits per second associated with general communication activities or particular communication activities as standby network nodes regarding the intermediate electronic communication devices, etc.) for one or more fixed position base station devices (e.g. cellular towers, etc.) of one or more base station networks (e.g. cellular networks, etc.) with relating second communication bandwidth ratings (e.g. communication speed such as in gigabits per second associated with general communication activities or particular communication activities as standby network nodes regarding the intermediate electronic communication devices, etc.) for one or more second mobile operating system based mobile communication devices (e.g. Windows OS mobile phablets, etc.) of one or more second communication relay networks (e.g. temporary networks, etc.).

In one or more implementations, as shown in FIG. 14G, the operation o1301 can include operation o1317 for relating the first information regarding one or more aspects of one or more base station networks including one or more fixed position base station devices with the third information regarding one or more aspects of communication relay networks furnished by one or more second mobile operating system based mobile communication devices including relating first ease of use ratings for one or more fixed position base station devices of one or more base station networks with relating second ease of use ratings for one or more second mobile operating system based mobile communication devices of one or more second communication relay networks. Origination of a physically tangible component group can be accomplished through skilled in the art design choice selection including use of one or more components and/or subsystems explicitly and/or implicitly referred to herein for at least in part implementing execution of one or more instructions i1317 of the operation o1317, for performance of the operation o1317 by an electrical circuitry arrangement e1317 as activated thereto, and/or otherwise fulfillment of the operation o1317. One or more non-transitory signal bearing physical media can bear the one or more instructions i1317 that when executed can direct performance of the operation o1317. Furthermore, relating first ease of use ratings for fixed position base station devices of base station networks with relating second ease of use ratings for second mobile operating system based mobile communication devices of second communication relay networks module m1317 depicted in FIG. 10C as being included in the module m1301, when executed and/or activated, can direct performance of and/or perform the operation o1317. Illustratively, in one or more implementations, the operation o1317 can be carried out, for example, by relating (e.g. associating, interrelating, comparing, contrasting, summarizing, filtering, condensing, ascribing, connecting, combining, referencing, orienting, etc.) the first information (e.g. statistics, incident data, performance data, topology data, derived or original information, etc.) with the third information (e.g. statistics, incident data, performance data, topology data, derived or original information, etc.), the first information (e.g. statistics, incident data, performance data, topology data, derived or original information, etc.) regarding the second information (e.g. statistics, incident data, performance data, topology data, derived or original information, etc.) having been received (e.g. second reception of electronic transmission, etc.) at the one or more first fixed position base station devices (e.g. cellular towers, etc.) being part of a base station network (e.g. cellular network, etc.) including fixed position base station devices (e.g. other cellular towers, etc.), the second information regarding the one or more first communication related events (e.g. successful transmission, unsuccessful transmissions, communication obstruction identification, cost impositions, switch over to back-up network, etc.) involving the one or more first mobile operating system based mobile communication devices (e.g. smart phones, etc.) and the one or more first fixed position base station devices (e.g. cellular towers, etc.), each of the first communication related events involving one or more of the first mobile operating system based mobile communication devices (e.g. smartphones, etc.) and one or more of the first fixed position base station devices (e.g. cellular towers, etc.), the third information (e.g. statistics, incident data, performance data, topology data, derived or original information, etc.) regarding the fourth information (e.g. statistics, incident data, performance data, topology data, derived or original information, etc.) the fourth information having been received (e.g. fourth reception of cellular transmission, etc.) at the one or more second fixed position base station devices (e.g. wall mounted cellular base stations, etc.) being part of the base station network (e.g. cellular network, etc.) including fixed position base station devices (e.g. wall mounted cellular base stations, etc.), the fourth information regarding the one or more second communication related events (e.g. successful transmissions, unsuccessful transmissions, failed equipment, performance assessment, etc.) occurring directly (e.g. line-of-sight communication, point-to-point communication, one device transmits and the other device receives, etc.) between the two or more second mobile operating system based mobile communication devices relating (e.g. determining, concluding, calculating, comparing, etc.) the first information regarding one or more aspects of one or more base station networks including one or more fixed position base station devices with the third information regarding one or more aspects of communication relay networks (e.g. receiving through network packet traffic, etc.) furnished by one or more second mobile operating system based mobile communication devices relating first ease of use ratings (e.g. estimated ratings for future performance to indicate preferred configurations of intermediate electronic communication devices to constitute one or more standby electronic communication networks, etc.) for one or more fixed position base station devices (e.g. wall-mounted base station, etc.) of one or more base station networks (e.g. data communication networks, etc.) with relating second ease of use ratings (e.g. estimated ratings for future performance to indicate preferred configurations of intermediate electronic communication devices to constitute one or more standby electronic communication networks, etc.) for one or more second mobile operating system based mobile communication devices (e.g. laptops, etc.) of one or more second communication relay networks (e.g. data communication networks, etc.).

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

The one or more instructions discussed herein may be, for example, computer executable and/or logic-implemented instructions. In some implementations, signal-bearing medium as articles of manufacture may store the one or more instructions. In some implementations, the signal bearing medium may include a computer-readable medium. In some implementations, the signal-bearing medium may include a recordable medium. In some implementations, the signal-bearing medium may include a communication medium.

Those having skill in the art will recognize that the state of the art has progressed to the point where there is little distinction left between hardware and software implementations of aspects of systems; the use of hardware or software is generally (but not always, in that in certain contexts the choice between hardware an d software can become significant) a design choice representing cost vs. efficiency tradeoffs. Those having skill in the art will appreciate that there are various vehicles by which processes and/or systems and/or other technologies described herein can be effected (e.g., hardware, software, and/or firmware in one or more machines or articles of manufacture), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation that is implemented in one or more machines or articles of manufacture; or, yet again alternatively, the implementer may opt for some combination of hardware, software, and/or firmware in one or more machines or articles of manufacture (limited to patentable subject matter under 35 USC 101). Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware in one or more machines or articles of manufacture.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof (limited to patentable subject matter under 35 U.S.C. 101). In one embodiment, several portions of the subject matter described herein may be implemented via Application Specific Integrated Circuitry (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuitry, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure (limited to patentable subject matter under 35 USC 101). In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, (e.g., transmitter, receiver, transmission logic, reception logic, etc.), etc.).

### Electro-Mechanical System Support

In a general sense, those skilled in the art will recognize that the various embodiments described herein can be implemented, individually and/or collectively, by various types of electro-mechanical systems having a wide range of electrical components such as hardware, software, firmware, and/or virtually any combination thereof; and a wide range of components that may impart mechanical force or motion such as rigid bodies, spring or torsional bodies, hydraulics, electro-magnetically actuated devices, and/or virtually any combination thereof. Consequently, as used herein “electro-mechanical system” includes, but is not limited to, electrical circuitry operably coupled with a transducer (e.g., an actuator, a motor, a piezoelectric crystal, a Micro Electro Mechanical System (MEMS), etc.), electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), electrical circuitry forming a communications device (e.g., a modem, communications switch, optical-electrical equipment, etc.), and/or any non-electrical analog thereto, such as optical or other analogs (e.g., graphene based circuitry). Those skilled in the art will also appreciate that examples of electro-mechanical systems include but are not limited to a variety of consumer electronics systems, medical devices, as well as other systems such as motorized transport systems, factory automation systems, security systems, and/or communication/computing systems. Those skilled in the art will recognize that electro-mechanical as used herein is not necessarily limited to a system that has both electrical and mechanical actuation except as context may dictate otherwise.

### Electrical Circuitry Support

In a general sense, those skilled in the art will recognize that the various aspects described herein which can be implemented, individually and/or collectively, by a wide range of hardware, software, firmware, and/or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), and/or electrical circuitry forming a communications device (e.g., a modem, communications switch, optical-electrical equipment, etc.). Those having skill in the art will recognize that the subject matter described herein may be implemented in an analog or digital fashion or some combination thereof.

### Image Processing System Support

Those skilled in the art will recognize that at least a portion of the devices and/or processes described herein can be integrated into an image processing system. Those having skill in the art will recognize that a typical image processing system generally includes one or more of a system unit housing, a video display device, memory such as volatile or non-volatile memory, processors such as microprocessors or digital signal processors, computational entities such as operating systems, drivers, applications programs, one or more interaction devices (e.g., a touch pad, a touch screen, an antenna, etc.), control systems including feedback loops and control motors (e.g., feedback for sensing lens position and/or velocity; control motors for moving/distorting lenses to give desired focuses). An image processing system may be implemented utilizing suitable commercially available components, such as those typically found in digital still systems and/or digital motion systems.

### Data Processing System Support

Those skilled in the art will recognize that at least a portion of the devices and/or processes described herein can be integrated into a data processing system. Those having skill in the art will recognize that a data processing system generally includes one or more of a system unit housing, a video display device, memory such as volatile or non-volatile memory, processors such as microprocessors or digital signal processors, computational entities such as operating systems, drivers, graphical user interfaces, and applications programs, one or more interaction devices (e.g., a touch pad, a touch screen, an antenna, etc.), and/or control systems including feedback loops and control motors (e.g., feedback for sensing position and/or velocity; control motors for moving and/or adjusting components and/or quantities). A data processing system may be implemented utilizing suitable commercially available components, such as those typically found in data computing/communication and/or network computing/communication systems.

### Software as Patentable Subject Matter Support

The claims, description, and drawings of this application may describe one or more of the instant technologies in operational/functional language, for example as a set of operations to be performed by a computer. Such operational/functional description in most instances would be understood by one skilled the art as specifically-configured hardware (e.g., because a general purpose computer in effect becomes a special purpose computer once it is programmed to perform particular functions pursuant to instructions from program software).

Importantly, although the operational/functional descriptions described herein are understandable by the human mind, they are not abstract ideas of the operations/functions divorced from computational implementation of those operations/functions. Rather, the operations/functions represent a specification for the massively complex computational machines or other means. As discussed in detail below, the operational/functional language must be read in its proper technological context, i.e., as concrete specifications for physical implementations.

The logical operations/functions described herein are a distillation of machine specifications or other physical mechanisms specified by the operations/functions such that the otherwise inscrutable machine specifications may be comprehensible to the human mind. The distillation also allows one of skill in the art to adapt the operational/functional description of the technology across many different specific vendors' hardware configurations or platforms, without being limited to specific vendors' hardware configurations or platforms.

Some of the present technical description (e.g., detailed description, drawings, claims, etc.) may be set forth in terms of logical operations/functions. As described in more detail in the following paragraphs, these logical operations/functions are not representations of abstract ideas, but rather representative of static or sequenced specifications of various hardware elements. Differently stated, unless context dictates otherwise, the logical operations/functions will be understood by those of skill in the art to be representative of static or sequenced specifications of various hardware elements. This is true because tools available to one of skill in the art to implement technical disclosures set forth in operational/functional formats—tools in the form of a high-level programming language (e.g., C, java, visual basic), etc.), or tools in the form of Very high speed Hardware Description Language (“VHDL,” which is a language that uses text to describe logic circuits)—are generators of static or sequenced specifications of various hardware configurations. This fact is sometimes obscured by the broad term “software,” but, as shown by the following explanation, those skilled in the art understand that what is termed “software” is a shorthand for a massively complex interchaining/specification of ordered-matter elements. The term “ordered-matter elements” may refer to physical components of computation, such as assemblies of electronic logic gates, molecular computing logic constituents, quantum computing mechanisms, etc.

For example, a high-level programming language is a programming language with strong abstraction, e.g., multiple levels of abstraction, from the details of the sequential organizations, states, inputs, outputs, etc., of the machines that a high-level programming language actually specifies. See, e.g., Wikipedia, High-level programming language, http://en.wikipedia.org/wiki/High-level_programming_language (as of Jun. 5, 2012, 21:00 GMT). In order to facilitate human comprehension, in many instances, high-level programming languages resemble or even share symbols with natural languages. See, e.g., Wikipedia, Natural language, http://en.wikipedia.org/wiki/Natural_language (as of Jun. 5, 2012, 21:00 GMT).

It has been argued that because high-level programming languages use strong abstraction (e.g., that they may resemble or share symbols with natural languages), they are therefore a “purely mental construct.” (e.g., that “software”—a computer program or computer programming—is somehow an ineffable mental construct, because at a high level of abstraction, it can be conceived and understood in the human mind). This argument has been used to characterize technical description in the form of functions/operations as somehow “abstract ideas.” In fact, in technological arts (e.g., the information and communication technologies) this is not true.

The fact that high-level programming languages use strong abstraction to facilitate human understanding should not be taken as an indication that what is expressed is an abstract idea. In fact, those skilled in the art understand that just the opposite is true. If a high-level programming language is the tool used to implement a technical disclosure in the form of functions/operations, those skilled in the art will recognize that, far from being abstract, imprecise, “fuzzy,” or “mental” in any significant semantic sense, such a tool is instead a near incomprehensibly precise sequential specification of specific computational machines—the parts of which are built up by activating/selecting such parts from typically more general computational machines over time (e.g., clocked time). This fact is sometimes obscured by the superficial similarities between high-level programming languages and natural languages. These superficial similarities also may cause a glossing over of the fact that high-level programming language implementations ultimately perform valuable work by creating/controlling many different computational machines.

The many different computational machines that a high-level programming language specifies are almost unimaginably complex. At base, the hardware used in the computational machines typically consists of some type of ordered matter (e.g., traditional electronic devices (e.g., transistors), deoxyribonucleic acid (DNA), quantum devices, mechanical switches, optics, fluidics, pneumatics, optical devices (e.g., optical interference devices), molecules, etc.) that are arranged to form logic gates. Logic gates are typically physical devices that may be electrically, mechanically, chemically, or otherwise driven to change physical state in order to create a physical reality of Boolean logic.

Logic gates may be arranged to form logic circuits, which are typically physical devices that may be electrically, mechanically, chemically, or otherwise driven to create a physical reality of certain logical functions. Types of logic circuits include such devices as multiplexers, registers, arithmetic logic units (ALUs), computer memory, etc., each type of which may be combined to form yet other types of physical devices, such as a central processing unit (CPU)—the best known of which is the microprocessor. A modern microprocessor will often contain more than one hundred million logic gates in its many logic circuits (and often more than a billion transistors). See, e.g., Wikipedia, Logic gates, http://en.wikipedia.org/wiki/Logic_gates (as of Jun. 5, 2012, 21:03 GMT).

The logic circuits forming the microprocessor are arranged to provide a microarchitecture that will carry out the instructions defined by that microprocessor's defined Instruction Set Architecture. The Instruction Set Architecture is the part of the microprocessor architecture related to programming, including the native data types, instructions, registers, addressing modes, memory architecture, interrupt and exception handling, and external Input/Output. See, e.g., Wikipedia, Computer architecture, http://en.wikipedia.org/wiki/Computer_architecture (as of Jun. 5, 2012, 21:03 GMT).

The Instruction Set Architecture includes a specification of the machine language that can be used by programmers to use/control the microprocessor. Since the machine language instructions are such that they may be executed directly by the microprocessor, typically they consist of strings of binary digits, or bits. For example, a typical machine language instruction might be many bits long (e.g., 32, 64, or 128 bit strings are currently common). A typical machine language instruction might take the form “11110000101011110000111100111111” (a 32 bit instruction).

It is significant here that, although the machine language instructions are written as sequences of binary digits, in actuality those binary digits specify physical reality. For example, if certain semiconductors are used to make the operations of Boolean logic a physical reality, the apparently mathematical bits “1” and “0” in a machine language instruction actually constitute a shorthand that specifies the application of specific voltages to specific wires. For example, in some semiconductor technologies, the binary number “1” (e.g., logical “1”) in a machine language instruction specifies around +5 volts applied to a specific “wire” (e.g., metallic traces on a printed circuit board) and the binary number “0” (e.g., logical “0”) in a machine language instruction specifies around −5 volts applied to a specific “wire.” In addition to specifying voltages of the machines' configuration, such machine language instructions also select out and activate specific groupings of logic gates from the millions of logic gates of the more general machine. Thus, far from abstract mathematical expressions, machine language instruction programs, even though written as a string of zeros and ones, specify many, many constructed physical machines or physical machine states.

Machine language is typically incomprehensible by most humans (e.g., the above example was just ONE instruction, and some personal computers execute more than two billion instructions every second). See, e.g., Wikipedia, Instructions per second, http://en.wikipedia.org/wiki/Instructions_per_second (as of Jun. 5, 2012, 21:04 GMT). Thus, programs written in machine language—which may be tens of millions of machine language instructions long—are incomprehensible. In view of this, early assembly languages were developed that used mnemonic codes to refer to machine language instructions, rather than using the machine language instructions' numeric values directly (e.g., for performing a multiplication operation, programmers coded the abbreviation “mult,” which represents the binary number “011000” in MIPS machine code). While assembly languages were initially a great aid to humans controlling the microprocessors to perform work, in time the complexity of the work that needed to be done by the humans outstripped the ability of humans to control the microprocessors using merely assembly languages.

At this point, it was noted that the same tasks needed to be done over and over, and the machine language necessary to do those repetitive tasks was the same. In view of this, compilers were created. A compiler is a device that takes a statement that is more comprehensible to a human than either machine or assembly language, such as “add 2+2 and output the result,” and translates that human understandable statement into a complicated, tedious, and immense machine language code (e.g., millions of 32, 64, or 128 bit length strings). Compilers thus translate high-level programming language into machine language.

This compiled machine language, as described above, is then used as the technical specification which sequentially constructs and causes the interoperation of many different computational machines such that humanly useful, tangible, and concrete work is done. For example, as indicated above, such machine language—the compiled version of the higher-level language—functions as a technical specification which selects out hardware logic gates, specifies voltage levels, voltage transition timings, etc., such that the humanly useful work is accomplished by the hardware.

Thus, a functional/operational technical description, when viewed by one of skill in the art, is far from an abstract idea. Rather, such a functional/operational technical description, when understood through the tools available in the art such as those just described, is instead understood to be a humanly understandable representation of a hardware specification, the complexity and specificity of which far exceeds the comprehension of most any one human. With this in mind, those skilled in the art will understand that any such operational/functional technical descriptions—in view of the disclosures herein and the knowledge of those skilled in the art—may be understood as operations made into physical reality by (a) one or more interchained physical machines, (b) interchained logic gates configured to create one or more physical machine(s) representative of sequential/combinatorial logic(s), (c) interchained ordered matter making up logic gates (e.g., interchained electronic devices (e.g., transistors), DNA, quantum devices, mechanical switches, optics, fluidics, pneumatics, molecules, etc.) that create physical reality representative of logic(s), or (d) virtually any combination of the foregoing. Indeed, any physical object which has a stable, measurable, and changeable state may be used to construct a machine based on the above technical description. Charles Babbage, for example, constructed the first computer out of wood and powered by cranking a handle.

Thus, far from being understood as an abstract idea, those skilled in the art will recognize a functional/operational technical description as a humanly-understandable representation of one or more almost unimaginably complex and time sequenced hardware instantiations. The fact that functional/operational technical descriptions might lend themselves readily to high-level computing languages (or high-level block diagrams for that matter) that share some words, structures, phrases, etc. with natural language simply cannot be taken as an indication that such functional/operational technical descriptions are abstract ideas, or mere expressions of abstract ideas. In fact, as outlined herein, in the technological arts this is simply not true. When viewed through the tools available to those of skill in the art, such functional/operational technical descriptions are seen as specifying hardware configurations of almost unimaginable complexity.

As outlined above, the reason for the use of functional/operational technical descriptions is at least twofold. First, the use of functional/operational technical descriptions allows near-infinitely complex machines and machine operations arising from interchained hardware elements to be described in a manner that the human mind can process (e.g., by mimicking natural language and logical narrative flow). Second, the use of functional/operational technical descriptions assists the person of skill in the art in understanding the described subject matter by providing a description that is more or less independent of any specific vendor's piece(s) of hardware.

The use of functional/operational technical descriptions assists the person of skill in the art in understanding the described subject matter since, as is evident from the above discussion, one could easily, although not quickly, transcribe the technical descriptions set forth in this document as trillions of ones and zeroes, billions of single lines of assembly-level machine code, millions of logic gates, thousands of gate arrays, or any number of intermediate levels of abstractions. However, if any such low-level technical descriptions were to replace the present technical description, a person of skill in the art could encounter undue difficulty in implementing the disclosure, because such a low-level technical description would likely add complexity without a corresponding benefit (e.g., by describing the subject matter utilizing the conventions of one or more vendor-specific pieces of hardware). Thus, the use of functional/operational technical descriptions assists those of skill in the art by separating the technical descriptions from the conventions of any vendor-specific piece of hardware.

In view of the foregoing, the logical operations/functions set forth in the present technical description are representative of static or sequenced specifications of various ordered-matter elements, in order that such specifications may be comprehensible to the human mind and adaptable to create many various hardware configurations. The logical operations/functions disclosed herein should be treated as such, and should not be disparagingly characterized as abstract ideas merely because the specifications they represent are presented in a manner that one of skill in the art can readily understand and apply in a manner independent of a specific vendor's hardware implementation.

### Mote System Support

Those skilled in the art will recognize that at least a portion of the devices and/or processes described herein can be integrated into a mote system. Those having skill in the art will recognize that a typical mote system generally includes one or more memories such as volatile or non-volatile memories, processors such as microprocessors or digital signal processors, computational entities such as operating systems, user interfaces, drivers, sensors, actuators, applications programs, one or more interaction devices (e.g., an antenna USB ports, acoustic ports, etc.), control systems including feedback loops and control motors (e.g., feedback for sensing or estimating position and/or velocity; control motors for moving and/or adjusting components and/or quantities). A mote system may be implemented utilizing suitable components, such as those found in mote computing/communication systems. Specific examples of such components entail such as Intel Corporation's and/or Crossbow Corporation's mote components and supporting hardware, software, and/or firmware.

### Licensing System Support Language

Those skilled in the art will recognize that it is common within the art to implement devices and/or processes and/or systems, and thereafter use engineering and/or other practices to integrate such implemented devices and/or processes and/or systems into more comprehensive devices and/or processes and/or systems. That is, at least a portion of the devices and/or processes and/or systems described herein can be integrated into other devices and/or processes and/or systems via a reasonable amount of experimentation. Those having skill in the art will recognize that examples of such other devices and/or processes and/or systems might include—as appropriate to context and application—all or part of devices and/or processes and/or systems of (a) an air conveyance (e.g., an airplane, rocket, helicopter, etc.), (b) a ground conveyance (e.g., a car, truck, locomotive, tank, armored personnel carrier, etc.), (c) a building (e.g., a home, warehouse, office, etc.), (d) an appliance (e.g., a refrigerator, a washing machine, a dryer, etc.), (e) a communications system (e.g., a networked system, a telephone system, a Voice over IP system, etc.), (f) a business entity (e.g., an Internet Service Provider (ISP) entity such as Comcast Cable, Qwest, Southwestern Bell, etc.), or (g) a wired/wireless services entity (e.g., Sprint, Cingular, Nextel, etc.), etc.

### Extraterritorial Use Language

In certain cases, use of a system or method may occur in a territory even if components are located outside the territory. For example, in a distributed computing context, use of a distributed computing system may occur in a territory even though parts of the system may be located outside of the territory (e.g., relay, server, processor, signal-bearing medium, transmitting computer, receiving computer, etc. located outside the territory).

A sale of a system or method may likewise occur in a territory even if components of the system or method are located and/or used outside the territory. Further, implementation of at least part of a system for performing a method in one territory does not preclude use of the system in another territory.

### Residual Incorporation Language

All of the above U.S. patents, U.S. patent application publications, U.S. patent applications, foreign patents, foreign patent applications and non-patent publications referred to in this specification and/or listed in any Application Data Sheet, are incorporated herein by reference, to the extent not inconsistent herewith.

### Not Limited to Implementations Described Language

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken limiting.

### Not Limited to Human User Language

Although user XXX is shown/described herein as a single illustrated figure, those skilled in the art will appreciate that user XXX may be representative of a human user, a robotic user (e.g., computational entity), and/or substantially any combination thereof (e.g., a user may be assisted by one or more robotic agents) unless context dictates otherwise. Those skilled in the art will appreciate that, in general, the same may be said of “sender” and/or other entity-oriented terms as such terms are used herein unless context dictates otherwise.

### Plural Terms Language

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

### Operably-Coupled Language

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components, and/or wirelessly interactable, and/or wirelessly interacting components, and/or logically interacting, and/or logically interactable components.

Active/Inactive Component Language

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (e.g. “configured to”) generally encompass active-state components and/or inactive-state components and/or standby-state components, unless context requires otherwise.

### Cloud Computing Standard Language

For the purposes of this application, “cloud” computing may be understood as described in the cloud computing literature. For example, cloud computing may be methods and/or systems for the delivery of computational capacity and/or storage capacity as a service. The “cloud” may refer to one or more hardware and/or software components that deliver or assist in the delivery of computational and/or storage capacity, including, but not limited to, one or more of a client, an application, a platform, an infrastructure, and/or a server The cloud may refer to any of the hardware and/or software associated with a client, an application, a platform, an infrastructure, and/or a server. For example, cloud and cloud computing may refer to one or more of a computer, a processor, a storage medium, a router, a switch, a modem, a virtual machine (e.g., a virtual server), a data center, an operating system, a middleware, a firmware, a hardware back-end, a software back-end, and/or a software application. A cloud may refer to a private cloud, a public cloud, a hybrid cloud, and/or a community cloud. A cloud may be a shared pool of configurable computing resources, which may be public, private, semi-private, distributable, scalable, flexible, temporary, virtual, and/or physical. A cloud or cloud service may be delivered over one or more types of network, e.g., a mobile communication network, and the Internet.

As used in this application, a cloud or a cloud service may include one or more of infrastructure-as-a-service (“IaaS”), platform-as-a-service (“PaaS”), software-as-a-service (“SaaS”), and/or desktop-as-a-service (“DaaS”). As a non-exclusive example, IaaS may include, e.g., one or more virtual server instantiations that may start, stop, access, and/or configure virtual servers and/or storage centers (e.g., providing one or more processors, storage space, and/or network resources on-demand, e.g., EMC and Rackspace). PaaS may include, e.g., one or more software and/or development tools hosted on an infrastructure (e.g., a computing platform and/or a solution stack from which the client can create software interfaces and applications, e.g., Microsoft Azure). SaaS may include, e.g., software hosted by a service provider and accessible over a network (e.g., the software for the application and/or the data associated with that software application may be kept on the network, e.g., Google Apps, SalesForce). DaaS may include, e.g., providing desktop, applications, data, and/or services for the user over a network (e.g., providing a multi-application framework, the applications in the framework, the data associated with the applications, and/or services related to the applications and/or the data over the network, e.g., Citrix). The foregoing is intended to be exemplary of the types of systems and/or methods referred to in this application as “cloud” or “cloud computing” and should not be considered complete or exhaustive.

### Use of Trademarks in Specification Language

This application may make reference to one or more trademarks, e.g., a word, letter, symbol, or device adopted by one manufacturer or merchant and used to identify and/or distinguish his or her product from those of others. Trademark names used herein are set forth in such language that makes clear their identity, that distinguishes them from common descriptive nouns, that have fixed and definite meanings, or, in many if not all cases, are accompanied by other specific identification using terms not covered by trademark. In addition, trademark names used herein have meanings that are well-known and defined in the literature, or do not refer to products or compounds for which knowledge of one or more trade secrets is required in order to divine their meaning. All trademarks referenced in this application are the property of their respective owners, and the appearance of one or more trademarks in this application does not diminish or otherwise adversely affect the validity of the one or more trademarks. All trademarks, registered or unregistered, that appear in this application are assumed to include a proper trademark symbol, e.g., the circle R or bracketed capitalization (e.g., [trademark name]), even when such trademark symbol does not explicitly appear next to the trademark. To the extent a trademark is used in a descriptive manner to refer to a product or process, that trademark should be interpreted to represent the corresponding product or process as of the date of the filing of this patent application.

### Caselaw-Driven Clarification Language

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

What is claimed is:

1. A computationally-implemented method, comprising:
receiving first information regarding second information, the second information having been received at one or more first fixed position base station devices being part of a base station network including fixed position base station devices, the second information regarding one or more first communication related events involving one or more first mobile operating system based mobile communication devices and the one or more first fixed position base station devices, each of the first communication related events involving one or more of the first mobile operating system based mobile communication devices and one or more of the first fixed position base station devices;
receiving third information regarding fourth information, the fourth information having been received at one or more second fixed position base station devices being part of the base station network including fixed position base station devices, the fourth information regarding one or more second communication related events occurring directly between two or more second mobile operating system based mobile communication devices; and
relating the first information with the third information, the first information regarding the second information having been received at the one or more first fixed position base station devices being part of a base station network including fixed position base station devices, the second information regarding the one or more first communication related events involving the one or more first mobile operating system based mobile communication devices and the one or more first fixed position base station devices, each of the first communication related events involving one or more of the first mobile operating system based mobile communication devices and one or more of the first fixed position base station devices, the third information regarding the fourth information the fourth information having been received at the one or more second fixed position base station devices being part of the base station network including fixed position base station devices, the fourth information regarding the one or more second communication related events occurring directly between the two or more second mobile operating system based mobile communication devices.

2. The computationally-implemented method of claim 1, wherein the receiving first information regarding second information, the second information having been received at one or more first fixed position base station devices being part of a base station network including fixed position base station devices, the second information regarding one or more first communication related events involving one or more first mobile operating system based mobile communication devices and the one or more first fixed position base station devices, each of the first communication related events involving one or more of the first mobile operating system based mobile communication devices and one or more of the first fixed position base station devices comprises:
receiving first information regarding second information involving at least in part the one or more first mobile operating system based mobile communication devices including accessing data from a data source via a virtual machine representation of at least a part of a computing machine including accessing data from a data source via a virtual machine representation of at least a part of a real machine.

3. The computationally-implemented method of claim 1, wherein the receiving first information regarding second information, the second information having been received at one or more first fixed position base station devices being part of a base station network including fixed position base station devices, the second information regarding one or more first communication related events involving one or more first mobile operating system based mobile communication devices and the one or more first fixed position base station devices, each of the first communication related events involving one or more of the first mobile operating system based mobile communication devices and one or more of the first fixed position base station devices comprises:
receiving first information regarding second information involving at least in part the one or more first mobile operating system based mobile communication devices including accessing data from a data source via a virtual machine representation of at least a part of a computing machine including accessing data from a data source via a virtual machine representation of at least a part of a virtual machine.

4. The computationally-implemented method of claim 1, wherein the receiving first information regarding second information, the second information having been received at one or more first fixed position base station devices being part of a base station network including fixed position base station devices, the second information regarding one or more first communication related events involving one or more first mobile operating system based mobile communication devices and the one or more first fixed position base station devices, each of the first communication related events involving one or more of the first mobile operating system based mobile communication devices and one or more of the first fixed position base station devices comprises:
receiving first information regarding second information involving at least in part the one or more first mobile operating system based mobile communication devices including accessing data from a data source via a virtual machine representation of at least a part of a virtual machine including converting a file having a file-type associated with the virtual machine to a file-type associated with the virtual machine representation.

5. The computationally-implemented method of claim 4, wherein the receiving first information regarding second information involving at least in part the one or more first mobile operating system based mobile communication devices including accessing data from a data source via a virtual machine representation of at least a part of a virtual machine including converting a file having a file-type associated with the virtual machine to a file-type associated with the virtual machine representation comprises:
accessing data from a data source via a virtual machine representation of at least a part of a virtual machine including converting a file having a file-type associated with the virtual machine to a file-type associated with the virtual machine representation involving accessing data wherein the file-type associated with the second virtual machine is configured for a limited-resource computing machine.

6. The computationally-implemented method of claim 5, wherein the accessing data from a data source via a virtual machine representation of at least a part of a virtual machine including converting a file having a file-type associated with the virtual machine to a file-type associated with the virtual machine representation involving accessing data wherein the file-type associated with the second virtual machine is configured for a limited-resource computing machine comprises:
accessing data wherein the file-type associated with the second virtual machine is configured for a limited-resource computing machine involving receiving first information regarding at least in part wherein the file-type associated with the second virtual machine is configured for a mobile computing machine.

7. The computationally-implemented method of claim 1, wherein the receiving first information regarding second information, the second information having been received at one or more first fixed position base station devices being part of a base station network including fixed position base station devices, the second information regarding one or more first communication related events involving one or more first mobile operating system based mobile communication devices and the one or more first fixed position base station devices, each of the first communication related events involving one or more of the first mobile operating system based mobile communication devices and one or more of the first fixed position base station devices comprises:
receiving first information regarding second information involving at least in part the one or more first mobile operating system based mobile communication devices including receiving first information regarding at least part first mobile operating system based mobile communication devices (e.g. Android tablet, Samsung smartphone, etc.) being used by users (e.g. businessperson, etc.) thereof as a mobile handset communication devices (e.g. phablet, etc.) for communication with one or more users of other one or more mobile handset communication devices (e.g. Apple iPhones, etc.).

8. The computationally-implemented method of claim 1, wherein the receiving first information regarding second information, the second information having been received at one or more first fixed position base station devices being part of a base station network including fixed position base station devices, the second information regarding one or more first communication related events involving one or more first mobile operating system based mobile communication devices and the one or more first fixed position base station devices, each of the first communication related events involving one or more of the first mobile operating system based mobile communication devices and one or more of the first fixed position base station devices comprises:
receiving first information regarding second information involving at least in part the one or more first mobile operating system based mobile communication devices including receiving first information regarding at least in part first communication related events at least partially related to one or more communication transmissions received by one or more first fixed position base station devices being part of a base station network from first mobile operating system based mobile communication devices.

9. The computationally-implemented method of claim 8, wherein the receiving first information regarding second information involving at least in part the one or more first mobile operating system based mobile communication devices including receiving first information regarding at least in part first communication related events at least partially related to one or more communication transmissions received by one or more first fixed position base station devices being part of a base station network from first mobile operating system based mobile communication devices comprises:
receiving first information regarding at least in part first communication related events at least partially related to one or more communication transmissions received by one or more first fixed position base station devices being part of a base station network from first mobile operating system based mobile communication devices including receiving first information regarding first communication related events involving one or more obstructed communication paths that the one or more first mobile operating system based mobile communication devices have encountered when attempting past communication with one or more fixed position base station devices.

10. The computationally-implemented method of claim 9, wherein the receiving first information regarding at least in part first communication related events at least partially related to one or more communication transmissions received by one or more first fixed position base station devices being part of a base station network from first mobile operating system based mobile communication devices including receiving first information regarding first communication related events involving one or more obstructed communication paths that the one or more first mobile operating system based mobile communication devices have encountered when attempting past communication with one or more fixed position base station devices comprises:
receiving first information regarding first communication related events involving one or more obstructed communication paths that the one or more first mobile operating system based mobile communication devices have encountered when attempting past communication with one or more fixed position base station devices including receiving location information regarding one or more moveable objects that have previously obstructed communication of one or more of the first mobile operating system based mobile communication devices.

11. The computationally-implemented method of claim 9, wherein the receiving first information regarding at least in part first communication related events at least partially related to one or more communication transmissions received by one or more first fixed position base station devices being part of a base station network from first mobile operating system based mobile communication devices including receiving first information regarding first communication related events involving one or more obstructed communication paths that the one or more first mobile operating system based mobile communication devices have encountered when attempting past communication with one or more fixed position base station devices comprises:
receiving first information regarding first communication related events involving one or more obstructed communication paths that the one or more first mobile operating system based mobile communication devices have encountered when attempting past communication with one or more fixed position base station devices including receiving location information regarding one or more fixed position objects that have previously obstructed communication of one or more of the first mobile operating system based mobile communication devices.

12. The computationally-implemented method of claim 8, wherein the receiving first information regarding second information involving at least in part the one or more first mobile operating system based mobile communication devices including receiving first information regarding at least in part first communication related events at least partially related to one or more communication transmissions received by one or more first fixed position base station devices being part of a base station network from first mobile operating system based mobile communication devices comprises:
receiving first information regarding at least in part first communication related events at least partially related to one or more communication transmissions received by one or more first fixed position base station devices being part of a base station network from first mobile operating system based mobile communication devices including receiving information regarding map data of one or more locations of one or more fixed position objects.

13. The computationally-implemented method of claim 8, wherein the receiving first information regarding second information involving at least in part the one or more first mobile operating system based mobile communication devices including receiving first information regarding at least in part first communication related events at least partially related to one or more communication transmissions received by one or more first fixed position base station devices being part of a base station network from first mobile operating system based mobile communication devices comprises:
receiving first information regarding at least in part first communication related events at least partially related to one or more communication transmissions received by one or more first fixed position base station devices being part of a base station network from first mobile operating system based mobile communication devices including receiving information regarding one or more time based distributions of instances of obstruction of electronic device communication for one or more particular geographical locations.

14. The computationally-implemented method of claim 8, wherein the receiving first information regarding second information involving at least in part the one or more first mobile operating system based mobile communication devices including receiving first information regarding at least in part first communication related events at least partially related to one or more communication transmissions received by one or more first fixed position base station devices being part of a base station network from first mobile operating system based mobile communication devices comprises:
receiving first information regarding at least in part first communication related events at least partially related to one or more communication transmissions received by one or more first fixed position base station devices being part of a base station network from first mobile operating system based mobile communication devices including receiving information regarding one or more statistical probabilities of remaining in communication with the one or more first mobile operating system based mobile communication devices.

15. The computationally-implemented method of claim 8, wherein the receiving first information regarding second information involving at least in part the one or more first mobile operating system based mobile communication devices including receiving first information regarding at least in part first communication related events at least partially related to one or more communication transmissions received by one or more first fixed position base station devices being part of a base station network from first mobile operating system based mobile communication devices comprises:
receiving first information regarding at least in part first communication related events at least partially related to one or more communication transmissions received by one or more first fixed position base station devices being part of a base station network from first mobile operating system based mobile communication devices including receiving GPS positioning data regarding the one or more first mobile operating system based mobile communication devices.

16. The computationally-implemented method of claim 8, wherein the receiving first information regarding second information involving at least in part the one or more first mobile operating system based mobile communication devices including receiving first information regarding at least in part first communication related events at least partially related to one or more communication transmissions received by one or more first fixed position base station devices being part of a base station network from first mobile operating system based mobile communication devices comprises:
receiving first information regarding at least in part first communication related events at least partially related to one or more communication transmissions received by one or more first fixed position base station devices being part of a base station network from first mobile operating system based mobile communication devices including receiving information associated with communication histories of one or more other mobile operating system based mobile communication devices communicating through the base station network with the one or more first mobile operating system based mobile communication devices.

17. The computationally-implemented method of claim 16, wherein the receiving first information regarding at least in part first communication related events at least partially related to one or more communication transmissions received by one or more first fixed position base station devices being part of a base station network from first mobile operating system based mobile communication devices including receiving information associated with communication histories of one or more other mobile operating system based mobile communication devices communicating through the base station network with the one or more first mobile operating system based mobile communication devices comprises:
receiving information associated with communication histories of one or more other mobile operating system based mobile communication devices communicating through the base station network with the one or more first mobile operating system based mobile communication devices including receiving information as positioning data for the one or more first mobile operating system based mobile communication devices.

18. The computationally-implemented method of claim 16, wherein the receiving first information regarding at least in part first communication related events at least partially related to one or more communication transmissions received by one or more first fixed position base station devices being part of a base station network from first mobile operating system based mobile communication devices including receiving information associated with communication histories of one or more other mobile operating system based mobile communication devices communicating through the base station network with the one or more first mobile operating system based mobile communication devices comprises:
receiving information associated with communication histories of one or more other mobile operating system based mobile communication devices communicating through the base station network with the one or more first mobile operating system based mobile communication devices including receiving information as communication history data previously stored and forwarded between one or more of the first mobile operating system based mobile communication devices.

19. The computationally-implemented method of claim 8, wherein the receiving first information regarding second information involving at least in part the one or more first mobile operating system based mobile communication devices including receiving first information regarding at least in part first communication related events at least partially related to one or more communication transmissions received by one or more first fixed position base station devices being part of a base station network from first mobile operating system based mobile communication devices comprises:
receiving first information regarding at least in part first communication related events at least partially related to one or more communication transmissions received by one or more first fixed position base station devices being part of a base station network from first mobile operating system based mobile communication devices including receiving information regarding one or more potential obstructions to electronic communication located proximate to one or more of the first mobile operating system based mobile communication devices.

20. The computationally-implemented method of claim 19, wherein the receiving first information regarding at least in part first communication related events at least partially related to one or more communication transmissions received by one or more first fixed position base station devices being part of a base station network from first mobile operating system based mobile communication devices including receiving information regarding one or more potential obstructions to electronic communication located proximate to one or more of the first mobile operating system based mobile communication devices comprises:
receiving information regarding one or more potential obstructions to electronic communication located proximate to one or more of the first mobile operating system based mobile communication devices including receiving information regarding one or more moveable communication obstructions.

21. The computationally-implemented method of claim 20, wherein the receiving information regarding one or more potential obstructions to electronic communication located proximate to one or more of the first mobile operating system based mobile communication devices including receiving information regarding one or more moveable communication obstructions comprises:
receiving information regarding one or more moveable communication obstructions including receiving information regarding one or more moveable communication obstructions as one or more pedestrians.

22. The computationally-implemented method of claim 19, wherein the receiving first information regarding at least in part first communication related events at least partially related to one or more communication transmissions received by one or more first fixed position base station devices being part of a base station network from first mobile operating system based mobile communication devices including receiving information regarding one or more potential obstructions to electronic communication located proximate to one or more of the first mobile operating system based mobile communication devices comprises:
receiving information regarding one or more potential obstructions to electronic communication located proximate to one or more of the first mobile operating system based mobile communication devices including receiving information regarding one or more potential obstructions to electronic communication as one or more architectural structures.

23. The computationally-implemented method of claim 1, wherein the receiving third information regarding fourth information, the fourth information having been received at one or more second fixed position base station devices being part of the base station network including fixed position base station devices, the fourth information regarding one or more second communication related events occurring directly between two or more second mobile operating system based mobile communication devices comprises:
receiving third information regarding fourth information regarding one or more second communication related events occurring directly between two or more second mobile operating system based mobile communication devices including accessing data from a data source via a virtual machine representation of at least a part of a computing machine including accessing data from a data source via a virtual machine representation of at least a part of a real machine.

24. The computationally-implemented method of claim 1, wherein the receiving third information regarding fourth information, the fourth information having been received at one or more second fixed position base station devices being part of the base station network including fixed position base station devices, the fourth information regarding one or more second communication related events occurring directly between two or more second mobile operating system based mobile communication devices comprises:
receiving third information regarding fourth information regarding one or more second communication related events occurring directly between two or more second mobile operating system based mobile communication devices including accessing data from a data source via a virtual machine representation of at least a part of a computing machine including accessing data from a data source via a virtual machine representation of at least a part of a virtual machine.

25. The computationally-implemented method of claim 1, wherein the receiving third information regarding fourth information, the fourth information having been received at one or more second fixed position base station devices being part of the base station network including fixed position base station devices, the fourth information regarding one or more second communication related events occurring directly between two or more second mobile operating system based mobile communication devices comprises:
receiving third information regarding fourth information regarding one or more second communication related events occurring directly between two or more second mobile operating system based mobile communication devices including accessing data from a data source via a virtual machine representation of at least a part of a virtual machine including converting a file having a file-type associated with the virtual machine to a file-type associated with the virtual machine representation.

26. The computationally-implemented method of claim 25, wherein the receiving third information regarding fourth information regarding one or more second communication related events occurring directly between two or more second mobile operating system based mobile communication devices including accessing data from a data source via a virtual machine representation of at least a part of a virtual machine including converting a file having a file-type associated with the virtual machine to a file-type associated with the virtual machine representation comprises:
accessing data from a data source via a virtual machine representation of at least a part of a virtual machine including converting a file having a file-type associated with the virtual machine to a file-type associated with the virtual machine representation including wherein the file-type associated with the second virtual machine is configured for a limited-resource computing machine.

27. The computationally-implemented method of claim 26, wherein the accessing data from a data source via a virtual machine representation of at least a part of a virtual machine including converting a file having a file-type associated with the virtual machine to a file-type associated with the virtual machine representation including wherein the file-type associated with the second virtual machine is configured for a limited-resource computing machine comprises:
wherein the file-type associated with the second virtual machine is configured for a limited-resource computing machine including wherein the file-type associated with the second virtual machine is configured for a mobile computing machine.

28. The computationally-implemented method of claim 1, wherein the receiving third information regarding fourth information, the fourth information having been received at one or more second fixed position base station devices being part of the base station network including fixed position base station devices, the fourth information regarding one or more second communication related events occurring directly between two or more second mobile operating system based mobile communication devices comprises:
receiving third information regarding fourth information regarding one or more second communication related events occurring directly between two or more second mobile operating system based mobile communication devices including receiving information regarding activation of the two or more second mobile operating system based mobile communication devices as network relay devices based at least in part upon one or more fixed position base station devices becoming unavailable for communication with one or more mobile operating system based mobile communication devices.

29. The computationally-implemented method of claim 1, wherein the receiving third information regarding fourth information, the fourth information having been received at one or more second fixed position base station devices being part of the base station network including fixed position base station devices, the fourth information regarding one or more second communication related events occurring directly between two or more second mobile operating system based mobile communication devices comprises:
receiving third information regarding fourth information regarding one or more second communication related events occurring directly between two or more second mobile operating system based mobile communication devices including receiving wireless packetized communication.

30. The computationally-implemented method of claim 29, wherein the receiving third information regarding fourth information regarding one or more second communication related events occurring directly between two or more second mobile operating system based mobile communication devices including receiving wireless packetized communication comprises:
receiving wireless packetized communication including receiving incoming message traffic.

31. The computationally-implemented method of claim 30, wherein the receiving wireless packetized communication including receiving incoming message traffic comprises:
receiving incoming message traffic including receiving one or more high bandwidth data transfers.

32. The computationally-implemented method of claim 30, wherein the receiving wireless packetized communication including receiving incoming message traffic comprises:
receiving incoming message traffic including receiving one or more high resolution audio formatted messages.

33. The computationally-implemented method of claim 30, wherein the receiving wireless packetized communication including receiving incoming message traffic comprises:
receiving incoming message traffic including receiving one or more high resolution video formatted messages.

34. The computationally-implemented method of claim 30, wherein the receiving wireless packetized communication including receiving incoming message traffic comprises:
receiving incoming message traffic including receiving one or more high capacity data files.

35. The computationally-implemented method of claim 29, wherein the receiving third information regarding fourth information regarding one or more second communication related events occurring directly between two or more second mobile operating system based mobile communication devices including receiving wireless packetized communication comprises:
receiving wireless packetized communication including receiving one or more communication network relay related transmissions from one or more second mobile operating system based mobile communication devices.

36. The computationally-implemented method of claim 29, wherein the receiving third information regarding fourth information regarding one or more second communication related events occurring directly between two or more second mobile operating system based mobile communication devices including receiving wireless packetized communication comprises:
receiving wireless packetized communication including receiving one or more communication network relay related transmissions from one or more second mobile operating system based mobile communication devices as heterogeneous types.

37. The computationally-implemented method of claim 36, wherein the receiving wireless packetized communication including receiving one or more communication network relay related transmissions from one or more second mobile operating system based mobile communication devices as heterogeneous types comprises:
receiving one or more communication network relay related transmissions from one or more second mobile operating system based mobile communication devices as heterogeneous types including receiving one or more communication network relay related transmissions from one or more laptops, one or more phablets, one or more tablets, one or more smart phones, one or more notebooks, one or more handsets, one or more palmtops, one or more personal digital assistants, one or more digital audio players, one or more portable media players, one or more digital cameras, or one or more cell phones.

38. The computationally-implemented method of claim 36, wherein the receiving wireless packetized communication including receiving one or more communication network relay related transmissions from one or more second mobile operating system based mobile communication devices as heterogeneous types comprises:
receiving one or more communication network relay related transmissions from one or more second mobile operating system based mobile communication devices as heterogeneous types including receiving one or more communication network relay related transmissions as using hybridized protocols including one or more IEEE 802.11ac protocols, one or more IEEE 802.11ad protocols, or one or more IEEE 802.11n/g protocols.

39. The computationally-implemented method of claim 36, wherein the receiving wireless packetized communication including receiving one or more communication network relay related transmissions from one or more second mobile operating system based mobile communication devices as heterogeneous types comprises:
receiving one or more communication network relay related transmissions from one or more second mobile operating system based mobile communication devices as heterogeneous types including receiving one or more communication network relay related transmissions as using one or more cellular protocols.

40. The computationally-implemented method of claim 36, wherein the receiving wireless packetized communication including receiving one or more communication network relay related transmissions from one or more second mobile operating system based mobile communication devices as heterogeneous types comprises:
receiving one or more communication network relay related transmissions from one or more second mobile operating system based mobile communication devices as heterogeneous types including receiving one or more communication network relay related transmissions as using one or more WiFi protocols, or one or more direct WiFi protocols.

41. The computationally-implemented method of claim 36, wherein the receiving wireless packetized communication including receiving one or more communication network relay related transmissions from one or more second mobile operating system based mobile communication devices as heterogeneous types comprises:
receiving one or more communication network relay related transmissions from one or more second mobile operating system based mobile communication devices as heterogeneous types including receiving one or more communication network relay related transmissions as using protocols including one or more 3G protocols, one or more 4G protocols, one or more 5G protocols, one or more 6G or one or more 7G protocols.

42. The computationally-implemented method of claim 36, wherein the receiving wireless packetized communication including receiving one or more communication network relay related transmissions from one or more second mobile operating system based mobile communication devices as heterogeneous types comprises:
receiving one or more communication network relay related transmissions from one or more second mobile operating system based mobile communication devices as heterogeneous types including receiving one or more communication network relay related transmissions as using protocols including one or more 20 GHz or above protocols, one or more 30 GHz or above protocols, or one or more 60 GHz or above protocols.

43. The computationally-implemented method of claim 36, wherein the receiving wireless packetized communication including receiving one or more communication network relay related transmissions from one or more second mobile operating system based mobile communication devices as heterogeneous types comprises:
receiving one or more communication network relay related transmissions from one or more second mobile operating system based mobile communication devices as heterogeneous types including receiving one or more electronic token identifiers independent from device type of the one or more second mobile operating system based mobile communication devices one or more intermediate electronic communication devices.

44. The computationally-implemented method of claim 36, wherein the receiving wireless packetized communication including receiving one or more communication network relay related transmissions from one or more second mobile operating system based mobile communication devices as heterogeneous types comprises:
receiving one or more communication network relay related transmissions from one or more second mobile operating system based mobile communication devices as heterogeneous types including receiving one or more rotating communication beams, one or more alternating communication beams, one or more sweeping communication beams, one or more multiple communication beams, one or more switching communication beams, or one or more diffracted communication beams.

45. The computationally-implemented method of claim 36, wherein the receiving wireless packetized communication including receiving one or more communication network relay related transmissions from one or more second mobile operating system based mobile communication devices as heterogeneous types comprises:
receiving one or more communication network relay related transmissions from one or more second mobile operating system based mobile communication devices as heterogeneous types including receiving from one or more multiple antennas, one or more directional antennas, one or more changeable antenna architectures, one or more mesh network antennas, or one or more omnidirectional antennas.

46. The computationally-implemented method of claim 1, wherein the receiving third information regarding fourth information, the fourth information having been received at one or more second fixed position base station devices being part of the base station network including fixed position base station devices, the fourth information regarding one or more second communication related events occurring directly between two or more second mobile operating system based mobile communication devices comprises:
receiving third information regarding fourth information regarding one or more second communication related events occurring directly between two or more second mobile operating system based mobile communication devices including receiving information at least partially contained in one or more second mobile operating system based mobile communication device relayed transmissions.

47. The computationally-implemented method of claim 46, wherein the receiving third information regarding fourth information regarding one or more second communication related events occurring directly between two or more second mobile operating system based mobile communication devices including receiving information at least partially contained in one or more second mobile operating system based mobile communication device relayed transmissions comprises:
receiving information at least partially contained in one or more second mobile operating system based mobile communication device relayed transmissions including obtaining information regarding one or more obstructed communication paths that one or more second mobile operating system based mobile communication devices have encountered when attempting to communicate with other one or more second mobile operating system based mobile communication devices.

48. The computationally-implemented method of claim 47, wherein the receiving information at least partially contained in one or more second mobile operating system based mobile communication device relayed transmissions including obtaining information regarding one or more obstructed communication paths that one or more second mobile operating system based mobile communication devices have encountered when attempting to communicate with other one or more second mobile operating system based mobile communication devices comprises:
obtaining information regarding one or more obstructed communication paths that one or more second mobile operating system based mobile communication devices have encountered when attempting to communicate with other one or more second mobile operating system based mobile communication devices including receiving location information regarding one or more moveable objects that have previously obstructed communication of one or more of the second mobile operating system based mobile communication devices.

49. The computationally-implemented method of claim 47, wherein the receiving information at least partially contained in one or more second mobile operating system based mobile communication device relayed transmissions including obtaining information regarding one or more obstructed communication paths that one or more second mobile operating system based mobile communication devices have encountered when attempting to communicate with other one or more second mobile operating system based mobile communication devices comprises:
obtaining information regarding one or more obstructed communication paths that one or more second mobile operating system based mobile communication devices have encountered when attempting to communicate with other one or more second mobile operating system based mobile communication devices including receiving location information regarding one or more fixed position objects that have previously obstructed communication of one or more second mobile operating system based mobile communication devices.

50. The computationally-implemented method of claim 46, wherein the receiving third information regarding fourth information regarding one or more second communication related events occurring directly between two or more second mobile operating system based mobile communication devices including receiving information at least partially contained in one or more second mobile operating system based mobile communication device relayed transmissions comprises:
receiving information at least partially contained in one or more second mobile operating system based mobile communication device relayed transmissions including receiving information regarding map data of locations of fixed position objects.

51. The computationally-implemented method of claim 46, wherein the receiving third information regarding fourth information regarding one or more second communication related events occurring directly between two or more second mobile operating system based mobile communication devices including receiving information at least partially contained in one or more second mobile operating system based mobile communication device relayed transmissions comprises:
receiving information at least partially contained in one or more second mobile operating system based mobile communication device relayed transmissions including receiving information regarding one or more time based distributions of instances of obstruction of second mobile operating system based mobile communication device communication for one or more particular geographical locations.

52. The computationally-implemented method of claim 46, wherein the receiving third information regarding fourth information regarding one or more second communication related events occurring directly between two or more second mobile operating system based mobile communication devices including receiving information at least partially contained in one or more second mobile operating system based mobile communication device relayed transmissions comprises:
receiving information at least partially contained in one or more second mobile operating system based mobile communication device relayed transmissions including receiving information regarding one or more statistical probabilities of remaining in communication with one or more second mobile operating system based mobile communication devices.

53. The computationally-implemented method of claim 46, wherein the receiving third information regarding fourth information regarding one or more second communication related events occurring directly between two or more second mobile operating system based mobile communication devices including receiving information at least partially contained in one or more second mobile operating system based mobile communication device relayed transmissions comprises:
receiving information at least partially contained in one or more second mobile operating system based mobile communication device relayed transmissions including receiving GPS positioning data regarding the one or more second mobile operating system based mobile communication devices.

54. The computationally-implemented method of claim 46, wherein the receiving third information regarding fourth information regarding one or more second communication related events occurring directly between two or more second mobile operating system based mobile communication devices including receiving information at least partially contained in one or more second mobile operating system based mobile communication device relayed transmissions comprises:
receiving information at least partially contained in one or more second mobile operating system based mobile communication device relayed transmissions including receiving information associated with communication histories of one or more other electronic communication devices communicating with the one or more intermediate electronic communication devices.

55. The computationally-implemented method of claim 54, wherein the receiving information at least partially contained in one or more second mobile operating system based mobile communication device relayed transmissions including receiving information associated with communication histories of one or more other electronic communication devices communicating with the one or more intermediate electronic communication devices comprises:
receiving information associated with communication histories of one or more other electronic communication devices communicating with the one or more intermediate electronic communication devices including receiving information as positioning data for one or more second mobile operating system based mobile communication devices.

56. The computationally-implemented method of claim 54, wherein the receiving information at least partially contained in one or more second mobile operating system based mobile communication device relayed transmissions including receiving information associated with communication histories of one or more other electronic communication devices communicating with the one or more intermediate electronic communication devices comprises:
receiving information associated with communication histories of one or more other electronic communication devices communicating with the one or more intermediate electronic communication devices including receiving information as communication history data previously stored and forwarded between two or more second mobile operating system based mobile communication devices.

57. The computationally-implemented method of claim 46, wherein the receiving third information regarding fourth information regarding one or more second communication related events occurring directly between two or more second mobile operating system based mobile communication devices including receiving information at least partially contained in one or more second mobile operating system based mobile communication device relayed transmissions comprises:
receiving information at least partially contained in one or more second mobile operating system based mobile communication device relayed transmissions including receiving information regarding one or more potential obstructions to electronic communication located proximate to one or more of the second mobile operating system based mobile communication devices.

58. The computationally-implemented method of claim 57, wherein the receiving information at least partially contained in one or more second mobile operating system based mobile communication device relayed transmissions including receiving information regarding one or more potential obstructions to electronic communication located proximate to one or more of the second mobile operating system based mobile communication devices comprises:
receiving information regarding one or more potential obstructions to electronic communication located proximate to one or more of the second mobile operating system based mobile communication devices including receiving information regarding one or more moveable communication obstructions.

59. The computationally-implemented method of claim 58, wherein the receiving information regarding one or more potential obstructions to electronic communication located proximate to one or more of the second mobile operating system based mobile communication devices including receiving information regarding one or more moveable communication obstructions comprises:
receiving information regarding one or more moveable communication obstructions including receiving information regarding one or more moveable communication obstructions as one or more pedestrians.

60. The computationally-implemented method of claim 57, wherein the receiving information at least partially contained in one or more second mobile operating system based mobile communication device relayed transmissions including receiving information regarding one or more potential obstructions to electronic communication located proximate to one or more of the second mobile operating system based mobile communication devices comprises:
receiving information regarding one or more potential obstructions to electronic communication located proximate to one or more of the second mobile operating system based mobile communication devices including receiving information regarding one or more potential obstructions to electronic communication as one or more architectural structures.

61. The computationally-implemented method of claim 46, wherein the receiving third information regarding fourth information regarding one or more second communication related events occurring directly between two or more second mobile operating system based mobile communication devices including receiving information at least partially contained in one or more second mobile operating system based mobile communication device relayed transmissions comprises:
receiving information at least partially contained in one or more second mobile operating system based mobile communication device relayed transmissions including receiving information regarding communication capacity available to one or more of standby communication relays furnished by one or more second mobile operating system based mobile communication devices.

62. The computationally-implemented method of claim 61, wherein the receiving information at least partially contained in one or more second mobile operating system based mobile communication device relayed transmissions including receiving information regarding communication capacity available to one or more of standby communication relays furnished by one or more second mobile operating system based mobile communication devices comprises:
receiving information regarding communication capacity available to one or more of standby communication relays furnished by one or more second mobile operating system based mobile communication devices including receiving information regarding communication bandwidth available to one or more of standby communication relays furnished by one or more second mobile operating system based mobile communication devices.

63. The computationally-implemented method of claim 62, wherein the receiving information regarding communication capacity available to one or more of standby communication relays furnished by one or more second mobile operating system based mobile communication devices including receiving information regarding communication bandwidth available to one or more of standby communication relays furnished by one or more second mobile operating system based mobile communication devices comprises:
receiving information regarding communication bandwidth available to one or more of standby communication relays furnished by one or more second mobile operating system based mobile communication devices including receiving information regarding runtime duration available to one or more of standby communication relays furnished by one or more second mobile operating system based mobile communication devices.

64. The computationally-implemented method of claim 63, wherein the receiving information regarding communication bandwidth available to one or more of standby communication relays furnished by one or more second mobile operating system based mobile communication devices including receiving information regarding runtime duration available to one or more of standby communication relays furnished by one or more second mobile operating system based mobile communication devices comprises:
receiving information regarding runtime duration available to one or more of standby communication relays furnished by one or more second mobile operating system based mobile communication devices including receiving information regarding runtime duration available regarding battery level available to one or more one or more second mobile operating system based mobile communication devices.

65. The computationally-implemented method of claim 63, wherein the receiving information regarding communication bandwidth available to one or more of standby communication relays furnished by one or more second mobile operating system based mobile communication devices including receiving information regarding runtime duration available to one or more of standby communication relays furnished by one or more second mobile operating system based mobile communication devices comprises:
receiving information regarding runtime duration available to one or more of standby communication relays furnished by one or more second mobile operating system based mobile communication devices including receiving information regarding runtime duration available regarding predetermined commitments by users of one or more second mobile operating system based mobile communication devices.

66. The computationally-implemented method of claim 63, wherein the receiving information regarding communication bandwidth available to one or more of standby communication relays furnished by one or more second mobile operating system based mobile communication devices including receiving information regarding runtime duration available to one or more of standby communication relays furnished by one or more second mobile operating system based mobile communication devices comprises:
receiving information regarding runtime duration available to one or more of standby communication relays furnished by one or more second mobile operating system based mobile communication devices including receiving information regarding runtime duration available regarding potential obstructed communication paths of one or more second mobile operating system based mobile communication devices.

67. The computationally-implemented method of claim 46, wherein the receiving third information regarding fourth information regarding one or more second communication related events occurring directly between two or more second mobile operating system based mobile communication devices including receiving information at least partially contained in one or more second mobile operating system based mobile communication device relayed transmissions comprises:
receiving information at least partially contained in one or more second mobile operating system based mobile communication device relayed transmissions including receiving information regarding quality of service of communication available to one or more standby communication network relay as furnished by one or more second mobile operating system based mobile communication devices.

68. The computationally-implemented method of claim 46, wherein the receiving third information regarding fourth information regarding one or more second communication related events occurring directly between two or more second mobile operating system based mobile communication devices including receiving information at least partially contained in one or more second mobile operating system based mobile communication device relayed transmissions comprises:
receiving information at least partially contained in one or more second mobile operating system based mobile communication device relayed transmissions including receiving information regarding one or more economic cost structures to be imposed associated with one or more standby communication relays furnished by one or more second mobile operating system based mobile communication devices.

69. The computationally-implemented method of claim 68, wherein the receiving information at least partially contained in one or more second mobile operating system based mobile communication device relayed transmissions including receiving information regarding one or more economic cost structures to be imposed associated with one or more standby communication relays furnished by one or more second mobile operating system based mobile communication devices comprises:
receiving information regarding one or more economic cost structures to be imposed associated with one or more standby communication relays furnished by one or more second mobile operating system based mobile communication devices including receiving information regarding commercial credit or cash requirements to access one or more of standby communication relays as furnished by one or more second mobile operating system based mobile communication devices.

70. The computationally-implemented method of claim 46, wherein the receiving third information regarding fourth information regarding one or more second communication related events occurring directly between two or more second mobile operating system based mobile communication devices including receiving information at least partially contained in one or more second mobile operating system based mobile communication device relayed transmissions comprises:
receiving information at least partially contained in one or more second mobile operating system based mobile communication device relayed transmissions including receiving information regarding one or more second mobile operating system based mobile communication devices as having one or more communication paths including one or more line of sight pathways or one or more ricochet pathways.

71. The computationally-implemented method of claim 1, wherein the relating the first information with the third information, the first information regarding the second information having been received at the one or more first fixed position base station devices being part of a base station network including fixed position base station devices, the second information regarding the one or more first communication related events involving the one or more first mobile operating system based mobile communication devices and the one or more first fixed position base station devices, each of the first communication related events involving one or more of the first mobile operating system based mobile communication devices and one or more of the first fixed position base station devices, the third information regarding the fourth information the fourth information having been received at the one or more second fixed position base station devices being part of the base station network including fixed position base station devices, the fourth information regarding the one or more second communication related events occurring directly between the two or more second mobile operating system based mobile communication devices comprises:
relating the first information with the third information, the first information regarding the one or more first communication related events involving one or more first mobile operating system based mobile communication devices and one or more first fixed position base station devices, the third information regarding one or more second communication related events occurring directly between two or more second mobile operating system based mobile communication devices including relating the first information regarding one or more aspects of one or more base station networks including one or more fixed position base station devices with the third information regarding one or more aspects of communication relay networks furnished by one or more second mobile operating system based mobile communication devices.

72. The computationally-implemented method of claim 71, wherein the relating the first information with the third information, the first information regarding the one or more first communication related events involving one or more first mobile operating system based mobile communication devices and one or more first fixed position base station devices, the third information regarding one or more second communication related events occurring directly between two or more second mobile operating system based mobile communication devices including relating the first information regarding one or more aspects of one or more base station networks including one or more fixed position base station devices with the third information regarding one or more aspects of communication relay networks furnished by one or more second mobile operating system based mobile communication devices comprises:
relating the first information regarding one or more aspects of one or more base station networks including one or more fixed position base station devices with the third information regarding one or more aspects of communication relay networks furnished by one or more second mobile operating system based mobile communication devices including relating first location information regarding one or more first moveable objects that have previously obstructed communication of one or more base station networks including one or more fixed position base station devices with relating second location information regarding one or more second moveable objects that have previously obstructed communication of communication relay networks furnished by one or more second mobile operating system based mobile communication devices.

73. The computationally-implemented method of claim 71, wherein the relating the first information with the third information, the first information regarding the one or more first communication related events involving one or more first mobile operating system based mobile communication devices and one or more first fixed position base station devices, the third information regarding one or more second communication related events occurring directly between two or more second mobile operating system based mobile communication devices including relating the first information regarding one or more aspects of one or more base station networks including one or more fixed position base station devices with the third information regarding one or more aspects of communication relay networks furnished by one or more second mobile operating system based mobile communication devices comprises:
relating the first information regarding one or more aspects of one or more base station networks including one or more fixed position base station devices with the third information regarding one or more aspects of communication relay networks furnished by one or more second mobile operating system based mobile communication devices including relating first statistical information regarding one or more statistical probabilities of remaining in communication using one or more base station networks including one or more fixed position base station devices with relating second statistical information regarding one or more statistical probabilities of remaining in communication using one or more second communication relay networks furnished by one or more second mobile operating system based mobile communication devices.

74. The computationally-implemented method of claim 71, wherein the relating the first information with the third information, the first information regarding the one or more first communication related events involving one or more first mobile operating system based mobile communication devices and one or more first fixed position base station devices, the third information regarding one or more second communication related events occurring directly between two or more second mobile operating system based mobile communication devices including relating the first information regarding one or more aspects of one or more base station networks including one or more fixed position base station devices with the third information regarding one or more aspects of communication relay networks furnished by one or more second mobile operating system based mobile communication devices comprises:
relating the first information regarding one or more aspects of one or more base station networks including one or more fixed position base station devices with the third information regarding one or more aspects of communication relay networks furnished by one or more second mobile operating system based mobile communication devices including relating first GPS positioning data regarding one or more base station networks including one or more fixed position base station devices with relating second GPS positioning data regarding one or more second communication relay networks furnished by one or more second mobile operating system based mobile communication devices.

75. The computationally-implemented method of claim 71, wherein the relating the first information with the third information, the first information regarding the one or more first communication related events involving one or more first mobile operating system based mobile communication devices and one or more first fixed position base station devices, the third information regarding one or more second communication related events occurring directly between two or more second mobile operating system based mobile communication devices including relating the first information regarding one or more aspects of one or more base station networks including one or more fixed position base station devices with the third information regarding one or more aspects of communication relay networks furnished by one or more second mobile operating system based mobile communication devices comprises:
relating the first information regarding one or more aspects of one or more base station networks including one or more fixed position base station devices with the third information regarding one or more aspects of communication relay networks furnished by one or more second mobile operating system based mobile communication devices including relating first potential obstructions to electronic network communication located proximate to one or more fixed position base station devices of one or more base station networks with relating second potential obstructions to electronic network communication located proximate to one or more second mobile operating system based mobile communication devices of one or more second communication relay networks.

76. The computationally-implemented method of claim 71, wherein the relating the first information with the third information, the first information regarding the one or more first communication related events involving one or more first mobile operating system based mobile communication devices and one or more first fixed position base station devices, the third information regarding one or more second communication related events occurring directly between two or more second mobile operating system based mobile communication devices including relating the first information regarding one or more aspects of one or more base station networks including one or more fixed position base station devices with the third information regarding one or more aspects of communication relay networks furnished by one or more second mobile operating system based mobile communication devices comprises:
relating the first information regarding one or more aspects of one or more base station networks including one or more fixed position base station devices with the third information regarding one or more aspects of communication relay networks furnished by one or more second mobile operating system based mobile communication devices including relating first communication histories of successful communication of one or more fixed position base station devices of one or more base station networks with relating second communication histories of successful communication of one or more second mobile operating system based mobile communication devices of one or more second communication relay networks.

77. The computationally-implemented method of claim 76, wherein the relating the first information regarding one or more aspects of one or more base station networks including one or more fixed position base station devices with the third information regarding one or more aspects of communication relay networks furnished by one or more second mobile operating system based mobile communication devices including relating first communication histories of successful communication of one or more fixed position base station devices of one or more base station networks with relating second communication histories of successful communication of one or more second mobile operating system based mobile communication devices of one or more second communication relay networks comprises:
relating first communication histories of successful communication of one or more fixed position base station devices of one or more base station networks with relating second communication histories of successful communication of one or more second mobile operating system based mobile communication devices of one or more second communication relay networks including relating first communication history data previously stored and forwarded between one or more fixed position base station devices of one or more base station networks with relating second communication history data previously stored and forwarded between one or more second mobile operating system based mobile communication devices of one or more second communication relay networks.

78. The computationally-implemented method of claim 71, wherein the relating the first information with the third information, the first information regarding the one or more first communication related events involving one or more first mobile operating system based mobile communication devices and one or more first fixed position base station devices, the third information regarding one or more second communication related events occurring directly between two or more second mobile operating system based mobile communication devices including relating the first information regarding one or more aspects of one or more base station networks including one or more fixed position base station devices with the third information regarding one or more aspects of communication relay networks furnished by one or more second mobile operating system based mobile communication devices comprises:
relating the first information regarding one or more aspects of one or more base station networks including one or more fixed position base station devices with the third information regarding one or more aspects of communication relay networks furnished by one or more second mobile operating system based mobile communication devices including relating first information regarding communication capacity available to one or more fixed position base station devices of one or more base station networks with relating second information regarding communication capacity available to one or more second mobile operating system based mobile communication devices of one or more second communication relay networks.

79. The computationally-implemented method of claim 71, wherein the relating the first information with the third information, the first information regarding the one or more first communication related events involving one or more first mobile operating system based mobile communication devices and one or more first fixed position base station devices, the third information regarding one or more second communication related events occurring directly between two or more second mobile operating system based mobile communication devices including relating the first information regarding one or more aspects of one or more base station networks including one or more fixed position base station devices with the third information regarding one or more aspects of communication relay networks furnished by one or more second mobile operating system based mobile communication devices comprises:
relating the first information regarding one or more aspects of one or more base station networks including one or more fixed position base station devices with the third information regarding one or more aspects of communication relay networks furnished by one or more second mobile operating system based mobile communication devices including relating first information regarding one or more potential obstructions to electronic communication proximate to one or more fixed position base station devices of one or more base station networks with relating second information regarding one or more potential obstructions to electronic communication proximate to one or more second mobile operating system based mobile communication devices of one or more second communication relay networks.

80. The computationally-implemented method of claim 72, wherein the relating the first information regarding one or more aspects of one or more base station networks including one or more fixed position base station devices with the third information regarding one or more aspects of communication relay networks furnished by one or more second mobile operating system based mobile communication devices including relating first location information regarding one or more first moveable objects that have previously obstructed communication of one or more base station networks including one or more fixed position base station devices with relating second location information regarding one or more second moveable objects that have previously obstructed communication of communication relay networks furnished by one or more second mobile operating system based mobile communication devices comprises:
relating first location information regarding one or more first moveable objects that have previously obstructed communication of one or more base station networks including one or more fixed position base station devices with relating second location information regarding one or more second moveable objects that have previously obstructed communication of communication relay networks furnished by one or more second mobile operating system based mobile communication devices including relating first information regarding one or more potential electronic communication service interruptions of one or more fixed position base station devices of one or more base station networks with relating second information regarding one or more potential electronic communication service interruptions of one or more second mobile operating system based mobile communication devices of one or more second communication relay networks.

81. The computationally-implemented method of claim 71, wherein the relating the first information with the third information, the first information regarding the one or more first communication related events involving one or more first mobile operating system based mobile communication devices and one or more first fixed position base station devices, the third information regarding one or more second communication related events occurring directly between two or more second mobile operating system based mobile communication devices including relating the first information regarding one or more aspects of one or more base station networks including one or more fixed position base station devices with the third information regarding one or more aspects of communication relay networks furnished by one or more second mobile operating system based mobile communication devices comprises:
relating the first information regarding one or more aspects of one or more base station networks including one or more fixed position base station devices with the third information regarding one or more aspects of communication relay networks furnished by one or more second mobile operating system based mobile communication devices including relating first service quality ratings regarding one or more fixed position base station devices of one or more base station networks with relating second service quality ratings regarding one or more second mobile operating system based mobile communication devices of one or more second communication relay networks.

82. The computationally-implemented method of claim 71, wherein the relating the first information with the third information, the first information regarding the one or more first communication related events involving one or more first mobile operating system based mobile communication devices and one or more first fixed position base station devices, the third information regarding one or more second communication related events occurring directly between two or more second mobile operating system based mobile communication devices including relating the first information regarding one or more aspects of one or more base station networks including one or more fixed position base station devices with the third information regarding one or more aspects of communication relay networks furnished by one or more second mobile operating system based mobile communication devices comprises:
relating the first information regarding one or more aspects of one or more base station networks including one or more fixed position base station devices with the third information regarding one or more aspects of communication relay networks furnished by one or more second mobile operating system based mobile communication devices including relating first cost ratings regarding one or more fixed position base station devices of one or more base station networks with relating second cost ratings regarding one or more second mobile operating system based mobile communication devices of one or more second communication relay networks.

83. The computationally-implemented method of claim 71, wherein the relating the first information with the third information, the first information regarding the one or more first communication related events involving one or more first mobile operating system based mobile communication devices and one or more first fixed position base station devices, the third information regarding one or more second communication related events occurring directly between two or more second mobile operating system based mobile communication devices including relating the first information regarding one or more aspects of one or more base station networks including one or more fixed position base station devices with the third information regarding one or more aspects of communication relay networks furnished by one or more second mobile operating system based mobile communication devices comprises:
relating the first information regarding one or more aspects of one or more base station networks including one or more fixed position base station devices with the third information regarding one or more aspects of communication relay networks furnished by one or more second mobile operating system based mobile communication devices including relating first availability forecast ratings for one or more fixed position base station devices of one or more base station networks with relating second availability forecast ratings for one or more second mobile operating system based mobile communication devices of one or more second communication relay networks.

84. The computationally-implemented method of claim 71, wherein the relating the first information with the third information, the first information regarding the one or more first communication related events involving one or more first mobile operating system based mobile communication devices and one or more first fixed position base station devices, the third information regarding one or more second communication related events occurring directly between two or more second mobile operating system based mobile communication devices including relating the first information regarding one or more aspects of one or more base station networks including one or more fixed position base station devices with the third information regarding one or more aspects of communication relay networks furnished by one or more second mobile operating system based mobile communication devices comprises:
relating the first information regarding one or more aspects of one or more base station networks including one or more fixed position base station devices with the third information regarding one or more aspects of communication relay networks furnished by one or more second mobile operating system based mobile communication devices including relating first reliability ratings for one or more fixed position base station devices of one or more base station networks with relating second reliability ratings for one or more second mobile operating system based mobile communication devices of one or more second communication relay networks.

85. The computationally-implemented method of claim 71, wherein the relating the first information with the third information, the first information regarding the one or more first communication related events involving one or more first mobile operating system based mobile communication devices and one or more first fixed position base station devices, the third information regarding one or more second communication related events occurring directly between two or more second mobile operating system based mobile communication devices including relating the first information regarding one or more aspects of one or more base station networks including one or more fixed position base station devices with the third information regarding one or more aspects of communication relay networks furnished by one or more second mobile operating system based mobile communication devices comprises:
relating the first information regarding one or more aspects of one or more base station networks including one or more fixed position base station devices with the third information regarding one or more aspects of communication relay networks furnished by one or more second mobile operating system based mobile communication devices including relating first duration of connection ratings for one or more fixed position base station devices of one or more base station networks with relating second duration of connection ratings for one or more second mobile operating system based mobile communication devices of one or more second communication relay networks.

86. The computationally-implemented method of claim 71, wherein the relating the first information with the third information, the first information regarding the one or more first communication related events involving one or more first mobile operating system based mobile communication devices and one or more first fixed position base station devices, the third information regarding one or more second communication related events occurring directly between two or more second mobile operating system based mobile communication devices including relating the first information regarding one or more aspects of one or more base station networks including one or more fixed position base station devices with the third information regarding one or more aspects of communication relay networks furnished by one or more second mobile operating system based mobile communication devices comprises:
relating the first information regarding one or more aspects of one or more base station networks including one or more fixed position base station devices with the third information regarding one or more aspects of communication relay networks furnished by one or more second mobile operating system based mobile communication devices including relating first communication bandwidth ratings for one or more fixed position base station devices of one or more base station networks with relating second communication bandwidth ratings for one or more second mobile operating system based mobile communication devices of one or more second communication relay networks.

87. The computationally-implemented method of claim 71, wherein the relating the first information with the third information, the first information regarding the one or more first communication related events involving one or more first mobile operating system based mobile communication devices and one or more first fixed position base station devices, the third information regarding one or more second communication related events occurring directly between two or more second mobile operating system based mobile communication devices including relating the first information regarding one or more aspects of one or more base station networks including one or more fixed position base station devices with the third information regarding one or more aspects of communication relay networks furnished by one or more second mobile operating system based mobile communication devices comprises:
relating the first information regarding one or more aspects of one or more base station networks including one or more fixed position base station devices with the third information regarding one or more aspects of communication relay networks furnished by one or more second mobile operating system based mobile communication devices including relating first ease of use ratings for one or more fixed position base station devices of one or more base station networks with relating second ease of use ratings for one or more second mobile operating system based mobile communication devices of one or more second communication relay networks.

88. A computationally-implemented system, comprising:
one or more receiving first information regarding second information regarding first communication related events involving first mobile operating system based mobile communication devices and first fixed position base station devices electrical circuitry arrangements operable for receiving first information regarding second information, the second information having been received at one or more first fixed position base station devices being part of a base station network including fixed position base station devices, the second information regarding one or more first communication related events involving one or more first mobile operating system based mobile communication devices and the one or more first fixed position base station devices, each of the first communication related events involving one or more of the first mobile operating system based mobile communication devices and one or more of the first fixed position base station devices;
one or more receiving third information regarding fourth information regarding second communication related events occurring directly between second mobile operating system based mobile communication devices electrical circuitry arrangements operable for receiving third information regarding fourth information, the fourth information having been received at one or more second fixed position base station devices being part of the base station network including fixed position base station devices, the fourth information regarding one or more second communication related events occurring directly between two or more second mobile operating system based mobile communication devices; and
one or more relating first information with third information electrical circuitry arrangements operable for relating the first information with the third information, the first information regarding the second information having been received at the one or more first fixed position base station devices being part of a base station network including fixed position base station devices, the second information regarding the one or more first communication related events involving the one or more first mobile operating system based mobile communication devices and the one or more first fixed position base station devices, each of the first communication related events involving one or more of the first mobile operating system based mobile communication devices and one or more of the first fixed position base station devices, the third information regarding the fourth information the fourth information having been received at the one or more second fixed position base station devices being part of the base station network including fixed position base station devices, the fourth information regarding the one or more second communication related events occurring directly between the two or more second mobile operating system based mobile communication devices.

89. The computationally-implemented system of claim 88, wherein the one or more receiving first information regarding second information regarding first communication related events involving first mobile operating system based mobile communication devices and first fixed position base station devices electrical circuitry arrangements operable for receiving first information regarding second information, the second information having been received at one or more first fixed position base station devices being part of a base station network including fixed position base station devices, the second information regarding one or more first communication related events involving one or more first mobile operating system based mobile communication devices and the one or more first fixed position base station devices, each of the first communication related events involving one or more of the first mobile operating system based mobile communication devices and one or more of the first fixed position base station devices comprises:
one or more accessing data from data source via virtual machine representation of computing machine including accessing data from data source via virtual machine representation of real machine electrical circuitry arrangements operable for receiving first information regarding second information involving at least in part the one or more first mobile operating system based mobile communication devices including accessing data from a data source via a virtual machine representation of at least a part of a computing machine including accessing data from a data source via a virtual machine representation of at least a part of a real machine.

90. The computationally-implemented system of claim 88, wherein the one or more receiving first information regarding second information regarding first communication related events involving first mobile operating system based mobile communication devices and first fixed position base station devices electrical circuitry arrangements operable for receiving first information regarding second information, the second information having been received at one or more first fixed position base station devices being part of a base station network including fixed position base station devices, the second information regarding one or more first communication related events involving one or more first mobile operating system based mobile communication devices and the one or more first fixed position base station devices, each of the first communication related events involving one or more of the first mobile operating system based mobile communication devices and one or more of the first fixed position base station devices comprises:
one or more accessing data from data source via virtual machine representation of computing machine including accessing data from data source via virtual machine representation of virtual machine electrical circuitry arrangements operable for receiving first information regarding second information involving at least in part the one or more first mobile operating system based mobile communication devices including accessing data from a data source via a virtual machine representation of at least a part of a computing machine including accessing data from a data source via a virtual machine representation of at least a part of a virtual machine.

91. The computationally-implemented system of claim 88, wherein the one or more receiving first information regarding second information regarding first communication related events involving first mobile operating system based mobile communication devices and first fixed position base station devices electrical circuitry arrangements operable for receiving first information regarding second information, the second information having been received at one or more first fixed position base station devices being part of a base station network including fixed position base station devices, the second information regarding one or more first communication related events involving one or more first mobile operating system based mobile communication devices and the one or more first fixed position base station devices, each of the first communication related events involving one or more of the first mobile operating system based mobile communication devices and one or more of the first fixed position base station devices comprises:
one or more accessing data from data source via virtual machine representation of virtual machine including converting file having file-type associated virtual machine to file-type associated virtual machine representation electrical circuitry arrangements operable for receiving first information regarding second information involving at least in part the one or more first mobile operating system based mobile communication devices including accessing data from a data source via a virtual machine representation of at least a part of a virtual machine including converting a file having a file-type associated with the virtual machine to a file-type associated with the virtual machine representation.

92. The computationally-implemented system of claim 91, wherein the one or more accessing data from data source via virtual machine representation of virtual machine including converting file having file-type associated virtual machine to file-type associated virtual machine representation electrical circuitry arrangements operable for receiving first information regarding second information involving at least in part the one or more first mobile operating system based mobile communication devices including accessing data from a data source via a virtual machine representation of at least a part of a virtual machine including converting a file having a file-type associated with the virtual machine to a file-type associated with the virtual machine representation comprises:
one or more accessing data file-type associated second virtual machine for limited-resource computing machine electrical circuitry arrangements operable for accessing data from a data source via a virtual machine representation of at least a part of a virtual machine including converting a file having a file-type associated with the virtual machine to a file-type associated with the virtual machine representation involving accessing data wherein the file-type associated with the second virtual machine is configured for a limited-resource computing machine.

93. The computationally-implemented system of claim 92, wherein the one or more accessing data file-type associated second virtual machine for limited-resource computing machine electrical circuitry arrangements operable for accessing data from a data source via a virtual machine representation of at least a part of a virtual machine including converting a file having a file-type associated with the virtual machine to a file-type associated with the virtual machine representation involving accessing data wherein the file-type associated with the second virtual machine is configured for a limited-resource computing machine comprises:
one or more receiving first information regarding file-type associated second virtual machine for mobile computing machine electrical circuitry arrangements operable for accessing data wherein the file-type associated with the second virtual machine is configured for a limited-resource computing machine involving receiving first information regarding at least in part wherein the file-type associated with the second virtual machine is configured for a mobile computing machine.

94. The computationally-implemented system of claim 88, wherein the one or more receiving first information regarding second information regarding first communication related events involving first mobile operating system based mobile communication devices and first fixed position base station devices electrical circuitry arrangements operable for receiving first information regarding second information, the second information having been received at one or more first fixed position base station devices being part of a base station network including fixed position base station devices, the second information regarding one or more first communication related events involving one or more first mobile operating system based mobile communication devices and the one or more first fixed position base station devices, each of the first communication related events involving one or more of the first mobile operating system based mobile communication devices and one or more of the first fixed position base station devices comprises:
one or more receiving first information regarding first mobile operating system based mobile communication devices being used by users as mobile handset communication devices for communication with users of other mobile handset communication devices electrical circuitry arrangements operable for receiving first information regarding second information involving at least in part the one or more first mobile operating system based mobile communication devices including receiving first information regarding at least part first mobile operating system based mobile communication devices (e.g. Android tablet, Samsung smartphone, etc.) being used by users (e.g. businessperson, etc.) thereof as a mobile handset communication devices (e.g. phablet, etc.) for communication with one or more users of other one or more mobile handset communication devices (e.g. Apple iPhones, etc.).

95. The computationally-implemented system of claim 88, wherein the one or more receiving first information regarding second information regarding first communication related events involving first mobile operating system based mobile communication devices and first fixed position base station devices electrical circuitry arrangements operable for receiving first information regarding second information, the second information having been received at one or more first fixed position base station devices being part of a base station network including fixed position base station devices, the second information regarding one or more first communication related events involving one or more first mobile operating system based mobile communication devices and the one or more first fixed position base station devices, each of the first communication related events involving one or more of the first mobile operating system based mobile communication devices and one or more of the first fixed position base station devices comprises:
one or more receiving first information regarding first communication related events related to communication transmissions received by first fixed position base station devices being base station network from first mobile operating system based mobile communication devices electrical circuitry arrangements operable for receiving first information regarding second information involving at least in part the one or more first mobile operating system based mobile communication devices including receiving first information regarding at least in part first communication related events at least partially related to one or more communication transmissions received by one or more first fixed position base station devices being part of a base station network from first mobile operating system based mobile communication devices.

96. The computationally-implemented system of claim 95, wherein the one or more receiving first information regarding first communication related events related to communication transmissions received by first fixed position base station devices being base station network from first mobile operating system based mobile communication devices electrical circuitry arrangements operable for receiving first information regarding second information involving at least in part the one or more first mobile operating system based mobile communication devices including receiving first information regarding at least in part first communication related events at least partially related to one or more communication transmissions received by one or more first fixed position base station devices being part of a base station network from first mobile operating system based mobile communication devices comprises:
one or more receiving first information regarding first communication related events involving obstructed communication paths that first mobile operating system based mobile communication devices have encountered when attempting past communication with fixed position base station devices electrical circuitry arrangements operable for receiving first information regarding at least in part first communication related events at least partially related to one or more communication transmissions received by one or more first fixed position base station devices being part of a base station network from first mobile operating system based mobile communication devices including receiving first information regarding first communication related events involving one or more obstructed communication paths that the one or more first mobile operating system based mobile communication devices have encountered when attempting past communication with one or more fixed position base station devices.

97. The computationally-implemented system of claim 96, wherein the one or more receiving first information regarding first communication related events involving obstructed communication paths that first mobile operating system based mobile communication devices have encountered when attempting past communication with fixed position base station devices electrical circuitry arrangements operable for receiving first information regarding at least in part first communication related events at least partially related to one or more communication transmissions received by one or more first fixed position base station devices being part of a base station network from first mobile operating system based mobile communication devices including receiving first information regarding first communication related events involving one or more obstructed communication paths that the one or more first mobile operating system based mobile communication devices have encountered when attempting past communication with one or more fixed position base station devices comprises:
one or more receiving location information regarding moveable objects that have previously obstructed communication of first mobile operating system based mobile communication devices electrical circuitry arrangements operable for receiving first information regarding first communication related events involving one or more obstructed communication paths that the one or more first mobile operating system based mobile communication devices have encountered when attempting past communication with one or more fixed position base station devices including receiving location information regarding one or more moveable objects that have previously obstructed communication of one or more of the first mobile operating system based mobile communication devices.

98. The computationally-implemented system of claim 96, wherein the one or more receiving first information regarding first communication related events involving obstructed communication paths that first mobile operating system based mobile communication devices have encountered when attempting past communication with fixed position base station devices electrical circuitry arrangements operable for receiving first information regarding at least in part first communication related events at least partially related to one or more communication transmissions received by one or more first fixed position base station devices being part of a base station network from first mobile operating system based mobile communication devices including receiving first information regarding first communication related events involving one or more obstructed communication paths that the one or more first mobile operating system based mobile communication devices have encountered when attempting past communication with one or more fixed position base station devices comprises:
one or more receiving location information regarding fixed position objects that have previously obstructed communication of first mobile operating system based mobile communication devices electrical circuitry arrangements operable for receiving first information regarding first communication related events involving one or more obstructed communication paths that the one or more first mobile operating system based mobile communication devices have encountered when attempting past communication with one or more fixed position base station devices including receiving location information regarding one or more fixed position objects that have previously obstructed communication of one or more of the first mobile operating system based mobile communication devices.

99. The computationally-implemented system of claim 95, wherein the one or more receiving first information regarding first communication related events related to communication transmissions received by first fixed position base station devices being base station network from first mobile operating system based mobile communication devices electrical circuitry arrangements operable for receiving first information regarding second information involving at least in part the one or more first mobile operating system based mobile communication devices including receiving first information regarding at least in part first communication related events at least partially related to one or more communication transmissions received by one or more first fixed position base station devices being part of a base station network from first mobile operating system based mobile communication devices comprises:
one or more receiving information regarding map data of locations of fixed position objects electrical circuitry arrangements operable for receiving first information regarding at least in part first communication related events at least partially related to one or more communication transmissions received by one or more first fixed position base station devices being part of a base station network from first mobile operating system based mobile communication devices including receiving information regarding map data of one or more locations of one or more fixed position objects.

100. The computationally-implemented system of claim 95, wherein the one or more receiving first information regarding first communication related events related to communication transmissions received by first fixed position base station devices being base station network from first mobile operating system based mobile communication devices electrical circuitry arrangements operable for receiving first information regarding second information involving at least in part the one or more first mobile operating system based mobile communication devices including receiving first information regarding at least in part first communication related events at least partially related to one or more communication transmissions received by one or more first fixed position base station devices being part of a base station network from first mobile operating system based mobile communication devices comprises:
one or more receiving information regarding time based distributions of instances of obstruction of electronic device communication for particular geographical locations electrical circuitry arrangements operable for receiving first information regarding at least in part first communication related events at least partially related to one or more communication transmissions received by one or more first fixed position base station devices being part of a base station network from first mobile operating system based mobile communication devices including receiving information regarding one or more time based distributions of instances of obstruction of electronic device communication for one or more particular geographical locations.

101. The computationally-implemented system of claim 95, wherein the one or more receiving first information regarding first communication related events related to communication transmissions received by first fixed position base station devices being base station network from first mobile operating system based mobile communication devices electrical circuitry arrangements operable for receiving first information regarding second information involving at least in part the one or more first mobile operating system based mobile communication devices including receiving first information regarding at least in part first communication related events at least partially related to one or more communication transmissions received by one or more first fixed position base station devices being part of a base station network from first mobile operating system based mobile communication devices comprises:
one or more receiving information regarding statistical probabilities of remaining in communication with first mobile operating system based mobile communication devices electrical circuitry arrangements operable for receiving first information regarding at least in part first communication related events at least partially related to one or more communication transmissions received by one or more first fixed position base station devices being part of a base station network from first mobile operating system based mobile communication devices including receiving information regarding one or more statistical probabilities of remaining in communication with the one or more first mobile operating system based mobile communication devices.

102. The computationally-implemented system of claim 95, wherein the one or more receiving first information regarding first communication related events related to communication transmissions received by first fixed position base station devices being base station network from first mobile operating system based mobile communication devices electrical circuitry arrangements operable for receiving first information regarding second information involving at least in part the one or more first mobile operating system based mobile communication devices including receiving first information regarding at least in part first communication related events at least partially related to one or more communication transmissions received by one or more first fixed position base station devices being part of a base station network from first mobile operating system based mobile communication devices comprises:
one or more receiving GPS positioning data regarding first mobile operating system based mobile communication devices electrical circuitry arrangements operable for receiving first information regarding at least in part first communication related events at least partially related to one or more communication transmissions received by one or more first fixed position base station devices being part of a base station network from first mobile operating system based mobile communication devices including receiving GPS positioning data regarding the one or more first mobile operating system based mobile communication devices.

103. The computationally-implemented system of claim 95, wherein the one or more receiving first information regarding first communication related events related to communication transmissions received by first fixed position base station devices being base station network from first mobile operating system based mobile communication devices electrical circuitry arrangements operable for receiving first information regarding second information involving at least in part the one or more first mobile operating system based mobile communication devices including receiving first information regarding at least in part first communication related events at least partially related to one or more communication transmissions received by one or more first fixed position base station devices being part of a base station network from first mobile operating system based mobile communication devices comprises:
one or more receiving information associated communication histories of other mobile operating system based mobile communication devices communicating through base station network with first mobile operating system based mobile communication devices electrical circuitry arrangements operable for receiving first information regarding at least in part first communication related events at least partially related to one or more communication transmissions received by one or more first fixed position base station devices being part of a base station network from first mobile operating system based mobile communication devices including receiving information associated with communication histories of one or more other mobile operating system based mobile communication devices communicating through the base station network with the one or more first mobile operating system based mobile communication devices.

104. The computationally-implemented system of claim 103, wherein the one or more receiving information associated communication histories of other mobile operating system based mobile communication devices communicating through base station network with first mobile operating system based mobile communication devices electrical circuitry arrangements operable for receiving first information regarding at least in part first communication related events at least partially related to one or more communication transmissions received by one or more first fixed position base station devices being part of a base station network from first mobile operating system based mobile communication devices including receiving information associated with communication histories of one or more other mobile operating system based mobile communication devices communicating through the base station network with the one or more first mobile operating system based mobile communication devices comprises:
one or more receiving information as positioning data for first mobile operating system based mobile communication devices electrical circuitry arrangements operable for receiving information associated with communication histories of one or more other mobile operating system based mobile communication devices communicating through the base station network with the one or more first mobile operating system based mobile communication devices including receiving information as positioning data for the one or more first mobile operating system based mobile communication devices.

105. The computationally-implemented system of claim 103, wherein the one or more receiving information associated communication histories of other mobile operating system based mobile communication devices communicating through base station network with first mobile operating system based mobile communication devices electrical circuitry arrangements operable for receiving first information regarding at least in part first communication related events at least partially related to one or more communication transmissions received by one or more first fixed position base station devices being part of a base station network from first mobile operating system based mobile communication devices including receiving information associated with communication histories of one or more other mobile operating system based mobile communication devices communicating through the base station network with the one or more first mobile operating system based mobile communication devices comprises:
one or more receiving information as communication history data previously stored and forwarded between of first mobile operating system based mobile communication devices electrical circuitry arrangements operable for receiving information associated with communication histories of one or more other mobile operating system based mobile communication devices communicating through the base station network with the one or more first mobile operating system based mobile communication devices including receiving information as communication history data previously stored and forwarded between one or more of the first mobile operating system based mobile communication devices.

106. The computationally-implemented system of claim 95, wherein the one or more receiving first information regarding first communication related events related to communication transmissions received by first fixed position base station devices being base station network from first mobile operating system based mobile communication devices electrical circuitry arrangements operable for receiving first information regarding second information involving at least in part the one or more first mobile operating system based mobile communication devices including receiving first information regarding at least in part first communication related events at least partially related to one or more communication transmissions received by one or more first fixed position base station devices being part of a base station network from first mobile operating system based mobile communication devices comprises:
one or more receiving information regarding potential obstructions to electronic communication located proximate to of first mobile operating system based mobile communication devices electrical circuitry arrangements operable for receiving first information regarding at least in part first communication related events at least partially related to one or more communication transmissions received by one or more first fixed position base station devices being part of a base station network from first mobile operating system based mobile communication devices including receiving information regarding one or more potential obstructions to electronic communication located proximate to one or more of the first mobile operating system based mobile communication devices.

107. The computationally-implemented system of claim 106, wherein the one or more receiving information regarding potential obstructions to electronic communication located proximate to of first mobile operating system based mobile communication devices electrical circuitry arrangements operable for receiving first information regarding at least in part first communication related events at least partially related to one or more communication transmissions received by one or more first fixed position base station devices being part of a base station network from first mobile operating system based mobile communication devices including receiving information regarding one or more potential obstructions to electronic communication located proximate to one or more of the first mobile operating system based mobile communication devices comprises:
one or more receiving information regarding moveable communication obstructions electrical circuitry arrangements operable for receiving information regarding one or more potential obstructions to electronic communication located proximate to one or more of the first mobile operating system based mobile communication devices including receiving information regarding one or more moveable communication obstructions.

108. The computationally-implemented system of claim 107, wherein the one or more receiving information regarding moveable communication obstructions electrical circuitry arrangements operable for receiving information regarding one or more potential obstructions to electronic communication located proximate to one or more of the first mobile operating system based mobile communication devices including receiving information regarding one or more moveable communication obstructions comprises:
one or more receiving information regarding moveable communication obstructions as pedestrians electrical circuitry arrangements operable for receiving information regarding one or more moveable communication obstructions including receiving information regarding one or more moveable communication obstructions as one or more pedestrians.

109. The computationally-implemented system of claim 106, wherein the one or more receiving information regarding potential obstructions to electronic communication located proximate to of first mobile operating system based mobile communication devices electrical circuitry arrangements operable for receiving first information regarding at least in part first communication related events at least partially related to one or more communication transmissions received by one or more first fixed position base station devices being part of a base station network from first mobile operating system based mobile communication devices including receiving information regarding one or more potential obstructions to electronic communication located proximate to one or more of the first mobile operating system based mobile communication devices comprises:
one or more receiving information regarding potential obstructions to electronic communication as architectural structures electrical circuitry arrangements operable for receiving information regarding one or more potential obstructions to electronic communication located proximate to one or more of the first mobile operating system based mobile communication devices including receiving information regarding one or more potential obstructions to electronic communication as one or more architectural structures.

110. The computationally-implemented system of claim 88, wherein the one or more receiving third information regarding fourth information regarding second communication related events occurring directly between second mobile operating system based mobile communication devices electrical circuitry arrangements operable for receiving third information regarding fourth information, the fourth information having been received at one or more second fixed position base station devices being part of the base station network including fixed position base station devices, the fourth information regarding one or more second communication related events occurring directly between two or more second mobile operating system based mobile communication devices comprises:
one or more accessing data from data source via virtual machine representation of computing machine including accessing data from data source via virtual machine representation of real machine electrical circuitry arrangements operable for receiving third information regarding fourth information regarding one or more second communication related events occurring directly between two or more second mobile operating system based mobile communication devices including accessing data from a data source via a virtual machine representation of at least a part of a computing machine including accessing data from a data source via a virtual machine representation of at least a part of a real machine.

111. The computationally-implemented system of claim 88, wherein the one or more receiving third information regarding fourth information regarding second communication related events occurring directly between second mobile operating system based mobile communication devices electrical circuitry arrangements operable for receiving third information regarding fourth information, the fourth information having been received at one or more second fixed position base station devices being part of the base station network including fixed position base station devices, the fourth information regarding one or more second communication related events occurring directly between two or more second mobile operating system based mobile communication devices comprises:
one or more accessing data from data source via virtual machine representation of computing machine including accessing data from data source via virtual machine representation of virtual machine electrical circuitry arrangements operable for receiving third information regarding fourth information regarding one or more second communication related events occurring directly between two or more second mobile operating system based mobile communication devices including accessing data from a data source via a virtual machine representation of at least a part of a computing machine including accessing data from a data source via a virtual machine representation of at least a part of a virtual machine.

112. The computationally-implemented system of claim 88, wherein the one or more receiving third information regarding fourth information regarding second communication related events occurring directly between second mobile operating system based mobile communication devices electrical circuitry arrangements operable for receiving third information regarding fourth information, the fourth information having been received at one or more second fixed position base station devices being part of the base station network including fixed position base station devices, the fourth information regarding one or more second communication related events occurring directly between two or more second mobile operating system based mobile communication devices comprises:
one or more accessing data from data source via virtual machine representation of virtual machine including converting file having file-type associated virtual machine to file-type associated virtual machine representation electrical circuitry arrangements operable for receiving third information regarding fourth information regarding one or more second communication related events occurring directly between two or more second mobile operating system based mobile communication devices including accessing data from a data source via a virtual machine representation of at least a part of a virtual machine including converting a file having a file-type associated with the virtual machine to a file-type associated with the virtual machine representation.

113. The computationally-implemented system of claim 112, wherein the one or more accessing data from data source via virtual machine representation of virtual machine including converting file having file-type associated virtual machine to file-type associated virtual machine representation electrical circuitry arrangements operable for receiving third information regarding fourth information regarding one or more second communication related events occurring directly between two or more second mobile operating system based mobile communication devices including accessing data from a data source via a virtual machine representation of at least a part of a virtual machine including converting a file having a file-type associated with the virtual machine to a file-type associated with the virtual machine representation comprises:
one or more file-type associated second virtual machine for limited-resource computing machine electrical circuitry arrangements operable for accessing data from a data source via a virtual machine representation of at least a part of a virtual machine including converting a file having a file-type associated with the virtual machine to a file-type associated with the virtual machine representation including wherein the file-type associated with the second virtual machine is configured for a limited-resource computing machine.

114. The computationally-implemented system of claim 113, wherein the one or more file-type associated second virtual machine for limited-resource computing machine electrical circuitry arrangements operable for accessing data from a data source via a virtual machine representation of at least a part of a virtual machine including converting a file having a file-type associated with the virtual machine to a file-type associated with the virtual machine representation including wherein the file-type associated with the second virtual machine is configured for a limited-resource computing machine comprises:
one or more file-type associated second virtual machine for mobile computing machine electrical circuitry arrangements operable for wherein the file-type associated with the second virtual machine is configured for a limited-resource computing machine including wherein the file-type associated with the second virtual machine is configured for a mobile computing machine.

115. The computationally-implemented system of claim 88, wherein the one or more receiving third information regarding fourth information regarding second communication related events occurring directly between second mobile operating system based mobile communication devices electrical circuitry arrangements operable for receiving third information regarding fourth information, the fourth information having been received at one or more second fixed position base station devices being part of the base station network including fixed position base station devices, the fourth information regarding one or more second communication related events occurring directly between two or more second mobile operating system based mobile communication devices comprises:
one or more receiving information regarding activation of second mobile operating system based mobile communication devices as network relay devices based upon fixed position base station devices becoming unavailable for communication with mobile operating system based mobile communication devices electrical circuitry arrangements operable for receiving third information regarding fourth information regarding one or more second communication related events occurring directly between two or more second mobile operating system based mobile communication devices including receiving information regarding activation of the two or more second mobile operating system based mobile communication devices as network relay devices based at least in part upon one or more fixed position base station devices becoming unavailable for communication with one or more mobile operating system based mobile communication devices.

116. The computationally-implemented system of claim 88, wherein the one or more receiving third information regarding fourth information regarding second communication related events occurring directly between second mobile operating system based mobile communication devices electrical circuitry arrangements operable for receiving third information regarding fourth information, the fourth information having been received at one or more second fixed position base station devices being part of the base station network including fixed position base station devices, the fourth information regarding one or more second communication related events occurring directly between two or more second mobile operating system based mobile communication devices comprises:
one or more receiving wireless packetized communication electrical circuitry arrangements operable for receiving third information regarding fourth information regarding one or more second communication related events occurring directly between two or more second mobile operating system based mobile communication devices including receiving wireless packetized communication.

117. The computationally-implemented system of claim 116, wherein the one or more receiving wireless packetized communication electrical circuitry arrangements operable for receiving third information regarding fourth information regarding one or more second communication related events occurring directly between two or more second mobile operating system based mobile communication devices including receiving wireless packetized communication comprises:
one or more receiving incoming message traffic electrical circuitry arrangements operable for receiving wireless packetized communication including receiving incoming message traffic.

118. The computationally-implemented system of claim 117, wherein the one or more receiving incoming message traffic electrical circuitry arrangements operable for receiving wireless packetized communication including receiving incoming message traffic comprises:
one or more receiving high bandwidth data transfers electrical circuitry arrangements operable for receiving incoming message traffic including receiving one or more high bandwidth data transfers.

119. The computationally-implemented system of claim 117, wherein the one or more receiving incoming message traffic electrical circuitry arrangements operable for receiving wireless packetized communication including receiving incoming message traffic comprises:
one or more receiving high resolution audio formatted messages electrical circuitry arrangements operable for receiving incoming message traffic including receiving one or more high resolution audio formatted messages.

120. The computationally-implemented system of claim 117, wherein the one or more receiving incoming message traffic electrical circuitry arrangements operable for receiving wireless packetized communication including receiving incoming message traffic comprises:
one or more receiving high resolution video formatted messages electrical circuitry arrangements operable for receiving incoming message traffic including receiving one or more high resolution video formatted messages.

121. The computationally-implemented system of claim 117, wherein the one or more receiving incoming message traffic electrical circuitry arrangements operable for receiving wireless packetized communication including receiving incoming message traffic comprises:
one or more receiving incoming message traffic including receiving high capacity data files electrical circuitry arrangements operable for receiving incoming message traffic including receiving one or more high capacity data files.

122. The computationally-implemented system of claim 116, wherein the one or more receiving wireless packetized communication electrical circuitry arrangements operable for receiving third information regarding fourth information regarding one or more second communication related events occurring directly between two or more second mobile operating system based mobile communication devices including receiving wireless packetized communication comprises:
one or more receiving wireless packetized communication including receiving communication network relay related transmissions from second mobile operating system based mobile communication devices electrical circuitry arrangements operable for receiving wireless packetized communication including receiving one or more communication network relay related transmissions from one or more second mobile operating system based mobile communication devices.

123. The computationally-implemented system of claim 116, wherein the one or more receiving wireless packetized communication electrical circuitry arrangements operable for receiving third information regarding fourth information regarding one or more second communication related events occurring directly between two or more second mobile operating system based mobile communication devices including receiving wireless packetized communication comprises:
one or more receiving wireless packetized communication including receiving communication network relay related transmissions from second mobile operating system based mobile communication devices as heterogeneous types electrical circuitry arrangements operable for receiving wireless packetized communication including receiving one or more communication network relay related transmissions from one or more second mobile operating system based mobile communication devices as heterogeneous types.

124. The computationally-implemented system of claim 123, wherein the one or more receiving wireless packetized communication including receiving communication network relay related transmissions from second mobile operating system based mobile communication devices as heterogeneous types electrical circuitry arrangements operable for receiving wireless packetized communication including receiving one or more communication network relay related transmissions from one or more second mobile operating system based mobile communication devices as heterogeneous types comprises:
one or more receiving communication network relay related transmissions from laptops, phablets, tablets, smart phones, notebooks, handsets, palmtops, personal digital assistants, digital audio players, portable media players, digital cameras, or cell phones electrical circuitry arrangements operable for receiving one or more communication network relay related transmissions from one or more second mobile operating system based mobile communication devices as heterogeneous types including receiving one or more communication network relay related transmissions from one or more laptops, one or more phablets, one or more tablets, one or more smart phones, one or more notebooks, one or more handsets, one or more palmtops, one or more personal digital assistants, one or more digital audio players, one or more portable media players, one or more digital cameras, or one or more cell phones.

125. The computationally-implemented system of claim 123, wherein the one or more receiving wireless packetized communication including receiving communication network relay related transmissions from second mobile operating system based mobile communication devices as heterogeneous types electrical circuitry arrangements operable for receiving wireless packetized communication including receiving one or more communication network relay related transmissions from one or more second mobile operating system based mobile communication devices as heterogeneous types comprises:
one or more receiving communication network relay related transmissions as using hybridized protocols including IEEE 802.11 ac protocols, IEEE 802.11 ad protocols, or IEEE 802.11n/g protocols electrical circuitry arrangements operable for receiving one or more communication network relay related transmissions from one or more second mobile operating system based mobile communication devices as heterogeneous types including receiving one or more communication network relay related transmissions as using hybridized protocols including one or more IEEE 802.11 ac protocols, one or more IEEE 802.11ad protocols, or one or more IEEE 802.11n/g protocols.

126. The computationally-implemented system of claim 123, wherein the one or more receiving wireless packetized communication including receiving communication network relay related transmissions from second mobile operating system based mobile communication devices as heterogeneous types electrical circuitry arrangements operable for receiving wireless packetized communication including receiving one or more communication network relay related transmissions from one or more second mobile operating system based mobile communication devices as heterogeneous types comprises:
one or more receiving communication network relay related transmissions as using cellular protocols electrical circuitry arrangements operable for receiving one or more communication network relay related transmissions from one or more second mobile operating system based mobile communication devices as heterogeneous types including receiving one or more communication network relay related transmissions as using one or more cellular protocols.

127. The computationally-implemented system of claim 123, wherein the one or more receiving wireless packetized communication including receiving communication network relay related transmissions from second mobile operating system based mobile communication devices as heterogeneous types electrical circuitry arrangements operable for receiving wireless packetized communication including receiving one or more communication network relay related transmissions from one or more second mobile operating system based mobile communication devices as heterogeneous types comprises:
one or more receiving communication network relay related transmissions as using WiFi protocols, or direct WiFi protocols electrical circuitry arrangements operable for receiving one or more communication network relay related transmissions from one or more second mobile operating system based mobile communication devices as heterogeneous types including receiving one or more communication network relay related transmissions as using one or more WiFi protocols, or one or more direct WiFi protocols.

128. The computationally-implemented system of claim 123, wherein the one or more receiving wireless packetized communication including receiving communication network relay related transmissions from second mobile operating system based mobile communication devices as heterogeneous types electrical circuitry arrangements operable for receiving wireless packetized communication including receiving one or more communication network relay related transmissions from one or more second mobile operating system based mobile communication devices as heterogeneous types comprises:
one or more receiving communication network relay related transmissions as using protocols including 3G protocols, 4G protocols, 5G protocols, 6G or 7G protocols electrical circuitry arrangements operable for receiving one or more communication network relay related transmissions from one or more second mobile operating system based mobile communication devices as heterogeneous types including receiving one or more communication network relay related transmissions as using protocols including one or more 3G protocols, one or more 4G protocols, one or more 5G protocols, one or more 6G or one or more 7G protocols.

129. The computationally-implemented system of claim 123, wherein the one or more receiving wireless packetized communication including receiving communication network relay related transmissions from second mobile operating system based mobile communication devices as heterogeneous types electrical circuitry arrangements operable for receiving wireless packetized communication including receiving one or more communication network relay related transmissions from one or more second mobile operating system based mobile communication devices as heterogeneous types comprises:
one or more receiving communication network relay related transmissions as using protocols including 20 GHz or above protocols, 30 GHz or above protocols, or 60 GHz or above protocols electrical circuitry arrangements operable for receiving one or more communication network relay related transmissions from one or more second mobile operating system based mobile communication devices as heterogeneous types including receiving one or more communication network relay related transmissions as using protocols including one or more 20 GHz or above protocols, one or more 30 GHz or above protocols, or one or more 60 GHz or above protocols.

130. The computationally-implemented system of claim 123, wherein the one or more receiving wireless packetized communication including receiving communication network relay related transmissions from second mobile operating system based mobile communication devices as heterogeneous types electrical circuitry arrangements operable for receiving wireless packetized communication including receiving one or more communication network relay related transmissions from one or more second mobile operating system based mobile communication devices as heterogeneous types comprises:
one or more receiving electronic token identifiers independent from device type of second mobile operating system based mobile communication devices intermediate electronic communication devices electrical circuitry arrangements operable for receiving one or more communication network relay related transmissions from one or more second mobile operating system based mobile communication devices as heterogeneous types including receiving one or more electronic token identifiers independent from device type of the one or more second mobile operating system based mobile communication devices one or more intermediate electronic communication devices.

131. The computationally-implemented system of claim 123, wherein the one or more receiving wireless packetized communication including receiving communication network relay related transmissions from second mobile operating system based mobile communication devices as heterogeneous types electrical circuitry arrangements operable for receiving wireless packetized communication including receiving one or more communication network relay related transmissions from one or more second mobile operating system based mobile communication devices as heterogeneous types comprises:
one or more receiving rotating communication beams, alternating communication beams, sweeping communication beams, multiple communication beams, switching communication beams, or diffracted communication beams electrical circuitry arrangements operable for receiving one or more communication network relay related transmissions from one or more second mobile operating system based mobile communication devices as heterogeneous types including receiving one or more rotating communication beams, one or more alternating communication beams, one or more sweeping communication beams, one or more multiple communication beams, one or more switching communication beams, or one or more diffracted communication beams.

132. The computationally-implemented system of claim 123, wherein the one or more receiving wireless packetized communication including receiving communication network relay related transmissions from second mobile operating system based mobile communication devices as heterogeneous types electrical circuitry arrangements operable for receiving wireless packetized communication including receiving one or more communication network relay related transmissions from one or more second mobile operating system based mobile communication devices as heterogeneous types comprises:
one or more receiving from multiple antennas, directional antennas, changeable antenna architectures, mesh network antennas, or omnidirectional antennas electrical circuitry arrangements operable for receiving one or more communication network relay related transmissions from one or more second mobile operating system based mobile communication devices as heterogeneous types including receiving from one or more multiple antennas, one or more directional antennas, one or more changeable antenna architectures, one or more mesh network antennas, or one or more omnidirectional antennas.

133. The computationally-implemented system of claim 88, wherein the one or more receiving third information regarding fourth information regarding second communication related events occurring directly between second mobile operating system based mobile communication devices electrical circuitry arrangements operable for receiving third information regarding fourth information, the fourth information having been received at one or more second fixed position base station devices being part of the base station network including fixed position base station devices, the fourth information regarding one or more second communication related events occurring directly between two or more second mobile operating system based mobile communication devices comprises:
one or more receiving information contained in second mobile operating system based mobile communication device relayed transmissions electrical circuitry arrangements operable for receiving third information regarding fourth information regarding one or more second communication related events occurring directly between two or more second mobile operating system based mobile communication devices including receiving information at least partially contained in one or more second mobile operating system based mobile communication device relayed transmissions.

134. The computationally-implemented system of claim 133, wherein the one or more receiving information contained in second mobile operating system based mobile communication device relayed transmissions electrical circuitry arrangements operable for receiving third information regarding fourth information regarding one or more second communication related events occurring directly between two or more second mobile operating system based mobile communication devices including receiving information at least partially contained in one or more second mobile operating system based mobile communication device relayed transmissions comprises:
one or more obtaining information regarding obstructed communication paths that second mobile operating system based mobile communication devices have encountered when attempting to communicate with other second mobile operating system based mobile communication devices electrical circuitry arrangements operable for receiving information at least partially contained in one or more second mobile operating system based mobile communication device relayed transmissions including obtaining information regarding one or more obstructed communication paths that one or more second mobile operating system based mobile communication devices have encountered when attempting to communicate with other one or more second mobile operating system based mobile communication devices.

135. The computationally-implemented system of claim 134, wherein the one or more obtaining information regarding obstructed communication paths that second mobile operating system based mobile communication devices have encountered when attempting to communicate with other second mobile operating system based mobile communication devices electrical circuitry arrangements operable for receiving information at least partially contained in one or more second mobile operating system based mobile communication device relayed transmissions including obtaining information regarding one or more obstructed communication paths that one or more second mobile operating system based mobile communication devices have encountered when attempting to communicate with other one or more second mobile operating system based mobile communication devices comprises:
one or more receiving location information regarding moveable objects that have previously obstructed communication of second mobile operating system based mobile communication devices electrical circuitry arrangements operable for obtaining information regarding one or more obstructed communication paths that one or more second mobile operating system based mobile communication devices have encountered when attempting to communicate with other one or more second mobile operating system based mobile communication devices including receiving location information regarding one or more moveable objects that have previously obstructed communication of one or more of the second mobile operating system based mobile communication devices.

136. The computationally-implemented system of claim 134, wherein the one or more obtaining information regarding obstructed communication paths that second mobile operating system based mobile communication devices have encountered when attempting to communicate with other second mobile operating system based mobile communication devices electrical circuitry arrangements operable for receiving information at least partially contained in one or more second mobile operating system based mobile communication device relayed transmissions including obtaining information regarding one or more obstructed communication paths that one or more second mobile operating system based mobile communication devices have encountered when attempting to communicate with other one or more second mobile operating system based mobile communication devices comprises:
one or more receiving location information regarding fixed position objects obstructed communication of second mobile operating system based mobile communication devices module electrical circuitry arrangements operable for obtaining information regarding one or more obstructed communication paths that one or more second mobile operating system based mobile communication devices have encountered when attempting to communicate with other one or more second mobile operating system based mobile communication devices including receiving location information regarding one or more fixed position objects that have previously obstructed communication of one or more second mobile operating system based mobile communication devices.

137. The computationally-implemented system of claim 133, wherein the one or more receiving information contained in second mobile operating system based mobile communication device relayed transmissions electrical circuitry arrangements operable for receiving third information regarding fourth information regarding one or more second communication related events occurring directly between two or more second mobile operating system based mobile communication devices including receiving information at least partially contained in one or more second mobile operating system based mobile communication device relayed transmissions comprises:
one or more receiving information regarding map data of locations of fixed position objects electrical circuitry arrangements operable for receiving information at least partially contained in one or more second mobile operating system based mobile communication device relayed transmissions including receiving information regarding map data of locations of fixed position objects.

138. The computationally-implemented system of claim 133, wherein the one or more receiving information contained in second mobile operating system based mobile communication device relayed transmissions electrical circuitry arrangements operable for receiving third information regarding fourth information regarding one or more second communication related events occurring directly between two or more second mobile operating system based mobile communication devices including receiving information at least partially contained in one or more second mobile operating system based mobile communication device relayed transmissions comprises:
one or more receiving information regarding time based distributions of instances of obstruction of second mobile operating system based mobile communication device communication for particular geographical locations electrical circuitry arrangements operable for receiving information at least partially contained in one or more second mobile operating system based mobile communication device relayed transmissions including receiving information regarding one or more time based distributions of instances of obstruction of second mobile operating system based mobile communication device communication for one or more particular geographical locations.

139. The computationally-implemented system of claim 133, wherein the one or more receiving information contained in second mobile operating system based mobile communication device relayed transmissions electrical circuitry arrangements operable for receiving third information regarding fourth information regarding one or more second communication related events occurring directly between two or more second mobile operating system based mobile communication devices including receiving information at least partially contained in one or more second mobile operating system based mobile communication device relayed transmissions comprises:
one or more receiving information regarding statistical probabilities of remaining in communication with second mobile operating system based mobile communication devices electrical circuitry arrangements operable for receiving information at least partially contained in one or more second mobile operating system based mobile communication device relayed transmissions including receiving information regarding one or more statistical probabilities of remaining in communication with one or more second mobile operating system based mobile communication devices.

140. The computationally-implemented system of claim 133, wherein the one or more receiving information contained in second mobile operating system based mobile communication device relayed transmissions electrical circuitry arrangements operable for receiving third information regarding fourth information regarding one or more second communication related events occurring directly between two or more second mobile operating system based mobile communication devices including receiving information at least partially contained in one or more second mobile operating system based mobile communication device relayed transmissions comprises:
one or more receiving GPS positioning data regarding second mobile operating system based mobile communication devices electrical circuitry arrangements operable for receiving information at least partially contained in one or more second mobile operating system based mobile communication device relayed transmissions including receiving GPS positioning data regarding the one or more second mobile operating system based mobile communication devices.

141. The computationally-implemented system of claim 133, wherein the one or more receiving information contained in second mobile operating system based mobile communication device relayed transmissions electrical circuitry arrangements operable for receiving third information regarding fourth information regarding one or more second communication related events occurring directly between two or more second mobile operating system based mobile communication devices including receiving information at least partially contained in one or more second mobile operating system based mobile communication device relayed transmissions comprises:
one or more receiving information associated communication histories of other electronic communication devices communicating with intermediate electronic communication devices electrical circuitry arrangements operable for receiving information at least partially contained in one or more second mobile operating system based mobile communication device relayed transmissions including receiving information associated with communication histories of one or more other electronic communication devices communicating with the one or more intermediate electronic communication devices.

142. The computationally-implemented system of claim 141, wherein the one or more receiving information associated communication histories of other electronic communication devices communicating with intermediate electronic communication devices electrical circuitry arrangements operable for receiving information at least partially contained in one or more second mobile operating system based mobile communication device relayed transmissions including receiving information associated with communication histories of one or more other electronic communication devices communicating with the one or more intermediate electronic communication devices comprises:
one or more receiving information as positioning data for second mobile operating system based mobile communication devices electrical circuitry arrangements operable for receiving information associated with communication histories of one or more other electronic communication devices communicating with the one or more intermediate electronic communication devices including receiving information as positioning data for one or more second mobile operating system based mobile communication devices.

143. The computationally-implemented system of claim 141, wherein the one or more receiving information associated communication histories of other electronic communication devices communicating with intermediate electronic communication devices electrical circuitry arrangements operable for receiving information at least partially contained in one or more second mobile operating system based mobile communication device relayed transmissions including receiving information associated with communication histories of one or more other electronic communication devices communicating with the one or more intermediate electronic communication devices comprises:
one or more receiving information as communication history data previously stored and forwarded between second mobile operating system based mobile communication devices electrical circuitry arrangements operable for receiving information associated with communication histories of one or more other electronic communication devices communicating with the one or more intermediate electronic communication devices including receiving information as communication history data previously stored and forwarded between two or more second mobile operating system based mobile communication devices.

144. The computationally-implemented system of claim 133, wherein the one or more receiving information contained in second mobile operating system based mobile communication device relayed transmissions electrical circuitry arrangements operable for receiving third information regarding fourth information regarding one or more second communication related events occurring directly between two or more second mobile operating system based mobile communication devices including receiving information at least partially contained in one or more second mobile operating system based mobile communication device relayed transmissions comprises:
one or more receiving information regarding potential obstructions to electronic communication located proximate to of second mobile operating system based mobile communication devices electrical circuitry arrangements operable for receiving information at least partially contained in one or more second mobile operating system based mobile communication device relayed transmissions including receiving information regarding one or more potential obstructions to electronic communication located proximate to one or more of the second mobile operating system based mobile communication devices.

145. The computationally-implemented system of claim 144, wherein the one or more receiving information regarding potential obstructions to electronic communication located proximate to of second mobile operating system based mobile communication devices electrical circuitry arrangements operable for receiving information at least partially contained in one or more second mobile operating system based mobile communication device relayed transmissions including receiving information regarding one or more potential obstructions to electronic communication located proximate to one or more of the second mobile operating system based mobile communication devices comprises:
one or more receiving information regarding moveable communication obstructions electrical circuitry arrangements operable for receiving information regarding one or more potential obstructions to electronic communication located proximate to one or more of the second mobile operating system based mobile communication devices including receiving information regarding one or more moveable communication obstructions.

146. The computationally-implemented system of claim 145, wherein the one or more receiving information regarding moveable communication obstructions electrical circuitry arrangements operable for receiving information regarding one or more potential obstructions to electronic communication located proximate to one or more of the second mobile operating system based mobile communication devices including receiving information regarding one or more moveable communication obstructions comprises:
one or more receiving information regarding moveable communication obstructions as pedestrians electrical circuitry arrangements operable for receiving information regarding one or more moveable communication obstructions including receiving information regarding one or more moveable communication obstructions as one or more pedestrians.

147. The computationally-implemented system of claim 144, wherein the one or more receiving information regarding potential obstructions to electronic communication located proximate to of second mobile operating system based mobile communication devices electrical circuitry arrangements operable for receiving information at least partially contained in one or more second mobile operating system based mobile communication device relayed transmissions including receiving information regarding one or more potential obstructions to electronic communication located proximate to one or more of the second mobile operating system based mobile communication devices comprises:
one or more receiving information regarding potential obstructions to electronic communication as architectural structures electrical circuitry arrangements operable for receiving information regarding one or more potential obstructions to electronic communication located proximate to one or more of the second mobile operating system based mobile communication devices including receiving information regarding one or more potential obstructions to electronic communication as one or more architectural structures.

148. The computationally-implemented system of claim 133, wherein the one or more receiving information contained in second mobile operating system based mobile communication device relayed transmissions electrical circuitry arrangements operable for receiving third information regarding fourth information regarding one or more second communication related events occurring directly between two or more second mobile operating system based mobile communication devices including receiving information at least partially contained in one or more second mobile operating system based mobile communication device relayed transmissions comprises:
one or more receiving information regarding communication capacity available to of standby communication relays furnished by second mobile operating system based mobile communication devices electrical circuitry arrangements operable for receiving information at least partially contained in one or more second mobile operating system based mobile communication device relayed transmissions including receiving information regarding communication capacity available to one or more of standby communication relays furnished by one or more second mobile operating system based mobile communication devices.

149. The computationally-implemented system of claim 148, wherein the one or more receiving information regarding communication capacity available to of standby communication relays furnished by second mobile operating system based mobile communication devices electrical circuitry arrangements operable for receiving information at least partially contained in one or more second mobile operating system based mobile communication device relayed transmissions including receiving information regarding communication capacity available to one or more of standby communication relays furnished by one or more second mobile operating system based mobile communication devices comprises:
one or more receiving information regarding communication bandwidth available to of standby communication relays furnished by second mobile operating system based mobile communication devices electrical circuitry arrangements operable for receiving information regarding communication capacity available to one or more of standby communication relays furnished by one or more second mobile operating system based mobile communication devices including receiving information regarding communication bandwidth available to one or more of standby communication relays furnished by one or more second mobile operating system based mobile communication devices.

150. The computationally-implemented system of claim 149, wherein the one or more receiving information regarding communication bandwidth available to of standby communication relays furnished by second mobile operating system based mobile communication devices electrical circuitry arrangements operable for receiving information regarding communication capacity available to one or more of standby communication relays furnished by one or more second mobile operating system based mobile communication devices including receiving information regarding communication bandwidth available to one or more of standby communication relays furnished by one or more second mobile operating system based mobile communication devices comprises:
one or more receiving information regarding runtime duration available to of standby communication relays furnished by second mobile operating system based mobile communication devices electrical circuitry arrangements operable for receiving information regarding communication bandwidth available to one or more of standby communication relays furnished by one or more second mobile operating system based mobile communication devices including receiving information regarding runtime duration available to one or more of standby communication relays furnished by one or more second mobile operating system based mobile communication devices.

151. The computationally-implemented system of claim 150, wherein the one or more receiving information regarding runtime duration available to of standby communication relays furnished by second mobile operating system based mobile communication devices electrical circuitry arrangements operable for receiving information regarding communication bandwidth available to one or more of standby communication relays furnished by one or more second mobile operating system based mobile communication devices including receiving information regarding runtime duration available to one or more of standby communication relays furnished by one or more second mobile operating system based mobile communication devices comprises:
one or more receiving information regarding runtime duration available regarding battery level available to second mobile operating system based mobile communication devices electrical circuitry arrangements operable for receiving information regarding runtime duration available to one or more of standby communication relays furnished by one or more second mobile operating system based mobile communication devices including receiving information regarding runtime duration available regarding battery level available to one or more one or more second mobile operating system based mobile communication devices.

152. The computationally-implemented system of claim 150, wherein the one or more receiving information regarding runtime duration available to of standby communication relays furnished by second mobile operating system based mobile communication devices electrical circuitry arrangements operable for receiving information regarding communication bandwidth available to one or more of standby communication relays furnished by one or more second mobile operating system based mobile communication devices including receiving information regarding runtime duration available to one or more of standby communication relays furnished by one or more second mobile operating system based mobile communication devices comprises:
one or more receiving information regarding runtime duration available regarding predetermined commitments by users of second mobile operating system based mobile communication devices electrical circuitry arrangements operable for receiving information regarding runtime duration available to one or more of standby communication relays furnished by one or more second mobile operating system based mobile communication devices including receiving information regarding runtime duration available regarding predetermined commitments by users of one or more second mobile operating system based mobile communication devices.

153. The computationally-implemented system of claim 150, wherein the one or more receiving information regarding runtime duration available to of standby communication relays furnished by second mobile operating system based mobile communication devices electrical circuitry arrangements operable for receiving information regarding communication bandwidth available to one or more of standby communication relays furnished by one or more second mobile operating system based mobile communication devices including receiving information regarding runtime duration available to one or more of standby communication relays furnished by one or more second mobile operating system based mobile communication devices comprises:
one or more receiving information regarding runtime duration available regarding potential obstructed communication paths of second mobile operating system based mobile communication devices electrical circuitry arrangements operable for receiving information regarding runtime duration available to one or more of standby communication relays furnished by one or more second mobile operating system based mobile communication devices including receiving information regarding runtime duration available regarding potential obstructed communication paths of one or more second mobile operating system based mobile communication devices.

154. The computationally-implemented system of claim 133, wherein the one or more receiving information contained in second mobile operating system based mobile communication device relayed transmissions electrical circuitry arrangements operable for receiving third information regarding fourth information regarding one or more second communication related events occurring directly between two or more second mobile operating system based mobile communication devices including receiving information at least partially contained in one or more second mobile operating system based mobile communication device relayed transmissions comprises:
one or more receiving information regarding quality of service of communication available to standby communication network relay as furnished by second mobile operating system based mobile communication devices electrical circuitry arrangements operable for receiving information at least partially contained in one or more second mobile operating system based mobile communication device relayed transmissions including receiving information regarding quality of service of communication available to one or more standby communication network relay as furnished by one or more second mobile operating system based mobile communication devices.

155. The computationally-implemented system of claim 133, wherein the one or more receiving information contained in second mobile operating system based mobile communication device relayed transmissions electrical circuitry arrangements operable for receiving third information regarding fourth information regarding one or more second communication related events occurring directly between two or more second mobile operating system based mobile communication devices including receiving information at least partially contained in one or more second mobile operating system based mobile communication device relayed transmissions comprises:
one or more receiving information regarding economic cost structures to be imposed associated standby communication relays furnished by second mobile operating system based mobile communication devices electrical circuitry arrangements operable for receiving information at least partially contained in one or more second mobile operating system based mobile communication device relayed transmissions including receiving information regarding one or more economic cost structures to be imposed associated with one or more standby communication relays furnished by one or more second mobile operating system based mobile communication devices.

156. The computationally-implemented system of claim 155, wherein the one or more receiving information regarding economic cost structures to be imposed associated standby communication relays furnished by second mobile operating system based mobile communication devices electrical circuitry arrangements operable for receiving information at least partially contained in one or more second mobile operating system based mobile communication device relayed transmissions including receiving information regarding one or more economic cost structures to be imposed associated with one or more standby communication relays furnished by one or more second mobile operating system based mobile communication devices comprises:
one or more receiving information regarding commercial credit or cash requirements to access of standby communication relays as furnished by second mobile operating system based mobile communication devices electrical circuitry arrangements operable for receiving information regarding one or more economic cost structures to be imposed associated with one or more standby communication relays furnished by one or more second mobile operating system based mobile communication devices including receiving information regarding commercial credit or cash requirements to access one or more of standby communication relays as furnished by one or more second mobile operating system based mobile communication devices.

157. The computationally-implemented system of claim 133, wherein the one or more receiving information contained in second mobile operating system based mobile communication device relayed transmissions electrical circuitry arrangements operable for receiving third information regarding fourth information regarding one or more second communication related events occurring directly between two or more second mobile operating system based mobile communication devices including receiving information at least partially contained in one or more second mobile operating system based mobile communication device relayed transmissions comprises:
one or more receiving information regarding second mobile operating system based mobile communication devices as having communication paths including line of sight pathways or ricochet pathways electrical circuitry arrangements operable for receiving information at least partially contained in one or more second mobile operating system based mobile communication device relayed transmissions including receiving information regarding one or more second mobile operating system based mobile communication devices as having one or more communication paths including one or more line of sight pathways or one or more ricochet pathways.

158. The computationally-implemented system of claim 88, wherein the one or more relating first information with third information electrical circuitry arrangements operable for relating the first information with the third information, the first information regarding the second information having been received at the one or more first fixed position base station devices being part of a base station network including fixed position base station devices, the second information regarding the one or more first communication related events involving the one or more first mobile operating system based mobile communication devices and the one or more first fixed position base station devices, each of the first communication related events involving one or more of the first mobile operating system based mobile communication devices and one or more of the first fixed position base station devices, the third information regarding the fourth information the fourth information having been received at the one or more second fixed position base station devices being part of the base station network including fixed position base station devices, the fourth information regarding the one or more second communication related events occurring directly between the two or more second mobile operating system based mobile communication devices comprises:
one or more relating first information regarding aspects of base station networks including fixed position base station devices with third information regarding aspects of communication relay networks furnished by second mobile operating system based mobile communication devices electrical circuitry arrangements operable for relating the first information with the third information, the first information regarding the one or more first communication related events involving one or more first mobile operating system based mobile communication devices and one or more first fixed position base station devices, the third information regarding one or more second communication related events occurring directly between two or more second mobile operating system based mobile communication devices including relating the first information regarding one or more aspects of one or more base station networks including one or more fixed position base station devices with the third information regarding one or more aspects of communication relay networks furnished by one or more second mobile operating system based mobile communication devices.

159. The computationally-implemented system of claim 158, wherein the one or more relating first information regarding aspects of base station networks including fixed position base station devices with third information regarding aspects of communication relay networks furnished by second mobile operating system based mobile communication devices electrical circuitry arrangements operable for relating the first information with the third information, the first information regarding the one or more first communication related events involving one or more first mobile operating system based mobile communication devices and one or more first fixed position base station devices, the third information regarding one or more second communication related events occurring directly between two or more second mobile operating system based mobile communication devices including relating the first information regarding one or more aspects of one or more base station networks including one or more fixed position base station devices with the third information regarding one or more aspects of communication relay networks furnished by one or more second mobile operating system based mobile communication devices comprises:
one or more relating first location information regarding first moveable objects that have previously obstructed communication of base station networks including fixed position base station devices with relating second location information regarding second moveable objects that have previously obstructed communication of communication relay networks furnished by second mobile operating system based mobile communication devices electrical circuitry arrangements operable for relating the first information regarding one or more aspects of one or more base station networks including one or more fixed position base station devices with the third information regarding one or more aspects of communication relay networks furnished by one or more second mobile operating system based mobile communication devices including relating first location information regarding one or more first moveable objects that have previously obstructed communication of one or more base station networks including one or more fixed position base station devices with relating second location information regarding one or more second moveable objects that have previously obstructed communication of communication relay networks furnished by one or more second mobile operating system based mobile communication devices.

160. The computationally-implemented system of claim 158, wherein the one or more relating first information regarding aspects of base station networks including fixed position base station devices with third information regarding aspects of communication relay networks furnished by second mobile operating system based mobile communication devices electrical circuitry arrangements operable for relating the first information with the third information, the first information regarding the one or more first communication related events involving one or more first mobile operating system based mobile communication devices and one or more first fixed position base station devices, the third information regarding one or more second communication related events occurring directly between two or more second mobile operating system based mobile communication devices including relating the first information regarding one or more aspects of one or more base station networks including one or more fixed position base station devices with the third information regarding one or more aspects of communication relay networks furnished by one or more second mobile operating system based mobile communication devices comprises:
one or more relating first statistical information regarding statistical probabilities of remaining in communication using base station networks including fixed position base station devices with relating second statistical information regarding statistical probabilities of remaining in communication using second communication relay networks furnished by second mobile operating system based mobile communication devices electrical circuitry arrangements operable for relating the first information regarding one or more aspects of one or more base station networks including one or more fixed position base station devices with the third information regarding one or more aspects of communication relay networks furnished by one or more second mobile operating system based mobile communication devices including relating first statistical information regarding one or more statistical probabilities of remaining in communication using one or more base station networks including one or more fixed position base station devices with relating second statistical information regarding one or more statistical probabilities of remaining in communication using one or more second communication relay networks furnished by one or more second mobile operating system based mobile communication devices.

161. The computationally-implemented system of claim 158, wherein the one or more relating first information regarding aspects of base station networks including fixed position base station devices with third information regarding aspects of communication relay networks furnished by second mobile operating system based mobile communication devices electrical circuitry arrangements operable for relating the first information with the third information, the first information regarding the one or more first communication related events involving one or more first mobile operating system based mobile communication devices and one or more first fixed position base station devices, the third information regarding one or more second communication related events occurring directly between two or more second mobile operating system based mobile communication devices including relating the first information regarding one or more aspects of one or more base station networks including one or more fixed position base station devices with the third information regarding one or more aspects of communication relay networks furnished by one or more second mobile operating system based mobile communication devices comprises:
one or more relating first GPS positioning data regarding base station networks including fixed position base station devices with relating second GPS positioning data regarding second communication relay networks furnished by second mobile operating system based mobile communication devices electrical circuitry arrangements operable for relating the first information regarding one or more aspects of one or more base station networks including one or more fixed position base station devices with the third information regarding one or more aspects of communication relay networks furnished by one or more second mobile operating system based mobile communication devices including relating first GPS positioning data regarding one or more base station networks including one or more fixed position base station devices with relating second GPS positioning data regarding one or more second communication relay networks furnished by one or more second mobile operating system based mobile communication devices.

162. The computationally-implemented system of claim 158, wherein the one or more relating first information regarding aspects of base station networks including fixed position base station devices with third information regarding aspects of communication relay networks furnished by second mobile operating system based mobile communication devices electrical circuitry arrangements operable for relating the first information with the third information, the first information regarding the one or more first communication related events involving one or more first mobile operating system based mobile communication devices and one or more first fixed position base station devices, the third information regarding one or more second communication related events occurring directly between two or more second mobile operating system based mobile communication devices including relating the first information regarding one or more aspects of one or more base station networks including one or more fixed position base station devices with the third information regarding one or more aspects of communication relay networks furnished by one or more second mobile operating system based mobile communication devices comprises:
one or more relating first potential obstructions to electronic network communication located proximate to fixed position base station devices of base station networks with relating second potential obstructions to electronic network communication located proximate to second mobile operating system based mobile communication devices of second communication relay networks electrical circuitry arrangements operable for relating the first information regarding one or more aspects of one or more base station networks including one or more fixed position base station devices with the third information regarding one or more aspects of communication relay networks furnished by one or more second mobile operating system based mobile communication devices including relating first potential obstructions to electronic network communication located proximate to one or more fixed position base station devices of one or more base station networks with relating second potential obstructions to electronic network communication located proximate to one or more second mobile operating system based mobile communication devices of one or more second communication relay networks.

163. The computationally-implemented system of claim 158, wherein the one or more relating first information regarding aspects of base station networks including fixed position base station devices with third information regarding aspects of communication relay networks furnished by second mobile operating system based mobile communication devices electrical circuitry arrangements operable for relating the first information with the third information, the first information regarding the one or more first communication related events involving one or more first mobile operating system based mobile communication devices and one or more first fixed position base station devices, the third information regarding one or more second communication related events occurring directly between two or more second mobile operating system based mobile communication devices including relating the first information regarding one or more aspects of one or more base station networks including one or more fixed position base station devices with the third information regarding one or more aspects of communication relay networks furnished by one or more second mobile operating system based mobile communication devices comprises:
one or more relating first communication histories of successful communication of fixed position base station devices of base station networks with relating second communication histories of successful communication of second mobile operating system based mobile communication devices of second communication relay networks electrical circuitry arrangements operable for relating the first information regarding one or more aspects of one or more base station networks including one or more fixed position base station devices with the third information regarding one or more aspects of communication relay networks furnished by one or more second mobile operating system based mobile communication devices including relating first communication histories of successful communication of one or more fixed position base station devices of one or more base station networks with relating second communication histories of successful communication of one or more second mobile operating system based mobile communication devices of one or more second communication relay networks.

164. The computationally-implemented system of claim 163, wherein the one or more relating first communication histories of successful communication of fixed position base station devices of base station networks with relating second communication histories of successful communication of second mobile operating system based mobile communication devices of second communication relay networks electrical circuitry arrangements operable for relating the first information regarding one or more aspects of one or more base station networks including one or more fixed position base station devices with the third information regarding one or more aspects of communication relay networks furnished by one or more second mobile operating system based mobile communication devices including relating first communication histories of successful communication of one or more fixed position base station devices of one or more base station networks with relating second communication histories of successful communication of one or more second mobile operating system based mobile communication devices of one or more second communication relay networks comprises:
one or more relating first communication history data previously stored and forwarded between fixed position base station devices of base station networks with relating second communication history data previously stored and forwarded between second mobile operating system based mobile communication devices of second communication relay networks electrical circuitry arrangements operable for relating first communication histories of successful communication of one or more fixed position base station devices of one or more base station networks with relating second communication histories of successful communication of one or more second mobile operating system based mobile communication devices of one or more second communication relay networks including relating first communication history data previously stored and forwarded between one or more fixed position base station devices of one or more base station networks with relating second communication history data previously stored and forwarded between one or more second mobile operating system based mobile communication devices of one or more second communication relay networks.

165. The computationally-implemented system of claim 158, wherein the one or more relating first information regarding aspects of base station networks including fixed position base station devices with third information regarding aspects of communication relay networks furnished by second mobile operating system based mobile communication devices electrical circuitry arrangements operable for relating the first information with the third information, the first information regarding the one or more first communication related events involving one or more first mobile operating system based mobile communication devices and one or more first fixed position base station devices, the third information regarding one or more second communication related events occurring directly between two or more second mobile operating system based mobile communication devices including relating the first information regarding one or more aspects of one or more base station networks including one or more fixed position base station devices with the third information regarding one or more aspects of communication relay networks furnished by one or more second mobile operating system based mobile communication devices comprises:
one or more relating first information regarding communication capacity available to fixed position base station devices of base station networks with relating second information regarding communication capacity available to second mobile operating system based mobile communication devices of second communication relay networks electrical circuitry arrangements operable for relating the first information regarding one or more aspects of one or more base station networks including one or more fixed position base station devices with the third information regarding one or more aspects of communication relay networks furnished by one or more second mobile operating system based mobile communication devices including relating first information regarding communication capacity available to one or more fixed position base station devices of one or more base station networks with relating second information regarding communication capacity available to one or more second mobile operating system based mobile communication devices of one or more second communication relay networks.

166. The computationally-implemented system of claim 158, wherein the one or more relating first information regarding aspects of base station networks including fixed position base station devices with third information regarding aspects of communication relay networks furnished by second mobile operating system based mobile communication devices electrical circuitry arrangements operable for relating the first information with the third information, the first information regarding the one or more first communication related events involving one or more first mobile operating system based mobile communication devices and one or more first fixed position base station devices, the third information regarding one or more second communication related events occurring directly between two or more second mobile operating system based mobile communication devices including relating the first information regarding one or more aspects of one or more base station networks including one or more fixed position base station devices with the third information regarding one or more aspects of communication relay networks furnished by one or more second mobile operating system based mobile communication devices comprises:
one or more relating first information regarding potential obstructions to electronic communication proximate to fixed position base station devices of base station networks with relating second information regarding potential obstructions to electronic communication proximate to second mobile operating system based mobile communication devices of second communication relay networks electrical circuitry arrangements operable for relating the first information regarding one or more aspects of one or more base station networks including one or more fixed position base station devices with the third information regarding one or more aspects of communication relay networks furnished by one or more second mobile operating system based mobile communication devices including relating first information regarding one or more potential obstructions to electronic communication proximate to one or more fixed position base station devices of one or more base station networks with relating second information regarding one or more potential obstructions to electronic communication proximate to one or more second mobile operating system based mobile communication devices of one or more second communication relay networks.

167. The computationally-implemented system of claim 159, wherein the one or more relating first location information regarding first moveable objects that have previously obstructed communication of base station networks including fixed position base station devices with relating second location information regarding second moveable objects that have previously obstructed communication of communication relay networks furnished by second mobile operating system based mobile communication devices electrical circuitry arrangements operable for relating the first information regarding one or more aspects of one or more base station networks including one or more fixed position base station devices with the third information regarding one or more aspects of communication relay networks furnished by one or more second mobile operating system based mobile communication devices including relating first location information regarding one or more first moveable objects that have previously obstructed communication of one or more base station networks including one or more fixed position base station devices with relating second location information regarding one or more second moveable objects that have previously obstructed communication of communication relay networks furnished by one or more second mobile operating system based mobile communication devices comprises:
one or more relating first information regarding potential electronic communication service interruptions of fixed position base station devices of base station networks with relating second information regarding potential electronic communication service interruptions of second mobile operating system based mobile communication devices of second communication relay networks electrical circuitry arrangements operable for relating first location information regarding one or more first moveable objects that have previously obstructed communication of one or more base station networks including one or more fixed position base station devices with relating second location information regarding one or more second moveable objects that have previously obstructed communication of communication relay networks furnished by one or more second mobile operating system based mobile communication devices including relating first information regarding one or more potential electronic communication service interruptions of one or more fixed position base station devices of one or more base station networks with relating second information regarding one or more potential electronic communication service interruptions of one or more second mobile operating system based mobile communication devices of one or more second communication relay networks.

168. The computationally-implemented system of claim 158, wherein the one or more relating first information regarding aspects of base station networks including fixed position base station devices with third information regarding aspects of communication relay networks furnished by second mobile operating system based mobile communication devices electrical circuitry arrangements operable for relating the first information with the third information, the first information regarding the one or more first communication related events involving one or more first mobile operating system based mobile communication devices and one or more first fixed position base station devices, the third information regarding one or more second communication related events occurring directly between two or more second mobile operating system based mobile communication devices including relating the first information regarding one or more aspects of one or more base station networks including one or more fixed position base station devices with the third information regarding one or more aspects of communication relay networks furnished by one or more second mobile operating system based mobile communication devices comprises:
one or more relating first service quality ratings regarding fixed position base station devices of base station networks with relating second service quality ratings regarding second mobile operating system based mobile communication devices of second communication relay networks electrical circuitry arrangements operable for relating the first information regarding one or more aspects of one or more base station networks including one or more fixed position base station devices with the third information regarding one or more aspects of communication relay networks furnished by one or more second mobile operating system based mobile communication devices including relating first service quality ratings regarding one or more fixed position base station devices of one or more base station networks with relating second service quality ratings regarding one or more second mobile operating system based mobile communication devices of one or more second communication relay networks.

169. The computationally-implemented system of claim 158, wherein the one or more relating first information regarding aspects of base station networks including fixed position base station devices with third information regarding aspects of communication relay networks furnished by second mobile operating system based mobile communication devices electrical circuitry arrangements operable for relating the first information with the third information, the first information regarding the one or more first communication related events involving one or more first mobile operating system based mobile communication devices and one or more first fixed position base station devices, the third information regarding one or more second communication related events occurring directly between two or more second mobile operating system based mobile communication devices including relating the first information regarding one or more aspects of one or more base station networks including one or more fixed position base station devices with the third information regarding one or more aspects of communication relay networks furnished by one or more second mobile operating system based mobile communication devices comprises:
one or more relating first cost ratings regarding fixed position base station devices of base station networks with relating second cost ratings regarding second mobile operating system based mobile communication devices of second communication relay networks electrical circuitry arrangements operable for relating the first information regarding one or more aspects of one or more base station networks including one or more fixed position base station devices with the third information regarding one or more aspects of communication relay networks furnished by one or more second mobile operating system based mobile communication devices including relating first cost ratings regarding one or more fixed position base station devices of one or more base station networks with relating second cost ratings regarding one or more second mobile operating system based mobile communication devices of one or more second communication relay networks.

170. The computationally-implemented system of claim 158, wherein the one or more relating first information regarding aspects of base station networks including fixed position base station devices with third information regarding aspects of communication relay networks furnished by second mobile operating system based mobile communication devices electrical circuitry arrangements operable for relating the first information with the third information, the first information regarding the one or more first communication related events involving one or more first mobile operating system based mobile communication devices and one or more first fixed position base station devices, the third information regarding one or more second communication related events occurring directly between two or more second mobile operating system based mobile communication devices including relating the first information regarding one or more aspects of one or more base station networks including one or more fixed position base station devices with the third information regarding one or more aspects of communication relay networks furnished by one or more second mobile operating system based mobile communication devices comprises:
one or more relating first availability forecast ratings for fixed position base station devices of base station networks with relating second availability forecast ratings for second mobile operating system based mobile communication devices of second communication relay networks electrical circuitry arrangements operable for relating the first information regarding one or more aspects of one or more base station networks including one or more fixed position base station devices with the third information regarding one or more aspects of communication relay networks furnished by one or more second mobile operating system based mobile communication devices including relating first availability forecast ratings for one or more fixed position base station devices of one or more base station networks with relating second availability forecast ratings for one or more second mobile operating system based mobile communication devices of one or more second communication relay networks.

171. The computationally-implemented system of claim 158, wherein the one or more relating first information regarding aspects of base station networks including fixed position base station devices with third information regarding aspects of communication relay networks furnished by second mobile operating system based mobile communication devices electrical circuitry arrangements operable for relating the first information with the third information, the first information regarding the one or more first communication related events involving one or more first mobile operating system based mobile communication devices and one or more first fixed position base station devices, the third information regarding one or more second communication related events occurring directly between two or more second mobile operating system based mobile communication devices including relating the first information regarding one or more aspects of one or more base station networks including one or more fixed position base station devices with the third information regarding one or more aspects of communication relay networks furnished by one or more second mobile operating system based mobile communication devices comprises:
one or more relating first reliability ratings for fixed position base station devices of base station networks with relating second reliability ratings for second mobile operating system based mobile communication devices of second communication relay networks electrical circuitry arrangements operable for relating the first information regarding one or more aspects of one or more base station networks including one or more fixed position base station devices with the third information regarding one or more aspects of communication relay networks furnished by one or more second mobile operating system based mobile communication devices including relating first reliability ratings for one or more fixed position base station devices of one or more base station networks with relating second reliability ratings for one or more second mobile operating system based mobile communication devices of one or more second communication relay networks.

172. The computationally-implemented system of claim 158, wherein the one or more relating first information regarding aspects of base station networks including fixed position base station devices with third information regarding aspects of communication relay networks furnished by second mobile operating system based mobile communication devices electrical circuitry arrangements operable for relating the first information with the third information, the first information regarding the one or more first communication related events involving one or more first mobile operating system based mobile communication devices and one or more first fixed position base station devices, the third information regarding one or more second communication related events occurring directly between two or more second mobile operating system based mobile communication devices including relating the first information regarding one or more aspects of one or more base station networks including one or more fixed position base station devices with the third information regarding one or more aspects of communication relay networks furnished by one or more second mobile operating system based mobile communication devices comprises:
one or more relating first duration of connection ratings for fixed position base station devices of base station networks with relating second duration of connection ratings for second mobile operating system based mobile communication devices of second communication relay networks electrical circuitry arrangements operable for relating the first information regarding one or more aspects of one or more base station networks including one or more fixed position base station devices with the third information regarding one or more aspects of communication relay networks furnished by one or more second mobile operating system based mobile communication devices including relating first duration of connection ratings for one or more fixed position base station devices of one or more base station networks with relating second duration of connection ratings for one or more second mobile operating system based mobile communication devices of one or more second communication relay networks.

173. The computationally-implemented system of claim 158, wherein the one or more relating first information regarding aspects of base station networks including fixed position base station devices with third information regarding aspects of communication relay networks furnished by second mobile operating system based mobile communication devices electrical circuitry arrangements operable for relating the first information with the third information, the first information regarding the one or more first communication related events involving one or more first mobile operating system based mobile communication devices and one or more first fixed position base station devices, the third information regarding one or more second communication related events occurring directly between two or more second mobile operating system based mobile communication devices including relating the first information regarding one or more aspects of one or more base station networks including one or more fixed position base station devices with the third information regarding one or more aspects of communication relay networks furnished by one or more second mobile operating system based mobile communication devices comprises:
one or more relating first communication bandwidth ratings for fixed position base station devices of base station networks with relating second communication bandwidth ratings for second mobile operating system based mobile communication devices of second communication relay networks electrical circuitry arrangements operable for relating the first information regarding one or more aspects of one or more base station networks including one or more fixed position base station devices with the third information regarding one or more aspects of communication relay networks furnished by one or more second mobile operating system based mobile communication devices including relating first communication bandwidth ratings for one or more fixed position base station devices of one or more base station networks with relating second communication bandwidth ratings for one or more second mobile operating system based mobile communication devices of one or more second communication relay networks.

174. The computationally-implemented system of claim 158, wherein the one or more relating first information regarding aspects of base station networks including fixed position base station devices with third information regarding aspects of communication relay networks furnished by second mobile operating system based mobile communication devices electrical circuitry arrangements operable for relating the first information with the third information, the first information regarding the one or more first communication related events involving one or more first mobile operating system based mobile communication devices and one or more first fixed position base station devices, the third information regarding one or more second communication related events occurring directly between two or more second mobile operating system based mobile communication devices including relating the first information regarding one or more aspects of one or more base station networks including one or more fixed position base station devices with the third information regarding one or more aspects of communication relay networks furnished by one or more second mobile operating system based mobile communication devices comprises:
one or more relating first ease of use ratings for fixed position base station devices of base station networks with relating second ease of use ratings for second mobile operating system based mobile communication devices of second communication relay networks electrical circuitry arrangements operable for relating the first information regarding one or more aspects of one or more base station networks including one or more fixed position base station devices with the third information regarding one or more aspects of communication relay networks furnished by one or more second mobile operating system based mobile communication devices including relating first ease of use ratings for one or more fixed position base station devices of one or more base station networks with relating second ease of use ratings for one or more second mobile operating system based mobile communication devices of one or more second communication relay networks.

175. A computationally-implemented system comprising:
means for receiving first information regarding second information, the second information having been received at one or more first fixed position base station devices being part of a base station network including fixed position base station devices, the second information regarding one or more first communication related events involving one or more first mobile operating system based mobile communication devices and the one or more first fixed position base station devices, each of the first communication related events involving one or more of the first mobile operating system based mobile communication devices and one or more of the first fixed position base station devices;
means for receiving third information regarding fourth information, the fourth information having been received at one or more second fixed position base station devices being part of the base station network including fixed position base station devices, the fourth information regarding one or more second communication related events occurring directly between two or more second mobile operating system based mobile communication devices; and
means for relating the first information with the third information, the first information regarding the second information having been received at the one or more first fixed position base station devices being part of a base station network including fixed position base station devices, the second information regarding the one or more first communication related events involving the one or more first mobile operating system based mobile communication devices and the one or more first fixed position base station devices, each of the first communication related events involving one or more of the first mobile operating system based mobile communication devices and one or more of the first fixed position base station devices, the third information regarding the fourth information the fourth information having been received at the one or more second fixed position base station devices being part of the base station network including fixed position base station devices, the fourth information regarding the one or more second communication related events occurring directly between the two or more second mobile operating system based mobile communication devices.

176. A computer program product, comprising:
a signal-bearing medium bearing:
one or more instructions for receiving first information regarding second information, the second information having been received at one or more first fixed position base station devices being part of a base station network including fixed position base station devices, the second information regarding one or more first communication related events involving one or more first mobile operating system based mobile communication devices and the one or more first fixed position base station devices, each of the first communication related events involving one or more of the first mobile operating system based mobile communication devices and one or more of the first fixed position base station devices;
one or more instructions for receiving third information regarding fourth information, the fourth information having been received at one or more second fixed position base station devices being part of the base station network including fixed position base station devices, the fourth information regarding one or more second communication related events occurring directly between two or more second mobile operating system based mobile communication devices; and
one or more instructions for relating the first information with the third information, the first information regarding the second information having been received at the one or more first fixed position base station devices being part of a base station network including fixed position base station devices, the second information regarding the one or more first communication related events involving the one or more first mobile operating system based mobile communication devices and the one or more first fixed position base station devices, each of the first communication related events involving one or more of the first mobile operating system based mobile communication devices and one or more of the first fixed position base station devices, the third information regarding the fourth information the fourth information having been received at the one or more second fixed position base station devices being part of the base station network including fixed position base station devices, the fourth information regarding the one or more second communication related events occurring directly between the two or more second mobile operating system based mobile communication devices.

177. A device defined by a computational language comprising:
one or more interchained physical machines ordered for receiving first information regarding second information, the second information having been received at one or more first fixed position base station devices being part of a base station network including fixed position base station devices, the second information regarding one or more first communication related events involving one or more first mobile operating system based mobile communication devices and the one or more first fixed position base station devices, each of the first communication related events involving one or more of the first mobile operating system based mobile communication devices and one or more of the first fixed position base station devices;
one or more interchained physical machines ordered for receiving third information regarding fourth information, the fourth information having been received at one or more second fixed position base station devices being part of the base station network including fixed position base station devices, the fourth information regarding one or more second communication related events occurring directly between two or more second mobile operating system based mobile communication devices; and
one or more interchained physical machines ordered for relating the first information with the third information, the first information regarding the second information having been received at the one or more first fixed position base station devices being part of a base station network including fixed position base station devices, the second information regarding the one or more first communication related events involving the one or more first mobile operating system based mobile communication devices and the one or more first fixed position base station devices, each of the first communication related events involving one or more of the first mobile operating system based mobile communication devices and one or more of the first fixed position base station devices, the third information regarding the fourth information the fourth information having been received at the one or more second fixed position base station devices being part of the base station network including fixed position base station devices, the fourth information regarding the one or more second communication related events occurring directly between the two or more second mobile operating system based mobile communication devices.
